(19) United States
(12) Patent Application Publication
(10) Pub. No.: US 2018/0361326 A1
(43) Pub. Date: Dec. 20, 2018

(54) PERMEABLE MEMBRANE USING POLYMER AND LAMINATE THEREOF

(71) Applicant: DIC Corporation, Tokyo (JP)

(72) Inventors: Yasuhiro Kuwana, Kita-adachi-gun (JP); Kouichi Endo, Kita-adachi-gun (JP); Isa Nishiyama, Kita-adachi-gun (JP); Susumu Matsuzaki, Kita-adachi-gun (JP); Yutaka Kadomoto, Kita-adachi-gun (JP)

(73) Assignee: DIC Corporation, Tokyo (JP)

(21) Appl. No.: 15/777,518

(22) PCT Filed: Nov. 8, 2016
(86) PCT No.: PCT/JP2016/083036

§ 371 Date: May 18, 2018

(30) Foreign Application Priority Data
Nov. 20, 2015 (JP) 2015-227756

(51) Int. Cl. B01D 71/40; B01D 69/06; B01D 69/08; B01D 69/12; B01D 53/22; B01D 67/00; B01D 69/02; C08F 222/10; C08F 220/34; C08F 220/30; C08J 7/04

(52) U.S. Cl. CPC B01D 71/40; C08J 2433/14; B01D 69/08; B01D 69/125; B01D 53/228; B01D 67/0006; B01D 69/02; C08F 222/1006; C08F 220/34; C08F 220/30; C08J 7/047; B01D 2323/345; B01D 2053/224; C08F 2222/102; C08F 2220/303; C08F 2800/20; C08J 2301/08; C08J 2323/20; C08J 2323/12; C08J 2323/06; C08J 2435/02; B01D 69/06

(57) ABSTRACT

The present invention aims to provide a gas-selective permeable membrane that has gas permeability and gas selectivity capable of highly separating a target gas from other gases, is less likely to be influenced by the temperature condition employed, and is excellent in strength and handleability. The invention uses at least one or more polymerizable compounds to provide a gas-selective permeable film that contains a polymer having an optically uniaxial or multiaxial molecular alignment and to provide a laminate including a gas-permeable substrate and the permeable membrane laminated thereon.

### TECHNICAL FIELD

The present invention relates to a permeable membrane that enables selective permeation of gases such as hydrogen, helium, methane, carbon monoxide, carbon dioxide, nitrogen, oxygen, ethane, ethylene, propane, propylene, butane, hydrogen sulfide, etc., and to a laminate thereof.

### BACKGROUND ART

Heretofore, various technical fields have an important requirement for selective permeation of gases. For example, most urgently energy-saving selective recovery of carbon dioxide from a large-scale carbon dioxide generation source such as a thermal power plant, a steel plant blast furnace or the like, as well as most urgently selective recovery of carbon dioxide from a carbon dioxide generation source that is discharged out from an internal combustion engine system of automobiles, ships or the like is required. In addition, from petrochemical industry-derived off-gas source mixtures of natural gas, naphtha, liquefied natural gas, liquefied oil gas and the like, or from sludge in sewage treatment facilities, or from biogases generated by biologically treating garbage in garbage disposal facilities, selective recovery of energy sources such as hydrogen and methane is required.

Further, in general industrial use or household use, gas-selective permeable membranes such as oxygen enrichment membranes for increasing combustion efficiency in vehicles, oxygen enrichment membranes for various air conditioners, oxygen enrichment membranes for use in products for the purpose of increasing oxygen concentration in air for health maintenance and promotion, nitrogen enrichment membranes for use in products for the purpose of oxidation prevention, corrosion prevention, explosion protection use and food freshness enhancement and others have extremely wide-ranging applications including a large variety of gases.

Among gas mixtures, various methods of selectively permeating a specific gas are known, including a distillation method using a change of phase, an absorption method of making a specific gas absorbed by an absorbent, an adsorption method of utilizing adsorption/desorption to/from a porous adsorbent, a selective permeable membrane method of utilizing a difference in gas permeation speed between membranes, etc. According to the method of using a selective permeable membrane formed of a polymer material, a specific gas can be selectively taken in merely by making a gas mixture pass through the membrane, and therefore the method is excellent in the viewpoint of energy-saving performance. In addition, a polymer material has an extremely good workability, and therefore can be worked into a flat membrane, a hollow-fiber membrane, a laminate membrane, etc., can be down-sized in forming modules, and is consequently excellent also in point of space-saving performance.

The fundamental requirements for the gas-selective permeable membrane using a polymer material include:

(1) gas selectivity between the target gas and other components;

(2) gas permeability;

(3) physical/chemical properties of membrane such as strength, heat resistance, moisture resistance, solvent resistance, etc. The gas permeability of a gas-selective permeable membrane is a property that governs mainly the necessary membrane area and membrane module and the size of device, that is, the initial cost, and therefore, by developing a material having high gas permeability and by reducing the thickness of a highly gas-selective membrane, industrially practicable performance can be realized. On the other hand, the gas selectivity of a membrane is a property naturally intrinsic to the membrane material, and is therefore a property that governs mainly the yield to the necessary gas, namely, a property that governs the running cost.

From such viewpoints, development using various polymer materials is now under way (PTLs 1 to 4).

However, a gas-selective permeable membrane is generally under such a problematic trade-off relation that increase in gas selectivity reduces permeability. In such a manner, gas selectivity and permeability are generally in a contradictory relationship therebetween, and a polymer material excellent in permeability is poor in gas selectivity. Accordingly, for realizing a permeable membrane having excellent gas selectivity, it is indispensable to develop a membrane material excellent in the balance of the two contradictory properties and to develop a membrane material having an excellent membrane-forming property capable of forming a thin membrane” In addition, it is also indispensable to develop a most suitable membrane-forming method using these materials.

For solving the above-mentioned problems, development of a membrane material that contains a non-polymerizable compound has been investigated in some methods (PTLs 5 to 10). For example, using a polymer membrane formed by mixing a non-polymerizable compound in a polymer material such as a vinyl halide polymer, a polyarylene or the like, a permeation coefficient of various gases is measured (PTLs 5 and 7). Using a polymer membrane mixed with a non-polymerizable compound, the permeation coefficient of oxygen and nitrogen is measured. Further, there are known cases of using a laminate membrane produced by forming a layer of a non-polymerizable compound on a polymer material having fine pores, in measuring a permeation coefficient of various gases (PTLs 6 and 8). However, these non-polymerizable compounds have a problem in that the denseness thereof greatly varies depending on temperature, and with that, the condition of the polymer membrane greatly changes and the temperature dependence of the gas permeability thereof is great. In addition, in some cases, heating, cooling or the like is needed for attaining the desired permeability, and therefore there still remains a problem in point of energy-saving. Further, since the properties of the non-polymerizable compound vary at high temperatures, another problem is that it is difficult to maintain a constant membrane state at high temperatures. On the other hand, using an inorganic porous membrane that uses a non-polymerizable compound as a pore-forming material for forming the inorganic porous membrane, a permeation coefficient of various gases is measured (PTL 9). However, in this, excessive heat and much time are necessary in the membrane baking step, and therefore the method is problematic in point of energy saving. Further, since the membrane is not flexible, there still remains a problem of difficulty in module construction.

### CITATION LIST

### Patent Literature

PTL 1: JP-6-269650A

PTL 2: JP-2007-211208A

PTL 3: JP-10-156157A

PTL 4: JP-2006-314944A

PTL 5: JP-59-213407A

PTL 6: JP-60-102901A

PTL 7: JP-62-163710A

PTL 8: JP-02-175737A

PTL 9: JP-2004-029719A

PTL 10: JP-08-073572A

### SUMMARY OF INVENTION

### Technical Problem

In general, a process for a type of gas molecules to pass through an organic membrane is a complicated phenomenon that occurs on the molecule level, and therefore greatly varies depending on the structure of the molecules used in the organic membrane and on the structure of the entire membrane. In particular, gas-selective permeability is determined by the combination of dissolution of gas molecules into the surface of an organic membrane and diffusion of gas molecules into the organic membrane, and therefore for increasing the selective permeability, it is important to control the structures of the compounds to be used for the organic membrane (including low-molecular compounds, and high-molecular compounds), the distribution state of the compounds in the organic membrane, and the structure of the entire organic membrane. In addition, from the viewpoint of practical use, it is desired that the organic membrane can be kept in a constant state in a range from low temperatures to high temperatures, that is, the temperature dependence of the gas selectivity and permeability of the membrane is small, and the permeable membrane is easy to form.

Accordingly, a problem to be solved by the present invention is to provide a gas-selective permeable membrane which has gas permeability and gas selectivity capable of highly separating a target gas from other components, is less likely to be influenced by the temperature conditions used, and is excellent in handleability such as strength.

### Solution to Problem

For solving the above-mentioned problems, the present inventors have assiduously studied materials which can maintain a membrane state at high temperatures, whose temperature dependence in point of gas selectivity and permeability is relatively small, and which can be formed into a membrane relatively easily, and as a result, have specifically noted a polymerizable compound that can polymerize while the molecules thereof keep a predetermined alignment state. After that, the inventors have found that a composition using the polymerizable compound can be formed into a membrane with ease and that the polymerized membrane has a crosslinked structure and therefore can maintain a membrane state with a predetermined alignment state kept therein even at high temperatures, and have reached the present invention.

Specifically, the present invention provides a gas-selective permeable membrane that is produced using at least one or more polymerizable compounds and contains a polymer having an optically uniaxial or multiaxial molecular alignment, and provides a laminate including a gas-permeable substrate and the permeable membrane laminated thereon.

### Advantageous Effects of Invention

The permeable membrane of the present invention is excellent in gas-selective permeability and is easy to form, and is therefore excellent in productivity. In addition, the membrane can maintain the membrane state even at high temperature. Accordingly, the permeable membrane can be used for carbon dioxide recovery in thermal power plants, steel plant blast furnaces, etc., carbon dioxide recovery from carbon dioxide generation sources discharged out from internal combustion engine systems of automobiles, ships, etc., and recovery of energy sources such as hydrogen and methane from petrochemical industry-derived off-gas source mixtures of natural gas, naphtha, liquefied natural gas, liquefied oil gas and the like, or from sludge in sewage treatment facilities, or from biogases generated from garbage disposal facilities, and further, the permeable membrane can be used for oxygen enrichment membranes for increasing combustion efficiency in vehicles, oxygen enrichment membranes for various air conditioners, oxygen enrichment membranes for use in products for the purpose of increasing oxygen concentration in air for health maintenance and promotion, nitrogen enrichment membranes for use in products for the purpose of oxidation prevention, corrosion prevention, explosion protection use and food freshness enhancement, etc.

### DESCRIPTION OF EMBODIMENTS

### (Uniaxial or Multiaxial Molecular Alignment)

The permeable membrane of the present invention is a gas-selective permeable membrane, produced using at least one or more polymerizable compounds, and contains a polymer having an optically uniaxial or multiaxial molecular alignment. The permeable membrane of the present invention can be produced by forming, into a film, a composition that contains a polymerizable compound having at least one or more polymerizable groups and a hard segment having 3 or more cyclic structures, and optionally a soft segment, and polymerizing the composition.

Specifically, the permeable membrane containing a polymer having an optically uniaxial or multiaxial molecular alignment is a permeable membrane in which the polymerizable compound is polymerized in such a state as shown in FIGS. 1 to 6 to form a polymer.

The molecular alignment state of the polymer may be, for example, a) a molecular alignment state having alignment regularity alone, where the long axis of each rod-shaped molecule constituting the polymer faces the same direction, and the long-range order relating to the gravity center of the molecules is in the same state as that of a liquid, b) a helical structure-containing molecular alignment state, in which the molecular alignment of the polymer is twisted with a uniform period, c) a molecular alignment state corresponding to a uniaxial or pseudo-biaxial crystal state, in which the long axis of each rod-shaped molecule constituting the polymer faces a uniform direction, and the rod-shaped molecules form a layer structure by the molecular long axis unit, d) a molecular alignment state in which disc-shaped molecules constituting the polymer are layered to form a column-shaped structure, e) a molecular alignment state in which column-shaped structures each formed of layered disc-shaped molecules constituting the polymer are aligned at regular intervals, or f) a molecular alignment state with no molecular regularity except for disc-shaped molecules constituting the polymer facing a uniform direction.

In the case of the molecular alignment state of the above a) or the above b), the long axis direction of the rod-shaped molecules may align in the horizontal direction with respect to the face of the membrane, or may align at a continuously varying tilt angle, or may align in the vertical direction with respect to the face of the membrane. In the case of the molecular alignment state of the above c), the long axis direction of the rod-shaped molecules may align in the horizontal direction with respect to the face of the membrane, or may align in the vertical direction with respect to the face of the membrane, or may align at a predetermined tilt angle. Further, the rod-shaped molecules forming the layer structure may align at regular intervals. In the case of the molecular alignment state of the above d) or the above e), the disc-shaped molecules may align in the horizontal direction with respect to the face of the membrane, or may align in the vertical direction with respect to the face of the membrane, or may align at a predetermined tilt angle. In the case of the molecular alignment state of the above f), the disc-shaped molecules may align in the horizontal direction with respect to the face of the membrane or may align in the vertical direction with respect to the face of the membrane, or may align at a continuously varying tilt angle.

Examples of the molecular alignment state exhibited by the permeable membrane of the present invention are shown in FIGS. 1 to 6.

### BRIEF DESCRIPTION OF DRAWINGS

FIG. 1 shows a permeable membrane containing a polymer formed through polymerization in a state where the polymerizable compound used is aligned uniaxially in the horizontal direction with respect to the face of the membrane. The long axis of each rod-shaped molecule constituting the polymer is in the horizontal direction with respect to the face of the membrane.

FIG. 2 shows a permeable membrane containing a polymer formed through polymerization in a state where the polymerizable compound used is aligned uniaxially in the vertical direction with respect to the face of the membrane. The long axis of each rod-shaped molecule constituting the polymer is in the vertical direction with respect to the face of the membrane.

FIG. 3 shows a permeable membrane containing a polymer formed through polymerization in a state where the polymerizable compound used is aligned uniaxially in the horizontal direction only with respect to one face (back face) of the membrane and where the alignment state varies little by little in a tilt alignment state from the surface of the membrane toward the inside of the membrane. The long axis of each rod-shaped molecule constituting the polymer is in the horizontal direction with respect to one face alone of the membrane.

FIG. 4 shows a permeable membrane containing a polymer formed through polymerization in an alignment state having a predetermined periodical helical structure in the membrane thickness direction, in which the polymerizable compound used is aligned in the horizontal direction with respect to the face of the membrane. The long axis of each rod-shaped molecule constituting the polymer is in the horizontal direction with respect to the face of the membrane and aligns helically in the membrane thickness direction.

FIG. 5 shows a permeable membrane containing a polymer formed through polymerization in a state where the polymerizable compound used has a long-range order with predetermined periodicity in the vertical direction with respect to the face of the membrane and does not have an order or has a short-range order but not a long-range order in the horizontal direction with respect to the face of the membrane. The long axis of each rod-shaped molecule constituting the polymer is in the horizontal direction with respect to the face of the membrane.

FIG. 6 shows a permeable membrane containing a polymer formed through polymerization in a state where the polymerizable compound used has a long-range order with predetermined periodicity in the horizontal direction with respect to the face of the membrane and does not have an order or has a short-range order but not a long-range order in the vertical direction with respect to the face of the membrane. The long axis of each rod-shaped molecule constituting the polymer is in the vertical direction with respect to the face of the membrane.

For the molecular alignment of the polymer that the permeable membrane of the present invention contains, a preferred molecular alignment state can be suitably employed in consideration of dissolution of gas molecules into the surface of the organic membrane and diffusion of gas molecules into the organic membrane depending on the kind of the gas to permeate therethrough.

In the permeable membrane of the present invention, preferably, the polymerizable compound to be used mainly therein, which has at least one or more polymerizable groups, a hard segment and optionally a soft segment, may be adequately changed, or a polymer using a composition prepared by mixing the polymerizable compound and additives and the like adequately in a preferred ratio may be applied, or a polymer having an appropriately preferred molecular alignment state may be applied, for varying gas dissolution and diffusion into the membrane depending on the kind of the gas that is to selectively permeate therethrough.

The gas-selective permeable membrane of the present invention may have an appropriately preferred thickness for improving the gas selectivity thereof and depending on the kind of the gas to permeate therethrough. Specifically, the thickness of the permeable membrane is preferably 0.005 nm or more to 50 μm or less. When the permeable membrane of the present invention is too thin, micropores may form in producing the permeable membrane and, in addition, the membrane structure may have faults owing to some slight unevenness of the surface of the substrate to be used for enhancing the strength of the permeable membrane or owing to some dust adhering thereto, and as a result, the permeable membrane of the present invention could not sufficiently exhibit the gas selectivity intrinsic thereto. Consequently, the thickness of the gas-selective permeable membrane of the present invention is preferably 0.01 μm or more to 45 μm or less, more preferably 0.05 μm or more to 40 μm or less, even more preferably 0.1 μm or more to 30 μm or less, especially more preferably 0.2 μm or more to 10 μm or less.

The permeable membrane of the present invention is preferably a laminate as laminated on a substrate for enhancing the mechanical strength and the processability thereof in module construction. The substrate to be used is preferably one whose gas permeability is the same as or higher than that of the permeable membrane, and is preferably one whose gas selectively is lower than that of the permeable membrane. Regarding the interface between the permeable membrane and the substrate, each layer may be independently recognized as a laminate from the viewpoint of adhesiveness, or in the interface, the permeable membrane and the substrate may be partly miscible with each other. The miscibility means that the polymer that forms the permeable membrane and the material that forms the substrate mix together in the substrate/permeable membrane interface.

The permeable membrane of the present invention may have gas selectivity for at least any one or more of hydrogen, helium, methane, carbon monoxide, carbon dioxide, nitrogen, oxygen, ethane, ethylene, propane, propylene, butane, hydrogen sulfide, sulfur oxides, nitrogen oxides and the like, but preferably has gas selectivity for hydrogen, helium, methane, carbon dioxide, nitrogen, oxygen, ethane and propane, and even more preferably has gas selectivity for hydrogen, helium, methane, carbon dioxide, nitrogen and oxygen.

The permeable membrane of the present invention can be appropriately used in a range in which the mechanical strength of the permeable membrane or the laminate does not change drastically. Specifically, the membrane is used preferably at −100° C. to 250° C., more preferably at −50° C. to 150° C., even more preferably at −20° C. to 100° C.

### (Polymerizable Compound Having at Least 2 or More Polymerizable Groups and a Hard Segment Having 3 or More Cyclic Structures)

### (Polyfunctional Polycyclic Polymerizable Compound)

The compound having at least 2 or more polymerizable groups, a hard segment having 3 or more cyclic structures, and optionally a soft segment for use in the present invention (hereinafter in the present invention, this may be referred to as a polyfunctional polycyclic polymerizable compound) has, in the compound, 2 or more polymerizable functional groups, and a hard segment where 3 or more cyclic structures bond via a linking group and/or a single bond, in which the polymerizable group directly bonds to the cyclic structures contained in the hard segment, or the polymerizable group bonds to the cyclic structure contained in the hard segment via a soft segment.

Specifically, the polyfunctional polycyclic polymerizable compound for use in the present invention is represented by the following general formula (1):

[Chem. 1]

(P¹—Sf¹ₙ₁HDSf²-P²)ₙ₂ (1)

(wherein Sf¹ and Sf² each independently represent a soft segment, and plural Sf¹'s and Sf²'s, if any, each may be the same or different, P¹ and P² each independently represent a polymerizable group, and plural P¹'s and P²'s, if any, may be the same or different, HD represents a hard segment having 3 or more cyclic structures, n1 and n2 each independently represent an integer of 0 to 3, and when these are 0, HD has a terminal group in place of -Sf-P, and n1+n2≥2.)

P¹ and P² include radical-polymerizable ones and cationic-polymerizable ones.

P¹ and P² may be any polymerizable group capable of undergoing polymerization reaction with a thermal initiator, a photoinitiator, or heat or active energy rays, and preferably, each is independently a polymerizable group selected from the following formulae (P-1) to (P-20):

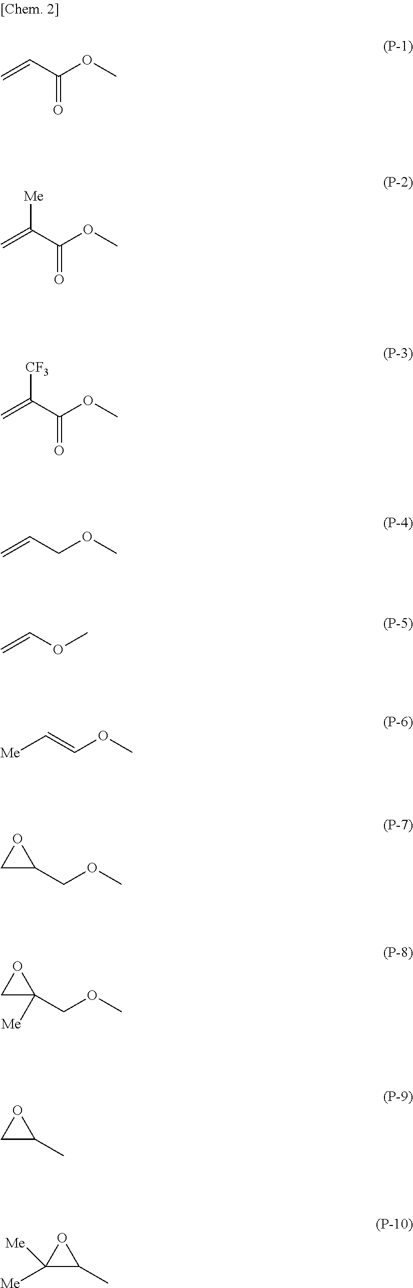

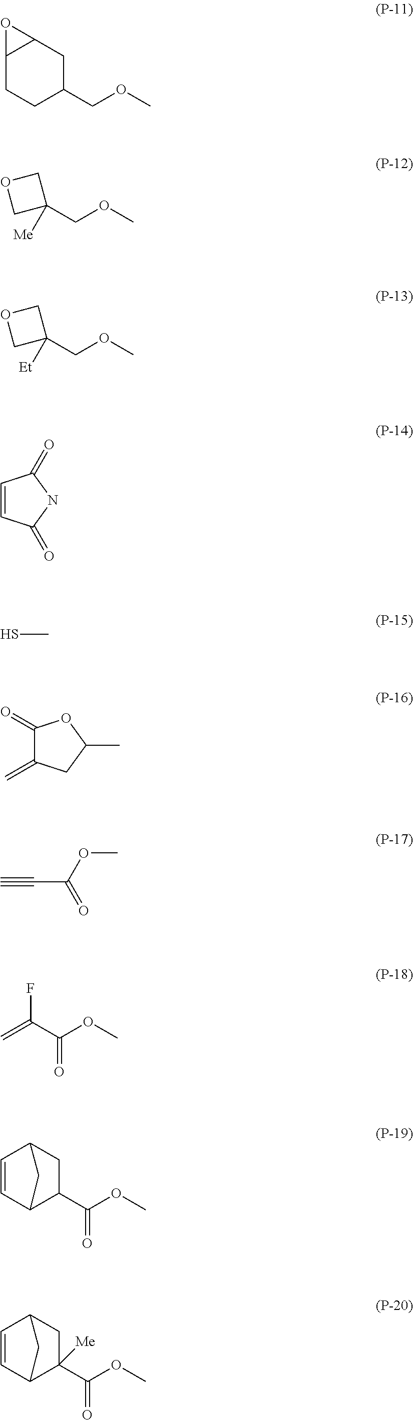

(The above Me represents a methyl group, and Et represents an ethyl group.) In particular, when UV polymerization is employed for the polymerization method, the formula (P-1), (P-2), (P-3), (P-4), (P-5), (P-7), (P-11), (P-13), (P-15) or (P-18) is preferred; the formula (P-1), (P-2), (P-7), (P-11) or (P-13) is more preferred; the formula (P-1), (P-2) or (P-3) is even more preferred; and the formula (P-1) or (P-2) is especially preferred.

Sf¹ and Sf² include linear or branched ones.

Preferably, Sf¹ and Sf² each are independently a single bond or an alkylene group having 1 to 18 carbon atoms (in which one or two or more hydrogen atoms bonding to the alkylene group may be each independently substituted with a halogen atom, a group CN, an alkyl group having 1 to 8 carbon atoms, or an alkylene group having 1 to 8 carbon atoms and having a polymerizable functional group, and one CH₂ group or two or more CH₂ groups not adjacent to each other existing in this group may be mutually independently substituted with —O—, —S—, —NH—, —N(CH₃)—, —CO—, —COO—, —OCO—, —OCOO—, —SCO—, —COS—, —CF₂O—, —OCF₂—, —CF₂S—, —SCF₂—, —CH═CH—, or —C≡C— in the form where the oxygen atoms do not mutually directly bond to each other).

In the case where n1 and/or n2 are/is 0, HD has a terminal group, and the terminal group is each independently a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO— or —C≡C—, and any hydrogen atom in the alkyl group may be substituted with a fluorine atom.

HD includes rod-shaped, disc-shaped or flexed ones.

Specifically, HD may be such that 3 or more cyclic structures therein may bond to each other via a linking group and/or a single bond, as so mentioned hereinabove. The cyclic structure includes 3-membered to 8-membered rings, hetero rings and condensed rings, and one or two or more hydrogen atoms bonding to each ring may be each independently substituted with a substituent.

More specifically, HD is preferably a hard segment represented by the following general formula (1-a):

[Chem. 3]

-(A¹-Z¹)ₗ-(A²Z²)ₘ-(A³-Z³)ₖ-A⁴-Z⁴-A⁵^{^{−}} (1-)

(wherein A¹, A², A³, A⁴ and A⁵ each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalane-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, one or two or more hydrogen atoms bonding to each ring of A¹, A², A³, A⁴ and A⁵ may be each independently substituted with a substituent L^{HD}, and the substituent L^{HD} represents F, Cl, CF₃, OCF₃, CN, a nitro group, an alkyl group having 1 to 8 carbon atoms, an alkoxy group having 1 to 8 carbon atoms, an alkanoyl group, an alkanoyloxy group, a carbamoyl group, a sulfamoyl group, an alkenyl group having 2 to 8 carbon atoms, an alkenyloxy group having 2 to 8 carbon atoms, an alkenoyl group, an alkenoyloxy group, or a group represented by the following general formula (1-c):

[Chem. 4]

A⁶_{q}Sf³ᵣP³ (1-c)

(wherein P³ represents a polymerizable group, and is the same as that defined for the above P¹ and P², A⁶ represents —O—, —COO—, —OCO—, —OCH₂—, —CH₂O—, —CH₂CH₂OCO—, —COOCH₂CH₂—, —OCOCH₂CH₂— or a single bond, Sf³ is the same as that defined for Sf¹ and Sf², q represents 0 or 1, and r represents 0 or 1)).

Preferably, A¹, A², A³, A⁴ and A⁵ each are independently a group selected from a 1,4-phenylene group, a 1,4-cyclohexylene group or a 2,6-naphthylene group in which one or two or more hydrogen atoms bonding to the ring may be substituted with the above-mentioned substituent L^{HD}, and are independently more preferably a group selected from a 1,4-phenylene group, a 1,4-cyclohexylene group or a 2,6-naphthylene group.

Z¹, Z², Z³ and Z⁴ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C— or a single bond,

l, m and k each independently represent an integer of 0 to 4, and l≥l+m+k≤8.

Also preferably, HD is a hard segment represented by the following general formula (1-b):

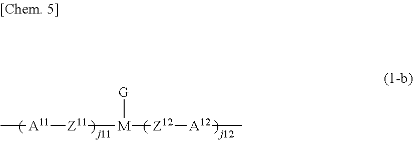

(wherein:
A¹¹ and A¹² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalane-2,6-diyl group, or a 1,3-dioxane-2,5-diyl group, and these groups may be unsubstituted or substituted with one or more L¹'s, and plural A¹¹'s and/or A¹²'s, if any, each may be the same or different, Z¹¹ and Z¹² each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C— or a single bond, and Z¹¹'s and/or Z¹²'s, if any, each may be the same or different, M represents a group selected from the following formulae (M-1) to (M-11):

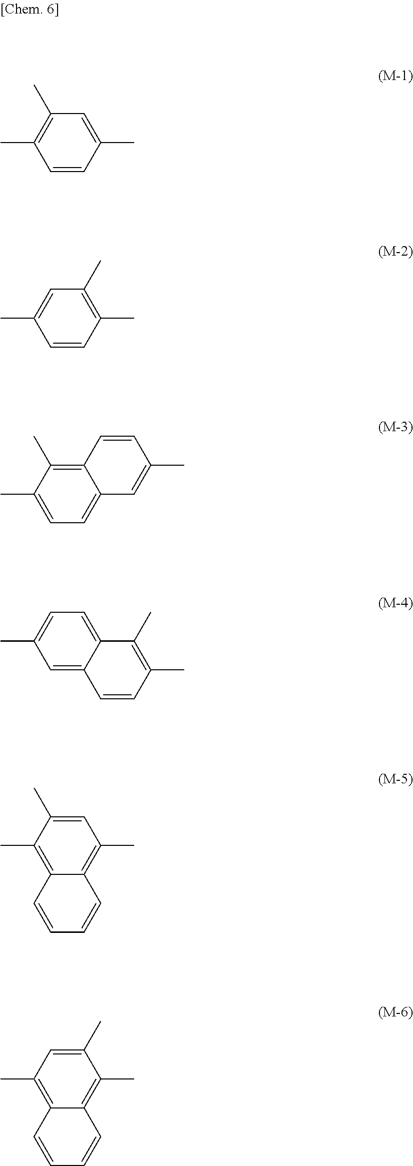

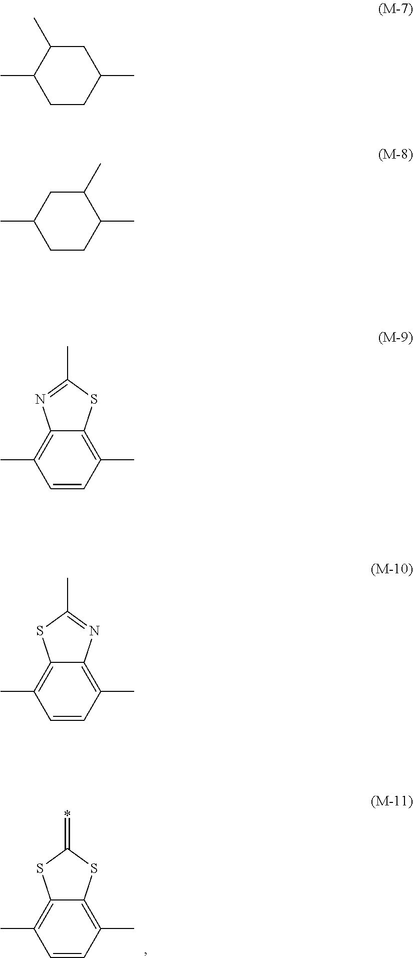

and these groups may be unsubstituted or substituted with one or more I¹'s,
G represents a group selected from the following formulae (G-1) to (G-6):

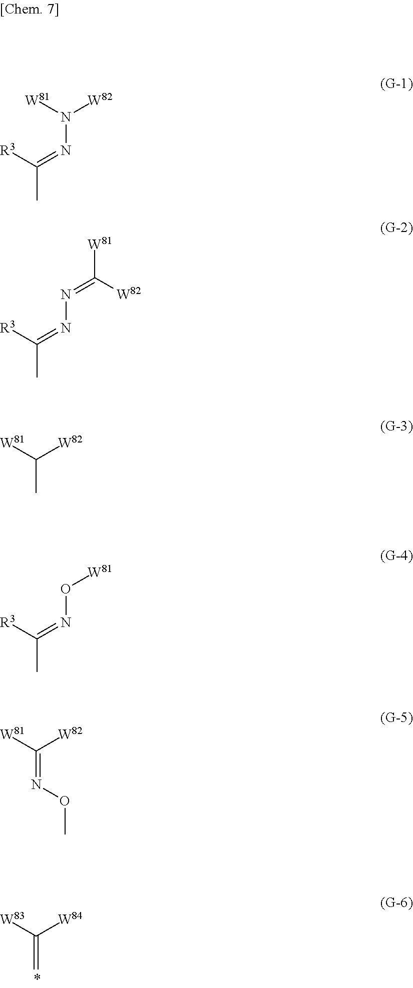

(wherein R³ represents a hydrogen atom, or an alkyl group having 1 to 20 carbon atoms, and the alkyl group may be linear or branched, and any hydrogen atom in the alkyl group may be substituted with a fluorine atom, and one —CH₂— or two or more (—CH₂—)'s not adjacent to each other in the alkyl group may be each independently substituted with —O—, —S—, —CO—, —COO—, —OCO—, —CO—S—, —S—CO—, —O—CO—O—, —CO—NH—, —NH—CO— or —C≡C—,
W⁸¹ represents a group having at least one aromatic group and having 5 to 30 carbon atoms, and the group may be unsubstituted or substituted with one or more L¹'s,
W⁸² represents a hydrogen atom or an alkyl group having 1 to 20 carbon atoms, and the alkyl group may be linear or branched, and any hydrogen atom in the alkyl group may be substituted with a fluorine atom, and one —CH₂— or two or more (—CH₂—)'s not adjacent to each other in the alkyl group may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, or W⁸² has the same meaning as that of W⁸¹, W⁸¹ and W⁸² may bond to each other to form one and the same cyclic structure, or W³² represents a group represented by the following general formula (1-c):

[Chem. 8]

A⁶_{q}Sf³ᵣP³ (1-c)

(wherein P³ represents a polymerizable group, and is the same as that defined for the above P¹ and P², A⁶ represents —O—, —COO—, —OCO—, —OCH₂—, —CH₂O—, —CH₂CH—OCO—, —COOCH₂CH₂—, —OCOCH₂CH₂— or a single bond, Sf³ is the same as that defined for Sf¹ and Sf², q represents 0 or 1, and r represents 0 or 1), W⁸³ and W⁸⁴ each independently represent a halogen atom, a cyano group, a hydroxy group, a nitro group, a carboxyl group, a carbamoyloxy group, an amino group, a sulfamoyl group, a group having at least one aromatic group and having 5 to 30 carbon atoms, an alkyl group having 1 to 20 carbon atoms, a cycloalkyl group having 3 to 20 carbon atoms, an alkenyl group having 2 to 20 carbon atoms, a cycloalkenyl group having 3 to 20 carbon atoms, an alkoxy group having 1 to 20 carbon atoms, an acyloxy group having 2 to 20 carbon atoms, or an alkylcarbonyloxy group having 2 to 20 carbon atoms, and one —CH₂— or two or more (—CH₂—)'s not adjacent to each other in the alkyl group, the cycloalkyl group, the alkenyl group, the cycloalkenyl group, the alkoxy group, the acyloxy group and the alkylcarbonyloxy group may be each independently substituted with —O—, —S—, —CO—, —COO—, —OCO—, —CO—S—, —S—CO—, —O—CO—O—, —CO—NH—, —NH—CO— or —C≡C—, provided that when M is selected from the formulae (M-1) to (M-10), G is selected from the formulae (G-1) to (G-5), and that when M is the formula (M-11), G represents the formula (G-6)),
L¹ represents a fluorine atom, a chlorine atom, a bromine atom, an iodine atom, a pentafluorosulfuranyl group, a nitro group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or an alkyl group having 1 to 20 carbon atoms, and the alkyl group may be linear or branched, and any hydrogen atom in the alkyl group may be substituted with a fluorine atom, and one —CH₂— or two or more (—CH₂—)'s not adjacent to each other in the alkyl group may be each independently substituted with a group selected from —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, and plural L¹'s, if any, in the compound may be the same or different), and
j11 represents an integer of 1 to 5, j12 represents an integer of 1 to 5, and j11+j12 is an integer of 2 to 5).

More specifically, the polyfunctional polycyclic polymerizable compound represented by the general formula (1) where HD is a hard segment represented by the general formula (1-a) is preferably any of compounds represented by the following general formulae (1-a-1) to (1-a-7):

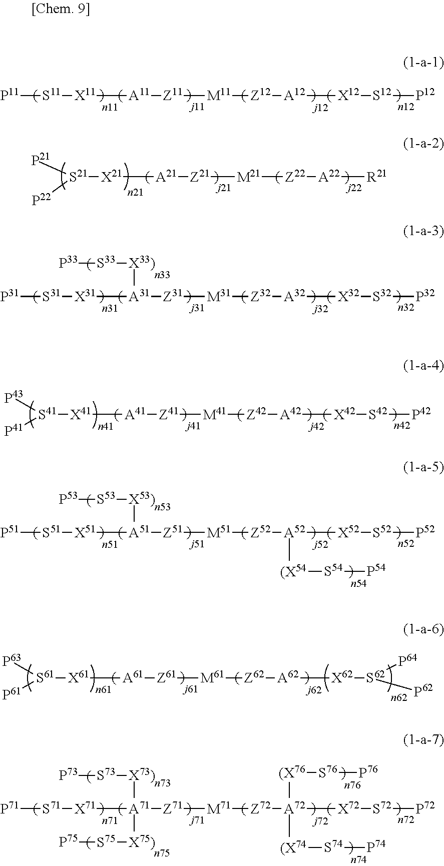

In the above-mentioned general formulae (1-a-1) to (1-a-7), P¹¹ to P⁷⁶ are polymerizable groups, and preferably each is independently selected from the following formulae (P-1) to (P-20):

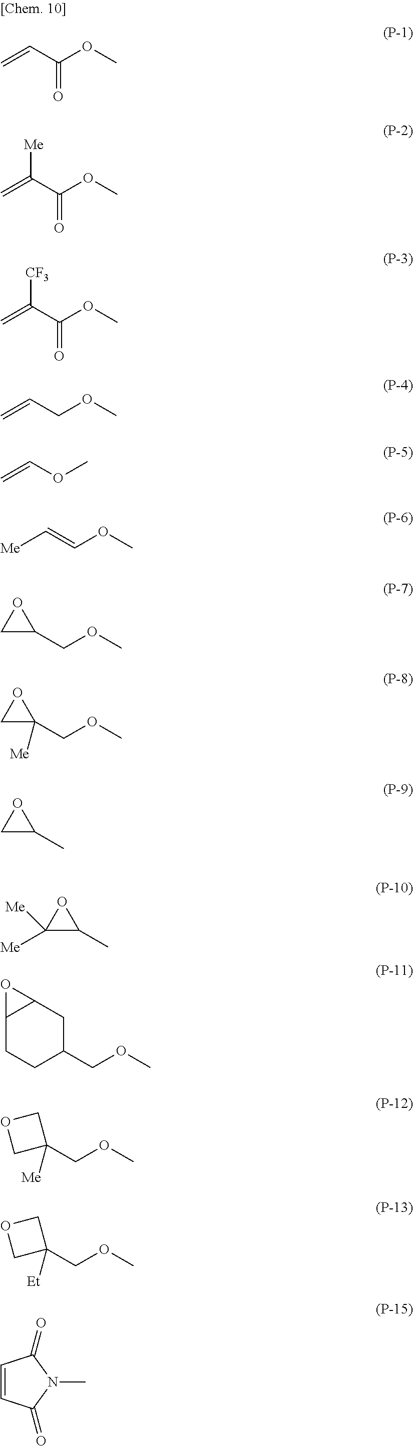

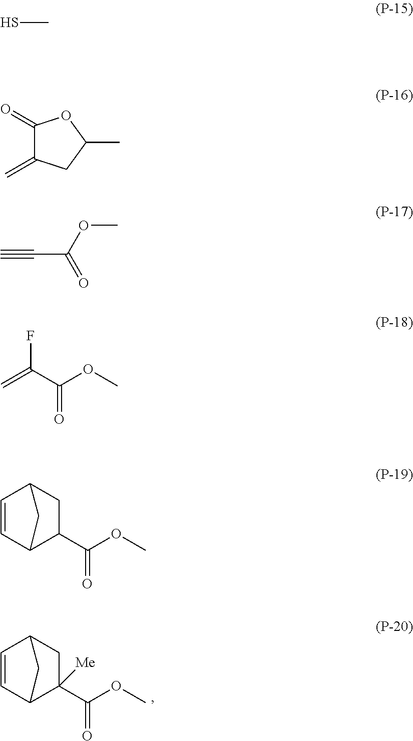

and among these polymerizable groups, the formula (P-1), (P-2), (P-7), (P-12) or (P-13) is preferred from the viewpoint of enhancing polymerizability and storage stability, the formula (P-1), (P-2), (P-7) or (P-12) is more preferred, and the formula (P-1) or (P-2) is even more preferred.

In the general formulae (1-a-1) to (1-a-7), —(S¹¹—X¹¹)— to —(S⁷⁶—X⁷⁶)— each independently represent a soft segment or a single bond.

S¹¹ to S⁷⁶ each independently represent a spacer group or a single bond, and plural S¹¹'s to S⁷⁶'s, if any, may be the same or different. The spacer group represents an alkylene group having 1 to 18 carbon atoms, and one or two or more hydrogen atoms bonding to the alkylene group may be each independently substituted with a halogen atom, a group CN, an alkyl group having 1 to 8 carbon atoms, or an alkylene group having 1 to 8 carbon atoms and having a polymerizable functional group, and one CH₂ group or two or more CH₂ groups not adjacent to each other existing in this group may be mutually independently substituted with —O—, —S—, —NH—, —N(CH₃)—, —CO—, —CH(OH)—, —CH(COOH)—, —COO—, —OCO—, —OCOO—, —SCO—, —COS— or —C≡C— in the form where the oxygen atoms do not mutually directly bond to each other. Among these spacer groups, a linear alkylene group having 2 to 8 carbon atoms, an alkylene group having 2 to 6 carbon atoms and substituted with a fluorine atom, or an alkylene group having 3 to 12 carbon atoms in which one CH₂ group or two or more CH₂ groups not adjacent to each other existing in the alkylene group may be substituted with —O— is preferred, from the viewpoint of alignment performance.

In the general formulae (1-a-1) to (1-a-7), X¹¹ to X⁷⁶ each independently represent —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C— or a single bond, and plural X¹¹'s to X⁷⁶'s, if any, each may be the same or different. From the viewpoint of easy availability of raw materials and easiness in synthesis, those plural groups, if any, may be each independently the same or different, and preferably, each independently represents —O—, —S—, —OCH₂—, —CH₂O—, —COO—, —OCO—, —CO—S—, —S—CO—, —O—CO—O—, —CO—NH—, —NH—CO—, —COO—CH₂CH₂—, —OCO—CH₂CH₂—, —CH₂CH₂COO—, —CH₂CH₂—OCO— or a single bond, and more preferably each independently represents —O—, —OCH—, —CH₂O—, —COO—, —OCO—, —COO—CH₂CH₂—, —OCO—CH₂CH₂—, —CH₂CH₂—COO—, —CH₂CH₂—OCO— or a single bond. Plural X¹¹'s to X⁷⁶'s, if any, each may be the same or different, and especially preferably, each represents —O—, —COO—, —OCO— or a single bond.

In the above-mentioned general formulae (1-a-1) to (1-a-7), each P—(S—X)— does not contain an —O—O— bond.

In the general formulae (1-a-1) to (1-a-7), A¹¹ to A⁷², and M¹¹ to M⁷¹ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalane-2,6-diyl group or a 1,3-dioxane-2,5-diyl group, and these groups may be unsubstituted or substituted with one or more substituents, and plural A¹¹'s to A⁷²'s, if any, may be the same or different. From the viewpoint of easy availability of raw materials and easiness in synthesis, preferably, A¹¹ to A⁷², and M¹¹ to M⁷¹ each are independently a 1,4-phenylene group, a 1,4-cyclohexylene group or a naphthalene-2,6-diyl group that is unsubstituted or may be substituted with one or more substituents of L¹ and L², and each is more preferably a group selected from the following formulae (A-1) to (A-16):

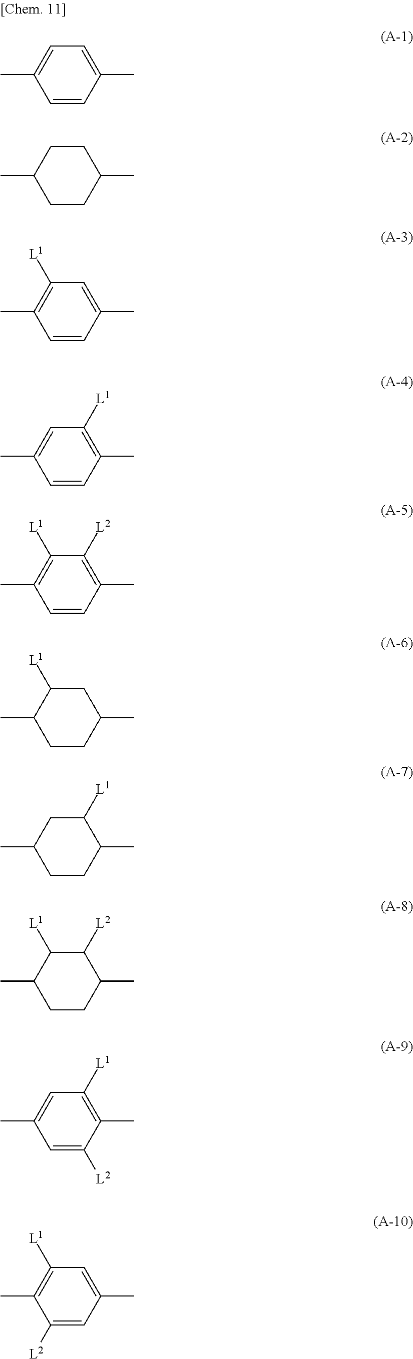

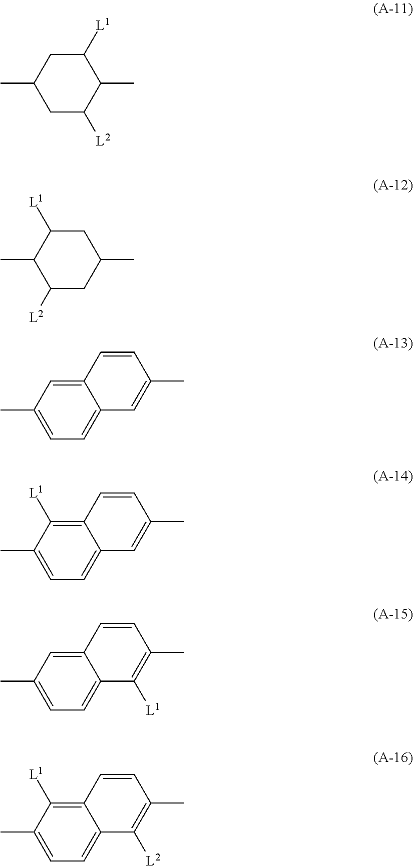

more preferably, each is a group selected from the formulae (A-1) to (A-13), and especially preferably each is a group selected from the formulae (A-1) to (A-4).

In the general formulae (1-a-1) to (1-a-7), Z¹¹ to Z⁷² each independently represent —O—, —S—, —OCH₂—, —CH—O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH—, —CH₂S—, —CF—O—, —OCF—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CHZ—, —CH₂—COO—, —CH—OCO—, —CH═CH—, —N═N—, —CH═N—, —N═CH—, —CH═N—N═CH—, —CF═CF—, —C≡C— or a single bond, plural Z¹¹'s to Z⁷²'s, if any, may be the same or different. From the viewpoint of easy availability of raw materials and easiness in synthesis, preferably, Z¹¹ to Z⁷² each are independently —OCH₂—, —CH—O—, —COO—, —OCO—, —O—CO—O—, —CO—NH—, —NH—CO—, —CF₂O—, —OCF—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C— or a single bond, more preferably Z¹¹ to Z⁷² each are independently —OCH—, —CH—O—, —CH₂CH₂—, —COO—, —OCO—, —O—CO—O—, —CO—NH—, —NH—CO—, —CF₂O—, —OCF₂—, —COO—CH₂CH₂—, —OCO—CH₂CH₂—, —CH₂CH₂—COO—, —CH₂CH₂—OCO—, —CH═CH—, —C≡C— or a single bond, even more preferably Z¹¹ to Z⁷² each are independently —CH₂CH₂—, —COO—, —OCO—, —O—CO—O—, —CO—NH—, —NH—CO—, —COO—CH₂CH₂—, —OCO—CH₂CH₂—, —CH₂CH₂—COO—, —CH₂CH₂—OCO— or a single bond, and especially more preferably each is independently —COO—, —OCO—, —COO—CH₂CH₂—, —OCO—CH₂CH₂—, —CH₂CH₂—COO—, —CH₂CH₂—OCO— or a single bond.

In the above-mentioned general formula (1-a-2), the terminal group R²¹ represents a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO— or —C≡C—, and any hydrogen atom in the alkyl group may be substituted with a fluorine atom. From the viewpoint of easiness in synthesis, R²¹ is preferably a hydrogen atom, a fluorine atom, a chlorine atom, a cyano group, or a linear or branched alkyl group having 1 to 12 carbon atoms in which one —CH₂— or two or more (—CH₂—)'s not adjacent to each other may be each independently substituted with —O—, —COO—, —OCO— or —O—CO—O—, more preferably a hydrogen atom, a fluorine atom, a chlorine atom, a cyano group, or a linear alkyl group or a linear alkoxy group having 1 to 12 carbon atoms, and is especially preferably a linear alkyl group or a linear alkoxy group having 1 to 12 carbon atoms.

In the above-mentioned general formulae (A-1) to (A-16), the substituents L¹ and L² each independently represent a fluorine atom, a chlorine atom, a bromine atom, an iodine atom, a pentafluorosulfuranyl group, a nitro group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, and any hydrogen atom in the alkyl group may be substituted with a fluorine atom, or the substituents each represent a group represented by the above-mentioned general formula (1-c). From the viewpoint of easiness in synthesis, preferably, the substituents L¹ and L² each are independently a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which any hydrogen atom may be substituted with a fluorine atom, and one —CH₂— or two or more (—CH₂—)'s not adjacent to each other therein may be each independently substituted with —O—, —S—, —CO—, —COO—, —OCO—, —O—CO—O—, —CH═CH—, —CF═CF— or —C≡C—, or each is a group represented by the general formula (1-c); more preferably, each is a fluorine atom, a chlorine atom, or a linear or branched alkyl group having 1 to 12 carbon atoms in which any hydrogen atom may be substituted with a fluorine atom, and one —CH₂— or two or more (—CH₂—)'s not adjacent to each other therein may be each independently substituted with —O—, —COO— or —OCO—; even more preferably, each is a fluorine atom, a chlorine atom, or a linear or branched alkyl or alkoxy group having 1 to 12 carbon atoms in which any hydrogen atom may be substituted with a fluorine atom; and especially preferably each is a fluorine atom, a chlorine atom, or a linear alkyl group or a linear alkoxy group having 1 to 8 carbon atoms.

In the above-mentioned general formulae (1-a-1) to (1-a-7), n11 to n76 each independently represent an integer of 0 to 6, and from the viewpoint of the properties of the compounds, easy availability of raw material and easiness in synthesis, preferably, each is an integer of 0 to 4, more preferably an integer of 0 to 2, and especially preferably 0 or 1.

In the general formulae (1-a-1) to (1-a-7), j11, j12, j21, j22, j31, j32, j41, j42, j51, j52, j61, j62, j71 and j72 each independently represent an integer of 0 to 5, and j11+j12 represents an integer of 2 to 7, j21+j22 represents an integer of 2 to 7, j31+j32 represents an integer of 2 to 7, j41+j42 represents an integer of 2 to 7, j51+j52 represents an integer of 2 to 7, j61+j62 represents an integer of 2 to 7, and j71+j72 represents an integer of 2 to 7. From the viewpoint of easiness in synthesis and storage stability, preferably, j11, j21, j22, j31, j32, j41, j42, j51, j52, j61, j62, j71 and j72 each independently represent an integer of 1 to 4, more preferably an integer of 1 to 3, even more preferably 1 or 2. j11+j12, j21+j22, j31+j32, j41+j42, j51+j52, j61+j62, and j71+j72 each are preferably an integer of 2 to 4, more preferably 2 or 3.

Specifically, the compounds represented by the general formula (1-a-1) are preferably compounds represented by the following general formulae (1-a-1-1) to (1-a-1-25):

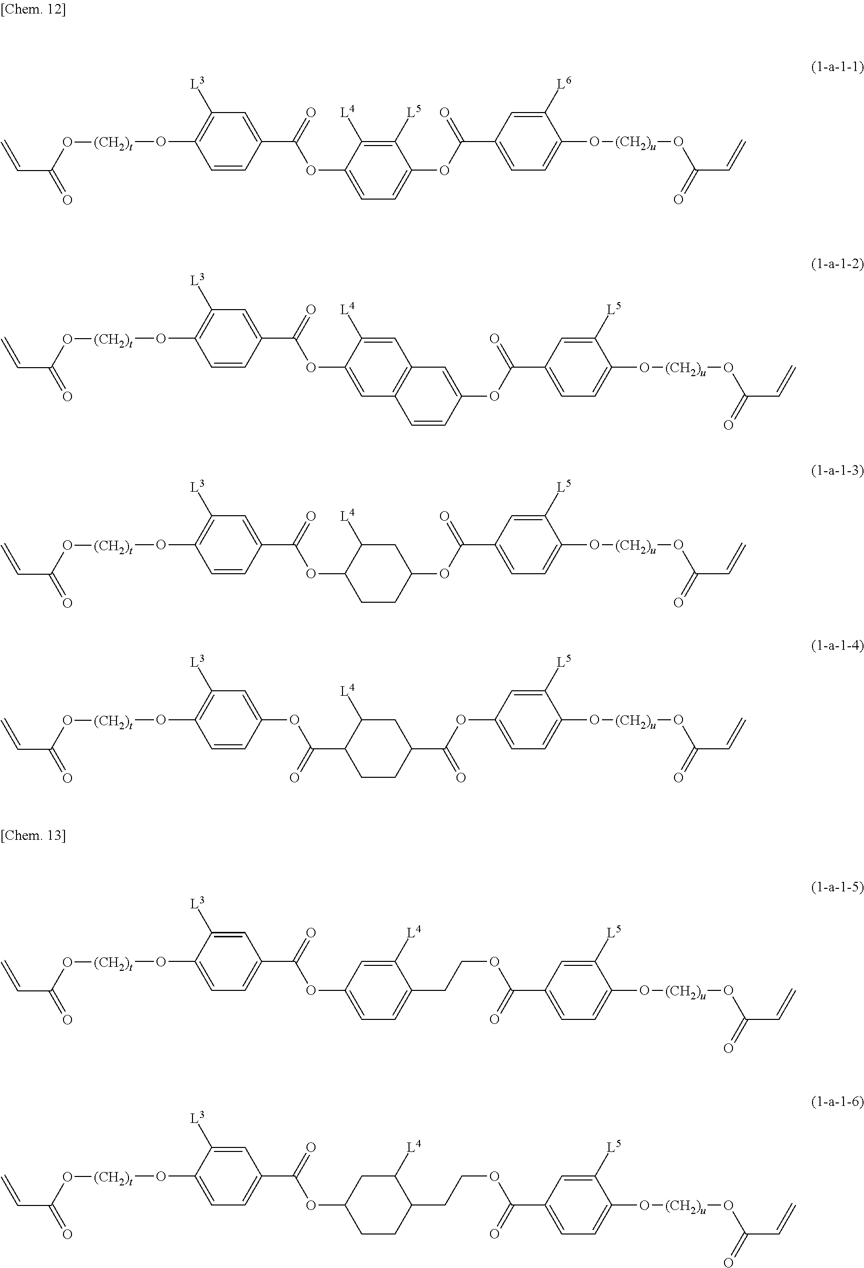

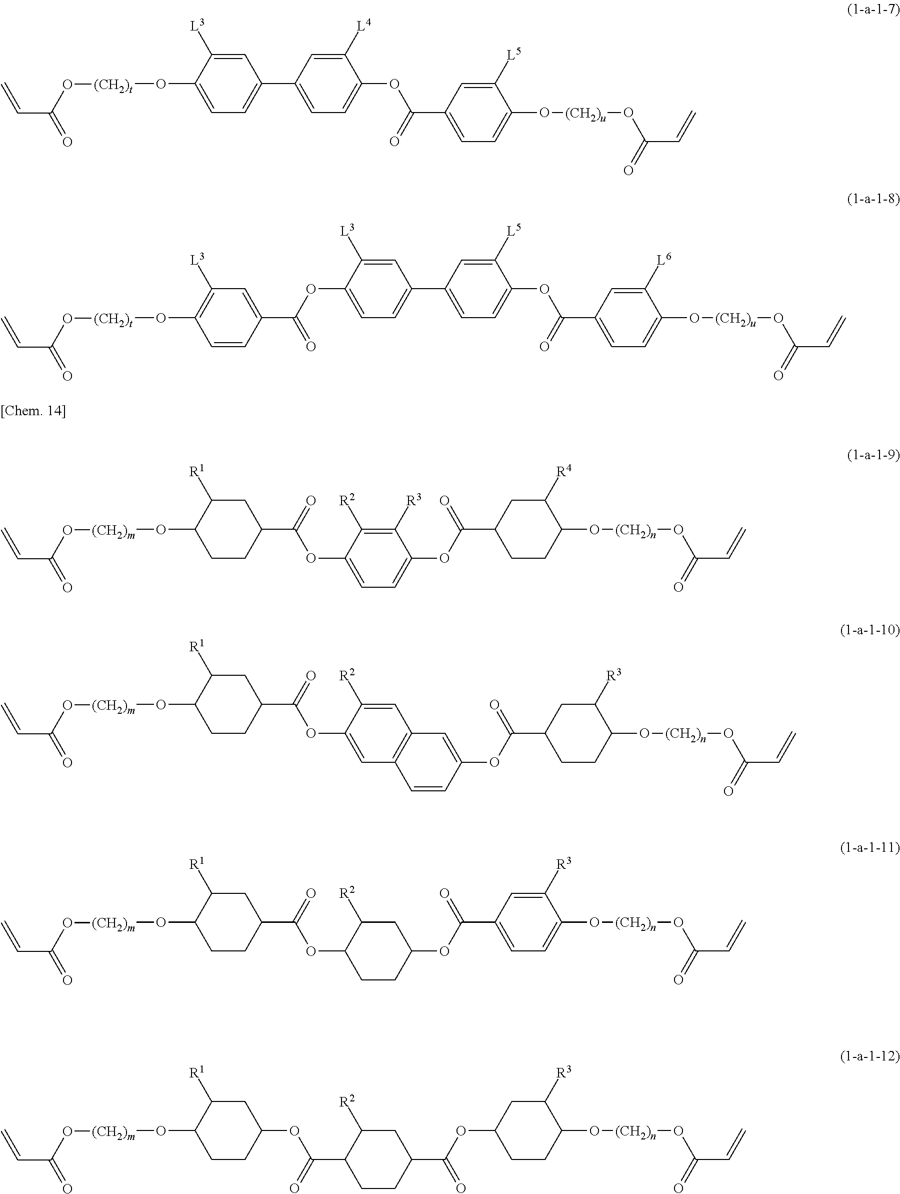

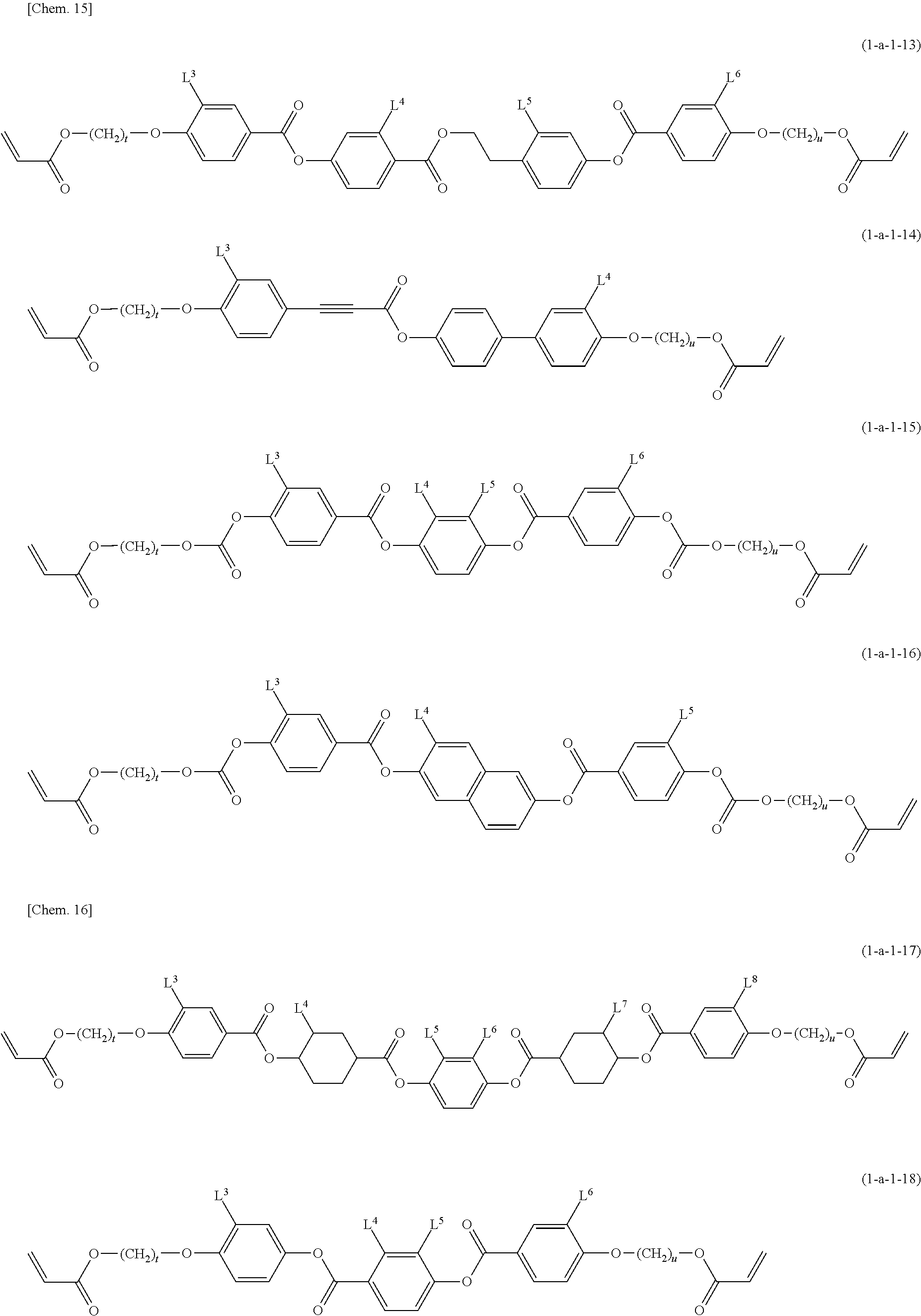

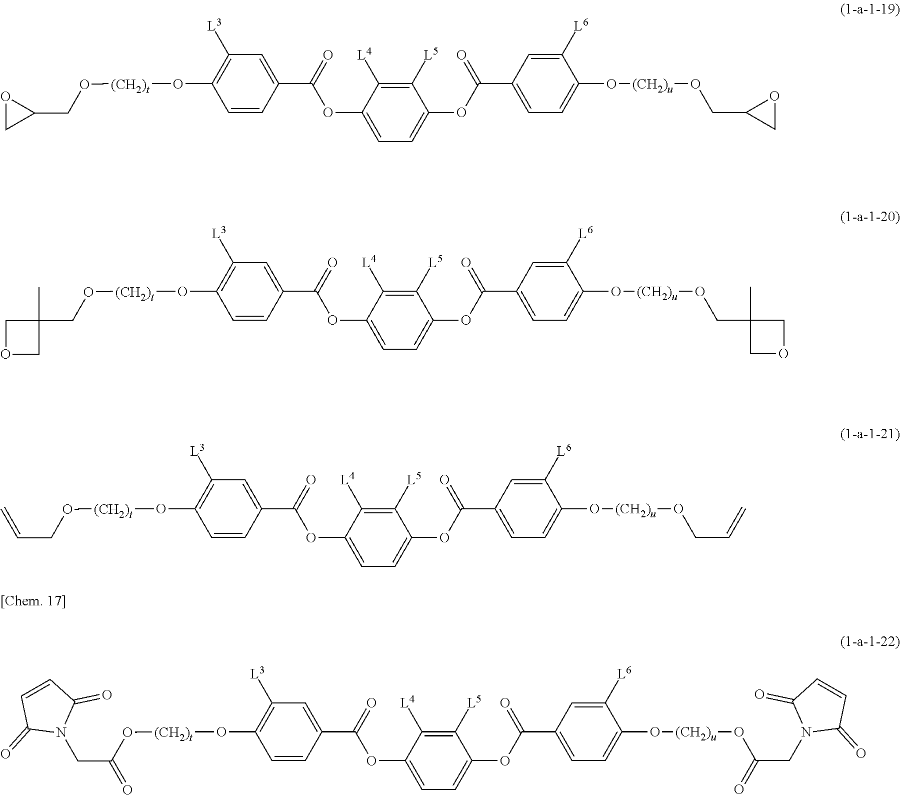

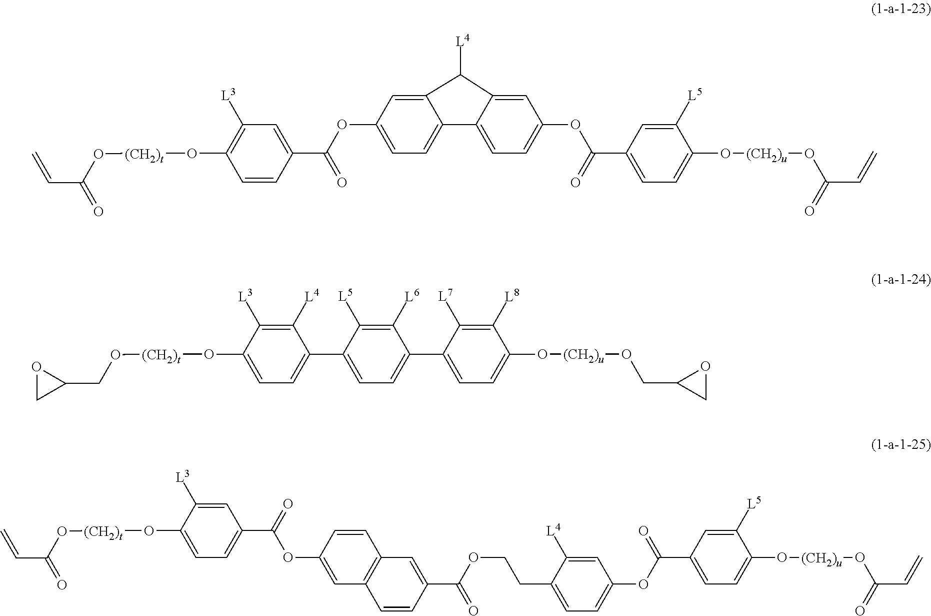

(In the formulae, t and u each independently represent an integer of 1 to 18, L³, L⁴, L⁵, L⁶, L⁷ and L³ each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups each are an alkyl group having 1 to 6 carbon atoms or an alkoxy group having 1 to 6 carbon atoms, the hydrogen atoms bonding to the alkyl group or the alkoxy group may be unsubstituted or may be substituted with one or two or more halogen atoms.) One alone or two or more of these compounds may be used either singly or as combined.

Specifically, the compounds represented by the general formula (1-a-2) are preferably compounds represented by the following formulae (1-a-2-1) to (1-a-2-11):

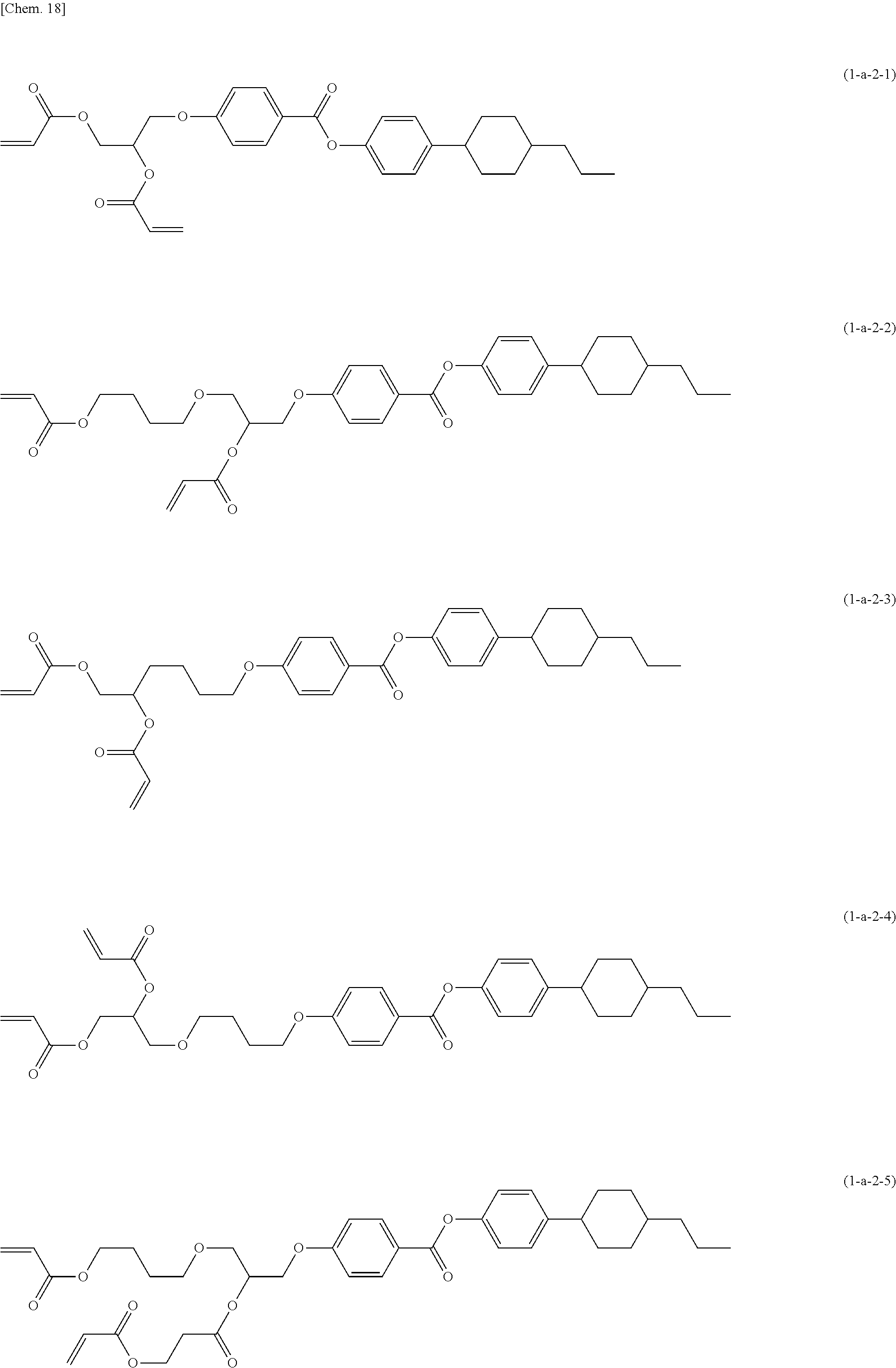

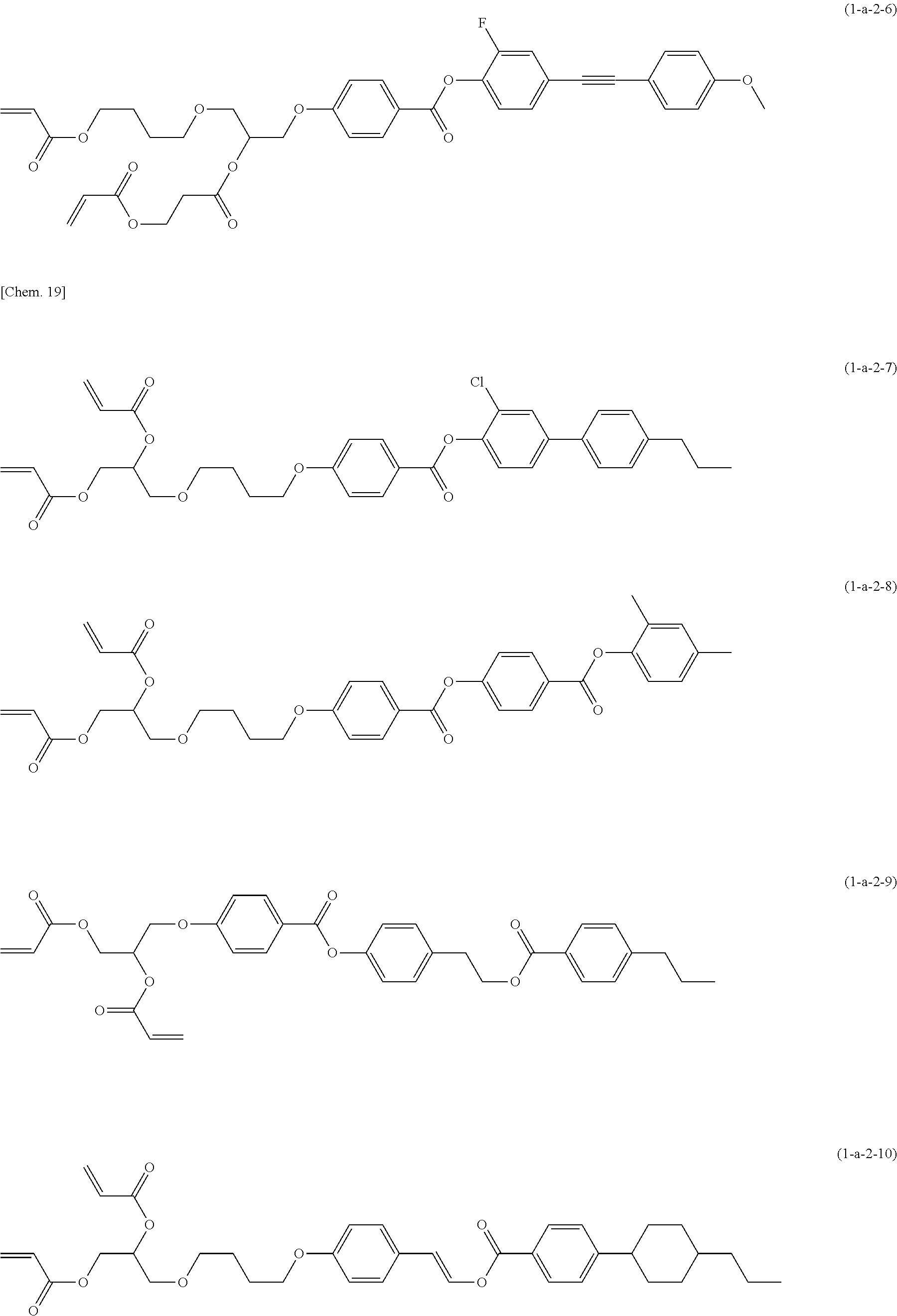

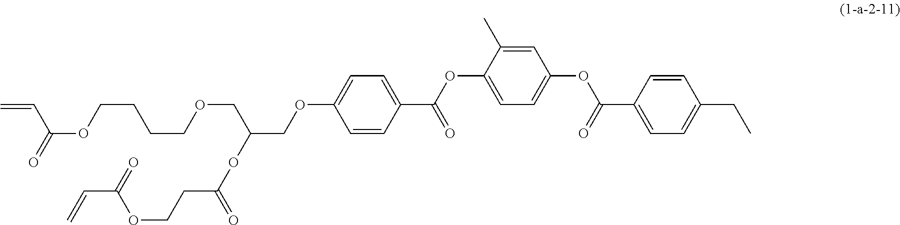

One alone or two or more of these compounds may be used either singly or as combined.

Specifically, the compounds represented by the general formula (1-a-3) are preferably compounds represented by the following formulae (1-a-3-1) to (1-a-3-23):

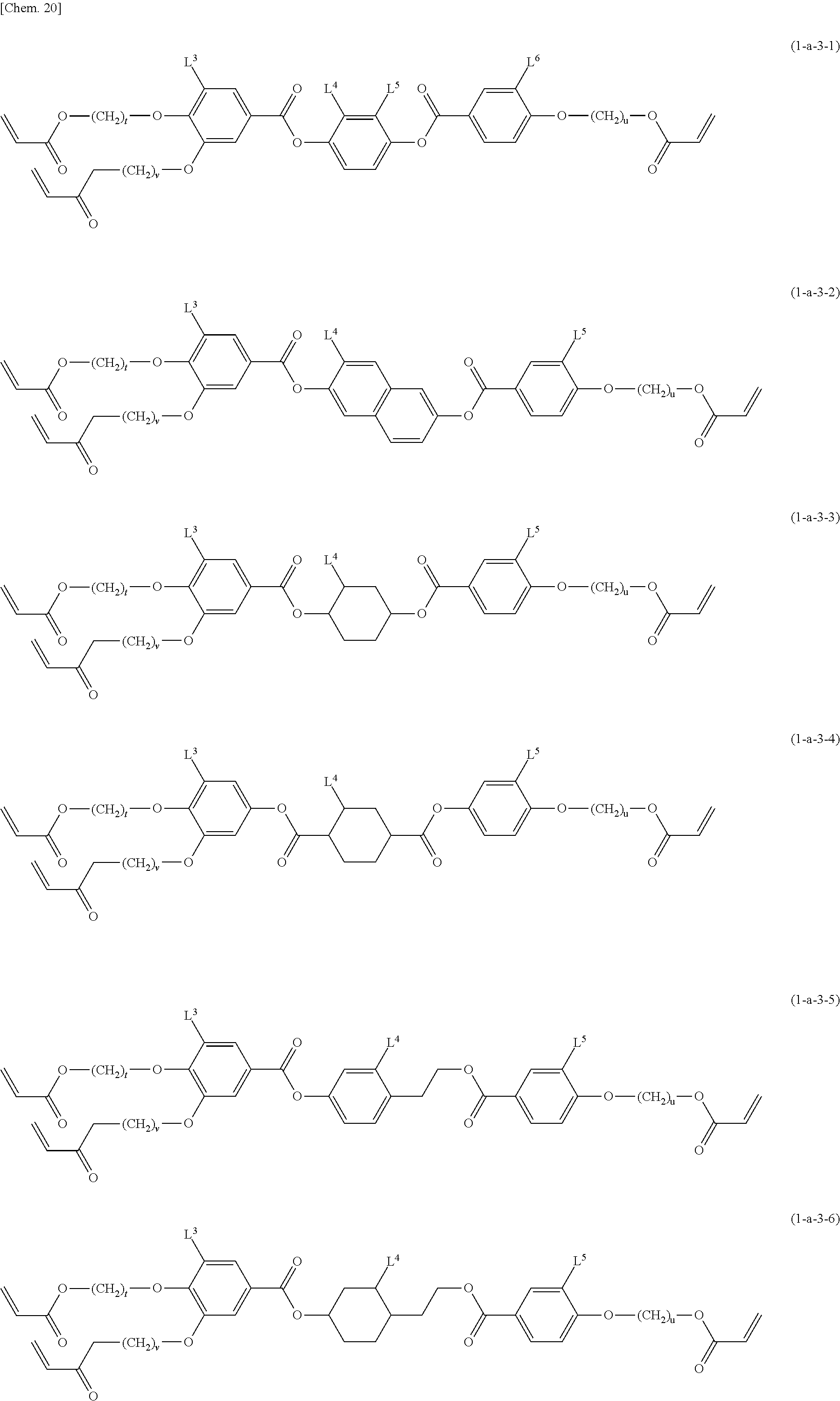

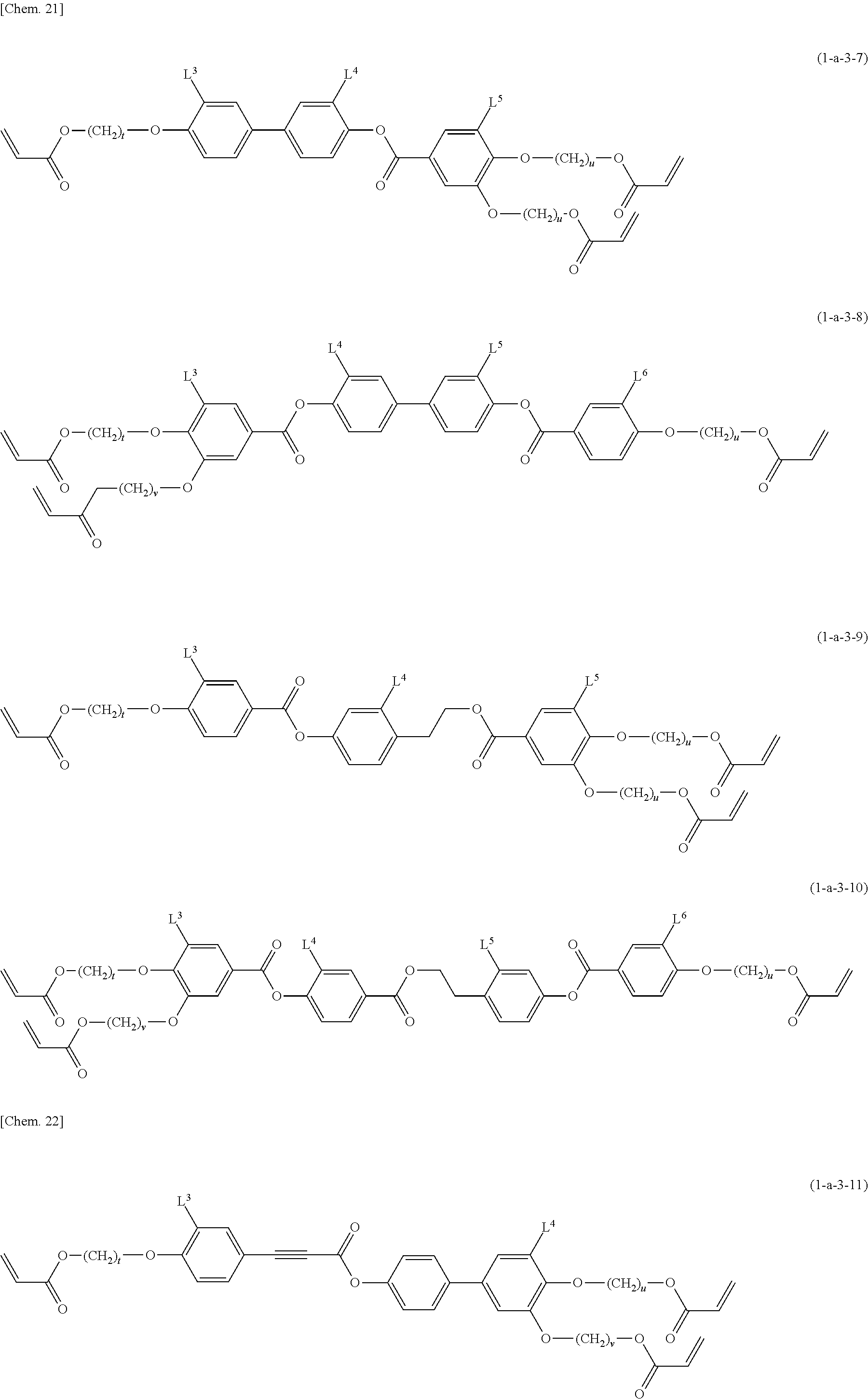

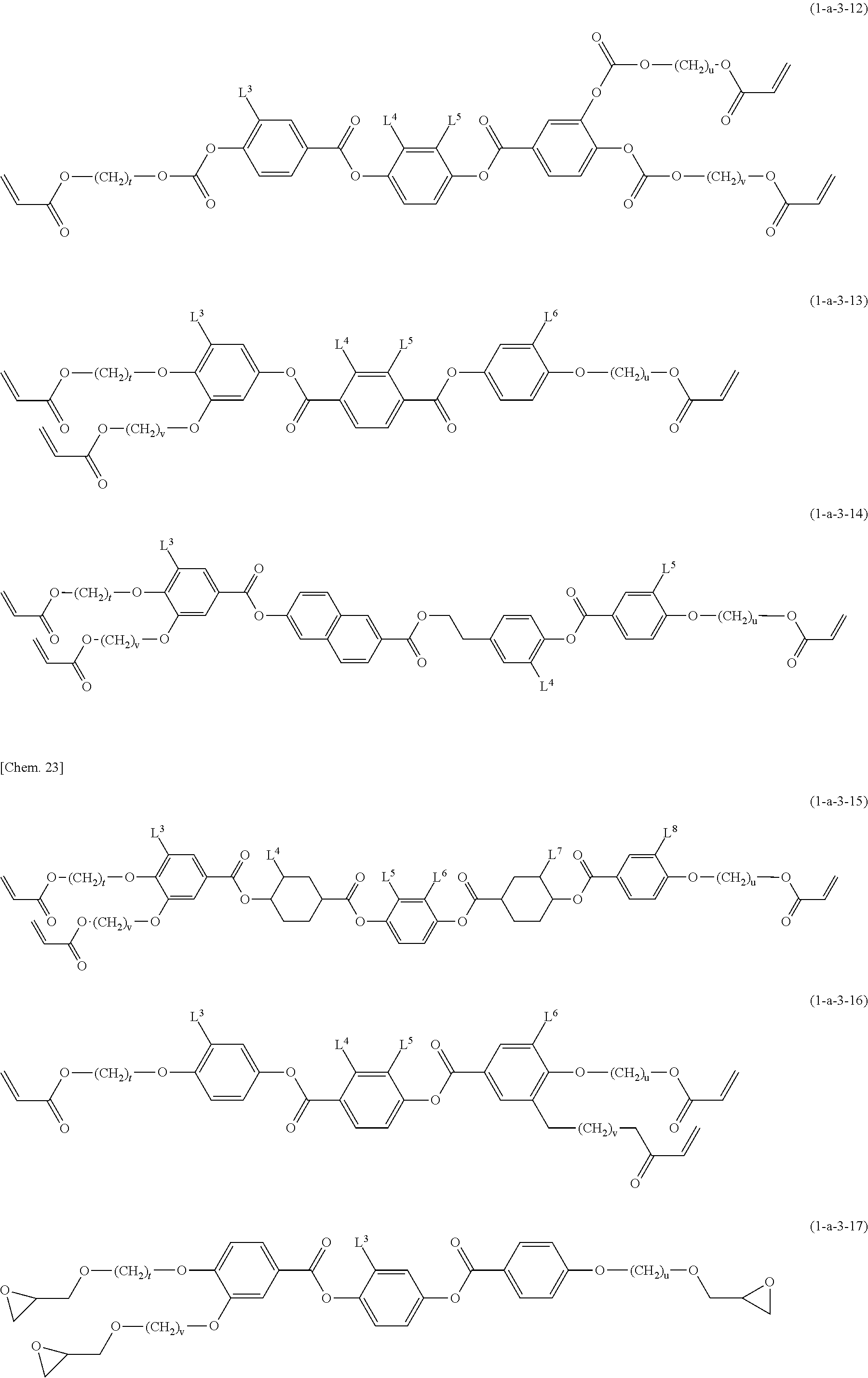

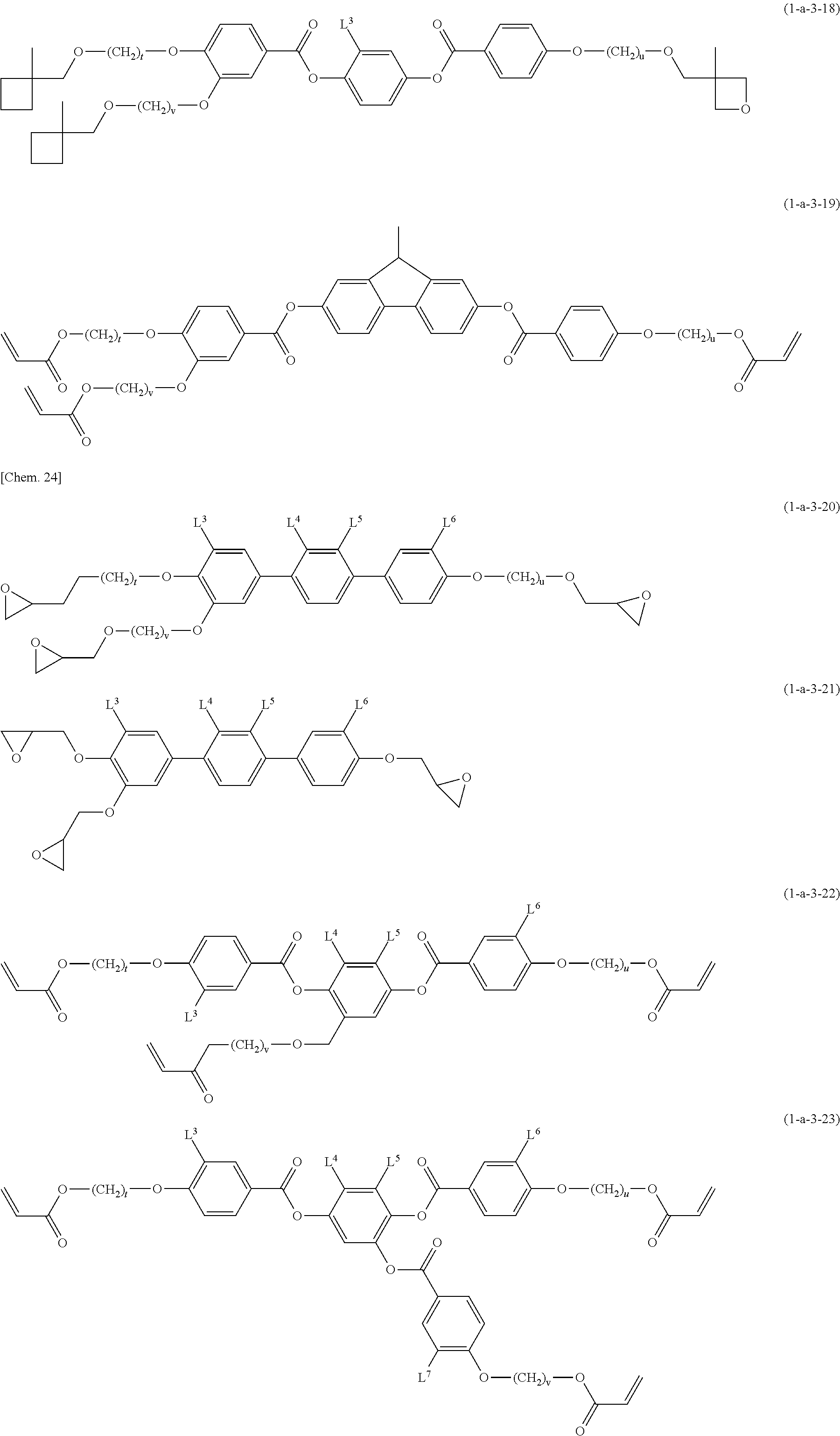

(In the formulae, t, u and v each independently represent an integer of 1 to 18. L³, L⁴, L⁵, L⁶, L⁷ and L⁸ each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups each are an alkyl group having 1 to 6 carbon atoms, or an alkoxy group having 1 to 6 carbon atoms, the hydrogen atoms bonding to the alkyl group or the alkoxy group may be unsubstituted or may be substituted with one or two or more halogen atoms.) One alone or two or more of these compounds may be used either singly or as combined.

Specifically, the compounds represented by the general formula (1-a-4) are preferably compounds represented by the following formulae (1-a-4-1) to (1-a-4-20):

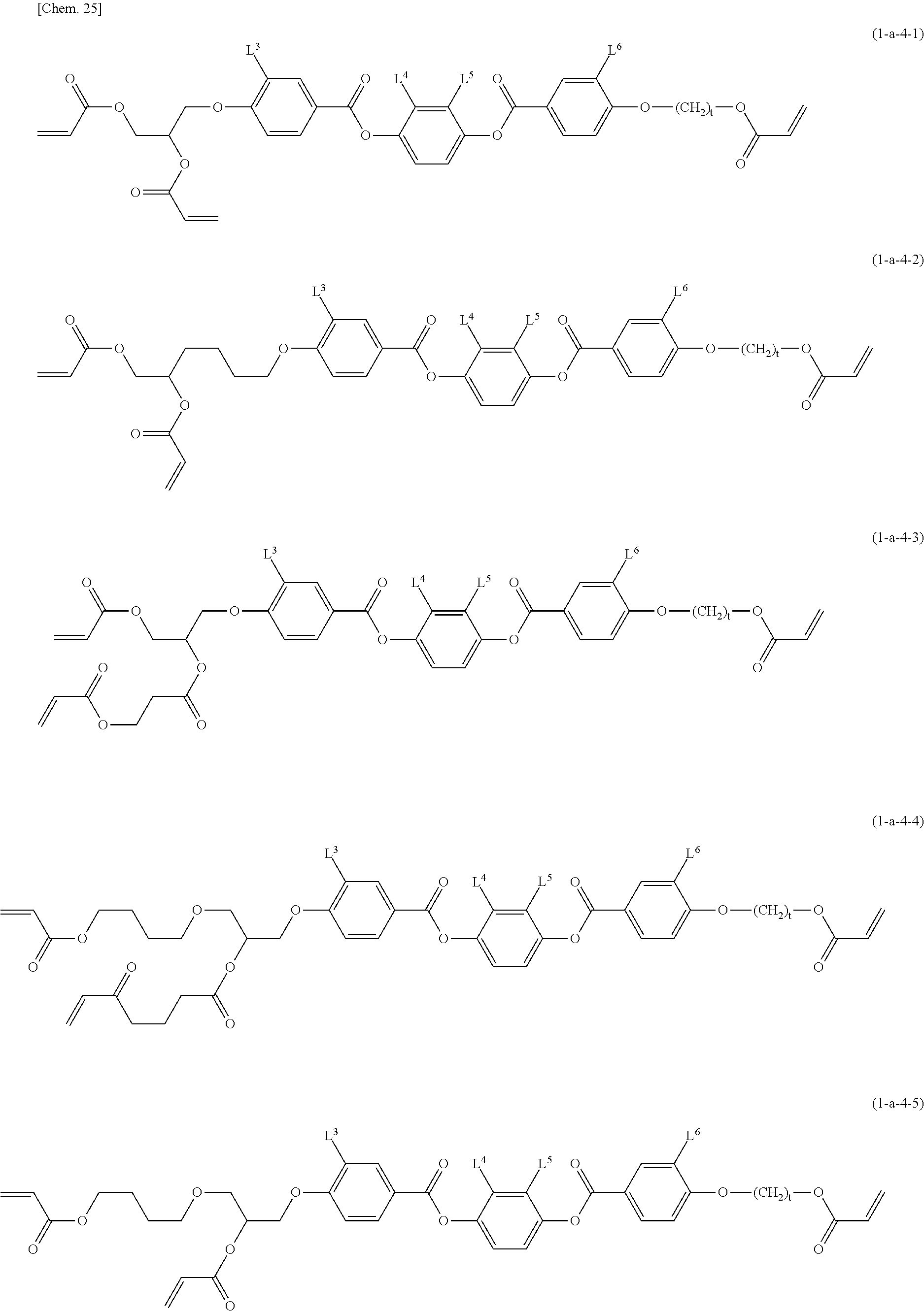

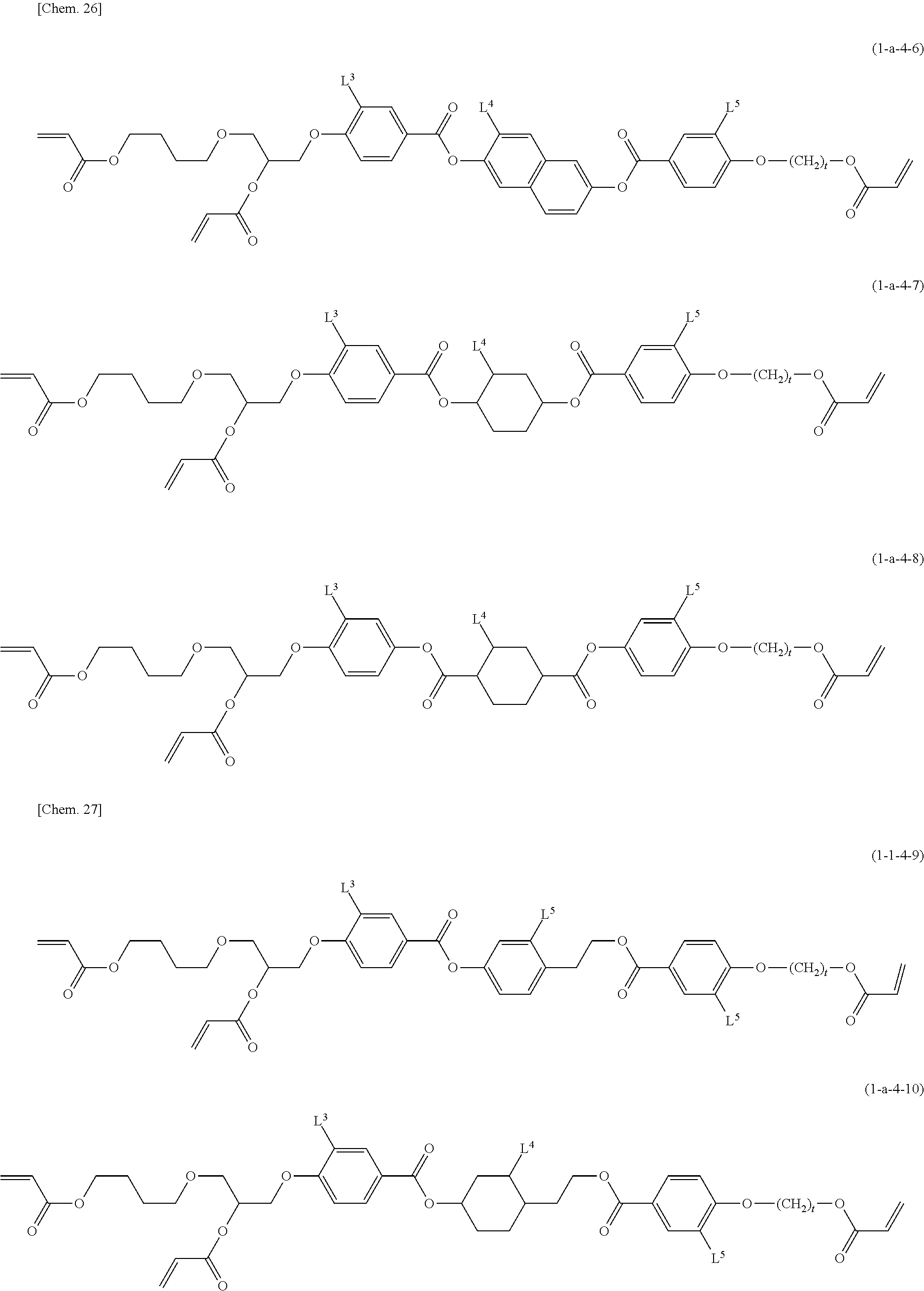

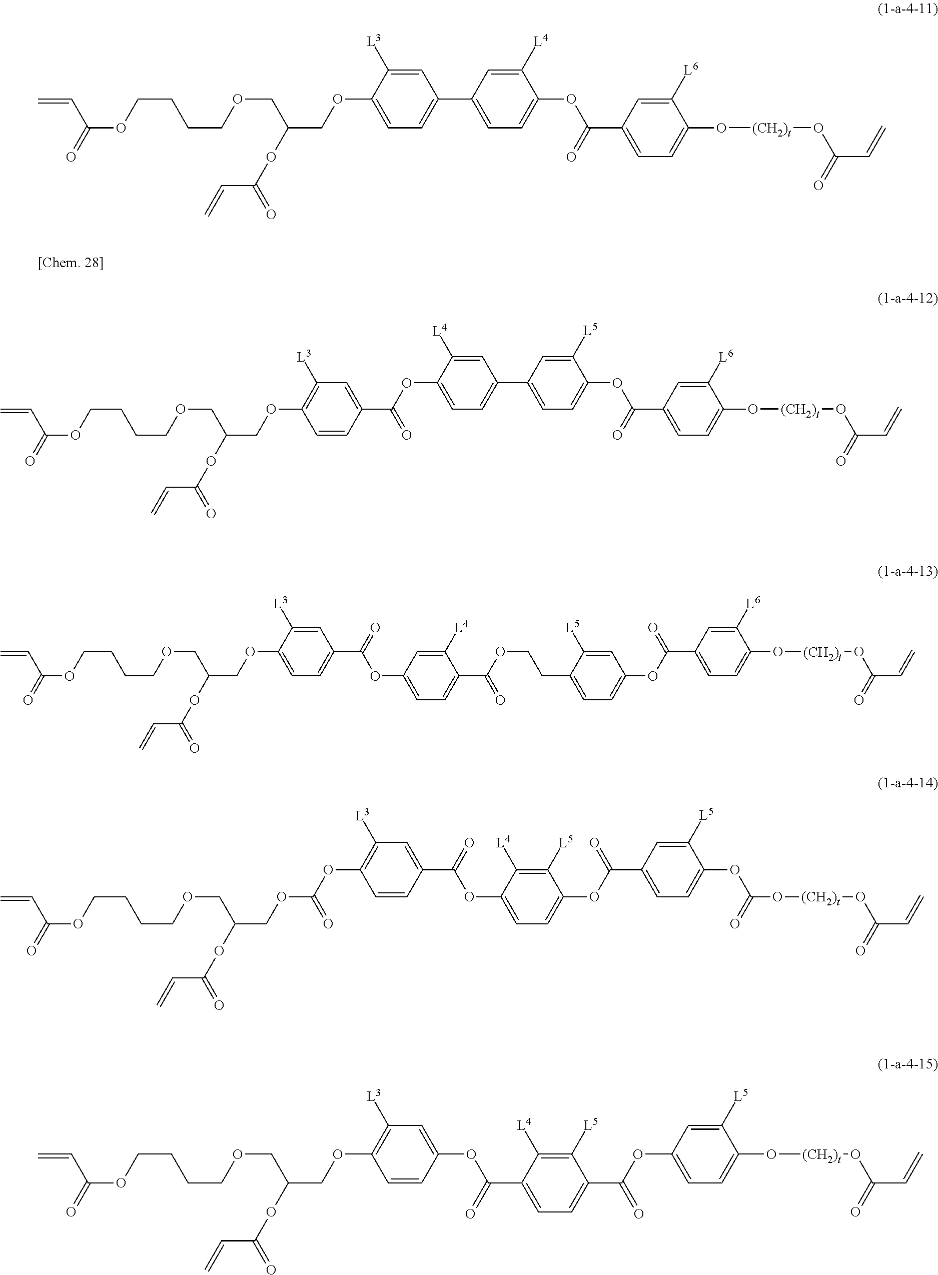

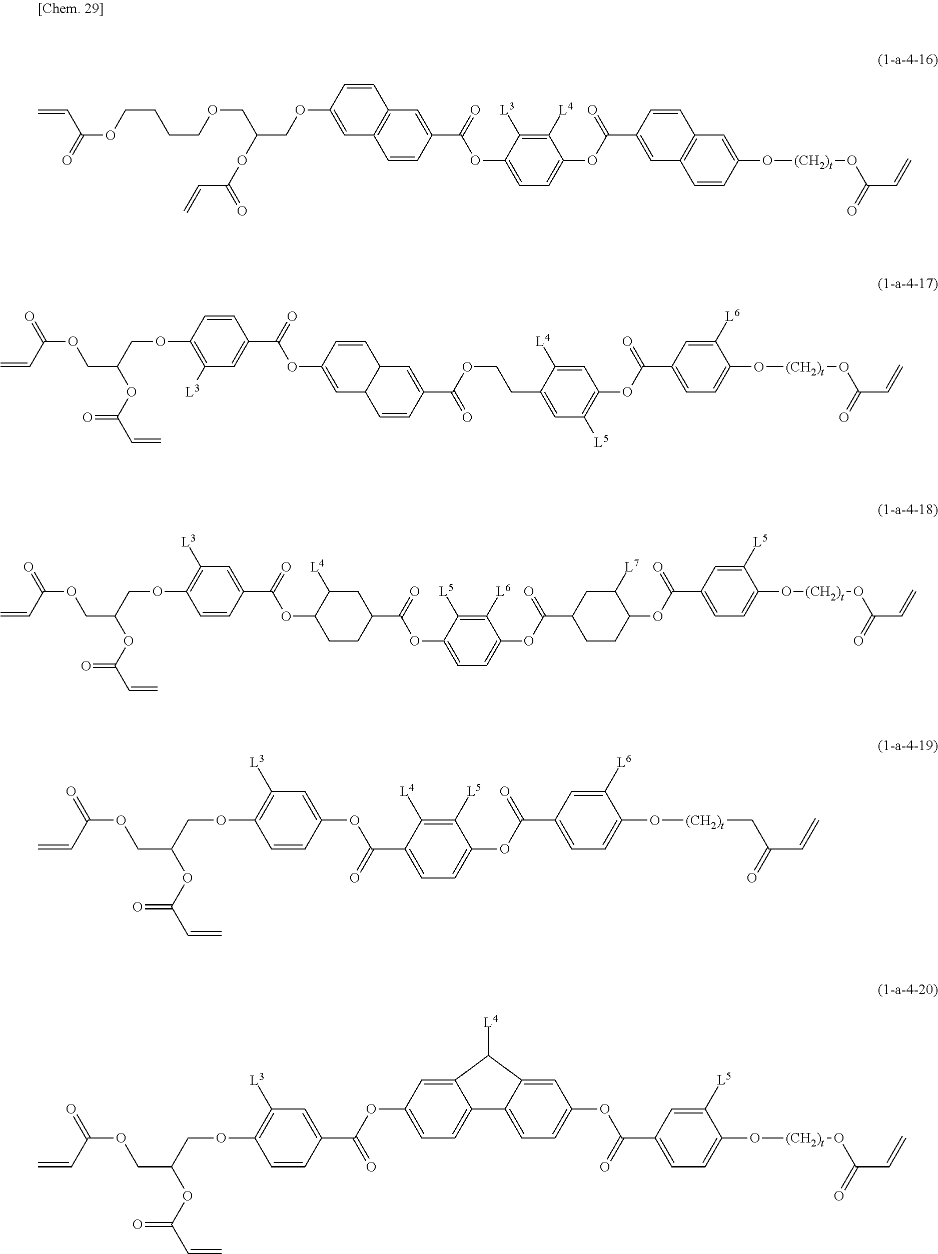

(In the formulae, t each independently represents an integer of 1 to 18, L³, L⁴, L⁵, L⁶, L⁷ and L⁸ each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups each are an alkyl group having 1 to 6 carbon atoms, or an alkoxy group having 1 to 6 carbon atoms, the hydrogen atoms bonding to the alkyl group or the alkoxy group may be unsubstituted or may be substituted with one or two or more halogen atoms.) One alone or two or more of these compounds may be used either singly or as combined.

Specifically, the compounds represented by the general formula (1-a-5) are preferably compounds represented by the following formulae (1-a-5-1) to (1-a-5-18):

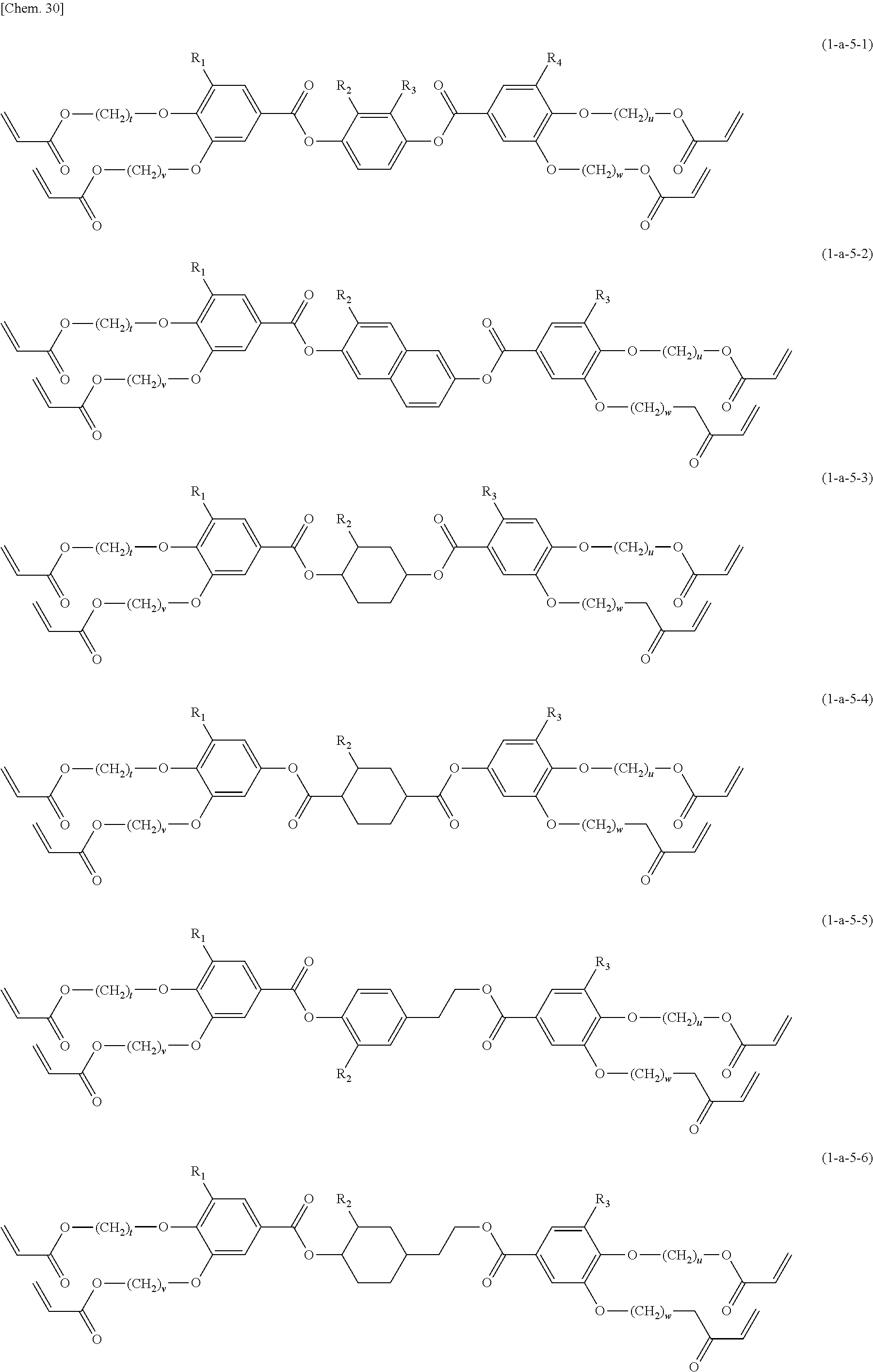

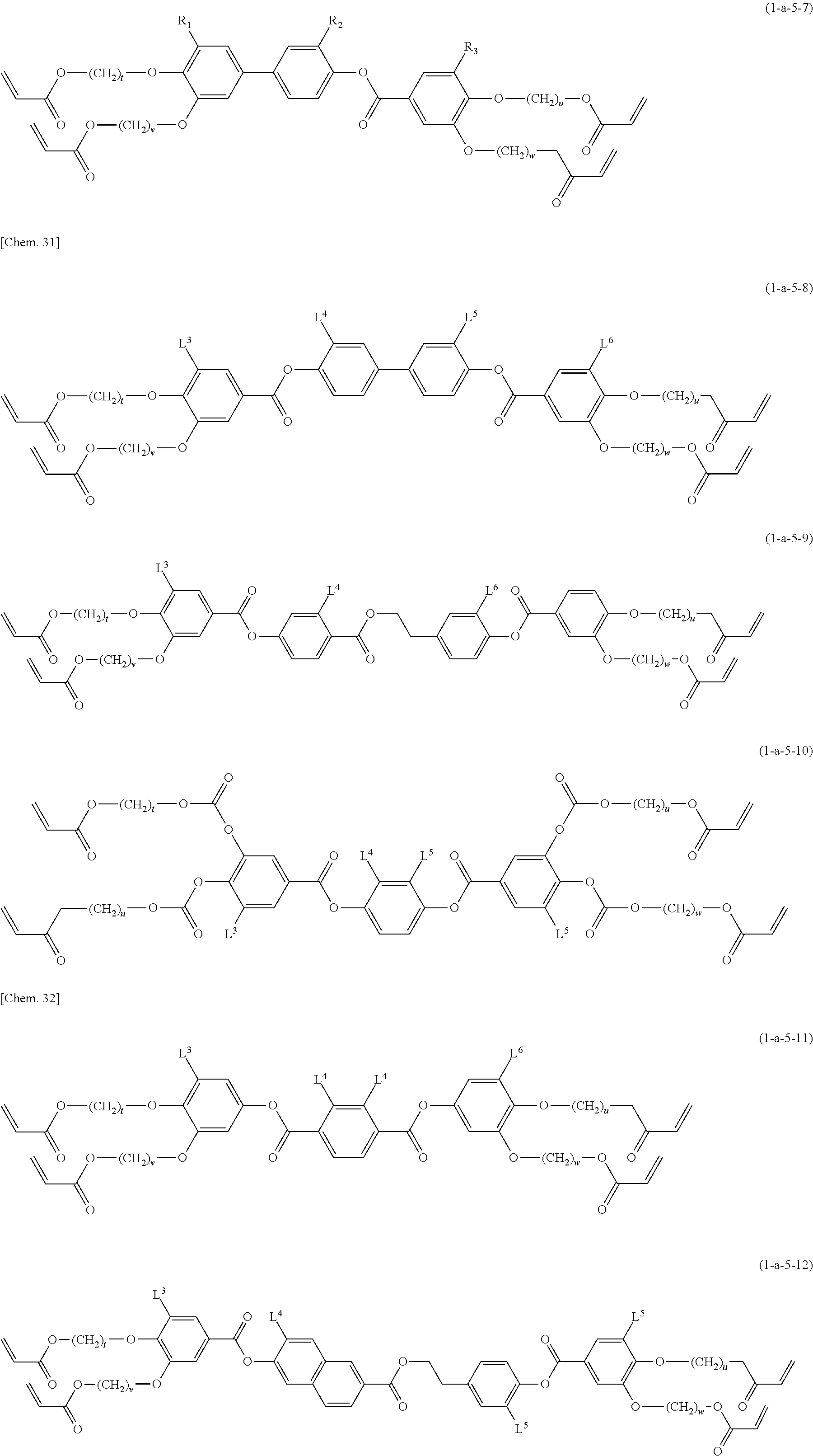

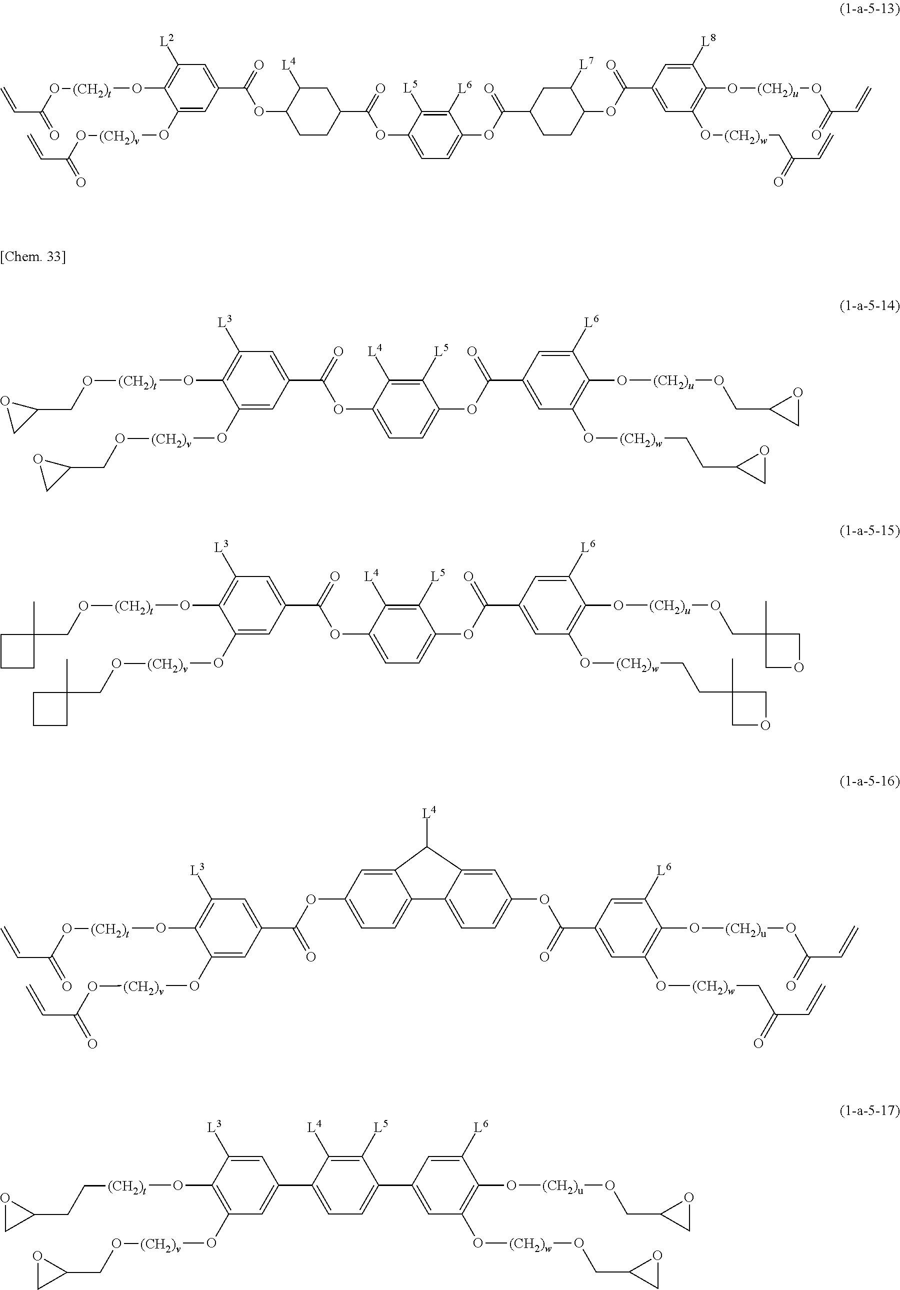

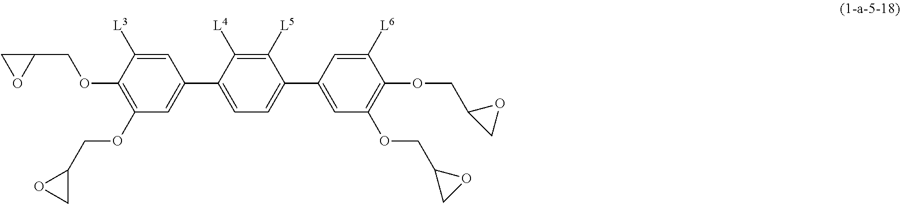

(In the formulae, t, u, v and w each independently represent an integer of 1 to 18, L³, L⁴, L⁵, L⁶, L⁷ and L⁸ each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups each are an alkyl group having 1 to 6 carbon atoms, or an alkoxy group having 1 to 6 carbon atoms, the hydrogen atoms bonding to the alkyl group or the alkoxy group may be unsubstituted or may be substituted with one or two or more halogen atoms.) One alone or two or more of these compounds may be used either singly or as combined.

Specifically, the compounds represented by the general formula (1-a-6) are preferably compounds represented by the following formulae (1-a-6-1) to (1-a-6-21):

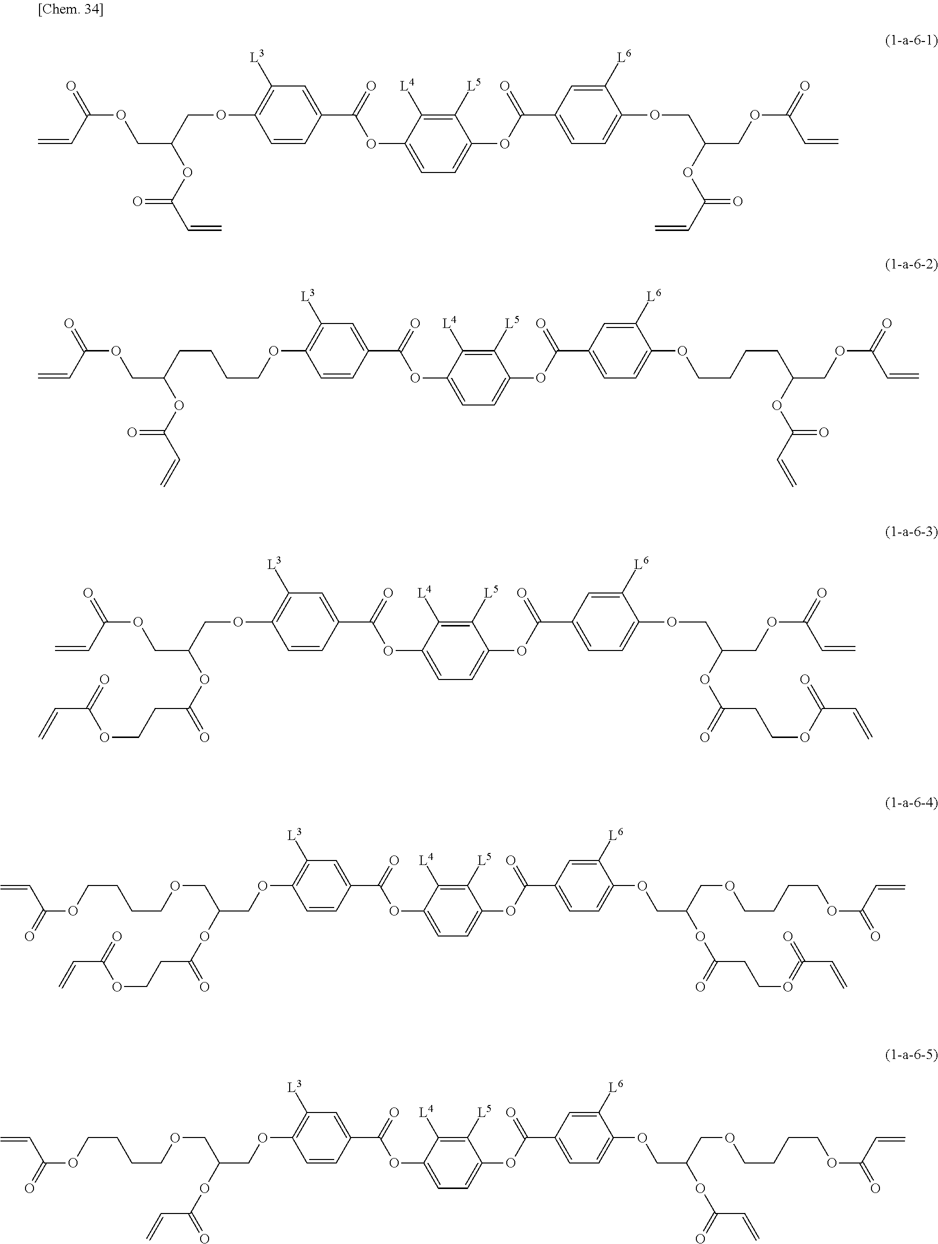

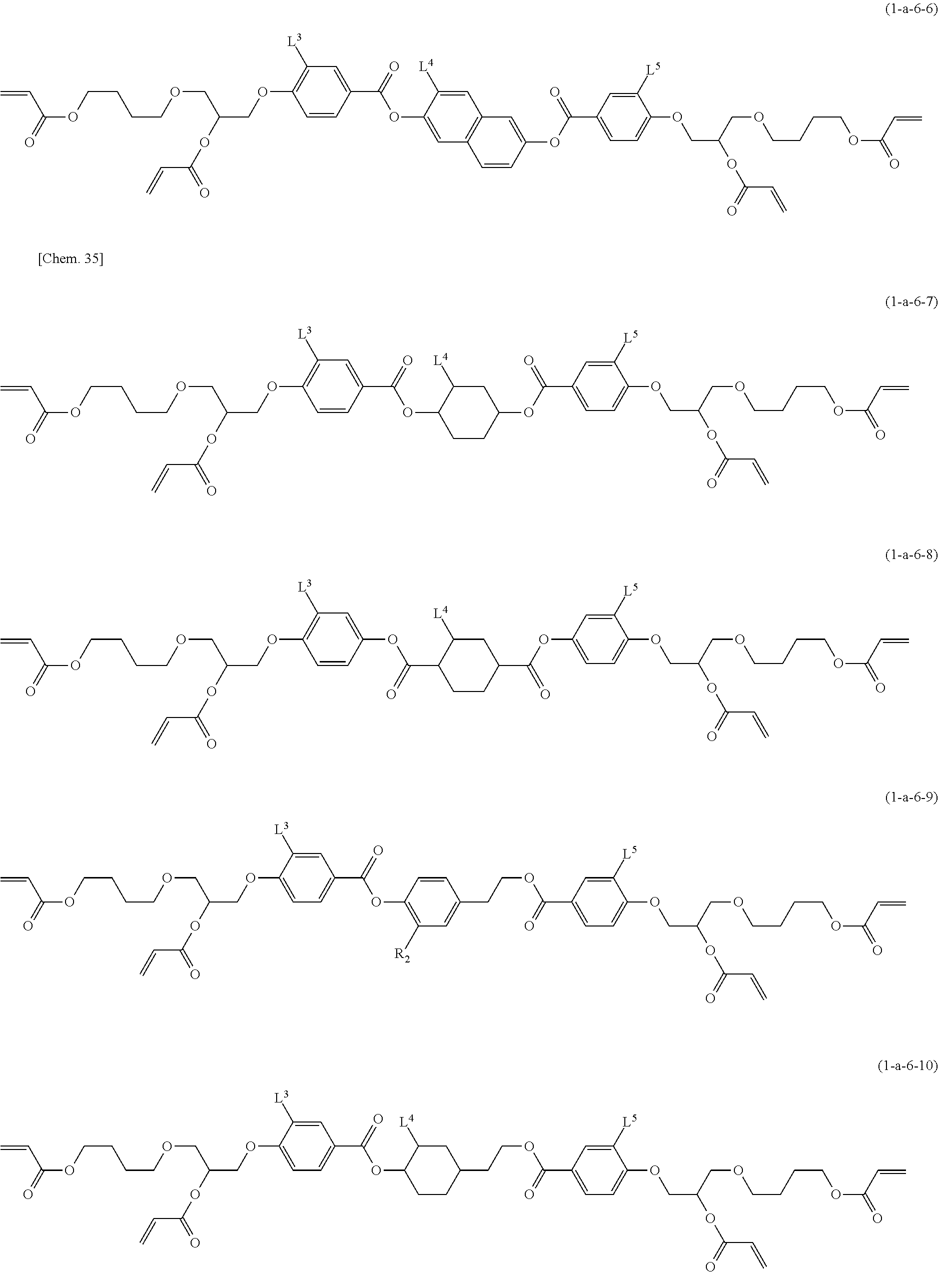

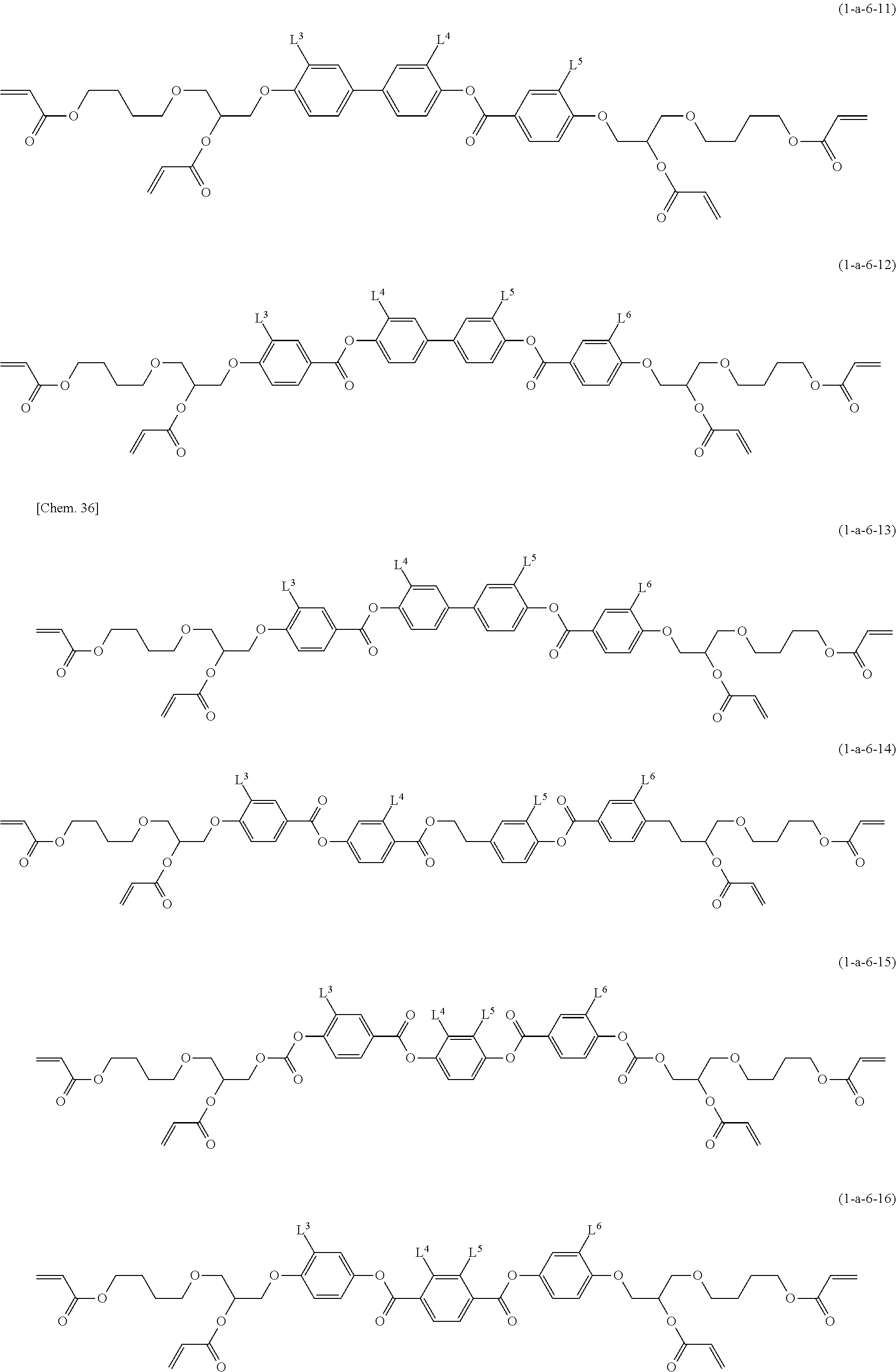

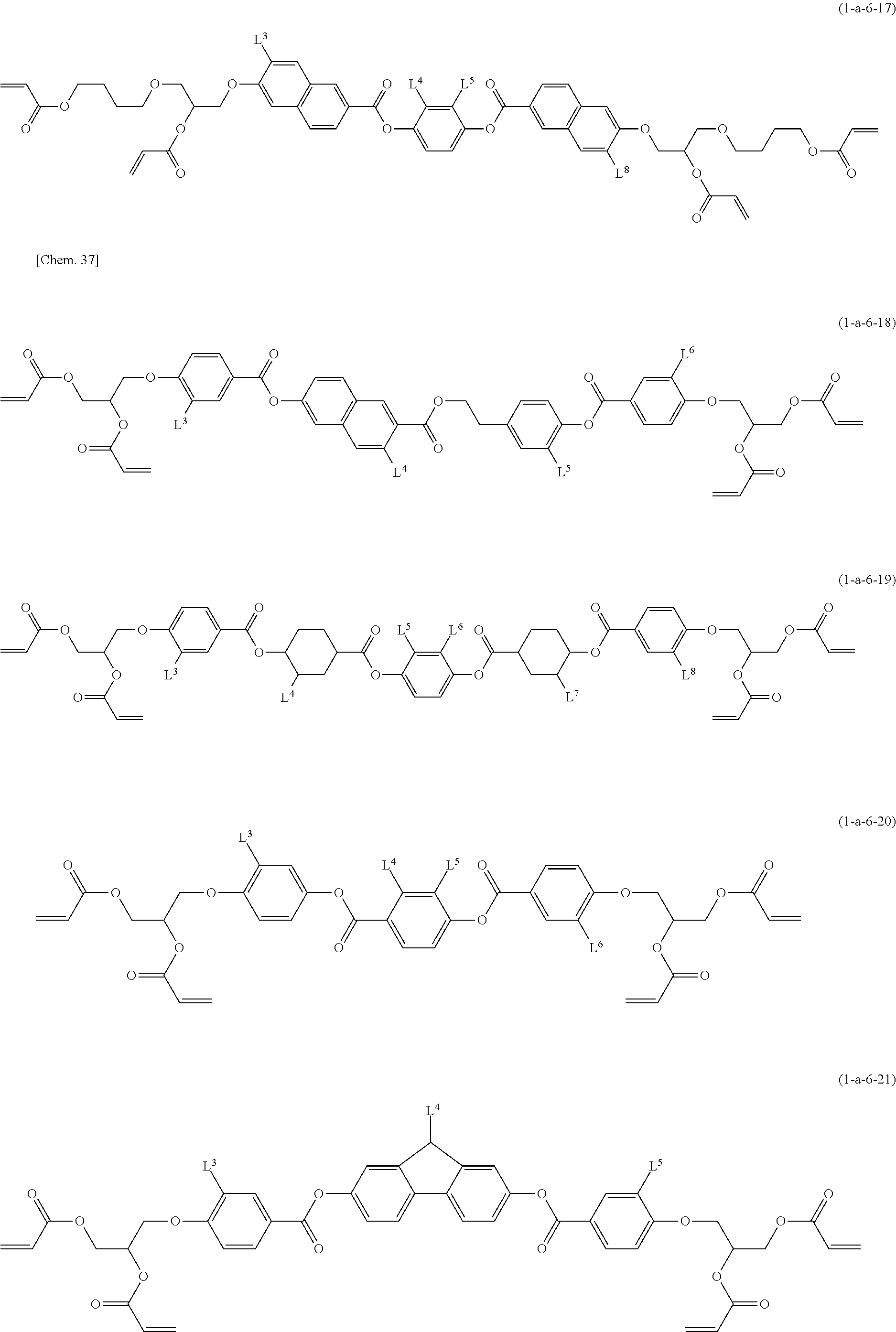

(In the formulae, L³, L⁴, L⁵, L⁶, L⁷ and L⁸ each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups each are an alkyl group having 1 to 6 carbon atoms, or an alkoxy group having 1 to 6 carbon atoms, the hydrogen atoms bonding to the alkyl group or the alkoxy group may be unsubstituted or may be substituted with one or two or more halogen atoms.) One alone or two or more of these compounds may be used either singly or as combined.

Specifically, the compounds represented by the general formula (1-a-7) are preferably compounds represented by the following formulae (1-a-7-1) to (1-a-7-18):

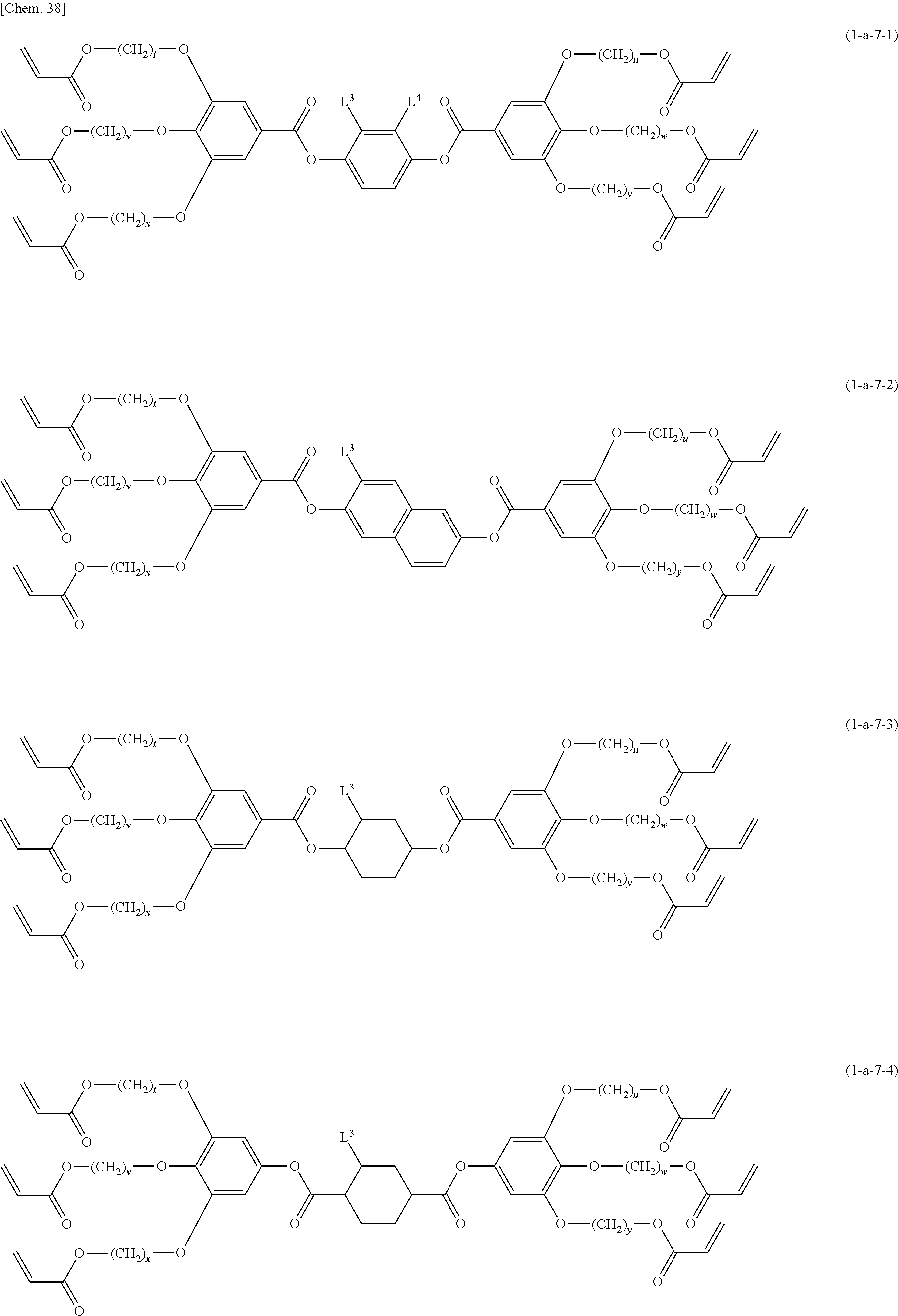

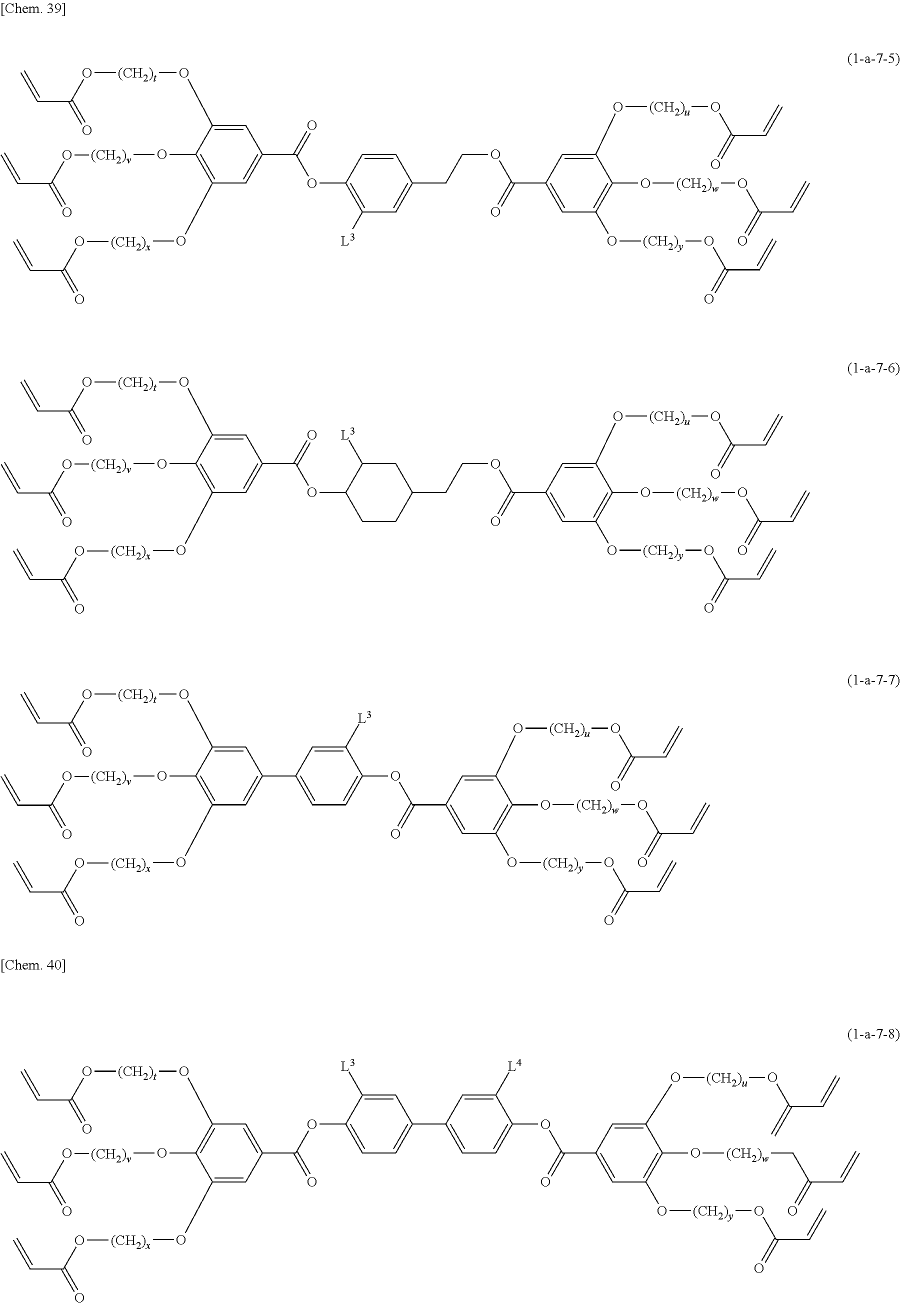

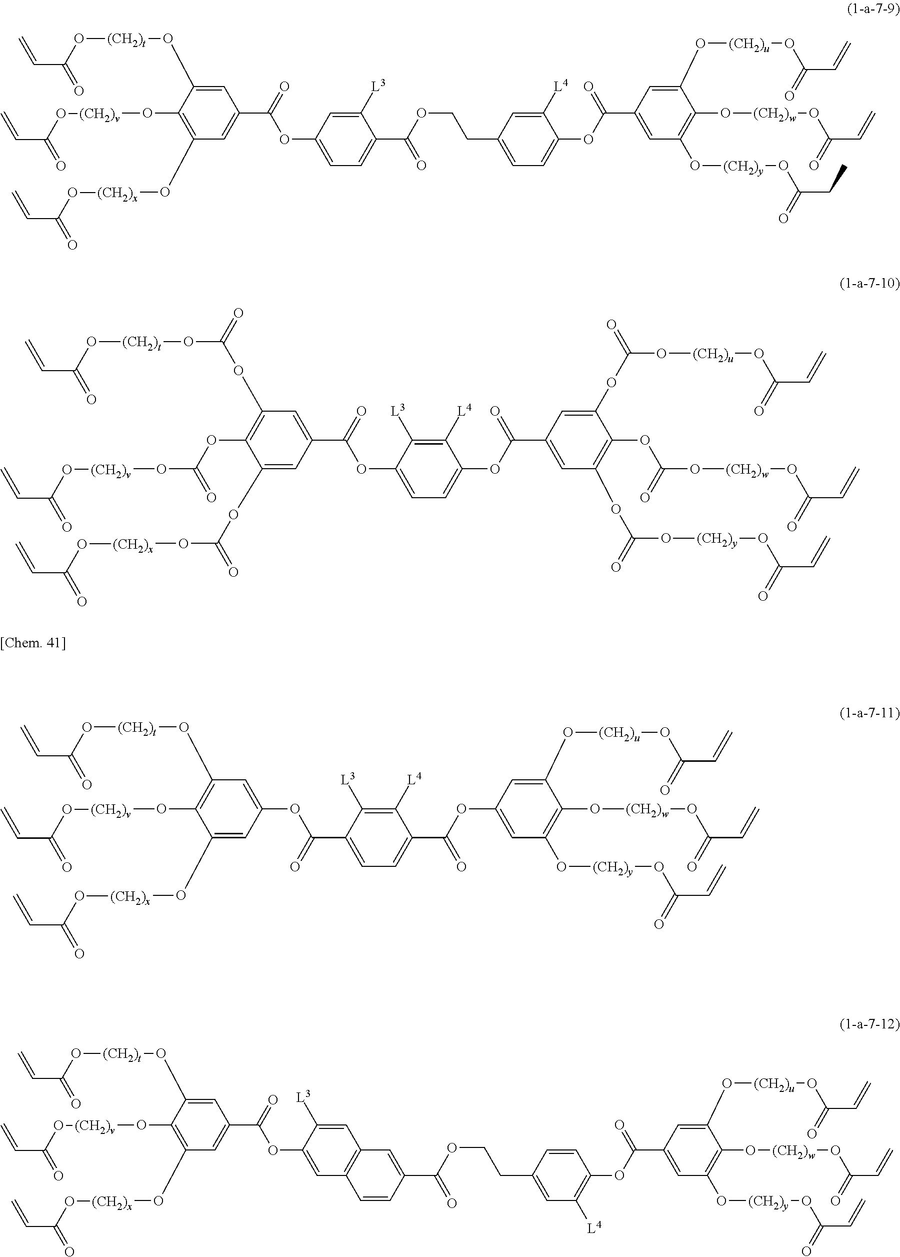

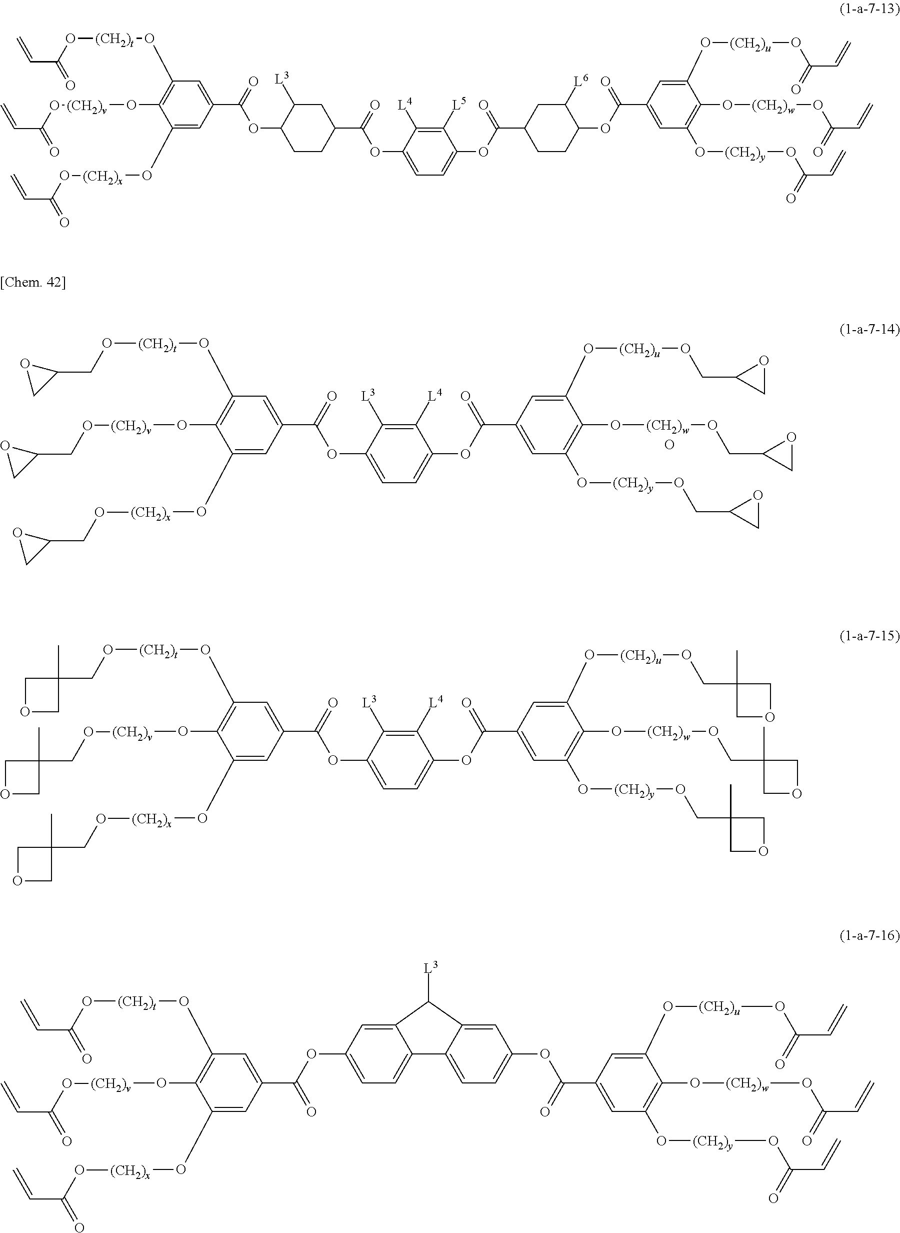

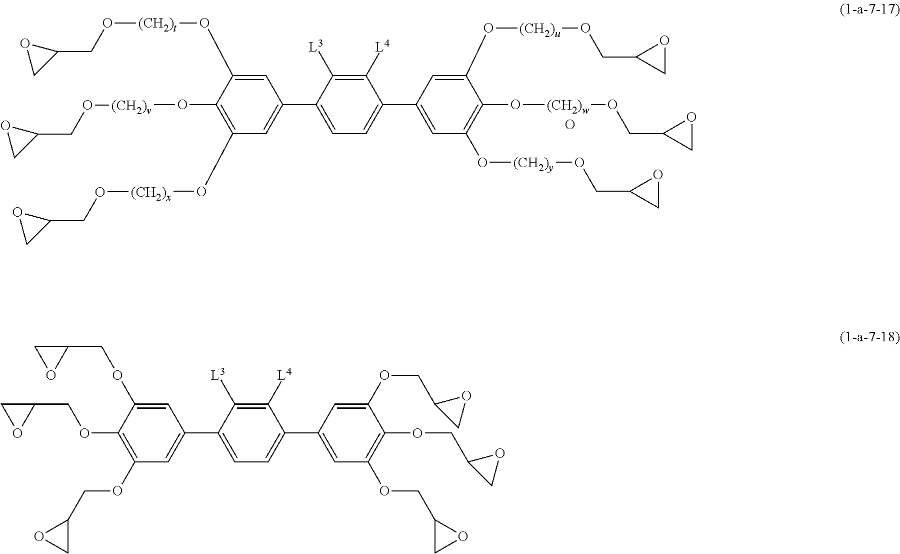

(In the formulae, t, u, v, w, x and y each independently represent an integer of 1 to 18. L³ and L⁴ each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups each are an alkyl group having 1 to 6 carbon atoms, or an alkoxy group having 1 to 6 carbon atoms, the hydrogen atoms bonding to the alkyl group or the alkoxy group may be unsubstituted or may be substituted with one or two or more halogen atoms.) One alone or two or more of these compounds may be used either singly or as combined.

More specifically, the polyfunctional polycyclic polymerizable compounds represented by the general formula (1) where HD is a hard segment of the general formula (1-b) are preferably compounds represented by the following general formulae (1-b-1) to (1-b-5):

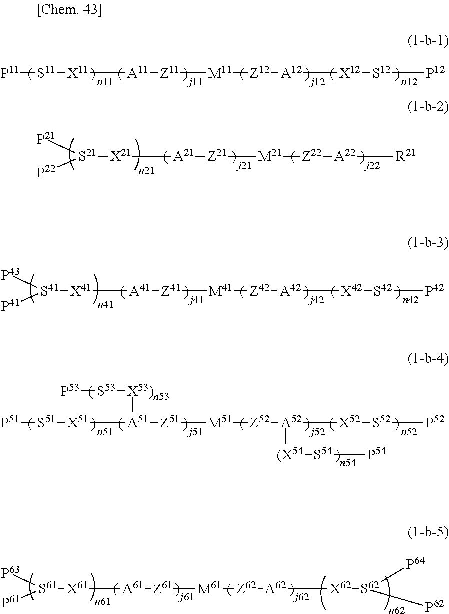

In the above-mentioned general formulae (1-b-1) to (1-b-5), P¹¹ to P^{7e} each independently represent a polymerizable group, and each is preferably a group selected from the following formulae (P-1) to (P-20):

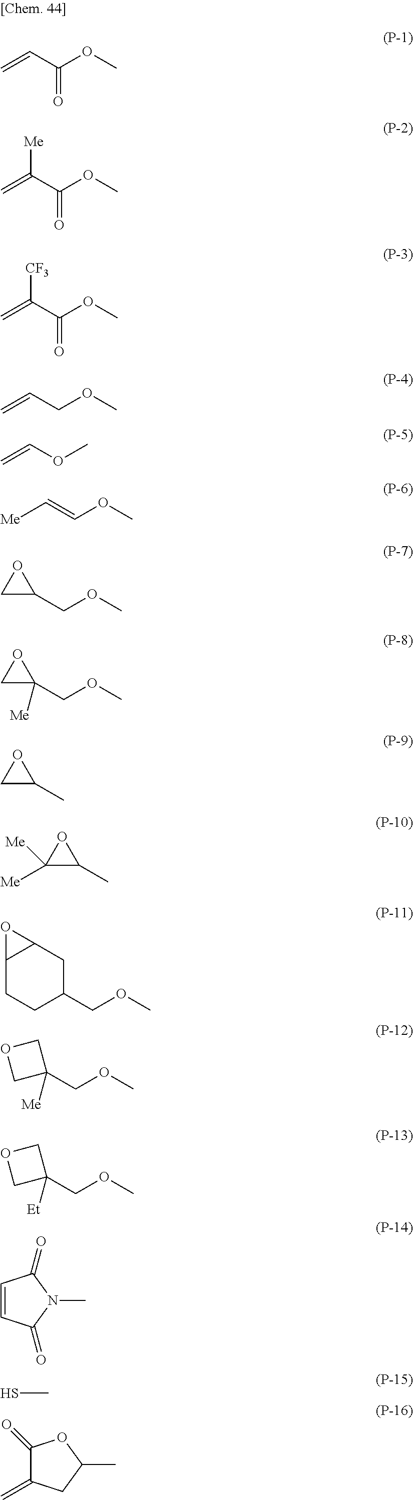

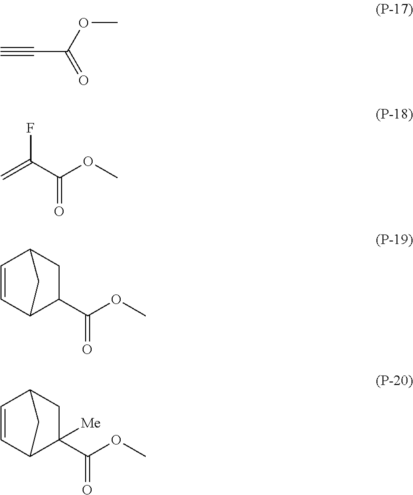

Among these polymerizable groups, from the viewpoint of enhancing polymerizability and storage stability, the formula (P-1), (P-2), (P-7), (P-12) or (P-13) is preferred; the formula (P-1), (P-2), (P-7) or (P-12) is more preferred; and the formula (P-1) or (P-2) is even more preferred.

In the general formulae (1-b-1) to (1-b-5), —(S¹¹—X¹¹)— to —(S⁶²—X⁶²)— each independently represent a soft segment or a single bond.

S¹¹ to S⁶² each independently represent a spacer group or a single bond, and plural S¹¹'s to S⁶²'s, if any, each may be the same or different. The spacer group represents an alkylene group having 1 to 18 carbon atoms, and one or two or more hydrogen atoms bonding to the alkylene group may be each independently substituted with a halogen atom, a group CN, an alkyl group having 1 to 8 carbon atoms, or an alkylene group having 1 to 8 carbon atoms and having a polymerizable functional group, and one CH₂ group or two or more CH₂ groups not adjacent to each other existing in this group may be mutually independently substituted with —O—, —S—, —NH—, —N(CH₃)—, —CO—, —CH(OH)—, —CH(COOH)—, —COO—, —OCO—, —OCOO—, —SCO—, —COS— or —C≡C— in the form where the oxygen atoms do not mutually directly bond to each other. Among these spacer groups, a linear alkylene group having 2 to 8 carbon atoms, an alkylene group having 2 to 6 carbon atoms and substituted with a fluorine atom, or an alkylene group having 3 to 12 carbon atoms in which one CH₂ group or two or more CH₂ groups not adjacent to each other existing in the alkylene group may be substituted with —O— is preferred, from the viewpoint of alignment performance.

In the general formulae (1-b-1) to (1-b-5), X¹¹ to X⁶² each independently represent —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C— or a single bond, and plural X¹¹'s to X⁶²'s, if any, each may be the same or different. From the viewpoint of easy availability of raw materials and easiness in synthesis, those plural groups, if any, may be each independently the same or different, and preferably, each independently represents —O—, —S—, —OCH₂—, —CH₂O—, —COO—, —OCO—, —CO—S—, —S—CO—, —O—CO—O—, —CO—NH—, —NH—CO—, —COO—CH₂CH₂—, —OCO—CH₂CH₂—, —CH₂CH₂—COO—, —CH₂CH₂—OCO— or a single bond, and more preferably each independently represents —O—, —OCH₂—, —CH₂O—, —COO—, —OCO—, —COO—CH₂CH₂—, —OCO—CH₂CH₂—, —CH₂CH₂—COO—, —CH₂CH₂—OCO— or a single bond. Plural X¹¹'s to X⁶²'s, if any, each may be the same or different, and especially preferably, each represents —O—, —COO—, —OCO— or a single bond.

In the above-mentioned general formulae (1-b-1) to (1-b-5), each P—(S—X)— does not contain an —O—O— bond.

In the general formulae (1-b-1) to (1-b-5), A¹¹ to A⁶² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalane-2,6-diyl group or a 1,3-dioxane-2,5-diyl group, and these groups may be unsubstituted or substituted with one or more substituents, and plural A¹¹'s to A⁶²'s, if any, each may be the same or different. From the viewpoint of easy availability of raw materials and easiness in synthesis, preferably, A¹¹ to A⁶² each are independently a 1,4-phenylene group, a 1,4-cyclohexylene group or a naphthalene-2,6-diyl group that is unsubstituted or may be substituted with one or more substituents of L¹ and L², and each is more preferably a group selected from the following formulae (A-1) to (A-16):

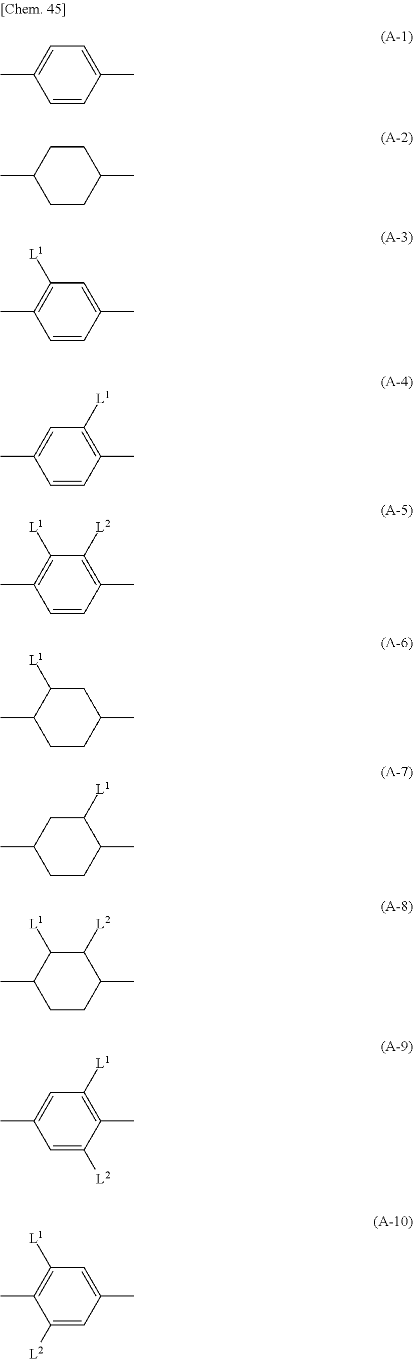

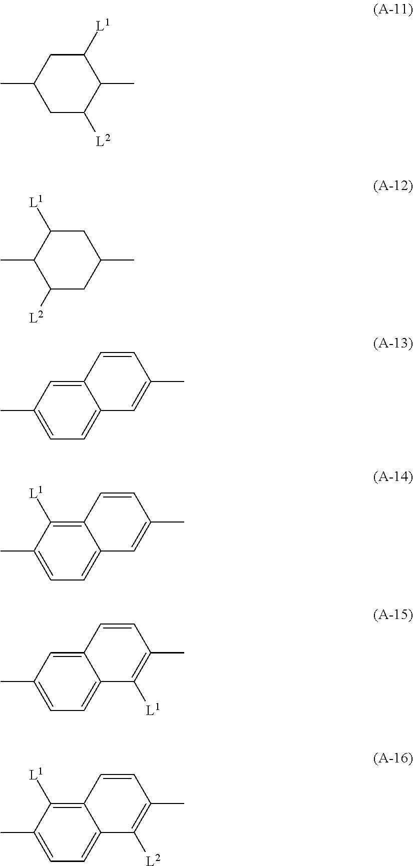

more preferably, each is a group selected from the formulae (A-1) to (A-13), and especially preferably each is a group selected from the formulae (A-1) to (A-4).

In the above-mentioned general formulae (A-1) to (A-16), the substituents L¹ and L² each independently represent a fluorine atom, a chlorine atom, a bromine atom, an iodine atom, a pentafluorosulfuranyl group, a nitro group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, and any hydrogen atom in the alkyl group may be substituted with a fluorine atom, or the substituents each represent a group represented by the above-mentioned general formula (1-c). From the viewpoint of easiness in synthesis, preferably, the substituents L¹ and L² each are independently a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which any hydrogen atom may be substituted with a fluorine atom, and one —CH₂— or two or more (—CH₂—)'s not adjacent to each other therein may be each independently substituted with —O—, —S—, —CO—, —COO—, —OCO—, —O—CO—O—, —CH═CH—, —CF═CF— or —C≡C—, or each is a group represented by the general formula (1-c); more preferably, each is a fluorine atom, a chlorine atom, or a linear or branched alkyl group having 1 to 12 carbon atoms in which any hydrogen atom may be substituted with a fluorine atom, and one —CH₂— or two or more (—CH₂—)'s not adjacent to each other therein may be each independently substituted with —O—, —COO— or —OCO—; even more preferably, each is a fluorine atom, a chlorine atom, or a linear or branched alkyl or alkoxy group having 1 to 12 carbon atoms in which any hydrogen atom may be substituted with a fluorine atom; and especially preferably each is a fluorine atom, a chlorine atom, or a linear alkyl group or a linear alkoxy group having 1 to 8 carbon atoms.

In the general formulae (A-1) to (A-16), M¹¹ to M⁵¹ each independently represent the following formula (1-b-MG):

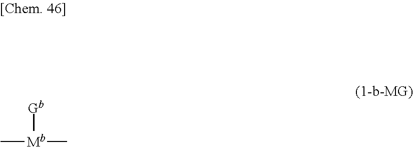

In the formula (1-b-MG), M^{b} represents a group selected from the following formulae (M-1) to (M-11):

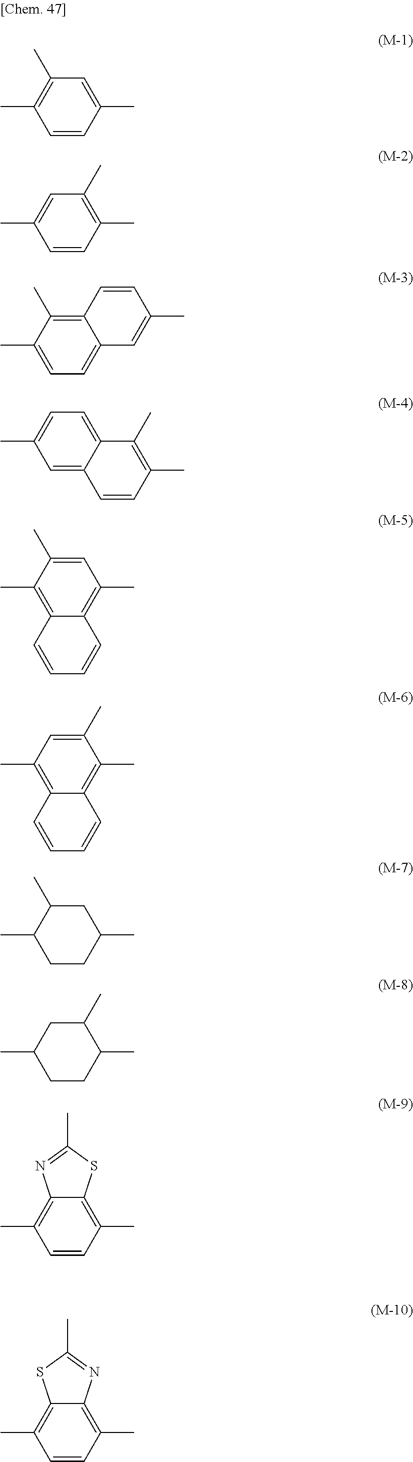

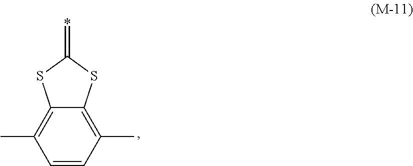

and these groups may be unsubstituted or substituted with one or more L^{b}'s. From the viewpoint of easy availability of raw materials and easiness in synthesis, preferably, M^{b} represents a group of the formula (M-1) or (M-2) that is unsubstituted or substituted with one or more L^{b}'s, or an unsubstituted group selected from the formulae (M-3) to (M-6); more preferably a group of the formula (M-1) or (M-2) that is unsubstituted or substituted with one or more L^{b}'s; and especially preferably an unsubstituted group of the formula (M-1) or (M-2).

In the formula (1-b-MG), G^{b} represents a group selected from the following formulae (G-1) to (G-6):

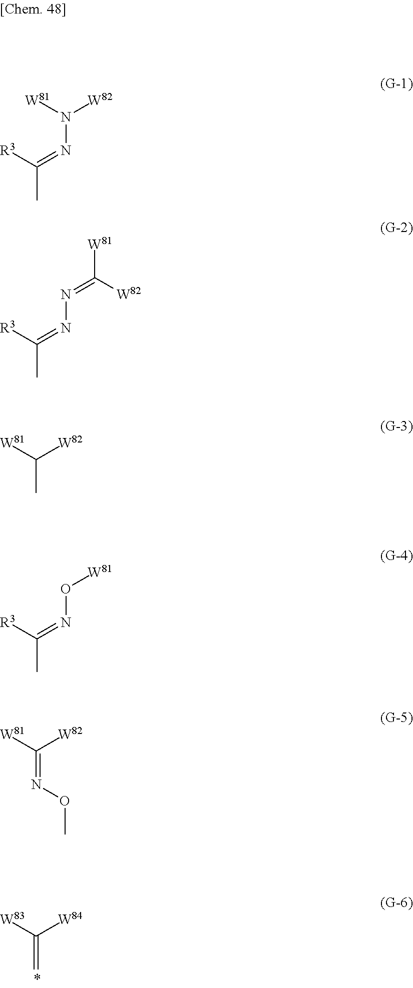

In the formulae (G-1) to (G-6), R³ represents a hydrogen atom, or an alkyl group having 1 to 20 carbon atoms, and the alkyl group may be linear or branched, any hydrogen atom in the alkyl group may be substituted with a fluorine atom, and one —CH₂— or two or more (—CH₂—)'s not adjacent to each other in the alkyl group may be each independently substituted with —O—, —S—, —CO—, —COO—, —OCO—, —CO—S—, —S—CO—, —O—CO—O—, —CO—NH—, —NH—CO— or —C≡C—,

in the formulae (G-1) to (G-6), W⁸¹ represents a group having at least one aromatic group and having 5 to 30 carbon atoms, and the group may be unsubstituted or substituted with one or more L^{b}'s,
W⁸² represents a hydrogen atom, or an alkyl group having 1 to 20 carbon atoms, and the alkyl group may be linear or branched, any hydrogen atom in the alkyl group may be substituted with a fluorine atom, and one —CH₂— or two or more (—CH₂—)'s not adjacent to each other in the alkyl group may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, or W⁶² represents a group represented by the following general formula (1-c):

[Chem. 49]

A⁶_{q}Sf³ᵣP³ (1-c)

(wherein P³ represents a polymerizable group, and has the same meaning as that defined hereinabove for P¹ and P², A⁶ represents —O—, —COO—, —OCO—, —OCH₂—, —CH₂O—, —CH₂CH₂OCO—, —COOCH₂CH₂—, —OCOCH₂CH₂— or a single bond, Sf³ has the same meaning as that defined hereinabove for Sf¹ and Sf², q represents 0 or 1, and r represents 0 or 1).

In the formulae (G-1) to (G-6), the aromatic group contained in W⁸¹ may be an aromatic hydrocarbon group or an aromatic hetero group, or may contain both of them. These aromatic groups may bond to each other via a single bond or a linking group (—OCO—, —COO—, —CO—, —O—), or may form a condensed ring. In addition to an aromatic group, W⁸¹ may contain any other acyclic structure and/or a cyclic structure than an aromatic group. The aromatic group contained in W⁸¹ is, from the viewpoint of easy availability of raw material and easiness in synthesis, preferably a group of the following formulae (W-1) to (W-19) which may be unsubstituted or substituted with one or more L^{b}'s:

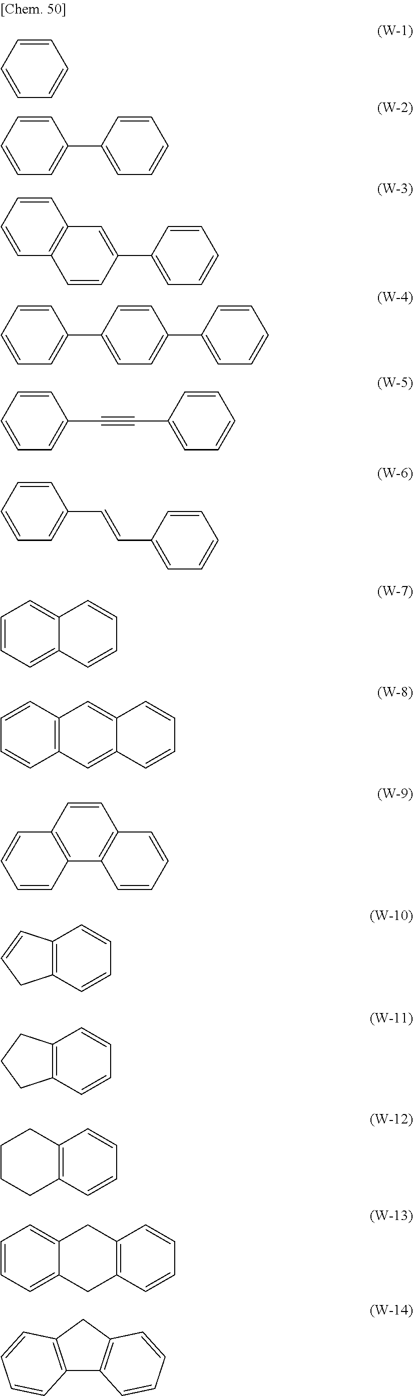

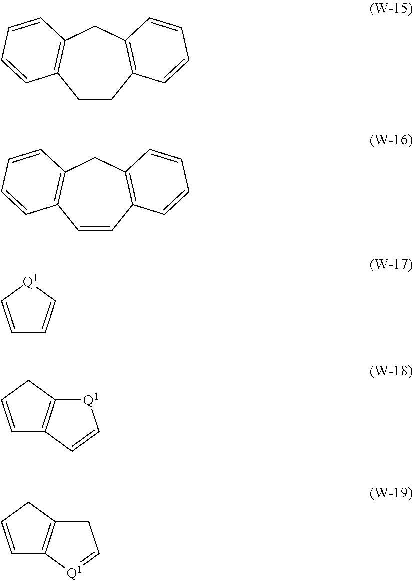

(wherein these groups may have a chemical bond at any position, or may form a group formed by bonding two or more aromatic groups selected from these groups via a single bond, Q¹ represents —O—, —S—, —NR⁴— (where R⁴ represents a hydrogen atom or an alkyl group having 1 to 8 carbon atoms) or —CO—). —CH═ in these aromatic groups may be each independently substituted with —N═, and —CH₂— may be each independently substituted with —O—, —S—, —NR⁴— (where R⁴ represents a hydrogen atom or an alkyl group having 1 to 8 carbon atoms) or —CO—, but does not contain an —O—O— bond. The group represented by the formula (W-1) is preferably a group selected from the following formulae (W-1-1) to (W-1-8) which may be unsubstituted or substituted with one or more L^{b}'s:

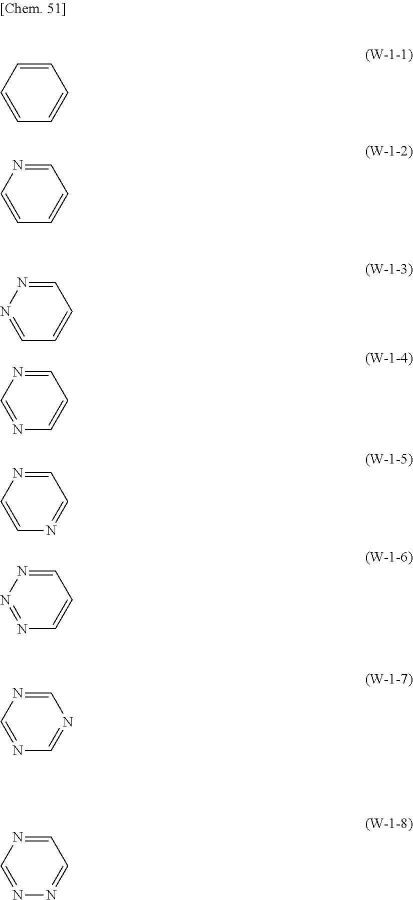

(wherein these groups may have a chemical bond at any position). The group represented by the formula (W-7) is preferably a group selected from the following formulae (W-7-1) to (W-7-7) which may be unsubstituted or substituted with one or more L^{b}'s:

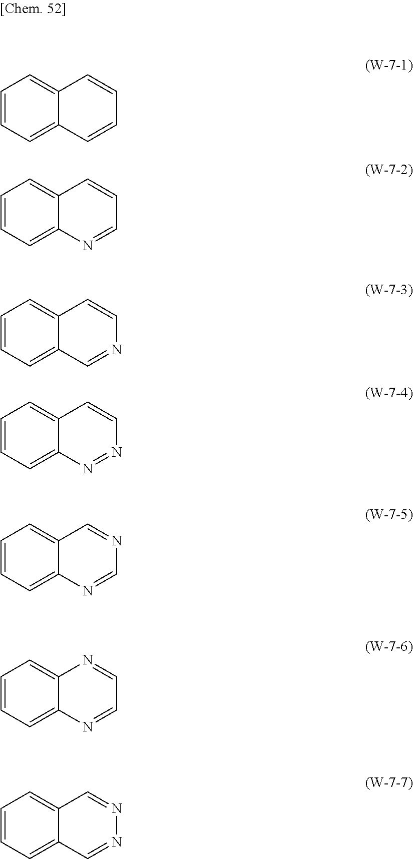

(wherein these groups may have a chemical bond at any position). The group represented by the formula (W-10) is preferably a group selected from the following formulae (W-10-1) to (W-10-8) which may be unsubstituted or substituted with one or more L^{b}'s:

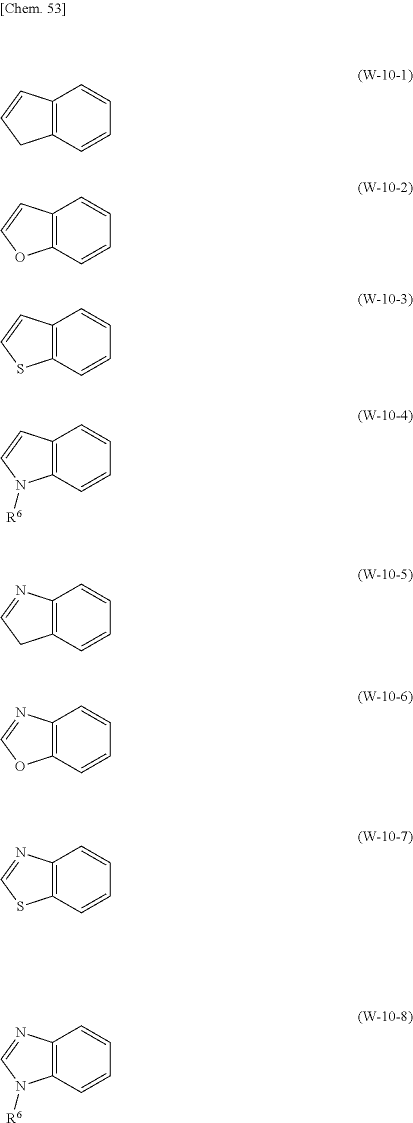

(wherein these groups may have a chemical bond at any position, and R⁶ represents a hydrogen atom or an alkyl group having 1 to 8 carbon atoms). The group represented by the formula (W-11) is preferably a group selected from the following formulae (W-11-1) to (W-11-13) which may be unsubstituted or substituted with one or more L^{b}'s:

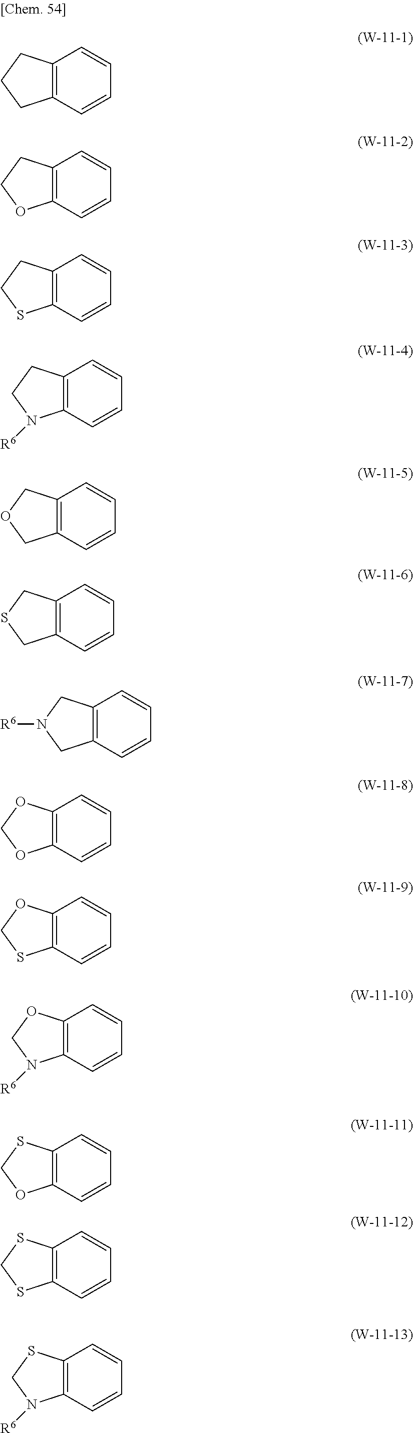

(wherein these groups may have a chemical bond at any position, and R⁶ represents a hydrogen atom or an alkyl group having 1 to 8 carbon atoms). The group represented by the formula (W-12) is preferably a group selected from the following formulae (W-12-1) to (W-12-19) which may be unsubstituted or substituted with one or more L^{b}'s:

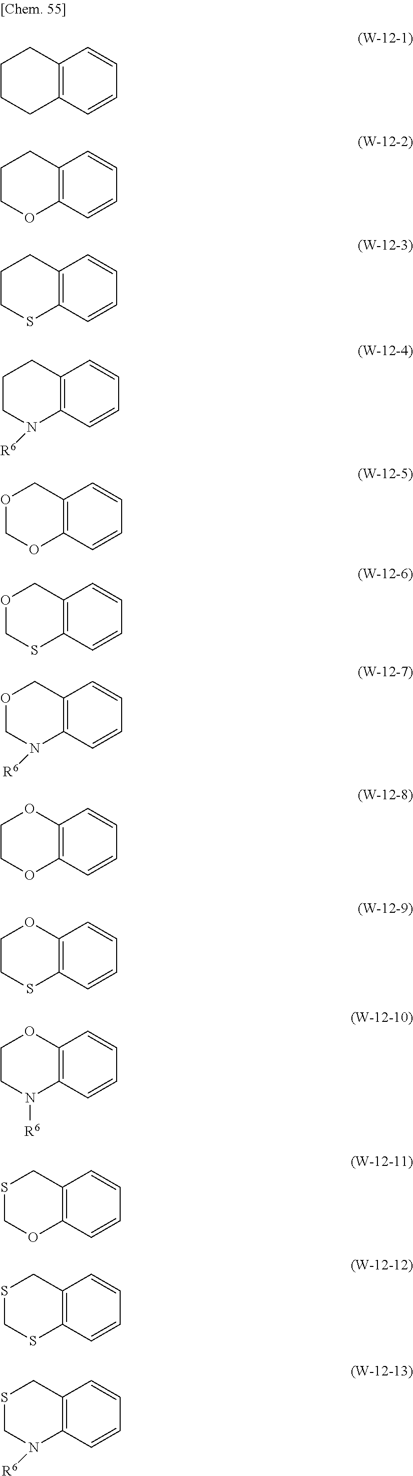

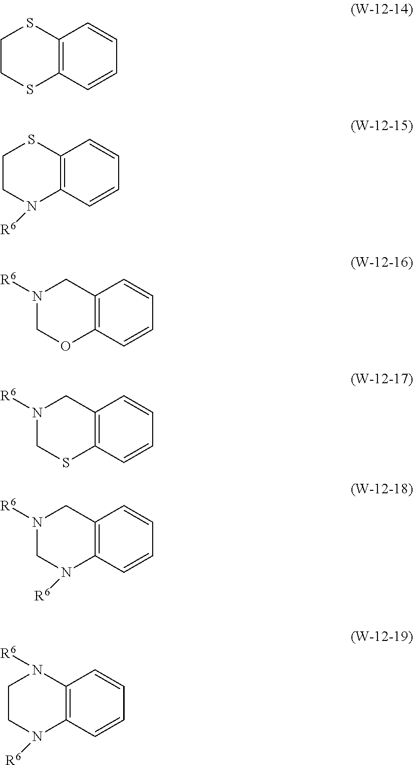

(wherein these groups may have a chemical bond at any position, and R⁶ represents a hydrogen atom or an alkyl group having 1 to 8 carbon atoms, and plural R⁶'s, if any, may be the same or different). The group represented by the formula (W-13) is preferably a group selected from the following formulae (W-13-1) to (W-13-10) which may be unsubstituted or substituted with one or more L^{b}'s:

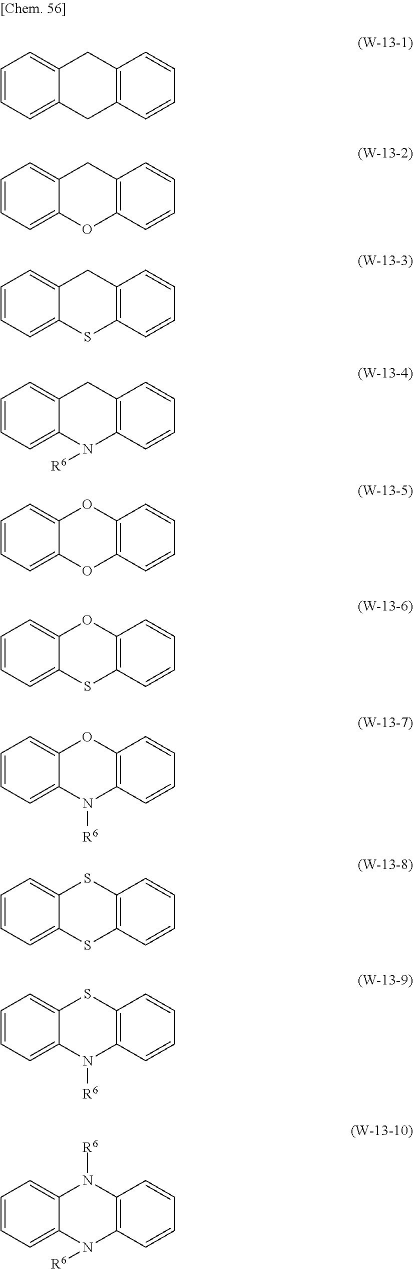

(wherein these groups may have a chemical bond at any position, and R⁶ represents a hydrogen atom or an alkyl group having 1 to 8 carbon atoms, and plural R⁶'s, if any, may be the same or different). The group represented by the formula (W-14) is preferably a group selected from the following formulae (W-14-1) to (W-14-4) which may be unsubstituted or substituted with one or more L^{b}'s:

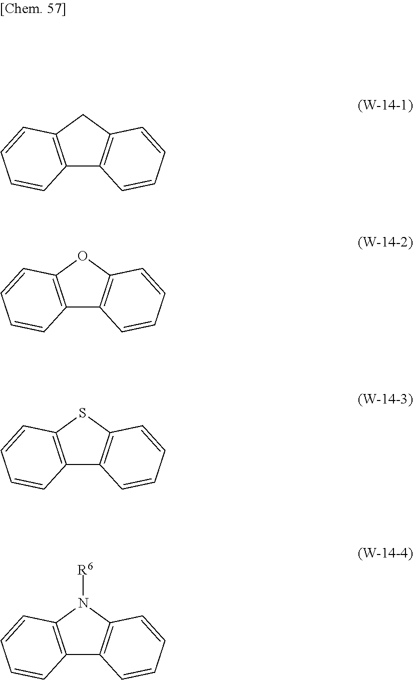

(wherein these groups may have a chemical bond at any position, and R⁶ represents a hydrogen atom or an alkyl group having 1 to 8 carbon atoms). The group represented by the formula (W-15) is preferably a group selected from the following formulae (W-15-1) to (W-15-18) which may be unsubstituted or substituted with one or more L^{b}'s:

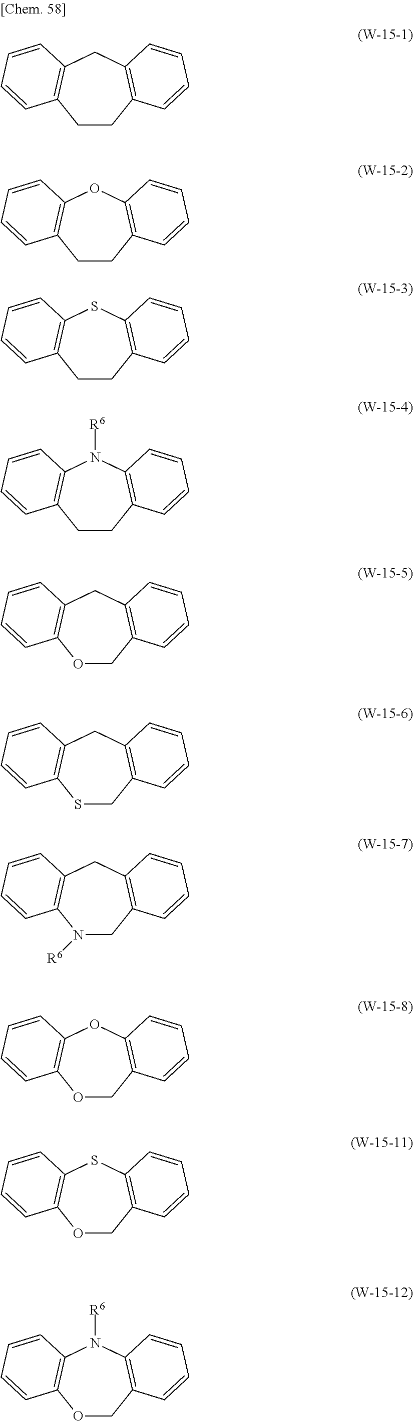

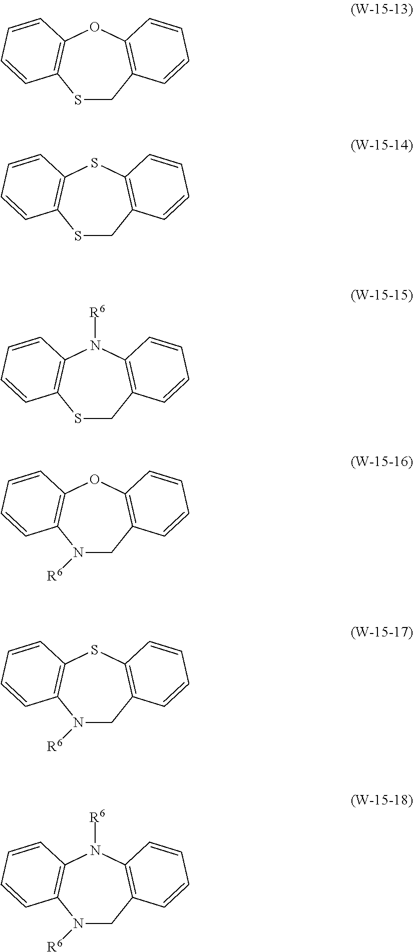

(wherein these groups may have a chemical bond at any position, and R⁶ represents a hydrogen atom or an alkyl group having 1 to 8 carbon atoms). The group represented by the formula (W-16) is preferably a group selected from the following formulae (W-16-1) to (W-16-4) which may be unsubstituted or substituted with one or more L^{b}'s:

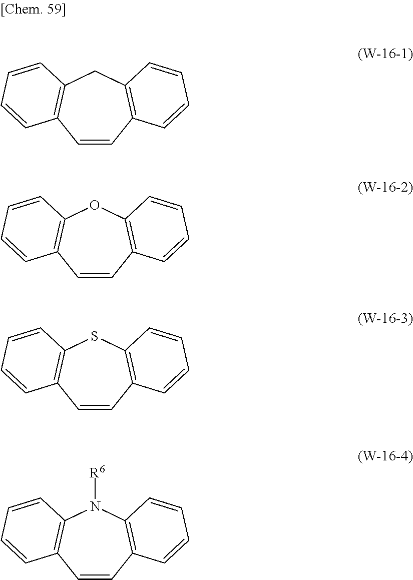

(wherein these groups may have a chemical bond at any position, and R⁶ represents a hydrogen atom or an alkyl group having 1 to 8 carbon atoms). The group represented by the formula (W-17) is preferably a group selected from the following formulae (W-17-1) to (W-17-6) which may be unsubstituted or substituted with one or more L^{b}'s:

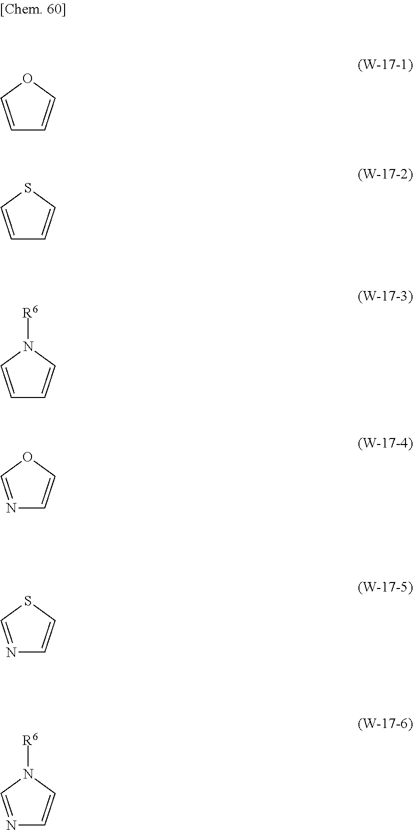

(wherein these groups may have a chemical bond at any position, and R⁶ represents a hydrogen atom or an alkyl group having 1 to 8 carbon atoms). The group represented by the formula (W-18) is preferably a group selected from the following formulae (W-18-1) to (W-18-6) which may be unsubstituted or substituted with one or more L^{b}'s:

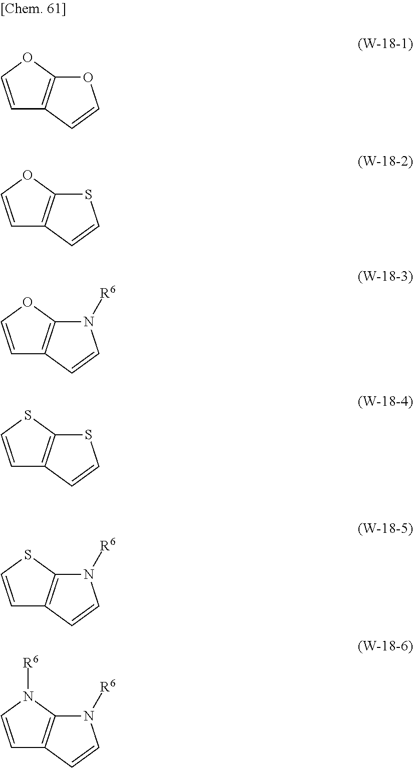

(wherein these groups may have a chemical bond at any position, and R⁶ represents a hydrogen atom or an alkyl group having 1 to 8 carbon atoms, and plural R⁶'s, if any, may be the same or different). The group represented by the formula (W-19) is preferably a group selected from the following formulae (W-19-1) to (W-19-9) which may be unsubstituted or substituted with one or more L^{b}'s:

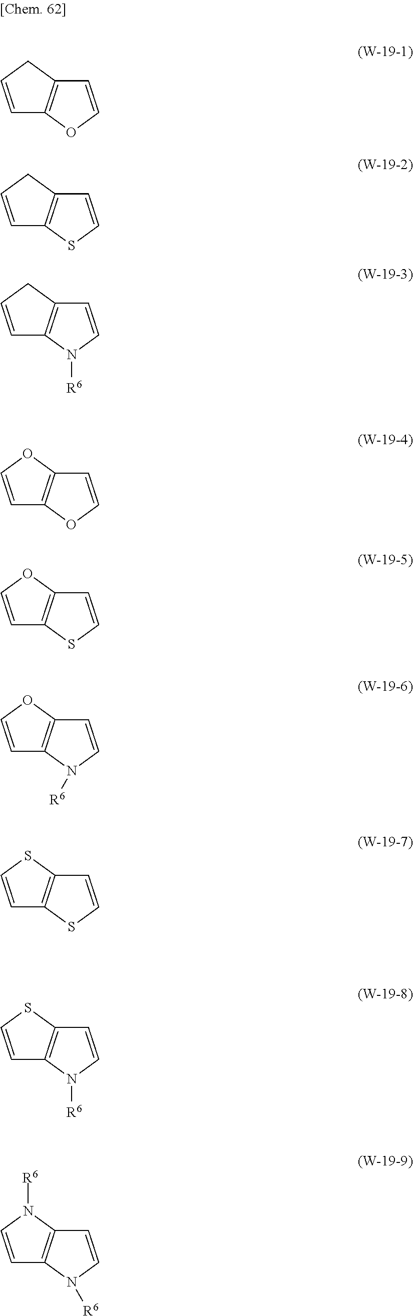

(wherein these groups may have a chemical bond at any position, and R⁶ represents a hydrogen atom or an alkyl group having 1 to 8 carbon atoms, and plural R⁶'s, if any, may be the same or different). The aromatic group contained in W⁸¹ is more preferably a group selected from the formula (W-1-1), (W-7-1), (W-7-2), (W-7-7), (W-8), (W-10-6), (W-10-7), (W-10-8), (W-11-8), (W-11-9), (W-11-10), (W-11-11), (W-11-12) or (W-11-13) which may be unsubstituted or substituted with one or more L^{b}'s, and is especially preferably a group selected from the formula (W-1-1), (W-7-1), (W-7-2), (W-7-7), (W-10-6), (W-10-7) or (W-10-8) which may be unsubstituted or substituted with one or more L¹'s. Even more preferably, W⁸¹ is a group selected from the following formulae (W-a-1) to (W-a-6):

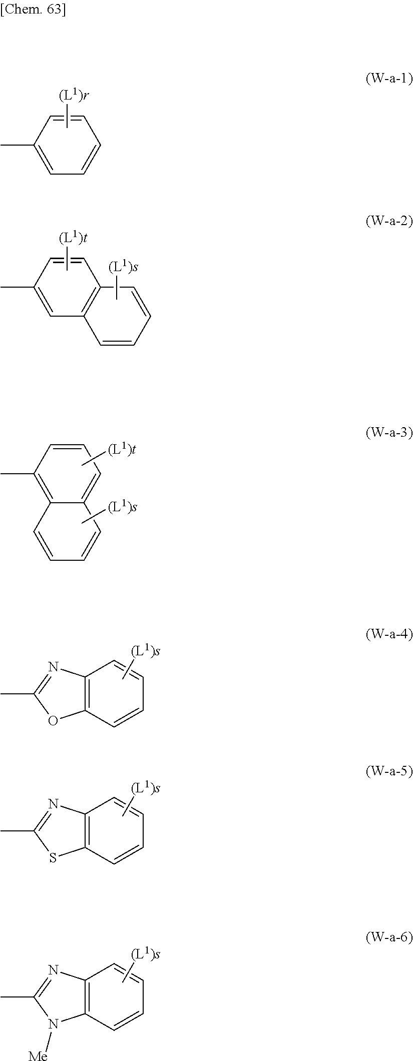

(wherein r represents an integer of 0 to 5's represents an integer of 0 to 4, and t represents an integer of 0 to 3).

W⁸² represents a hydrogen atom, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, and any hydrogen atom in the alkyl group may be substituted with a fluorine atom, or W⁸² may have the same meaning as that of W⁸¹, or W⁸¹ and W⁸² may together form a cyclic structure, or W³² represents a group represented by the following general formula (1-c):

[Chem. 64]

A⁶_{q}Sf³ᵣP³ (1-c)

(wherein P³ represents a polymerizable group and has the same meaning as that defined hereinabove for P¹ and P², A⁶ represents —O—, —COO—, —OCO—, —OCH₂—, —CH₂O—, —CH₂CH₂OCO—, —COOCH₂CH₂—, —OCOCH₂CH₂— or a single bond, Sf³ has the same meaning as that defined hereinabove for Sf¹ and Sf², q represents 0 or 1, and r represents 0 or 1).

From the viewpoint of easy availability of raw materials and easiness in synthesis, preferably, W⁸² is a hydrogen atom, or a linear or branched alkyl group having 1 to 20 carbon atoms in which any hydrogen atom may be substituted with a fluorine atom and one —CH₂— or two or more (—CH₂—)'s not adjacent to each other may be each independently substituted with —O—, —CO—, —COO—, —OCO—, —CH═CH—COO—, —OCO—CH═CH—, —CH═CH—, —CF═CF— or —C≡C—; more preferably, a hydrogen atom or a linear or branched alkyl group having 1 to 20 carbon atoms; even more preferably a hydrogen atom or a linear alkyl group having 1 to 12 carbon atoms. In the case where W⁸² and W⁸¹ have the same meaning, W⁸² may be the same as or different from W⁸¹, and preferred groups thereof are the same as those of W⁸¹. In the case where W⁸² and W⁸¹ together form a cyclic structure, the cyclic group represented by —NW⁸¹W⁸² is preferably a group selected from the following formulae (W-b-1) to (W-b-42) which may be unsubstituted or substituted with one or more L^{b}'s:

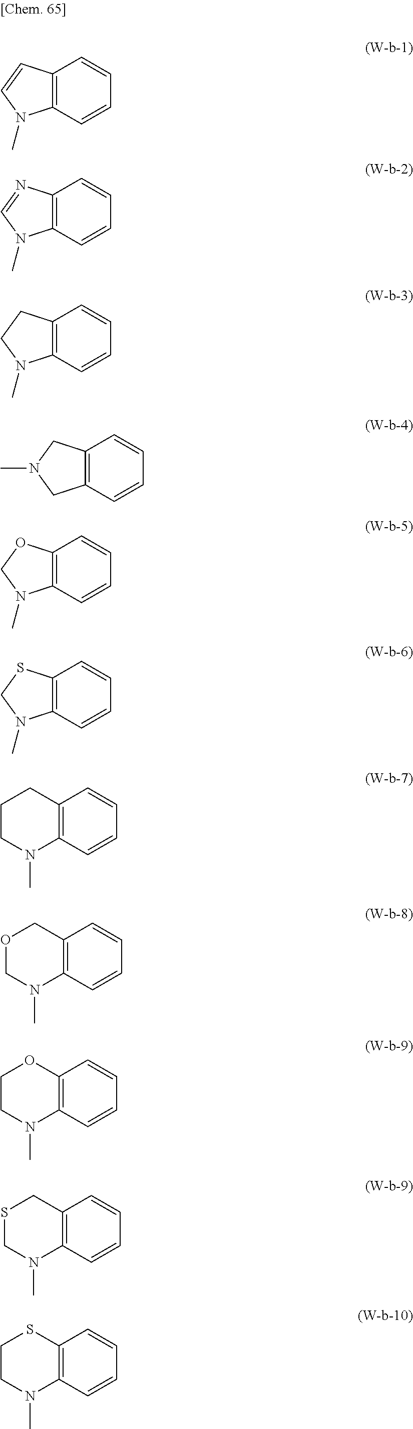

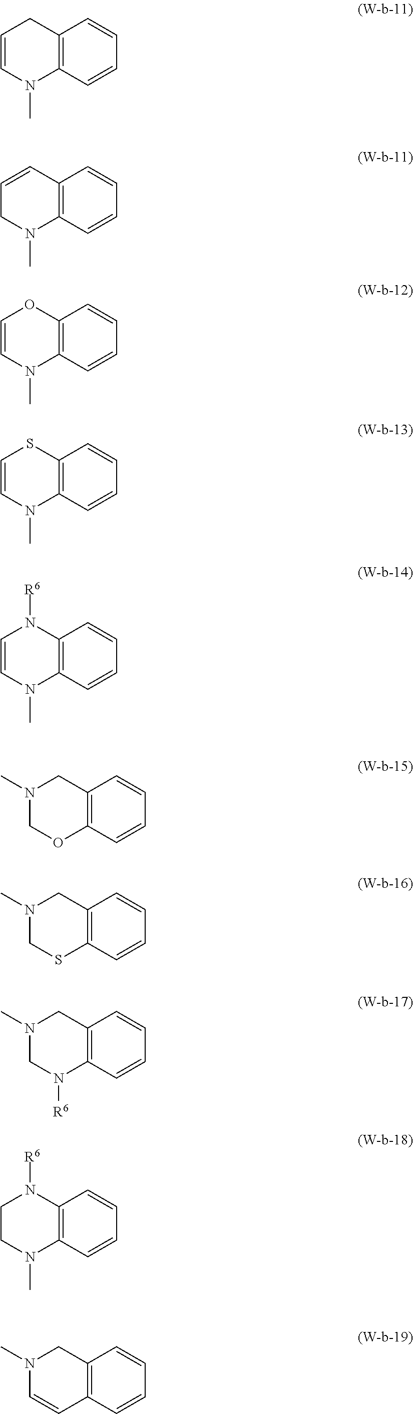

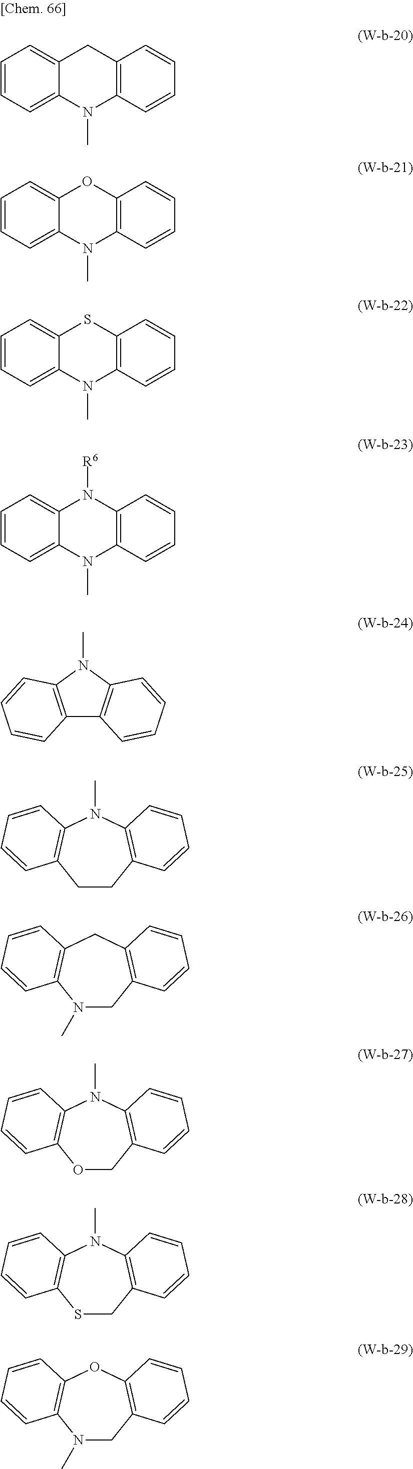

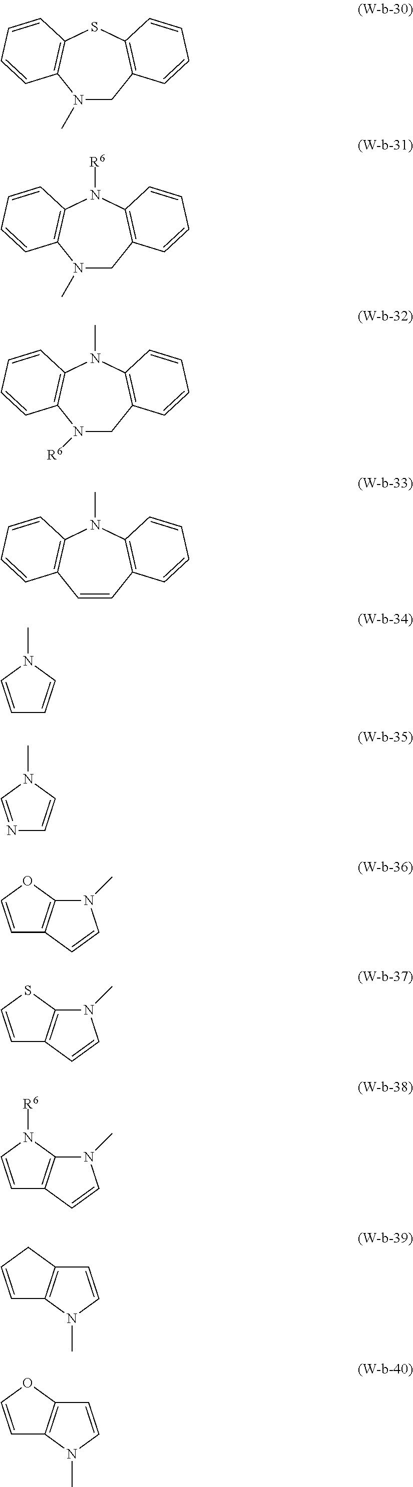

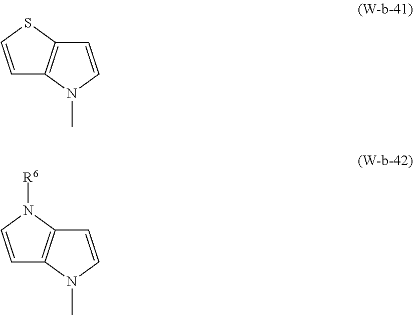

(wherein R⁶ represents a hydrogen atom or an alkyl group having 1 to 8 carbon atoms); and is, from the viewpoint of easy availability of raw materials and easiness in synthesis, more preferably a group selected from the formula (W-b-20), (W-b-21), (W-b-22), (W-b-23), (W-b-24), (W-b-25) or (W-b-33) which may be unsubstituted or substituted with one or more L^{b}'s.

Also, the cyclic group represented by ═CW⁸¹W⁸² is preferably a group selected from the following formulae (W-c-1) to (W-c-81) which may be unsubstituted or substituted with one or more L^{b}'s:

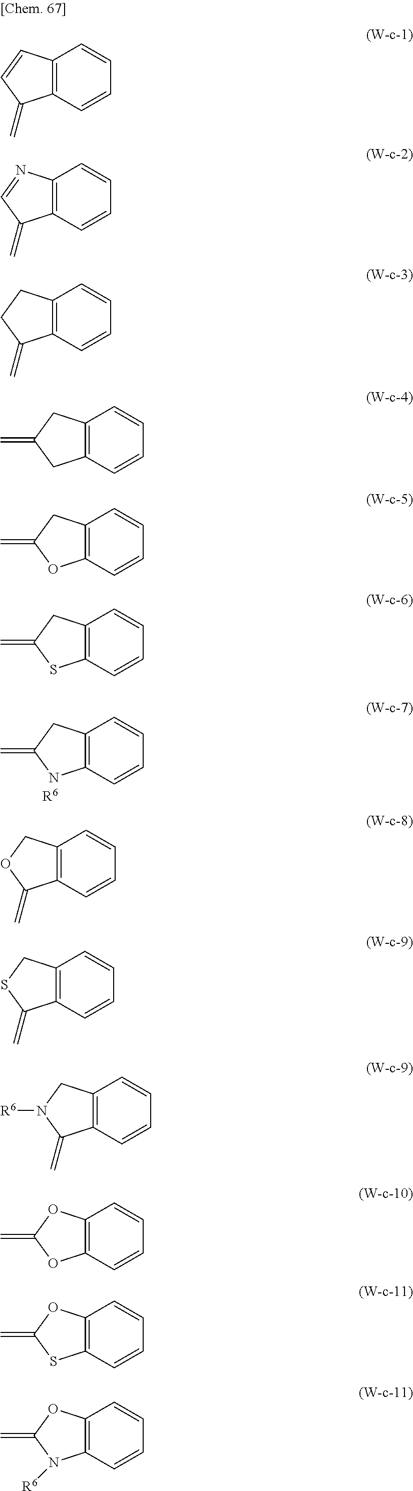

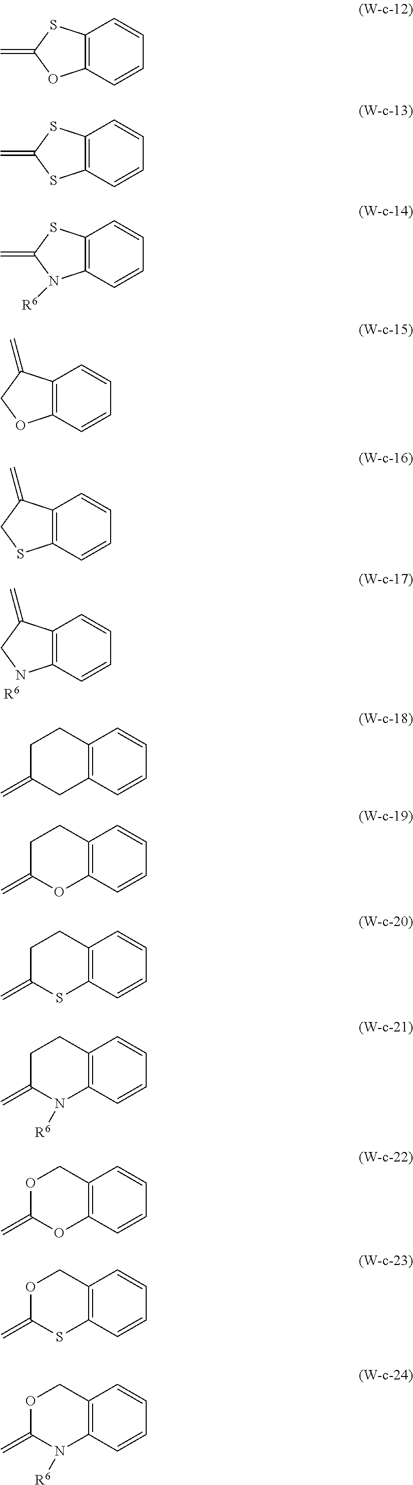

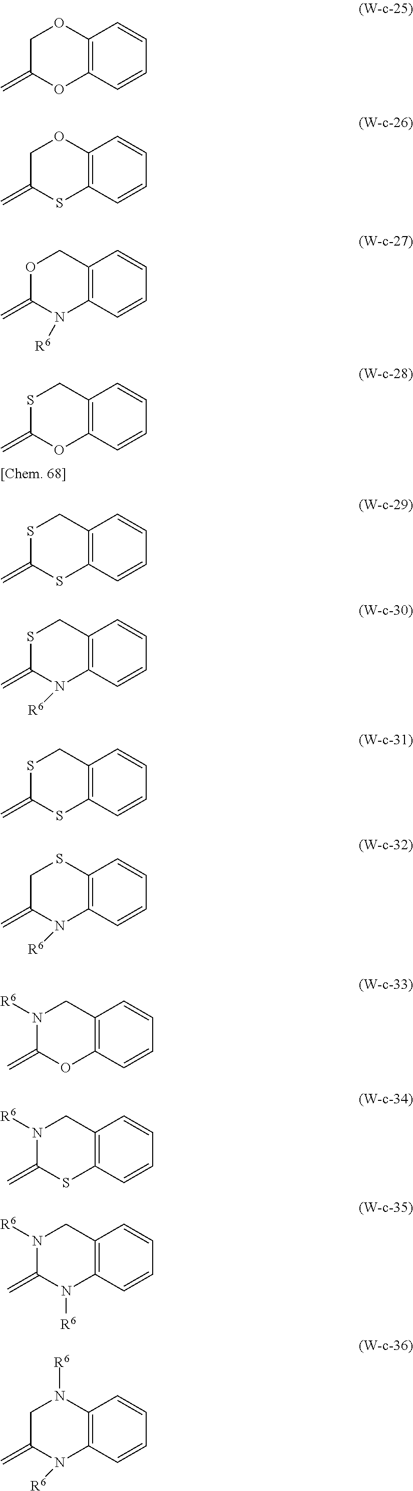

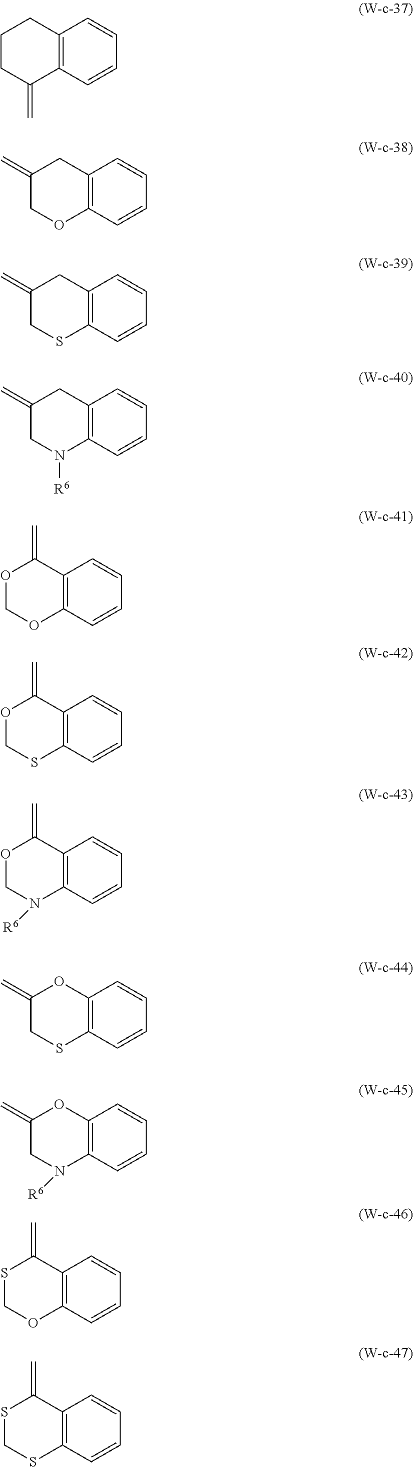

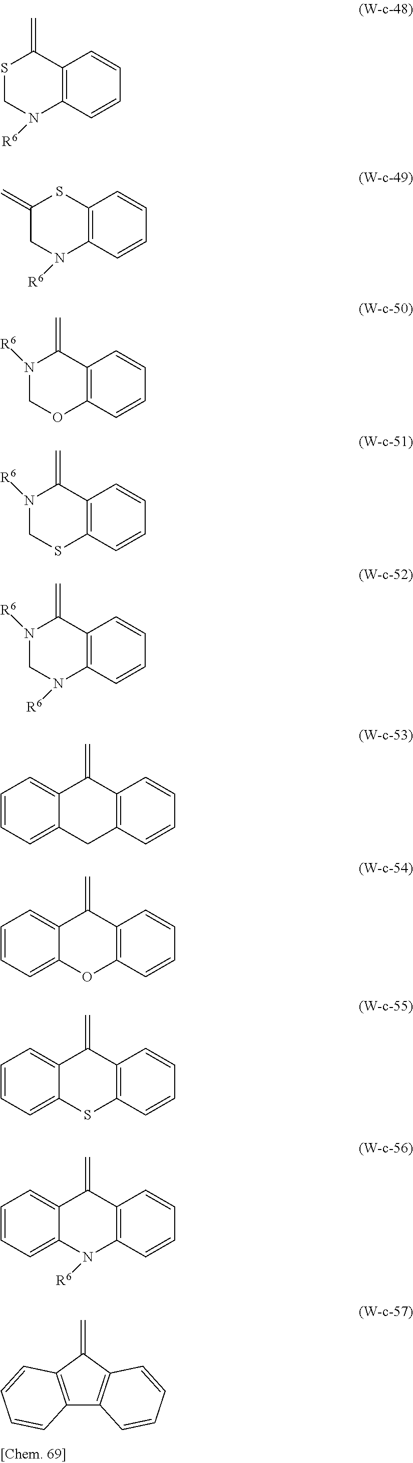

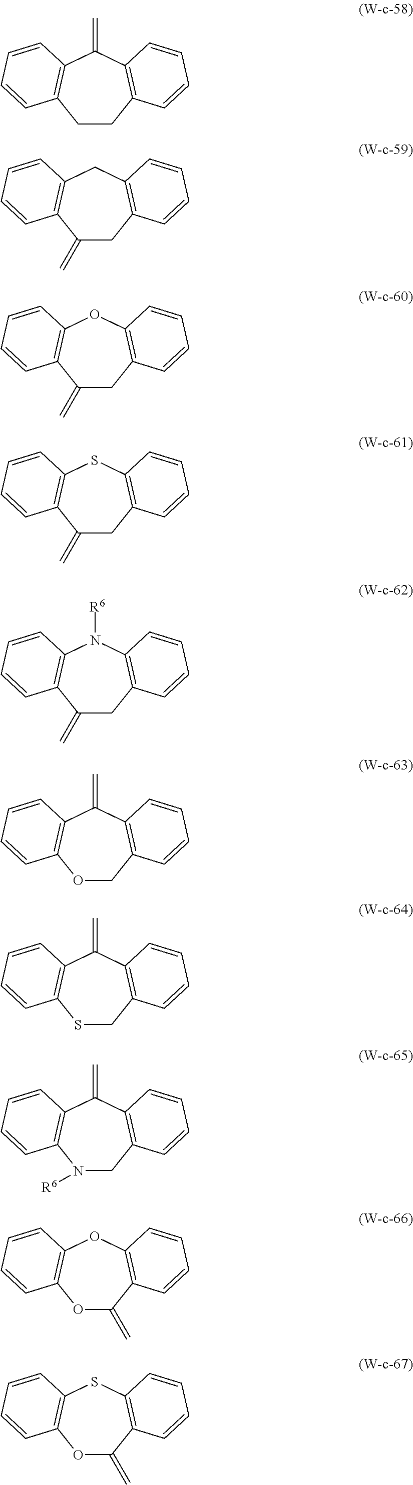

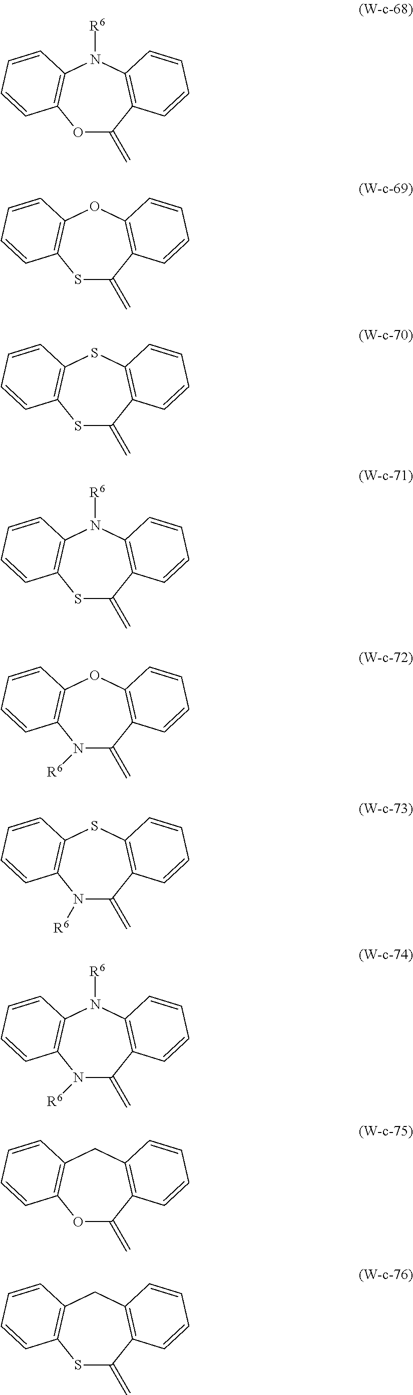

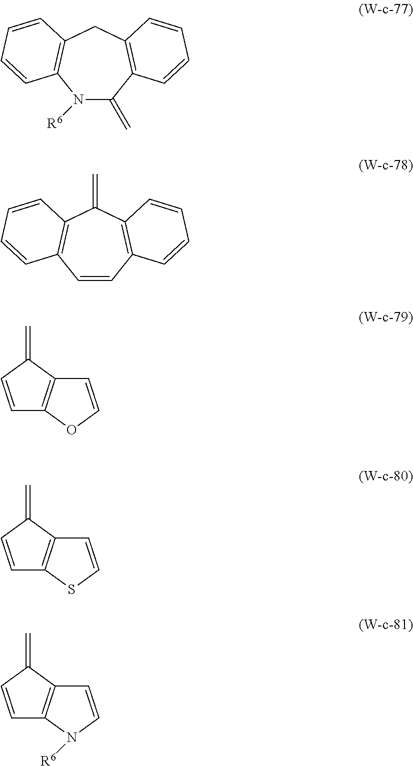

(wherein R⁶ represents a hydrogen atom or an alkyl group having 1 to 8 carbon atoms, and plural R⁶'s, if any, may be the same or different); and is, from the viewpoint of easy availability of raw materials and easiness in synthesis, more preferably a group selected from the formula (W-c-11), (W-c-12), (W-c-13), (W-c-14), (W-c-53), (W-c-54), (W-c-55), (W-c-56), (W-c-57) or (W-c-78) which may be unsubstituted or substituted with one or more L^{b}'s.

In the case where W⁸² represents the following group:

[Chem. 70]

A⁶_{q}Sf³ᵣP³ (1-c)

(wherein P³ represents a polymerizable group and has the same meaning as that defined hereinabove for P¹ and P², A⁶ represents —O—, —COO—, —OCO—, —OCH₂—, —CH₂O—, —CH₂CH₂OCO—ᵣ—COOCH₂CH₂—, —OCOCH₂CH₂— or a single bond, Sf³ has the same meaning as that defined hereinabove for Sf¹ and Sf², q represents 0 or 1, and r represents 0 or 1), preferred P³ is the same as that defined for P¹ and P², preferred Sf³ is the same as that defined for Sf¹ and Sf², and preferred A⁶ is —O— or a single bond.

The total number of the n electrons contained in W⁸¹ and W⁸² is, from the viewpoint of wavelength dispersion, storage stability and easiness in synthesis, preferably 4 to 24.

W⁸³ and W⁸⁴ each independently represent a halogen atom, a cyano group, a hydroxy group, a nitro group, a carboxyl group, a carbamoyloxy group, an amino group, a sulfamoyl group, a group having at least one aromatic group and having 5 to 30 carbon atoms, an alkyl group having 1 to 20 carbon atoms, a cycloalkyl group having 3 to 20 carbon atoms, an alkenyl group having 2 to 20 carbon atoms, a cycloalkenyl group having 3 to 20 carbon atoms, an alkoxy group having 1 to 20 carbon atoms, an acyloxy group having 2 to 20 carbon atoms, or an alkylcarbonyloxy group having 2 to 20 carbon atoms, and one —CH₂— or two or more (—CH₂—)'s not adjacent to each other in the alkyl group, the cycloalkyl group, the alkenyl group, the cycloalkenyl group, the alkoxy group, the acyloxy group and the alkylcarbonyloxy group may be each independently substituted with —O—, —S—, —CO—, —COO—, —OCO—, —CO—S—, —S—CO—, —O—CO—O—, —CO—NH—, —NH—CO— or —C≡C—. More preferably, W⁸³ is a group selected from a cyano group, a nitro group, a carboxyl group, or an alkyl group having 1 to 20 carbon atoms, an alkenyl group, an acyloxy group or an alkylcarbonyloxy group in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO— or —C≡C—, and is more preferably a group selected from a cyano group, a carboxyl group, or an alkyl group having 1 to 20 carbon atoms, an alkenyl group, an acyloxy group or an alkylcarbonyloxy group in which one —CH₂— or two or more (—CH₂—)'s not adjacent to each other may be each independently substituted with —CO—, —COO—, —OCO—, —O—CO—O—, —CO—NH—, —NH—CO— or —C≡C—. W⁸⁴ is preferably a group selected from a cyano group, a nitro group, a carboxyl group, or an alkyl group having 1 to 20 carbon atoms, an alkenyl group, an acyloxy group or an alkylcarbonyloxy group in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO— or —C≡C—, and is more preferably a group selected from a cyano group, a carboxyl group, or an alkyl group having 1 to 20 carbon atoms, an alkenyl group, an acyloxy group or an alkylcarbonyloxy group in which one —CH₂— or two or more (—CH₂—)'s not adjacent to each other may be each independently substituted with —CO—, —COO—, —OCO—, —O—CO—O—, —CO—NH—, —NH—CO— or —C≡C—.

L^{b} represents a fluorine atom, a chlorine atom, a bromine atom, an iodine atom, a pentafluorosulfuranyl group, a nitro group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, and any hydrogen atom in the alkyl group may be substituted with a fluorine atom. From the viewpoint of easiness in synthesis, L¹ is preferably a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which any hydrogen atom may be substituted with a fluorine atom and one —CH₂— or two or more (—CH₂—)'s not adjacent to each other may be each independently substituted with a group selected from —O—, —S—, —CO—, —COO—, —OCO—, —O—CO—O—, —CH═CH—, —CF═CF— or —C≡C—; more preferably a fluorine atom, a chlorine atom, or a linear or branched alkyl group having 1 to 12 carbon atoms in which any hydrogen atom may be substituted with a fluorine atom and one —CH₂— or two or more (—CH₂—)'s not adjacent to each other may be each independently substituted with a group selected from —O—, —COO— or —OCO—; even more preferably a fluorine atom, a chlorine atom, or a linear or branched alkyl or alkoxy group having 1 to 12 carbon atoms in which any hydrogen atom may be substituted with a fluorine atom; and especially more preferably a fluorine atom, a chlorine atom, or a linear alkyl or alkoxy group having 1 to 8 carbon atoms.

In the general formulae (1-b-1) to (1-b-5), Z¹¹ to Z⁷² each independently represent —O—, —S—, —OCH₂—, —CH₂O—, —CH₂CH₂—, —CO—, —COO—, —OCO—, —COS—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C— or a single bond, plural Z¹¹'s to Z⁷²'s, if any, each may be the same or different. From the viewpoint of easy availability of raw materials and easiness in synthesis, preferably, Z¹¹ to Z⁷² each are independently —OCH₂—, —CH₂O—, —COO—, —OCO—, —O—CO—O—, —CO—NH—, —NH—CO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C— or a single bond. More preferably, Z¹¹ to Z⁷² each are independently —OCH₂—, —CH₂O—, —CH₂CH₂—, —COO—, —OCO—, —O—CO—O—, —CO—NH—, —NH—CO—, —CF₂O—, —OCF₂—, —COO—CH₂CH₂—, —OCO—CH₂CH₂—, —CH₂CH₂—COO—, —CH₂CH₂—OCO—, —CH═CH—, —C≡C— or a single bond; even more preferably, Z¹¹ to Z⁷² each are independently —CH₂CH₂—, —COO—, —OCO—, —O—CO—O—, —CO—NH—, —NH—CO—, —COO—CH₂CH₂—, —OCO—CH₂CH₂—, —CH₂CH₂—COO—, —CH₂CH₂—OCO— or a single bond, and especially preferably, each independently —COO—, —OCO—, —COO—CH₂CH₂—, —OCO—CH₂CH₂—, —CH₂CH₂—COO—, —CH₂CH₂—OCO— or a single bond.

In the above-mentioned general formula (1-b-2), the terminal group R²¹ represents a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO— or —C≡C—, and any hydrogen atom in the alkyl group may be substituted with a fluorine atom. From the viewpoint of easiness in synthesis, R²¹ is preferably a hydrogen atom, a fluorine atom, a chlorine atom, a cyano group, or a linear or branched alkyl group having 1 to 12 carbon atoms in which one —CH₂— or two or more (—CH₂—)'s not adjacent to each other may be each independently substituted with —O—, —COO—, —OCO— or —O—CO—O—, more preferably a hydrogen atom, a fluorine atom, a chlorine atom, a cyano group, or a linear alkyl group or a linear alkoxy group having 1 to 12 carbon atoms, and is especially preferably a linear alkyl group or a linear alkoxy group having 1 to 12 carbon atoms.

In the general formulae (1-b-1) to (1-b-5), n11 to n62 each independently represent an integer of 0 to 6, and from the viewpoint of the properties of the compounds, easy availability of raw material and easiness in synthesis, preferably, each is an integer of 0 to 4, more preferably an integer of 0 to 2, and especially preferably 0 or 1.

In the general formulae (1-b-1) to (1-b-5), j11, j12, j21, j22, j41, j42, j51, j52, j61 and j62 each independently represent an integer of 0 to 5, and j11+j12 represents an integer of 2 to 7, j21+j22 represents an integer of 2 to 7, j41+j42 represents an integer of 2 to 7, j51+j52 represents an integer of 2 to 7, and j61+j62 represents an integer of 2 to 7. From the viewpoint of easiness in synthesis and storage stability, preferably, j11, j21, j22, j41, j42, j51, j52, j61 and j62 each independently represent an integer of 1 to 4, more preferably an integer of 1 to 3, even more preferably 1 or 2. j11+j12, j21+j22, j41+j42, j51+j52, and j61+j62 each are preferably an integer of 2 to 4, more preferably 2 or 3.

Specifically, the compounds represented by the general formula (1-b-1) are preferably compounds represented by the following general formulae (1-b-1-1) to (1-b-1-61):

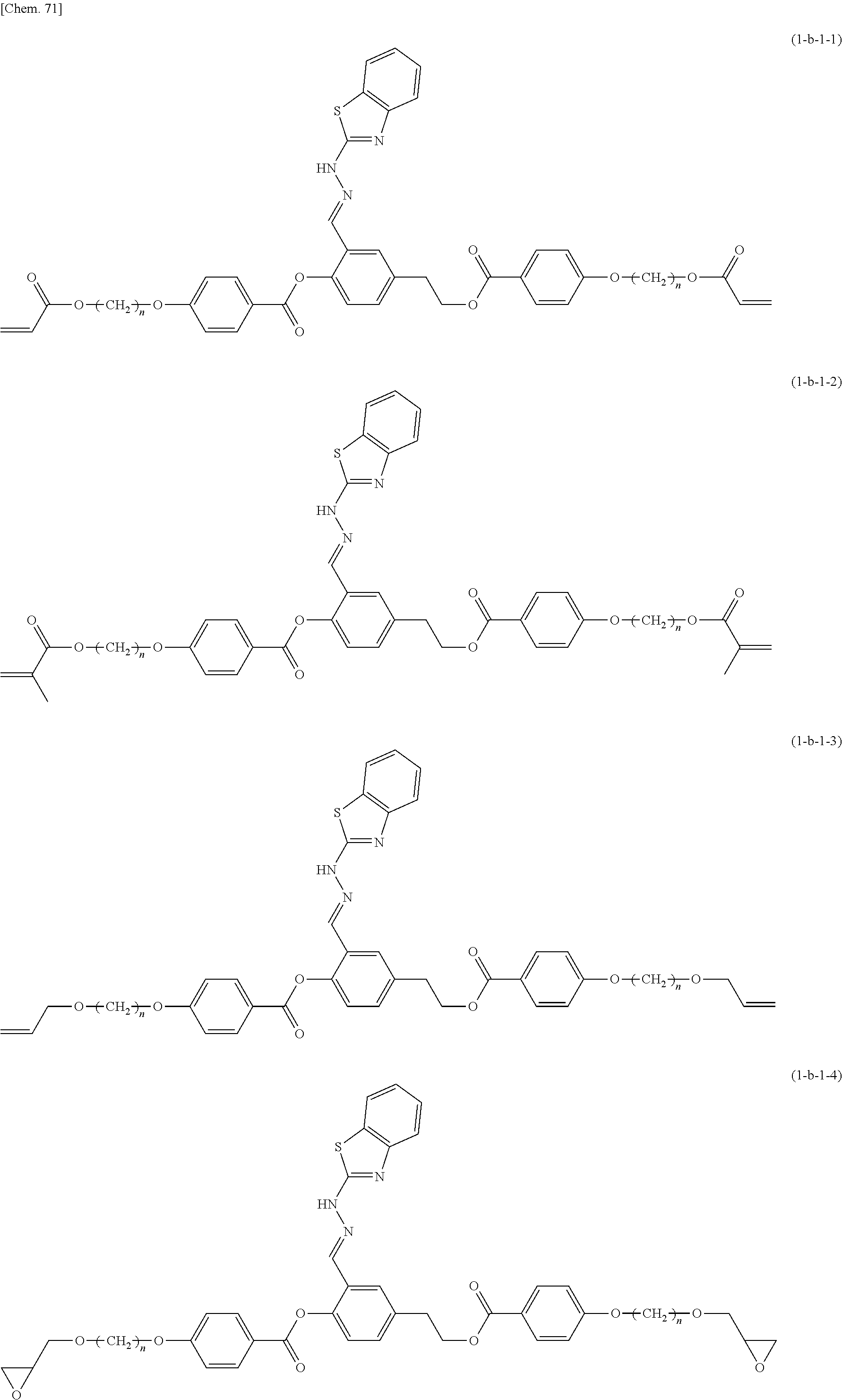

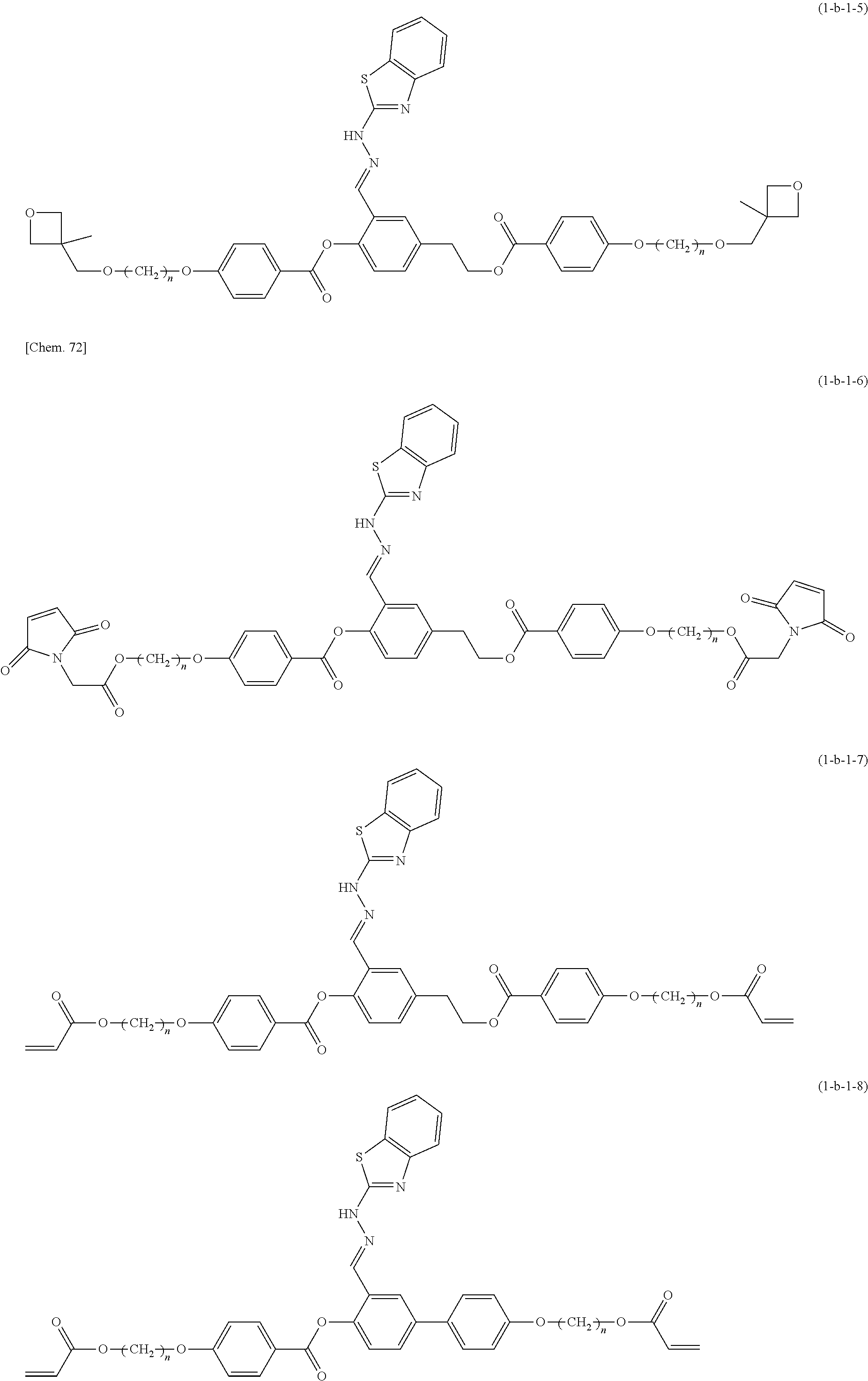

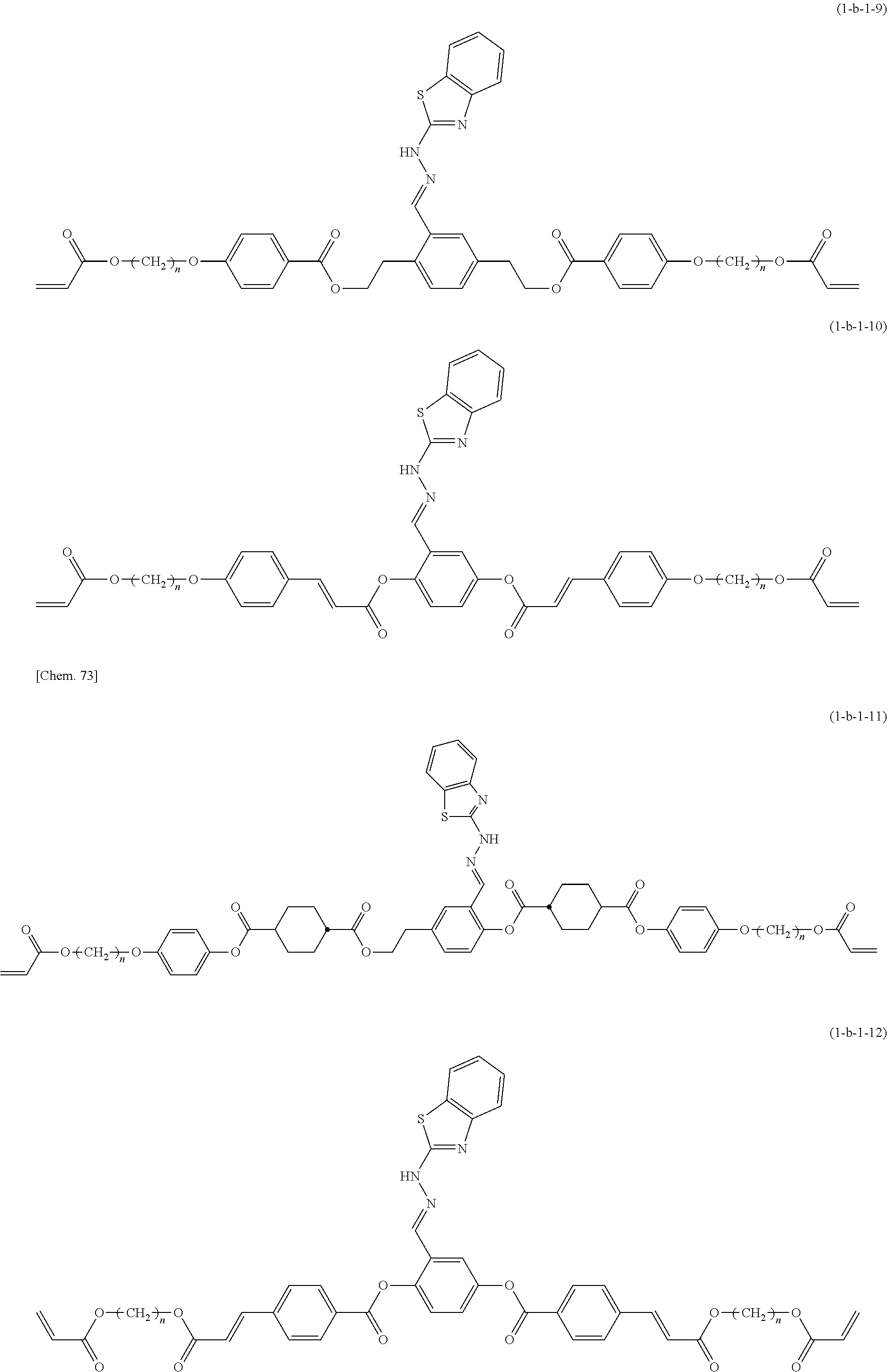

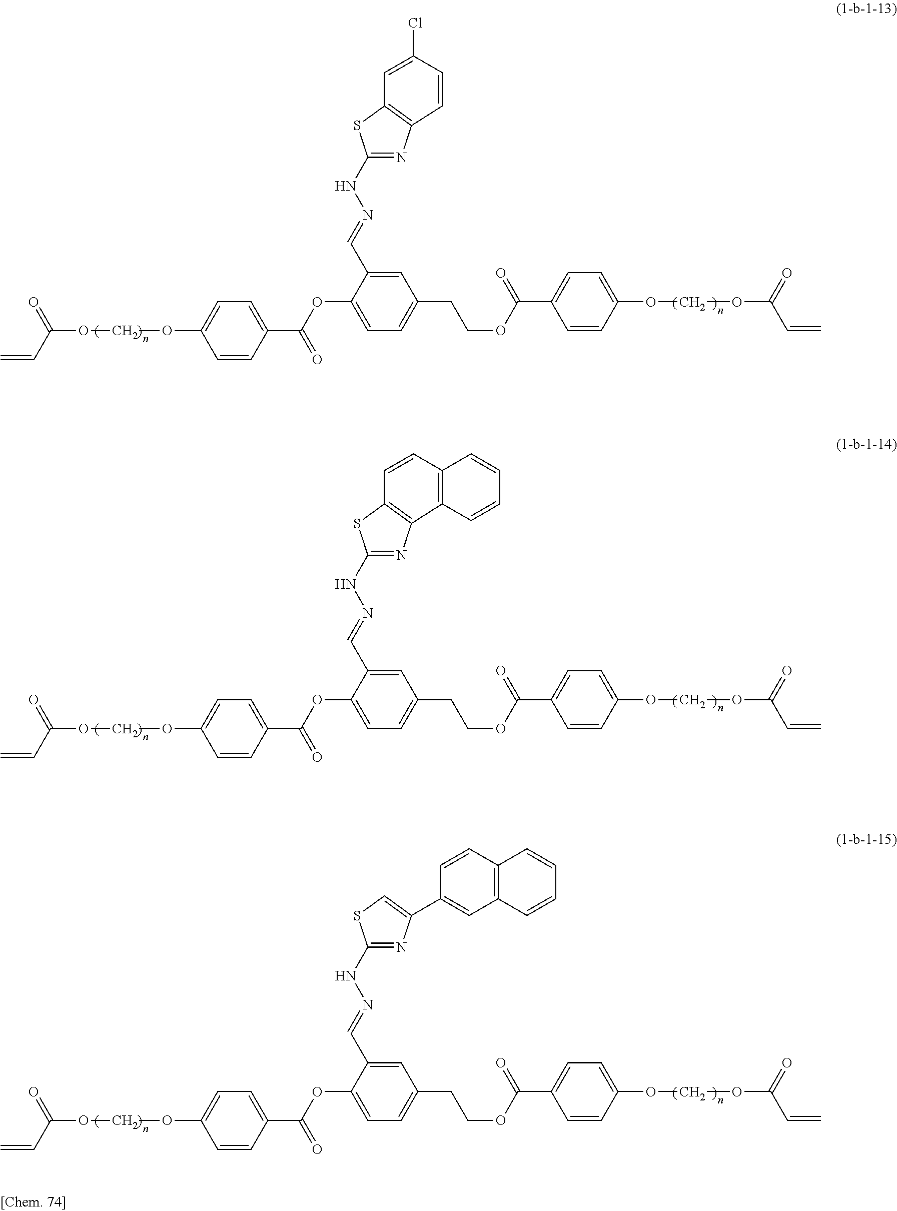

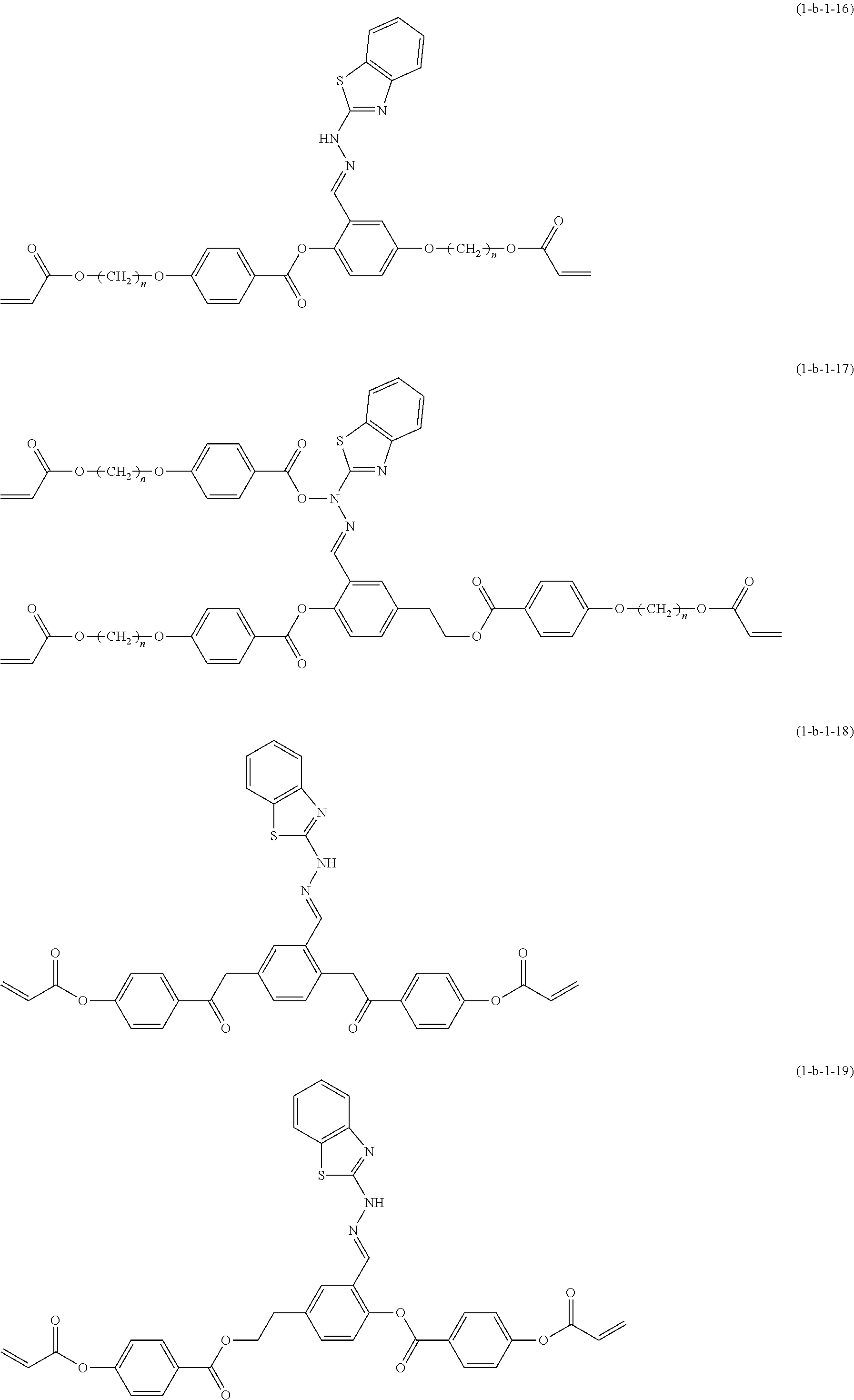

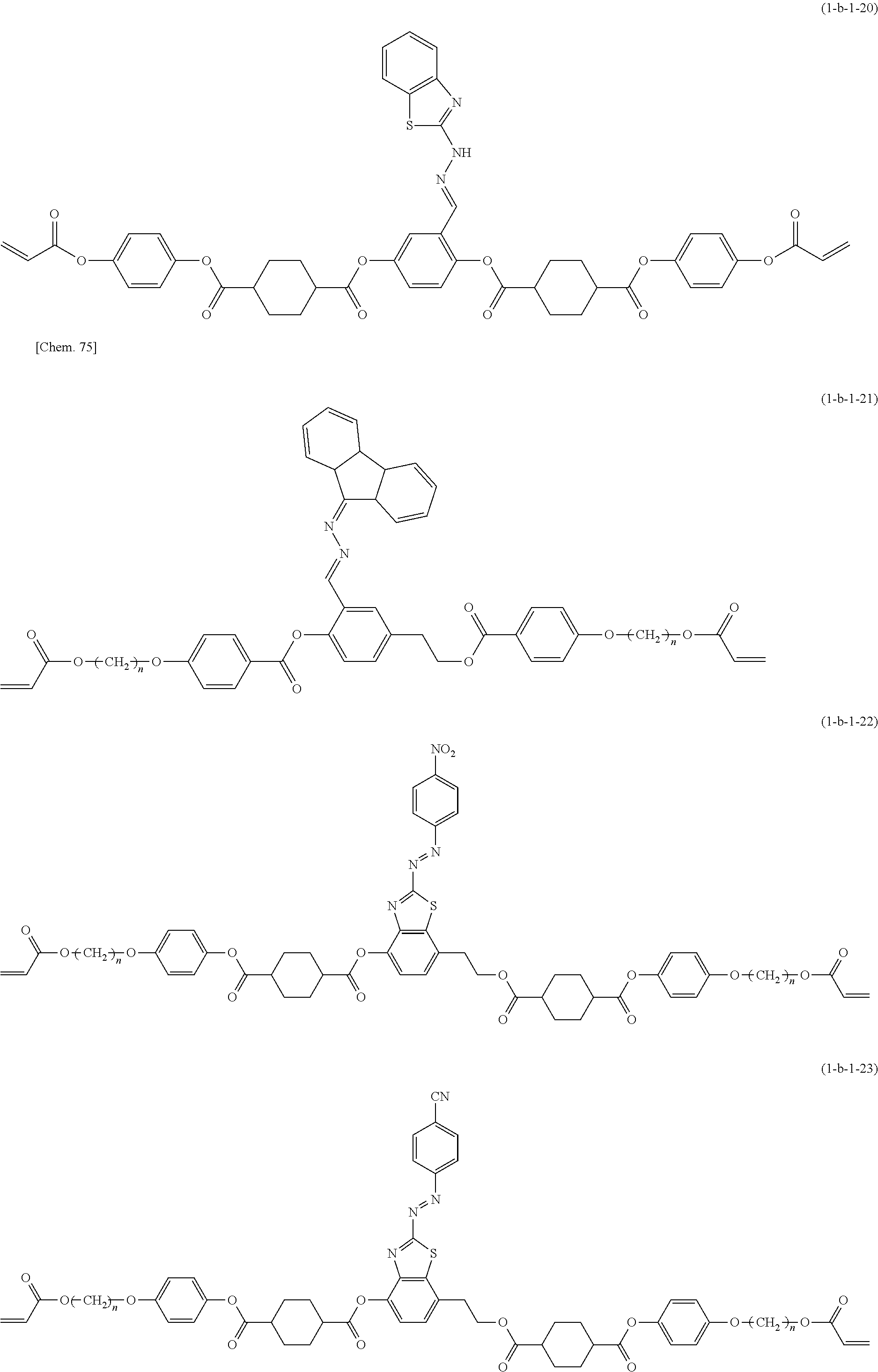

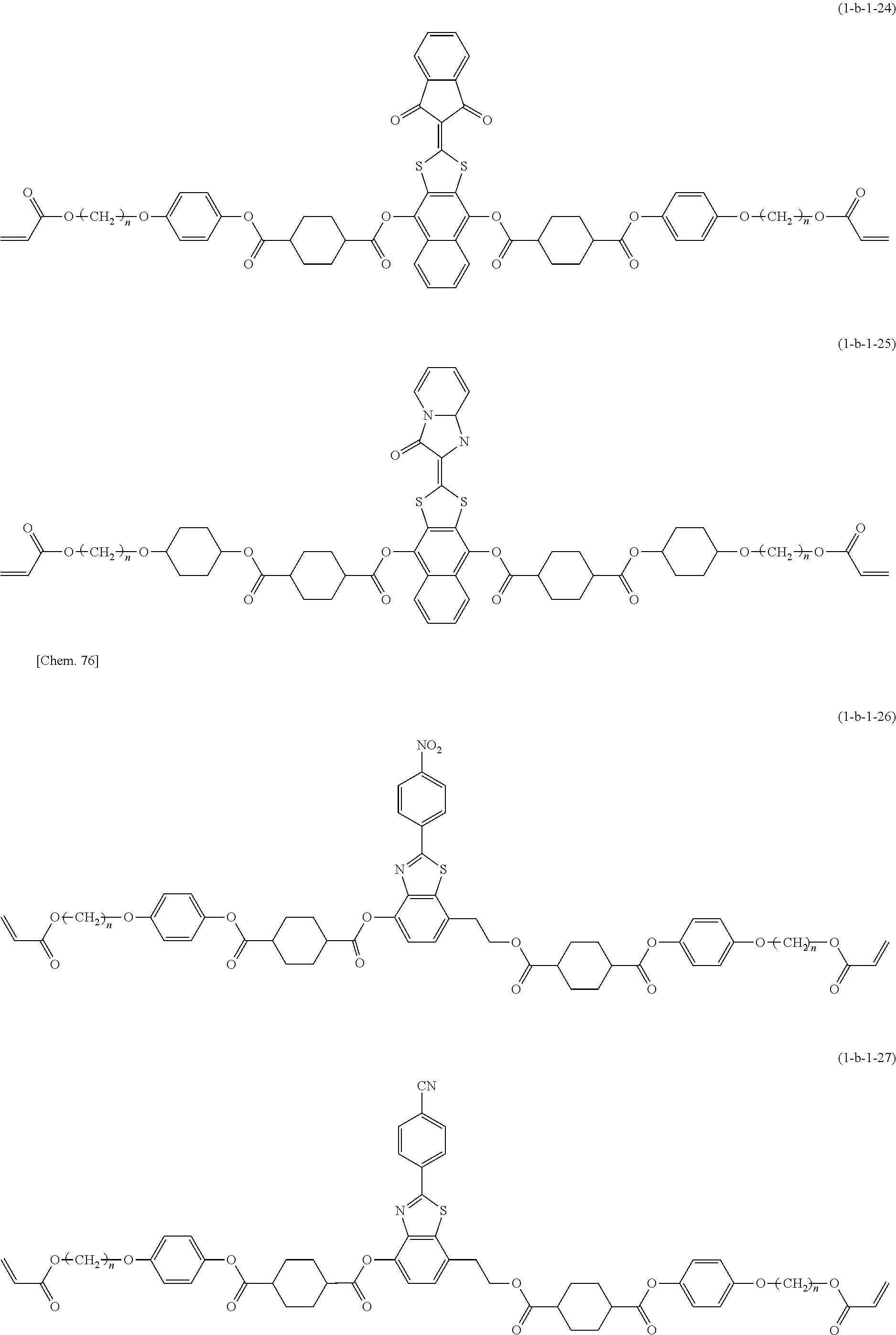

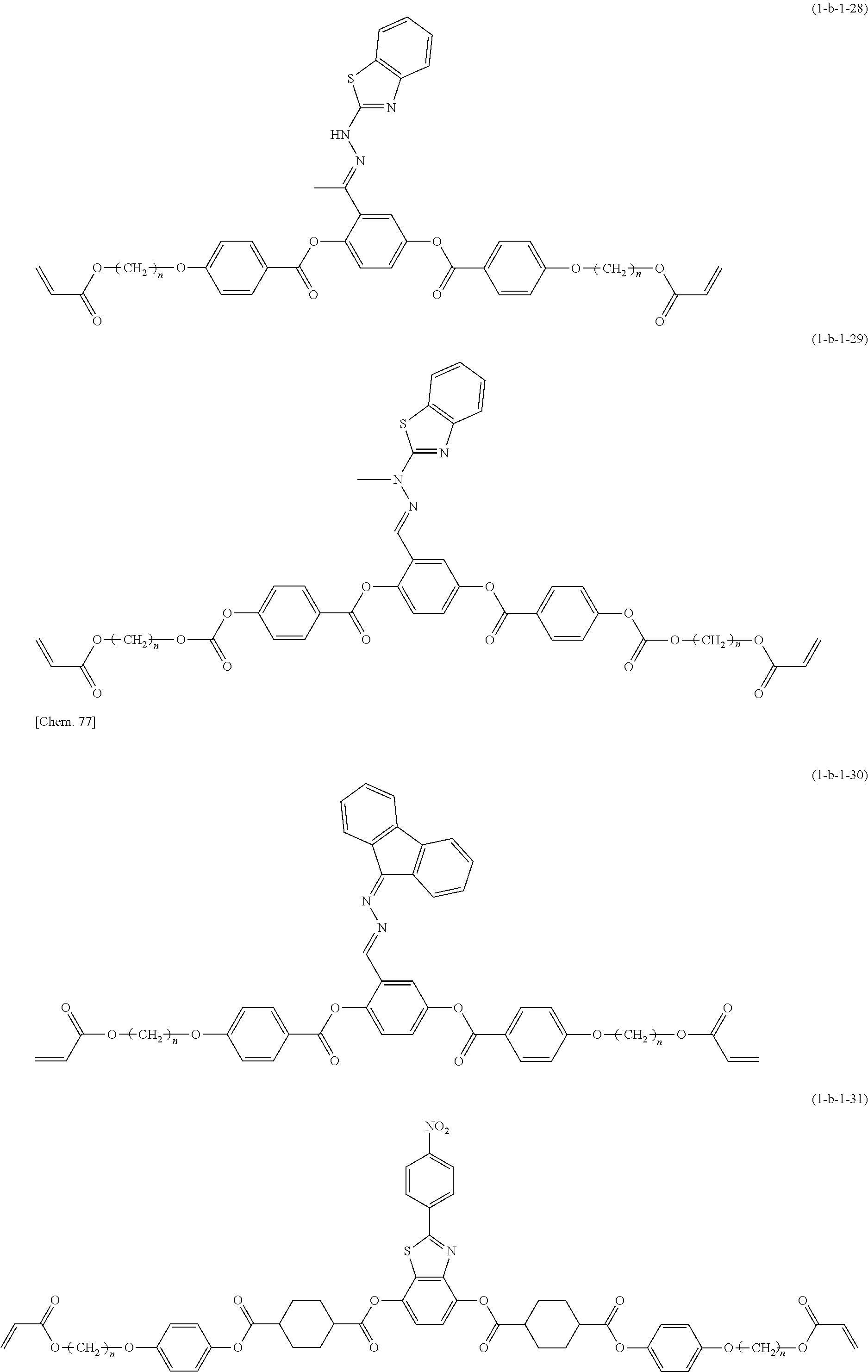

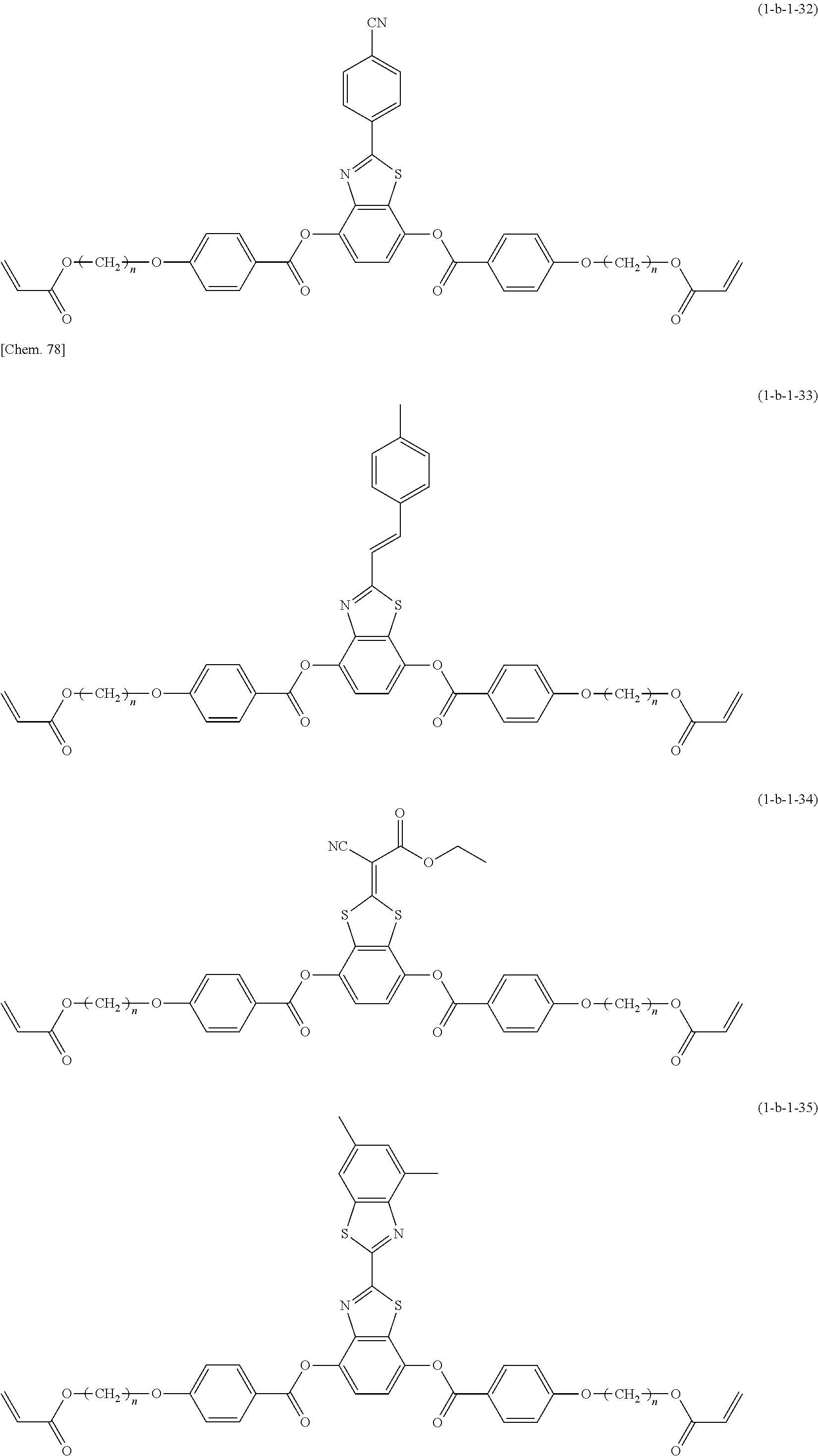

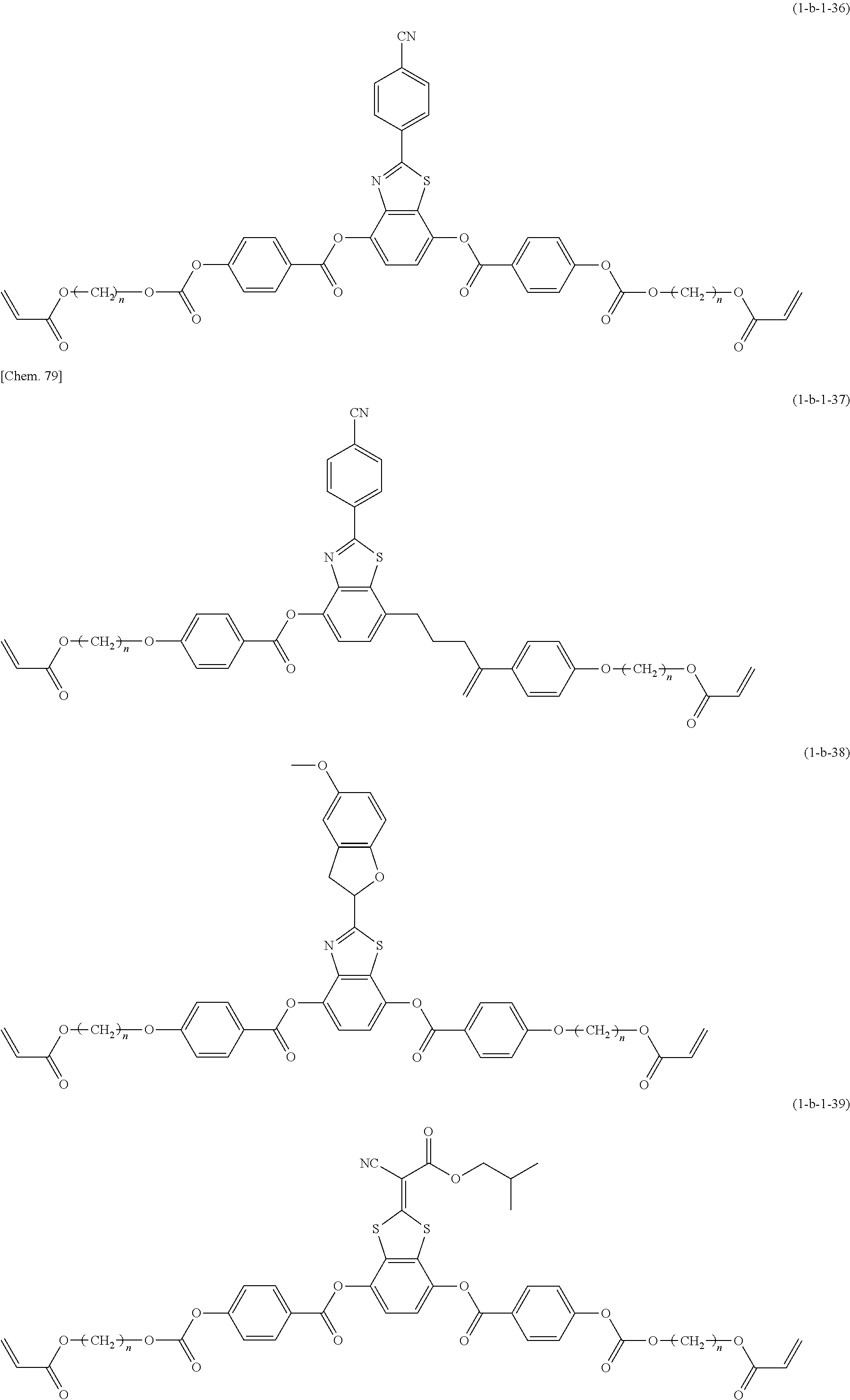

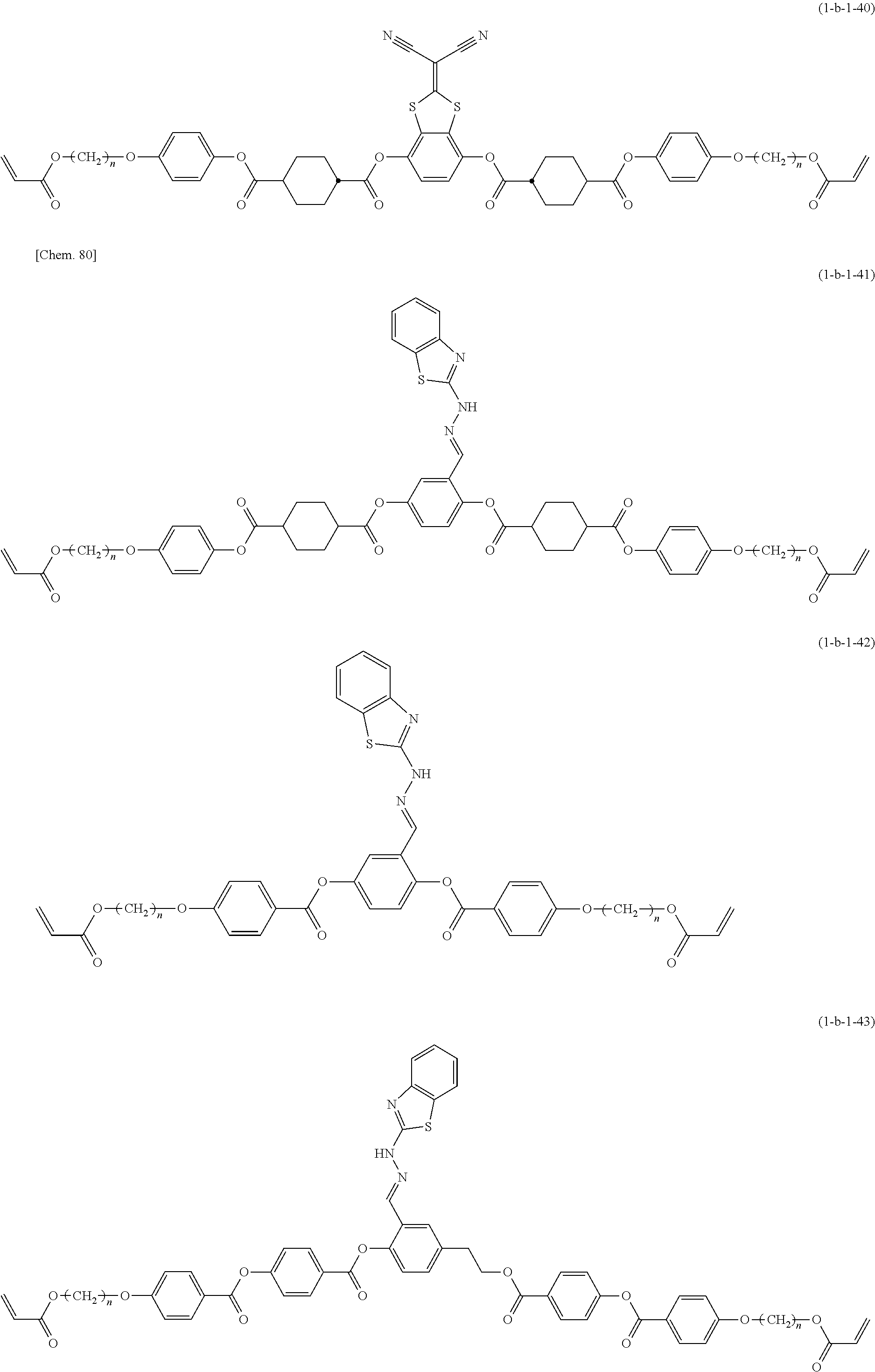

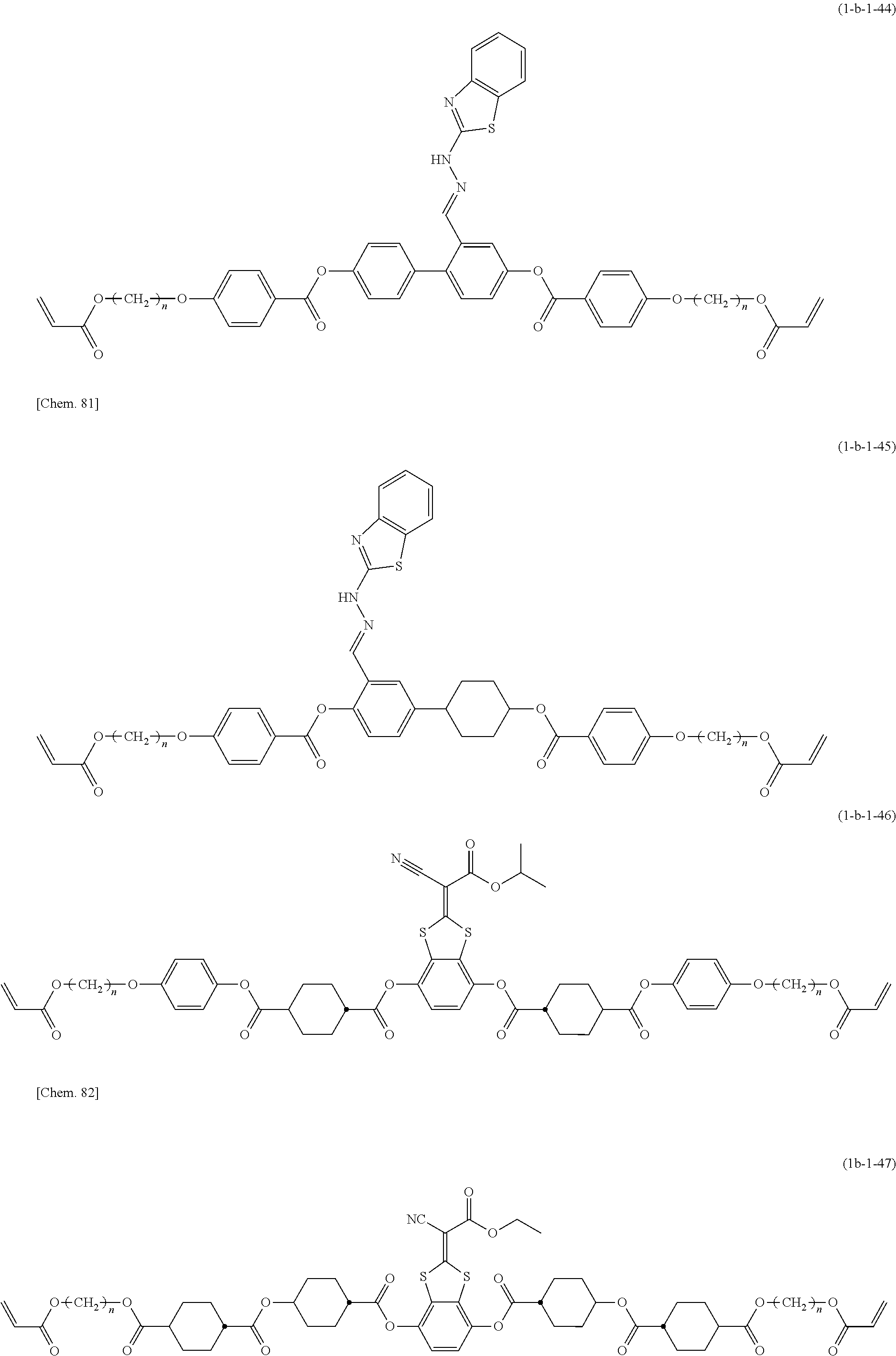

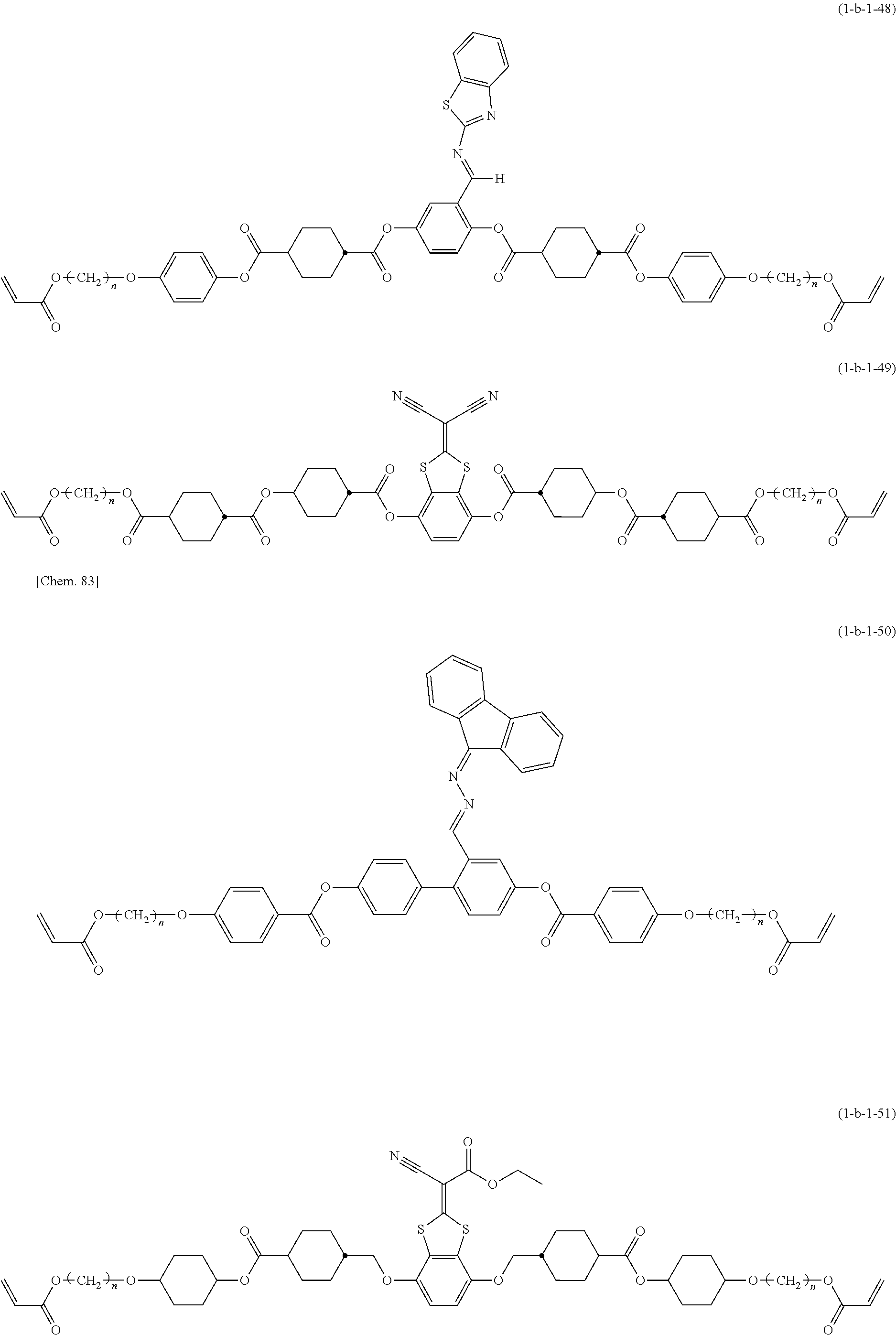

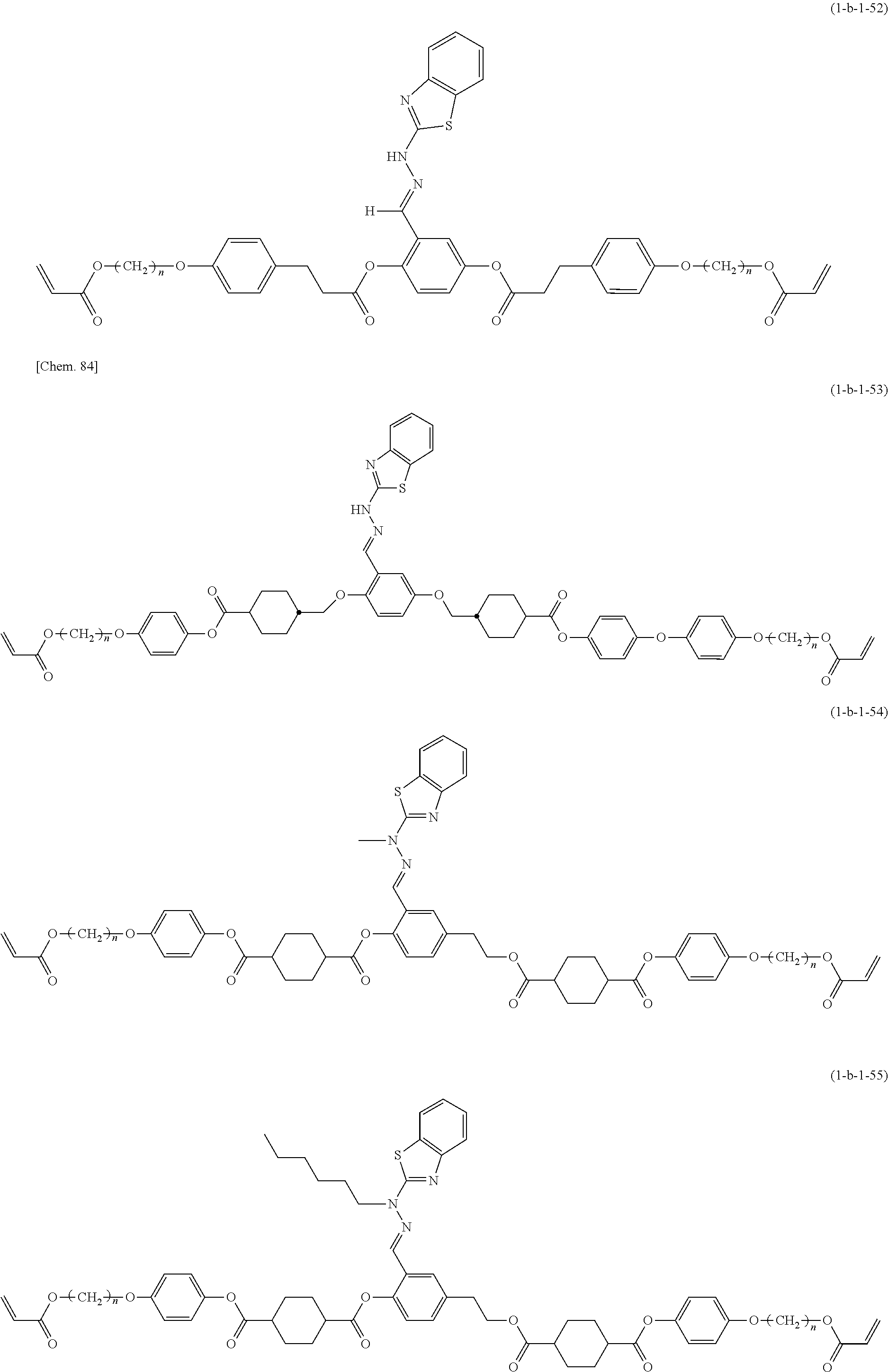

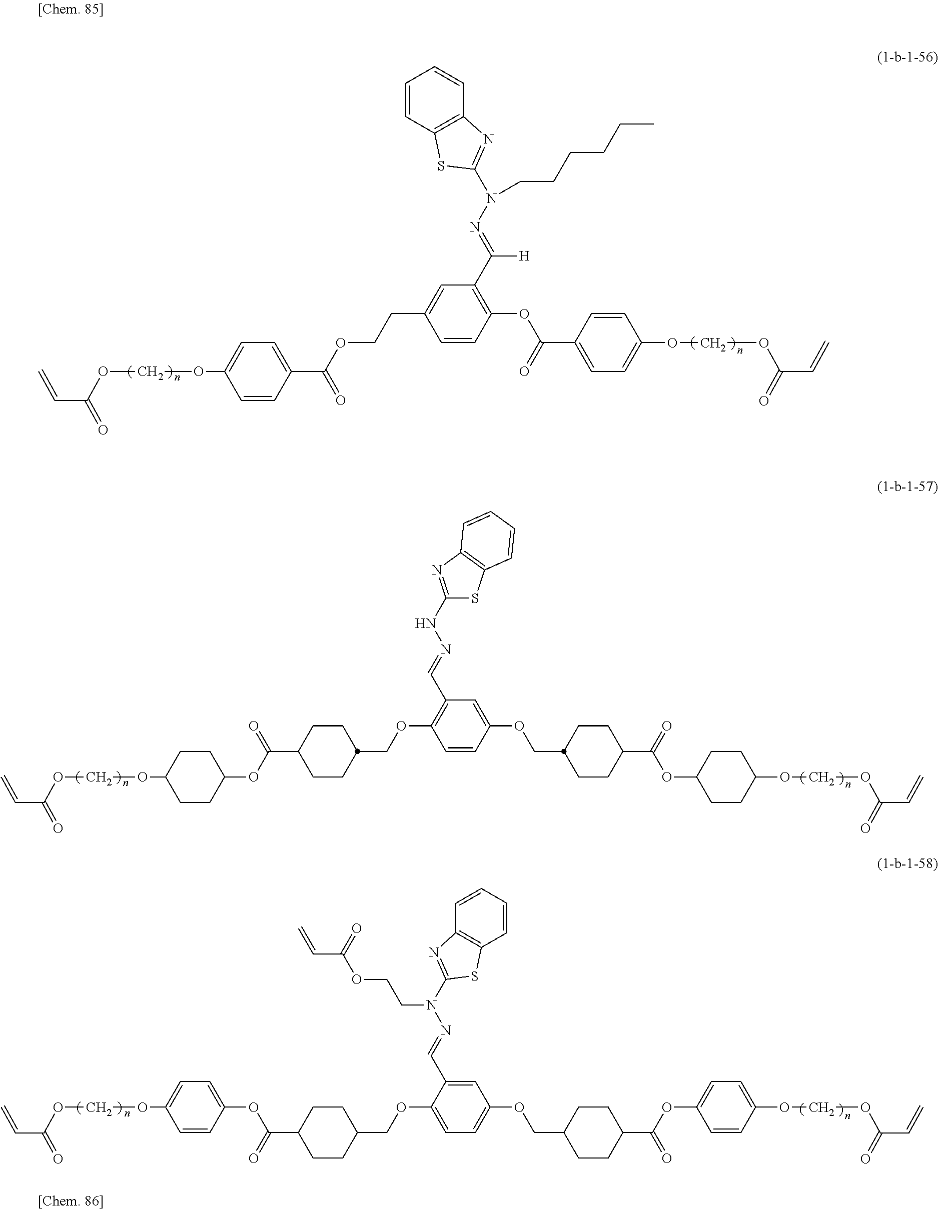

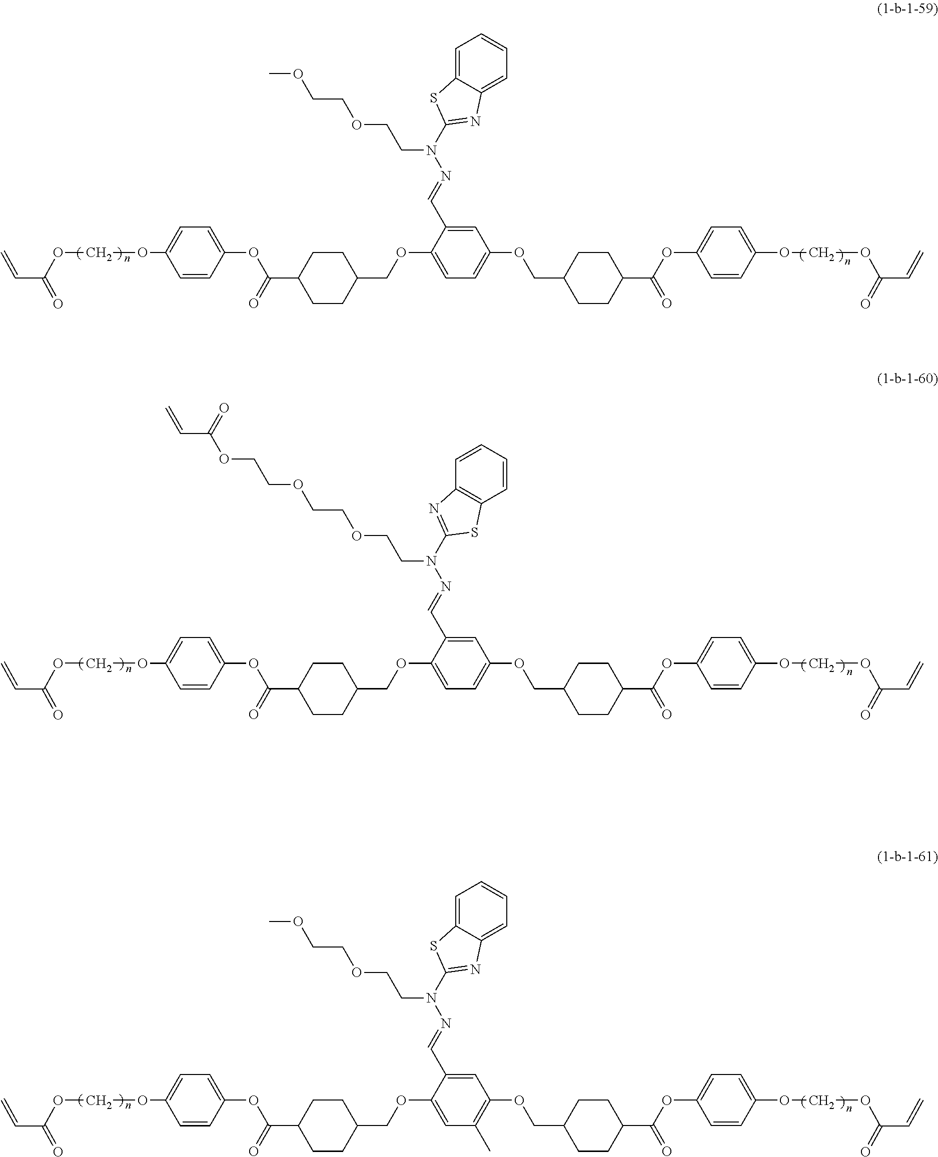

(wherein n represents an integer of 1 to 10). These polymerizable compounds may be used alone or may be used as a mixture of two or more of them.

Specifically, the compounds represented by the general formula (1-b-2) are preferably compounds represented by the following general formulae (1-b-2-1) to (1-b-2-17):

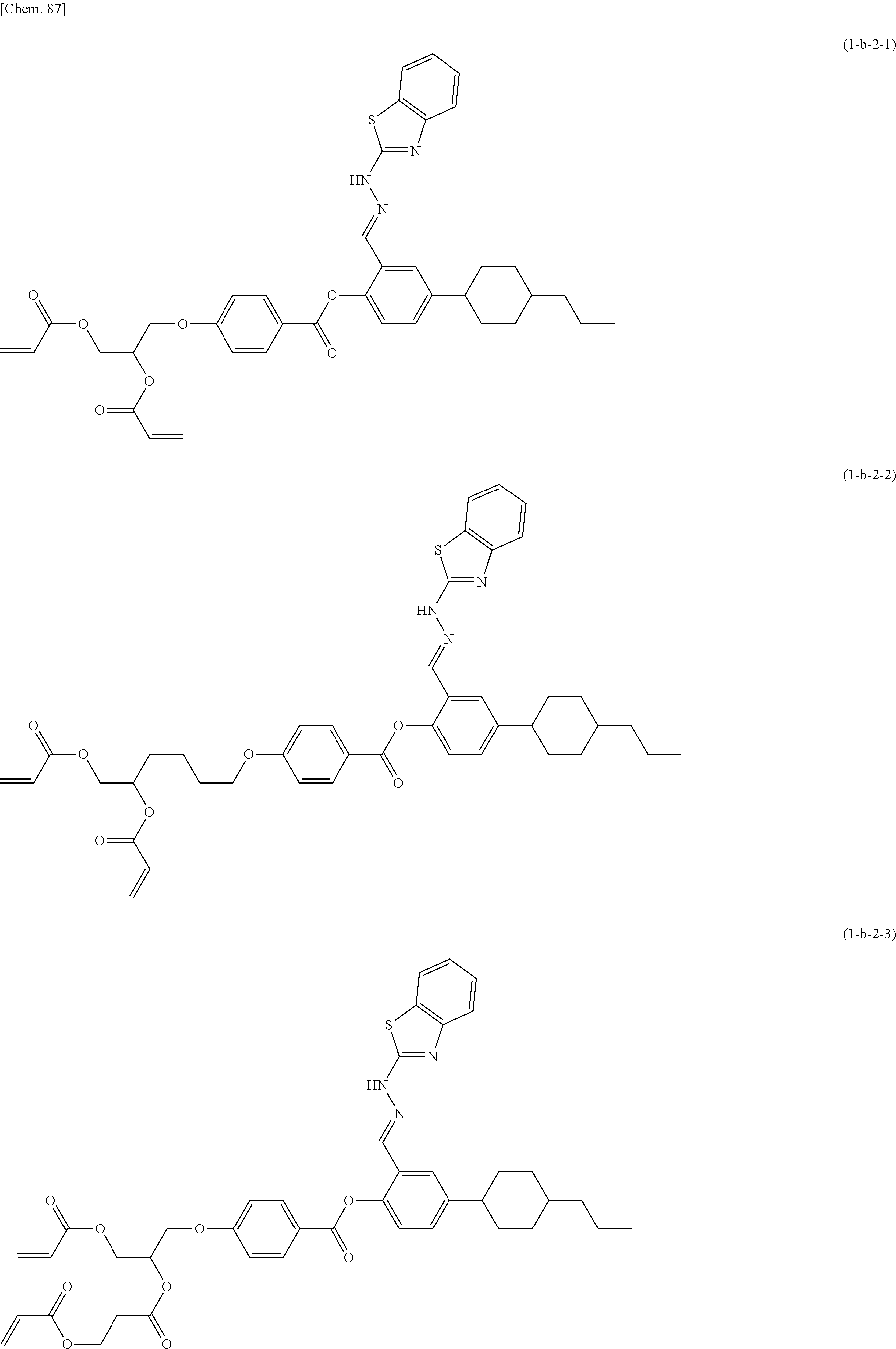

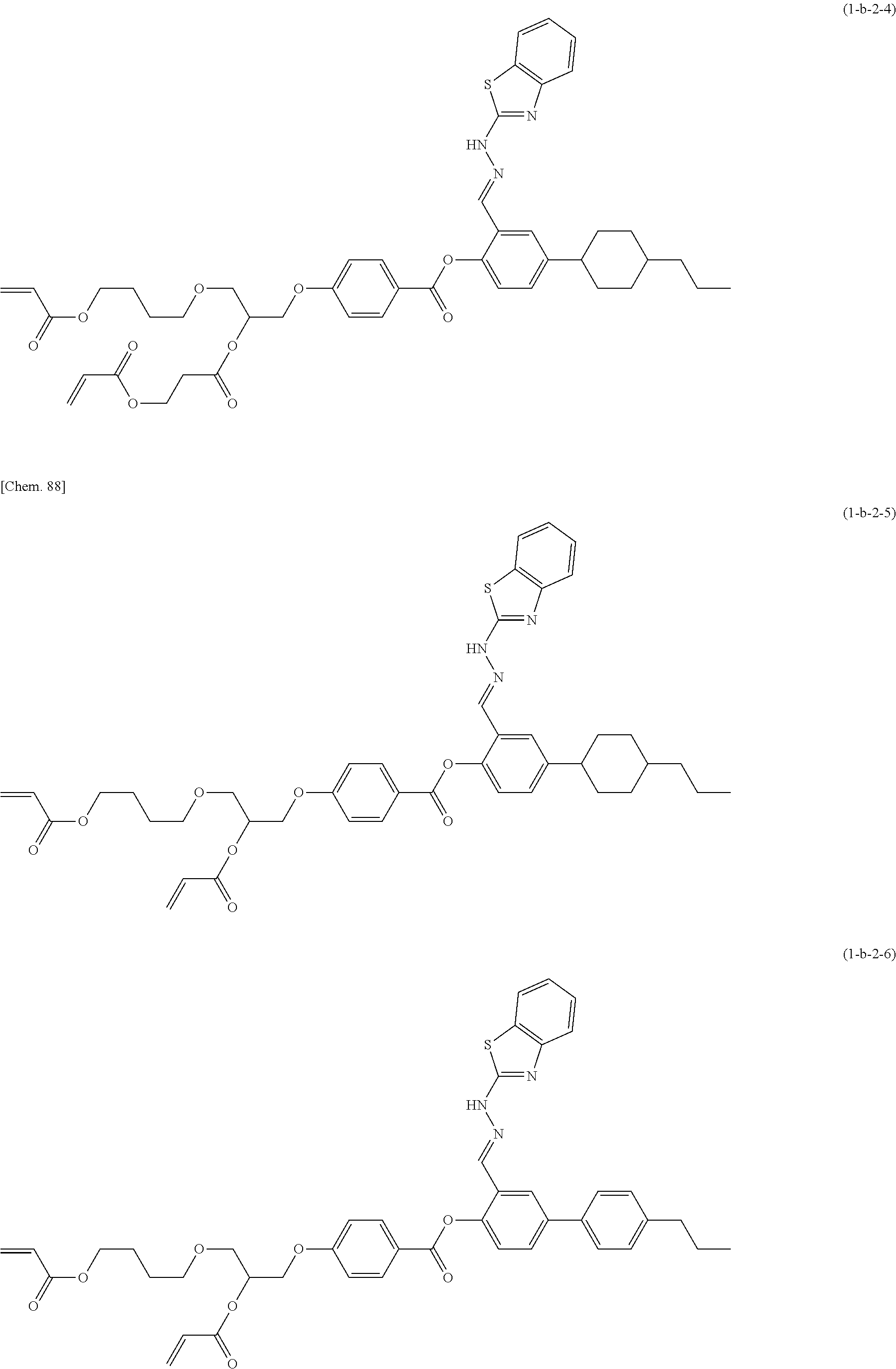

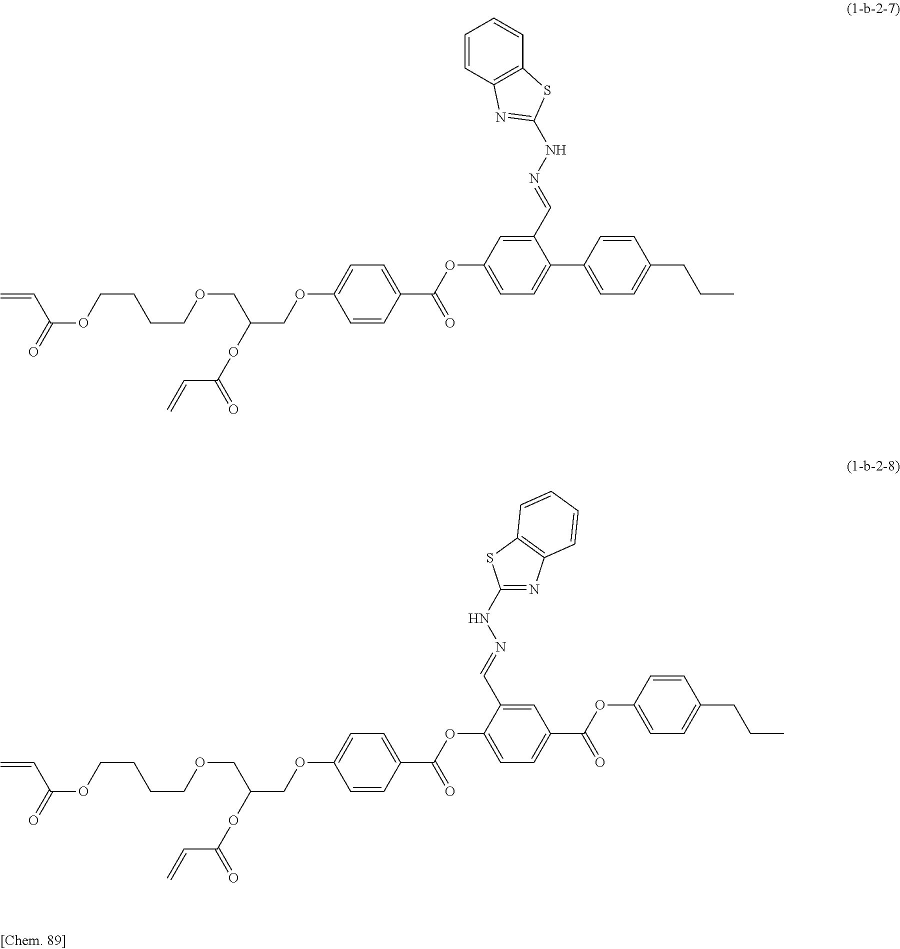

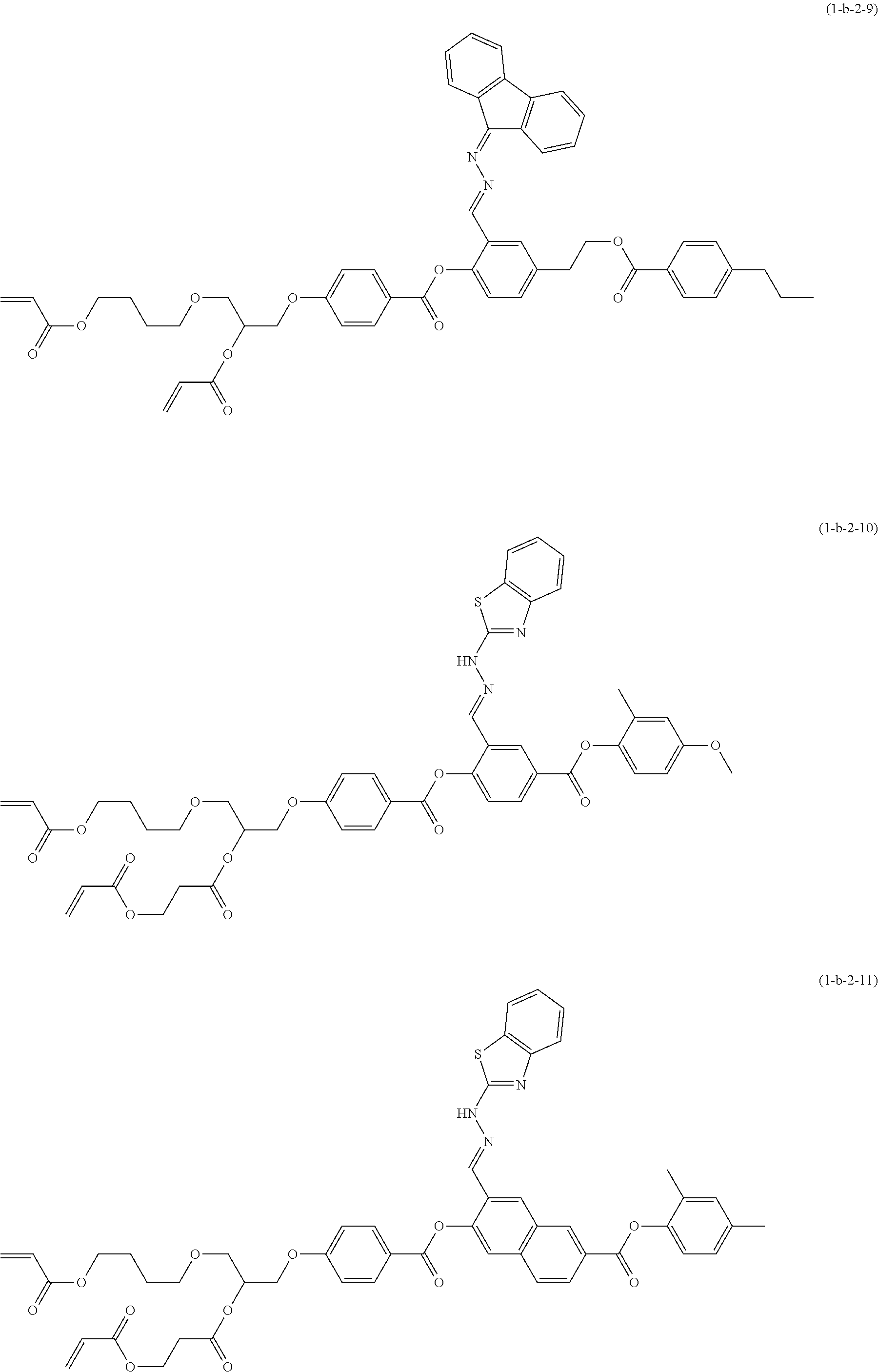

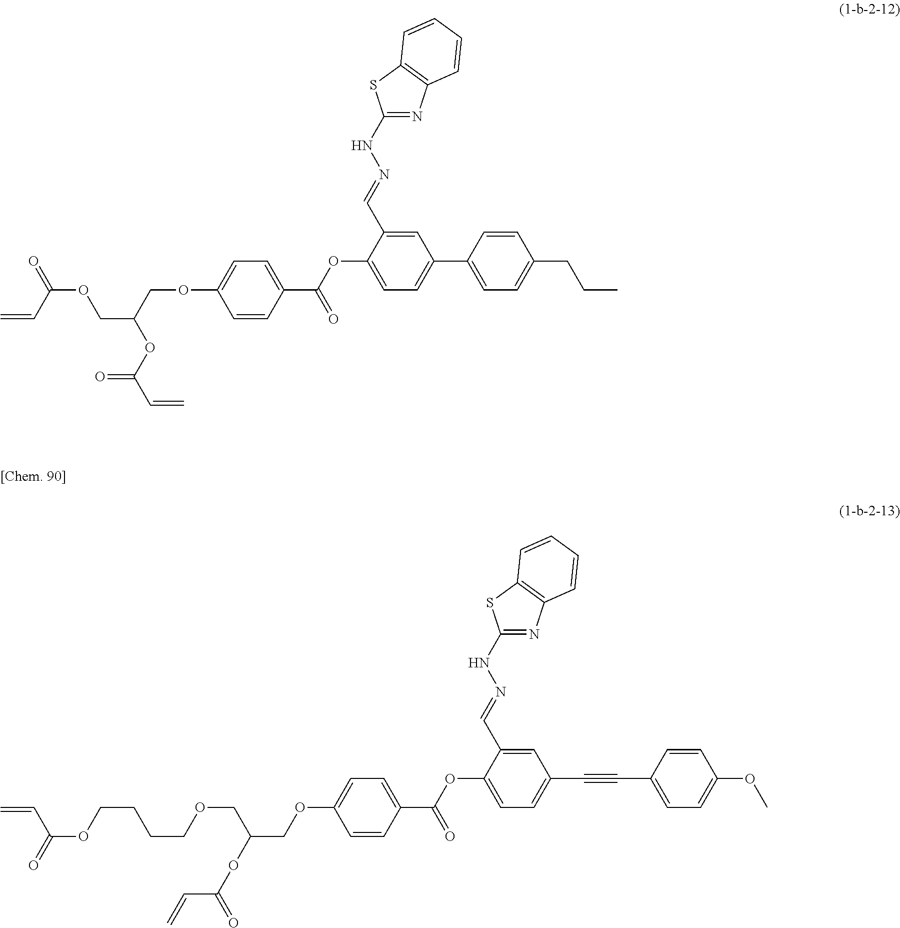

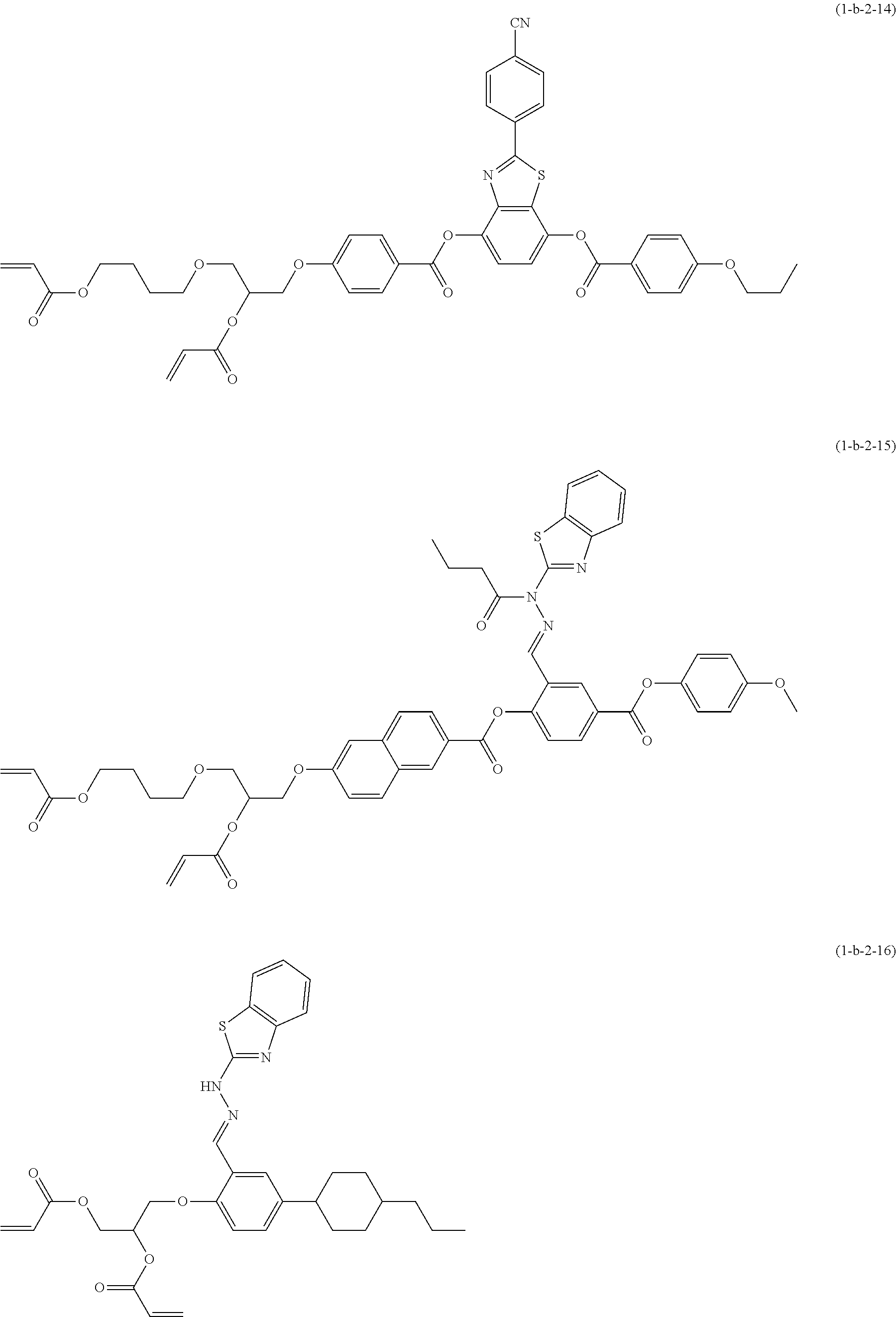

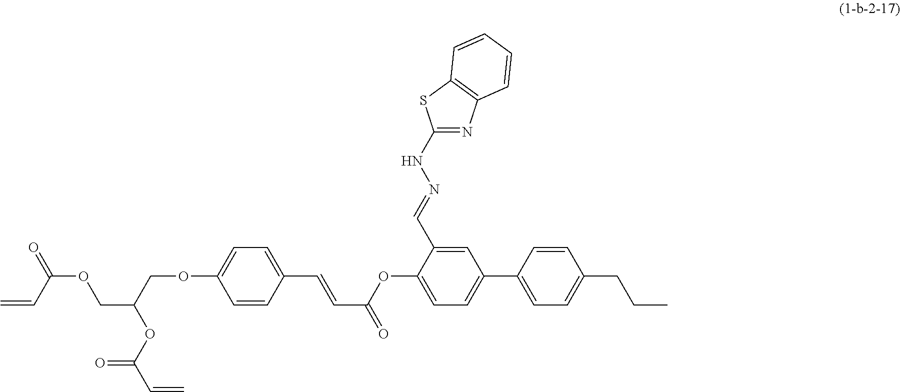

These polymerizable compounds may be used alone or may be used as a mixture of two or more of them.

Specifically, the compounds represented by the general formula (1-b-3) are preferably compounds represented by the following general formulae (1-b-3-1) to (1-b-3-29):

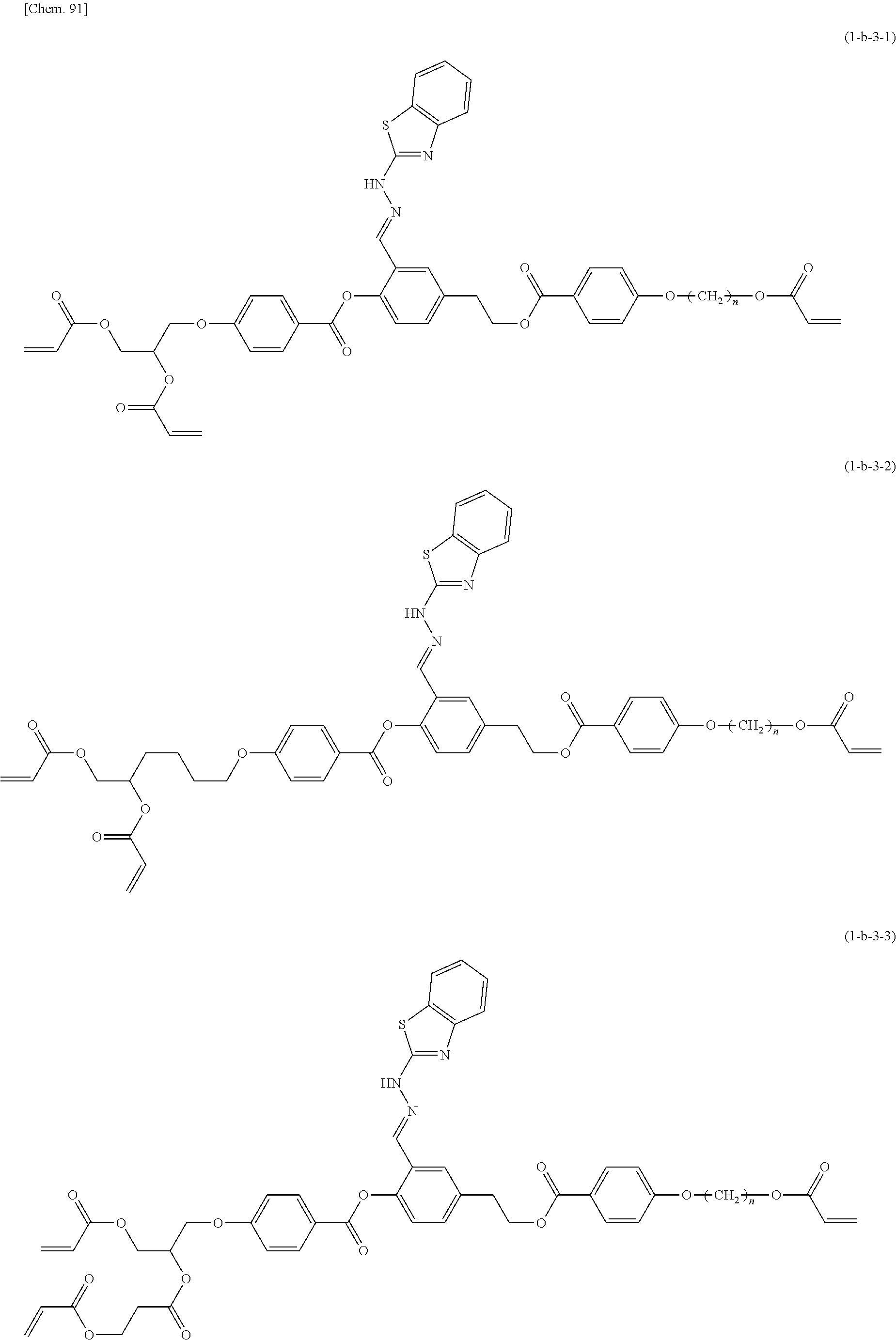

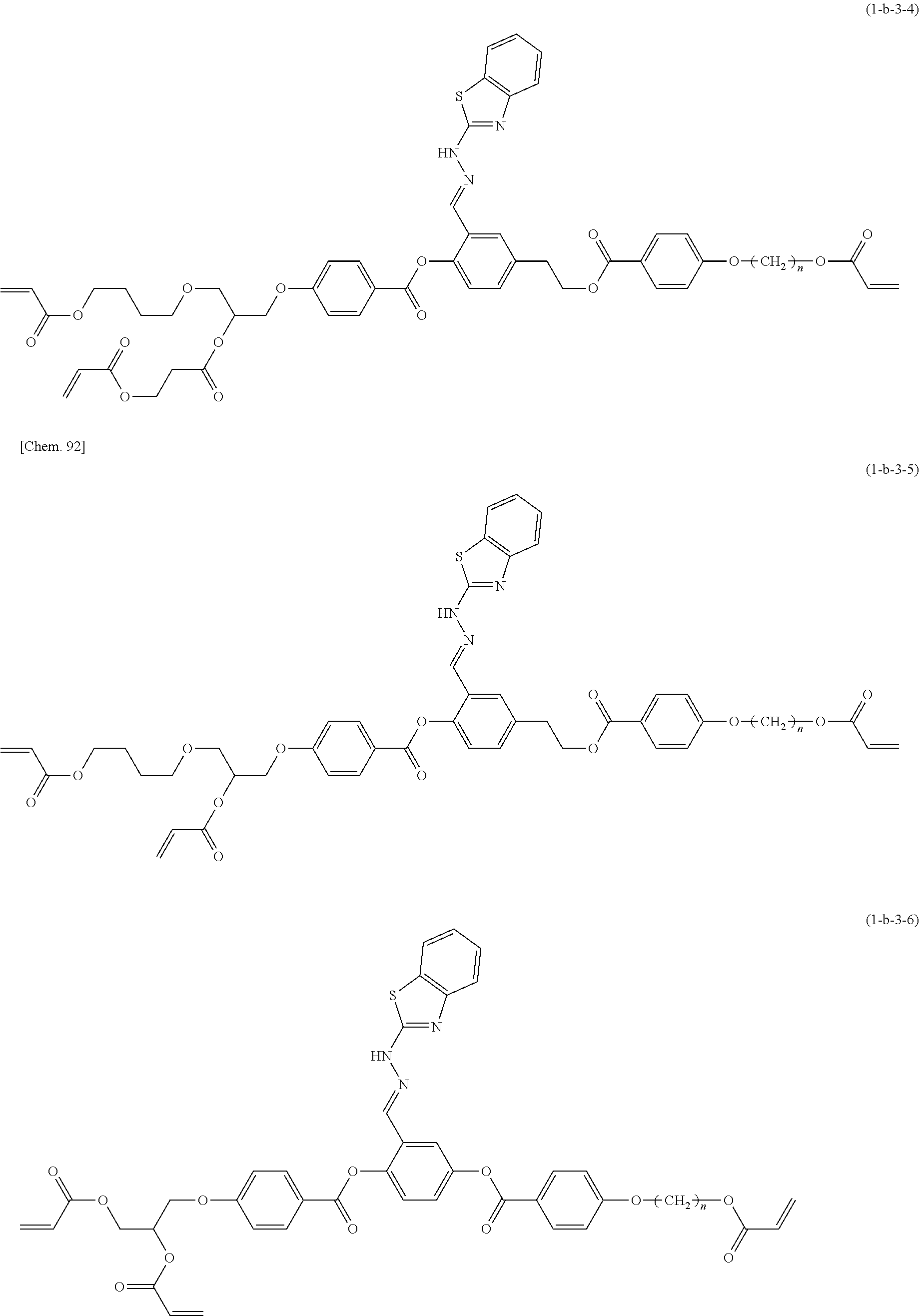

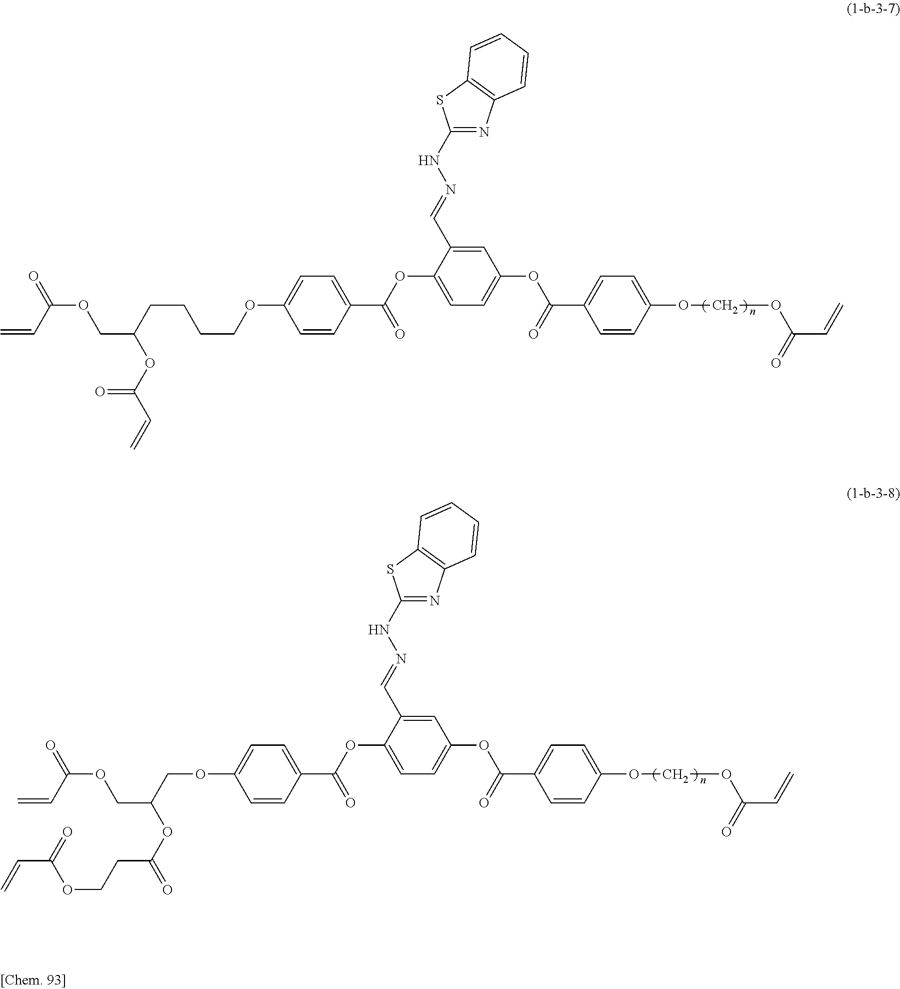

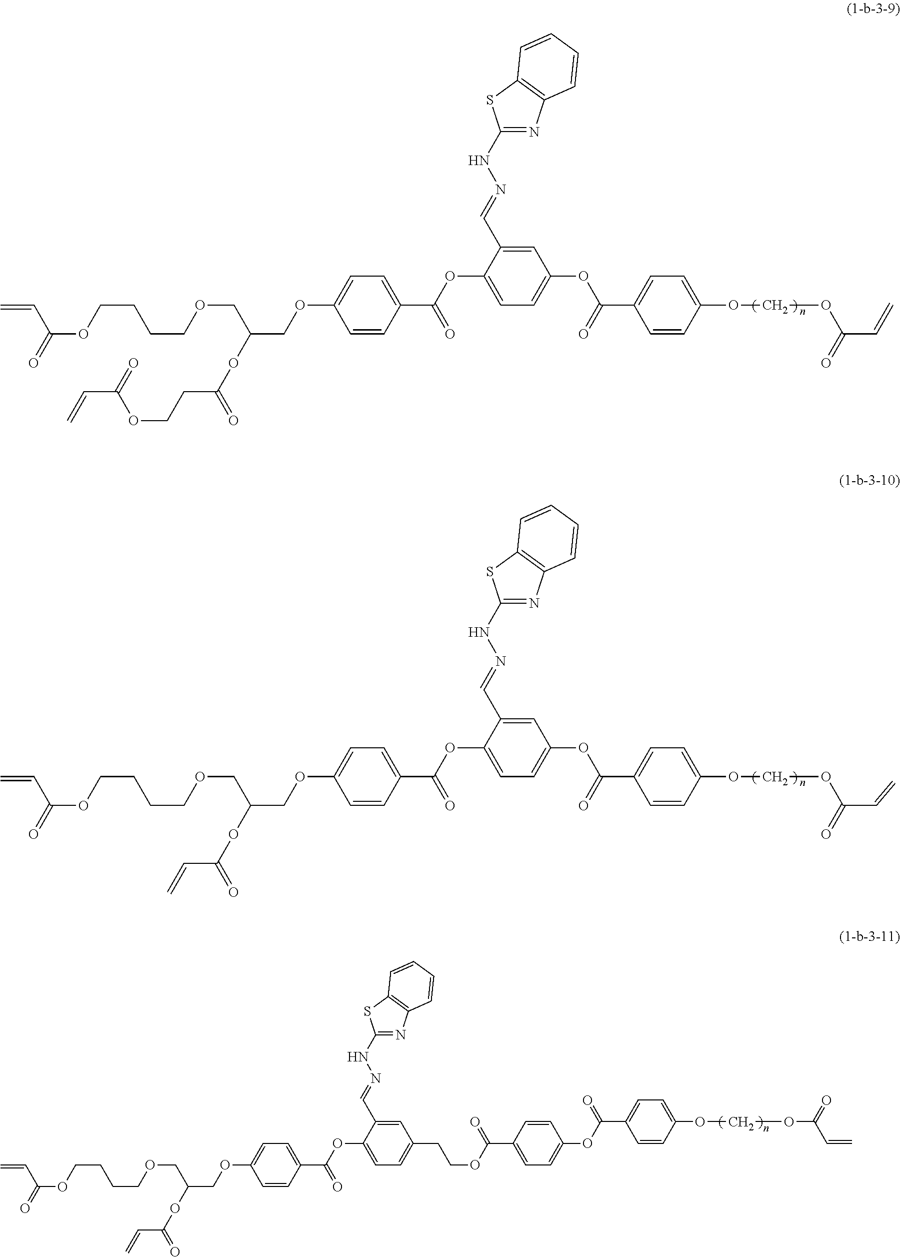

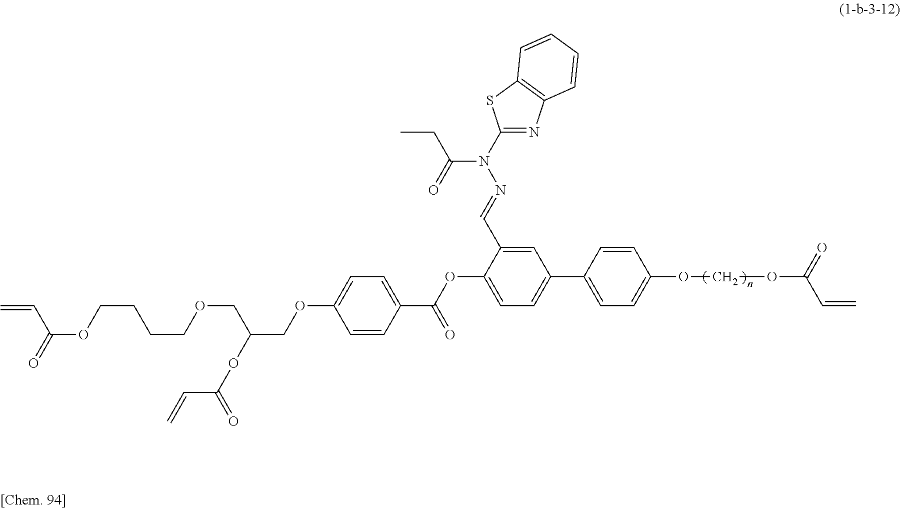

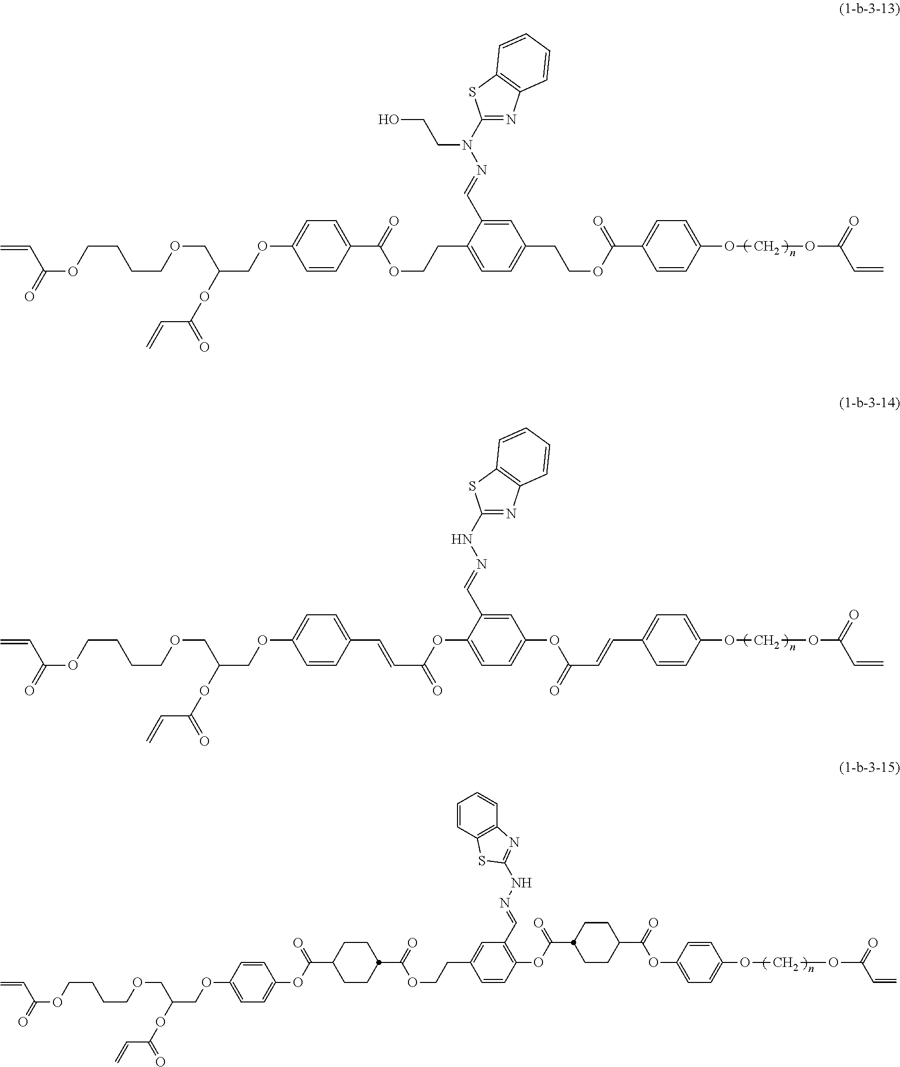

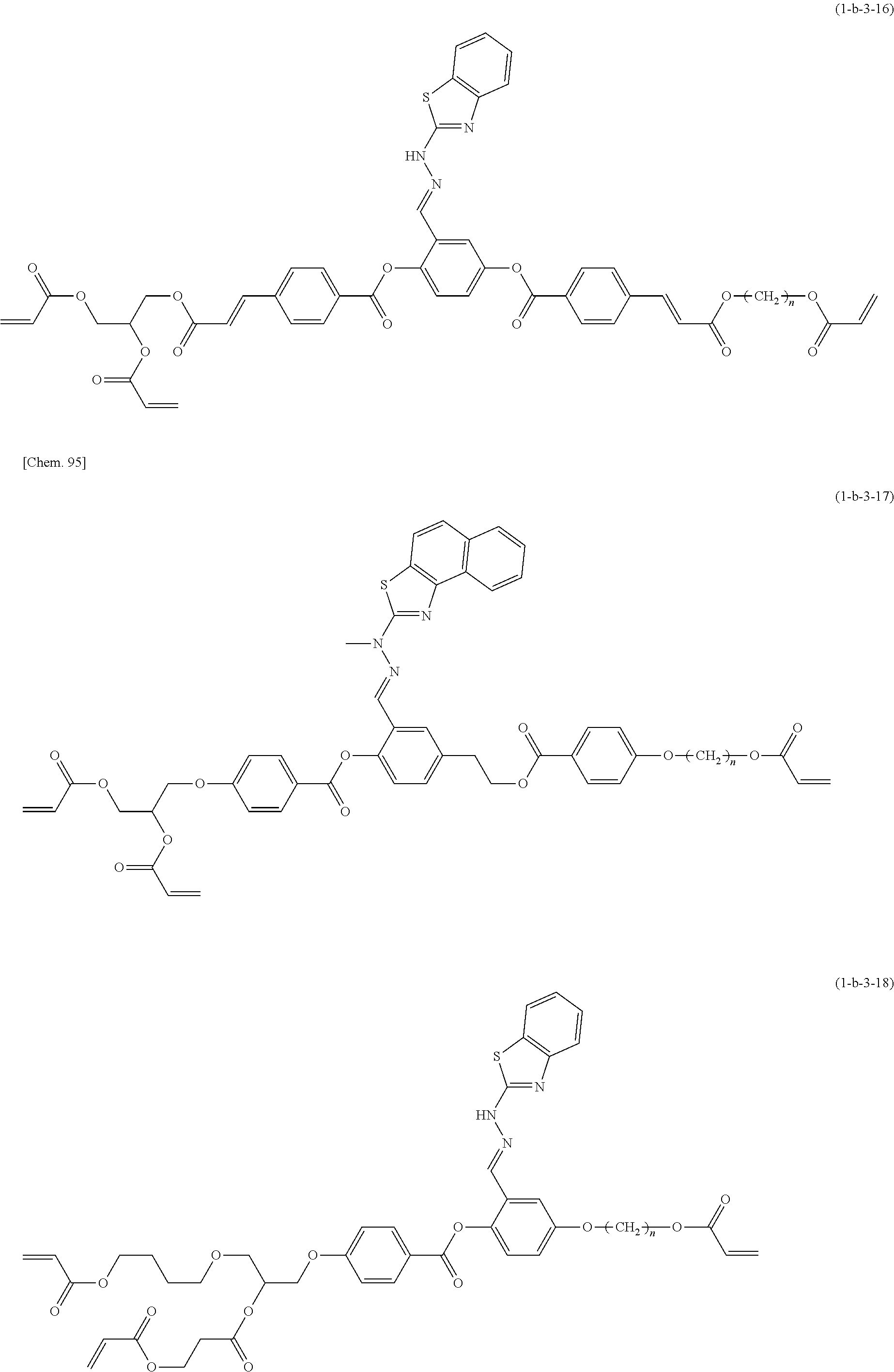

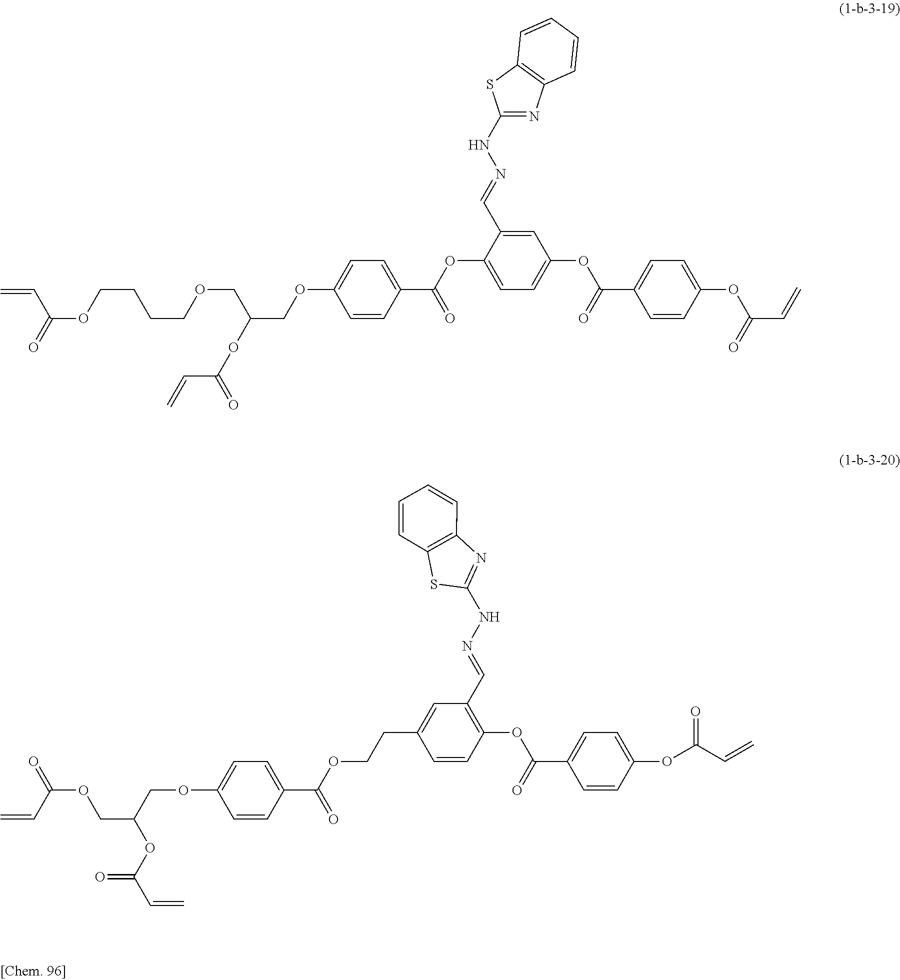

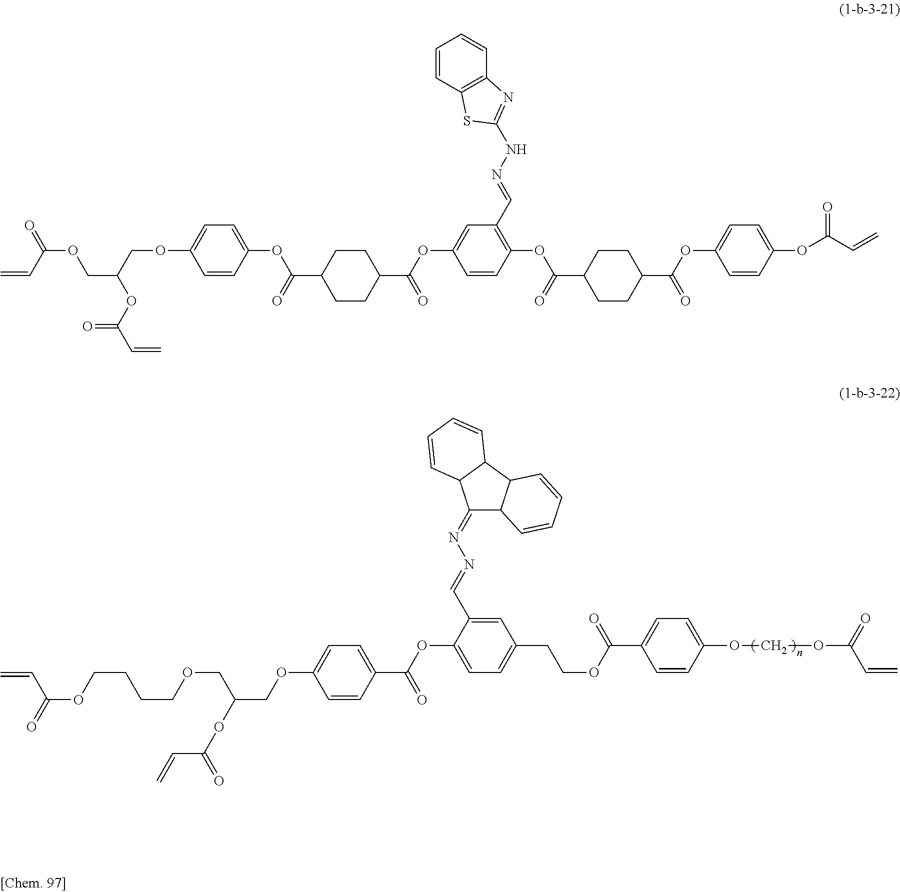

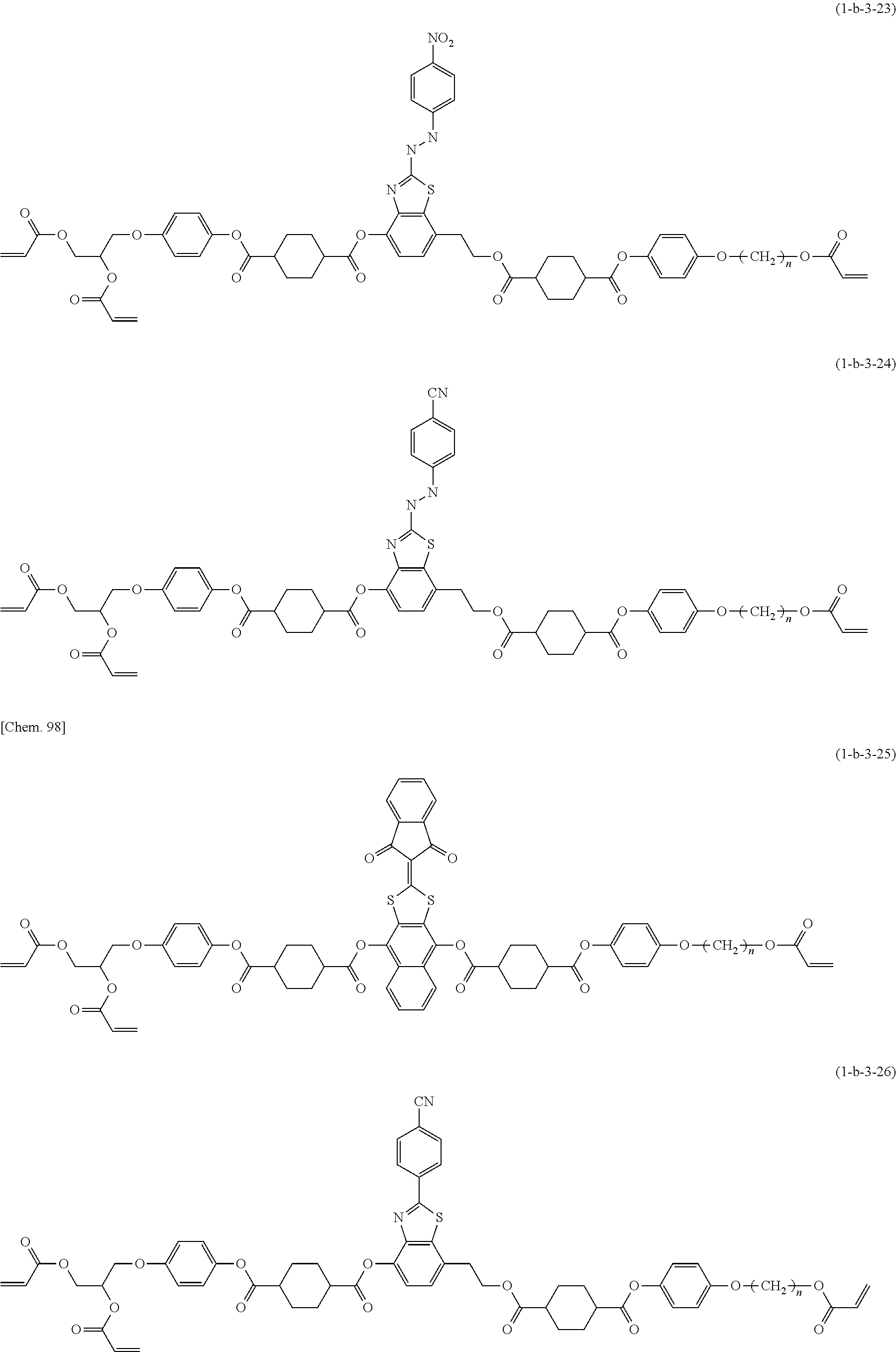

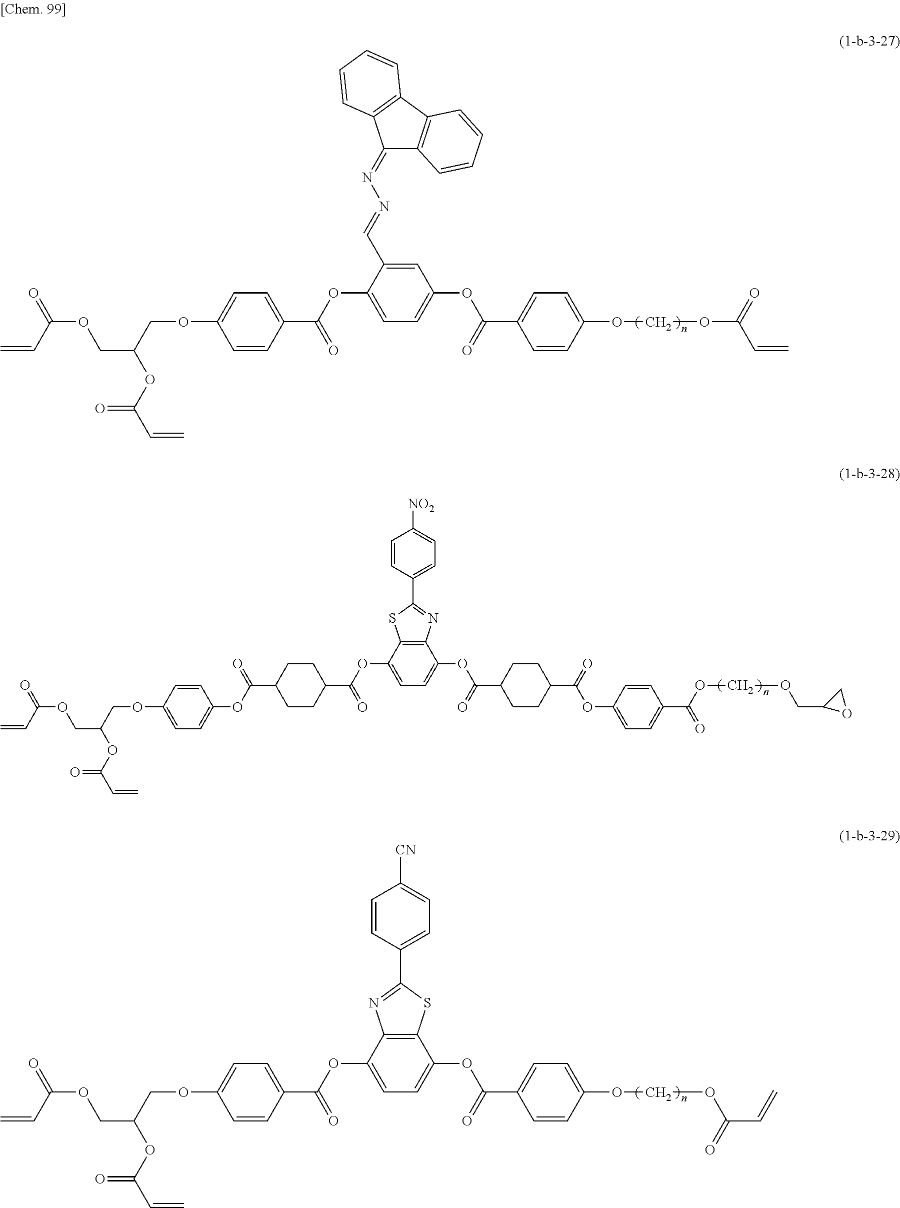

(wherein n represents a carbon number of 1 to 10). These liquid-crystalline compounds may be used singly or may be used as a mixture of two or more of them.

Specifically, the compounds represented by the general formula (1-b-4) are preferably compounds represented by the following general formulae (1-b-4-1) to (1-b-4-25):

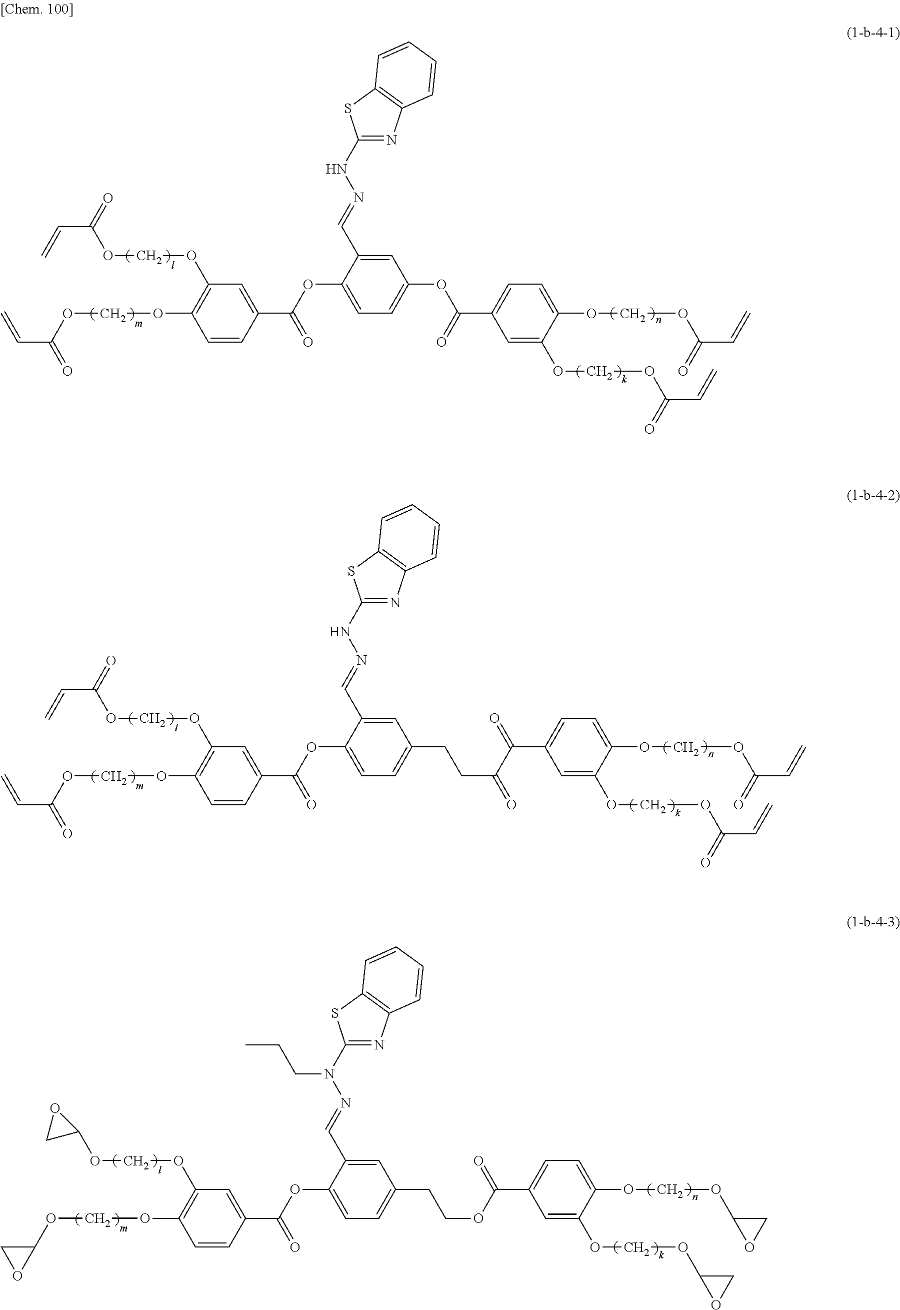

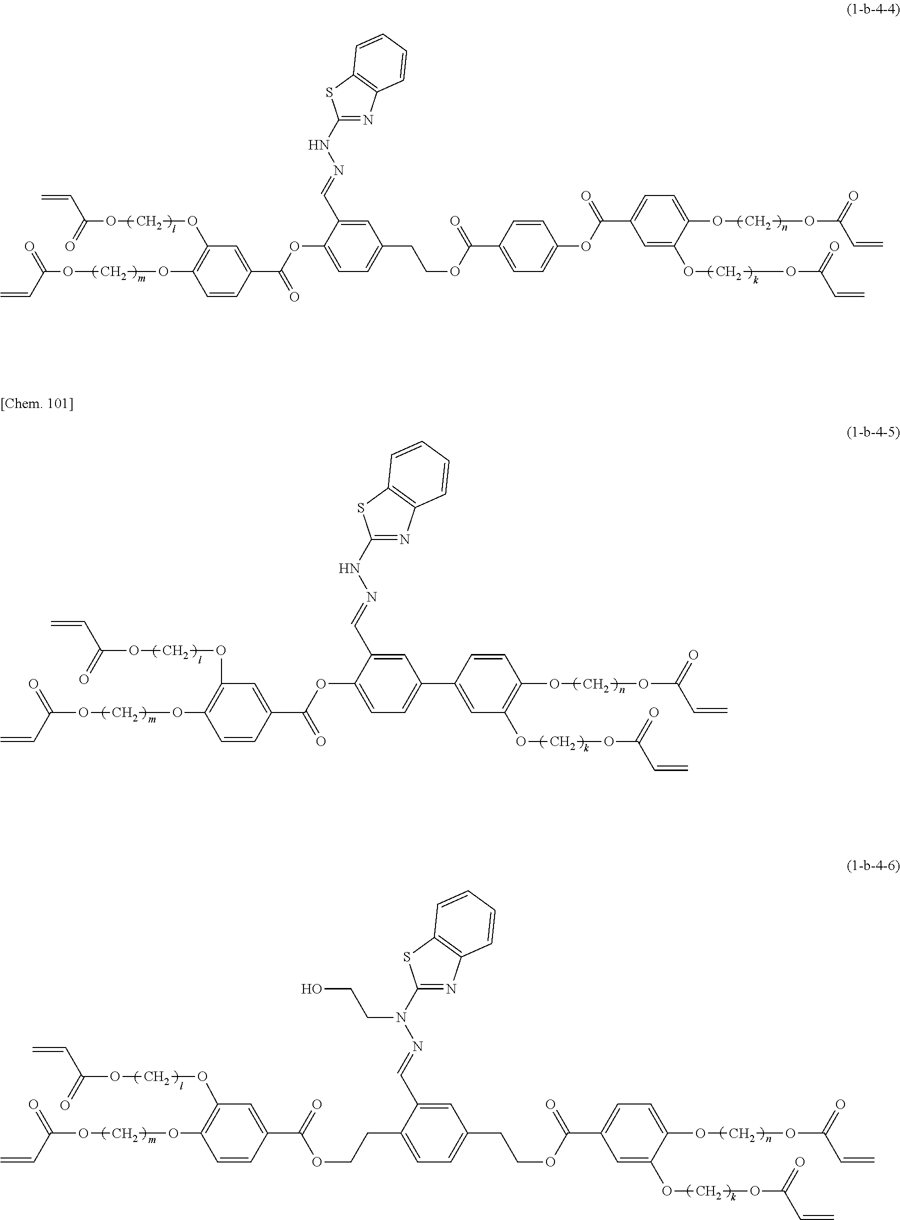

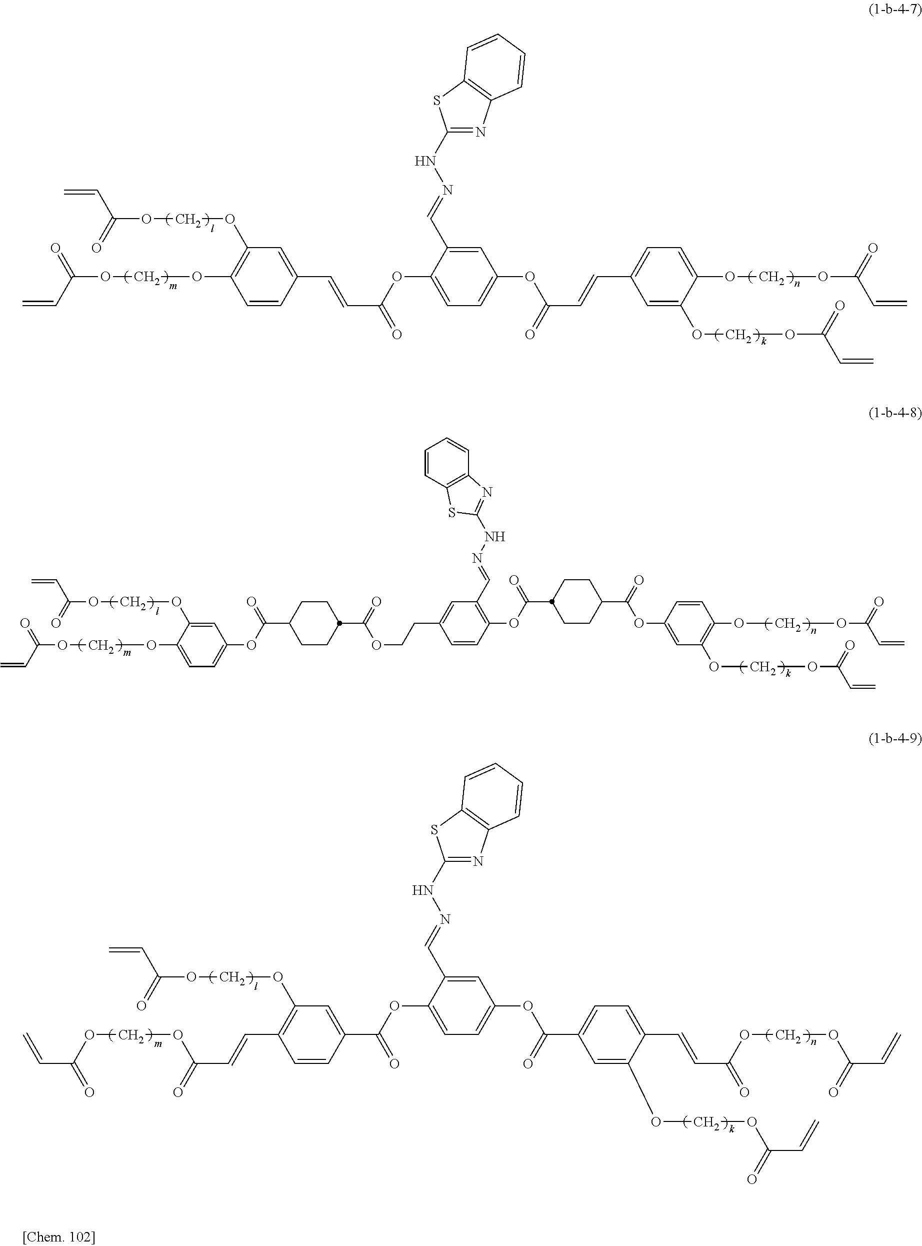

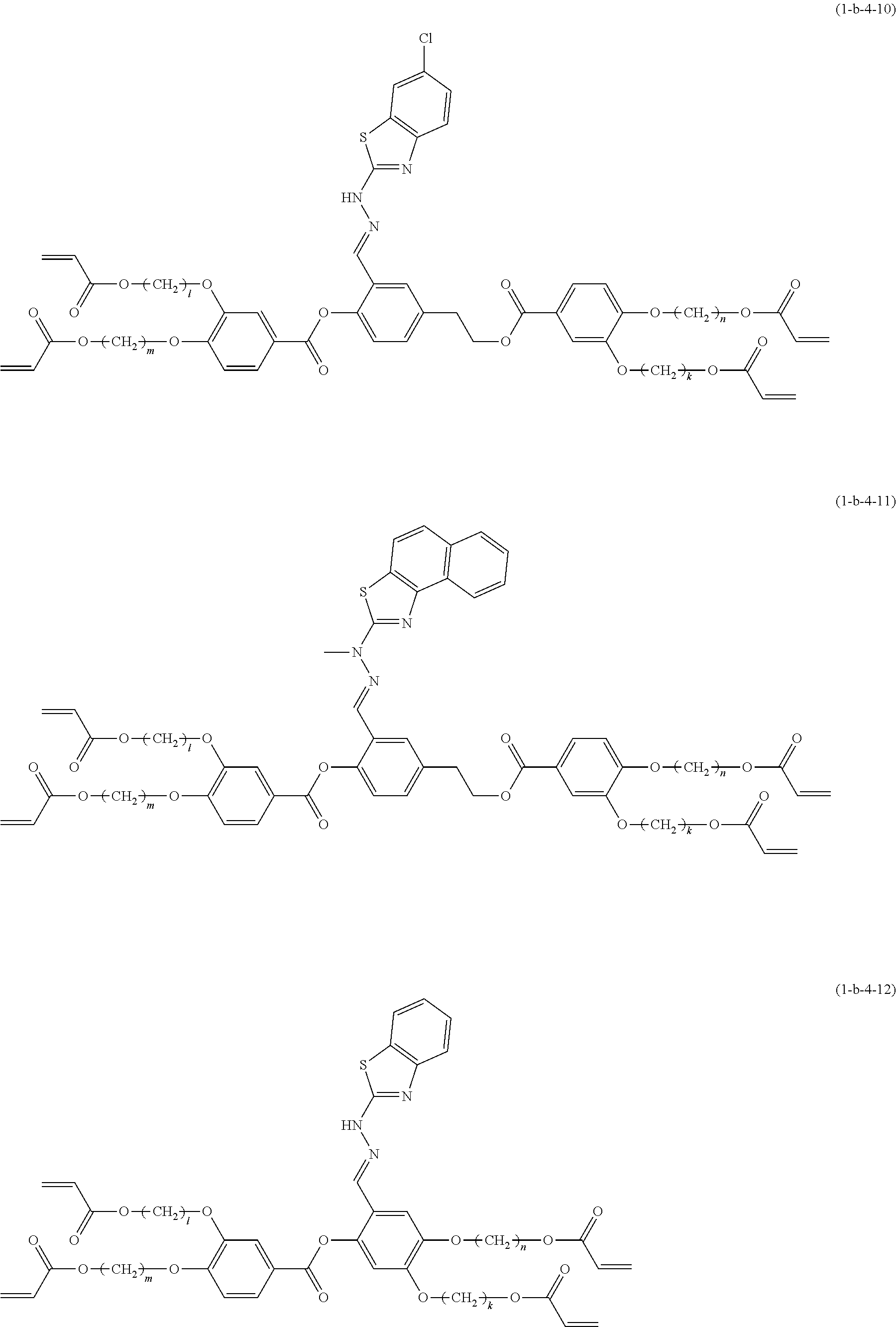

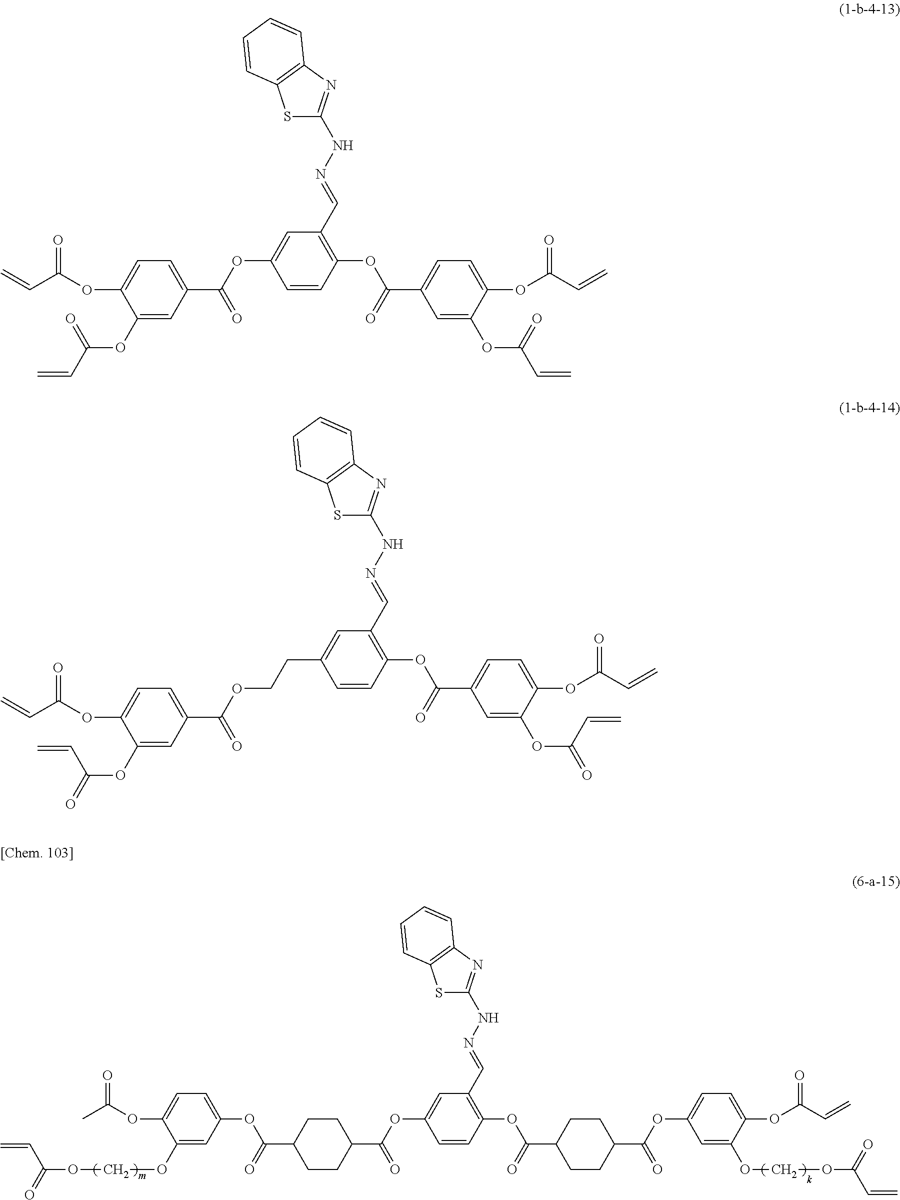

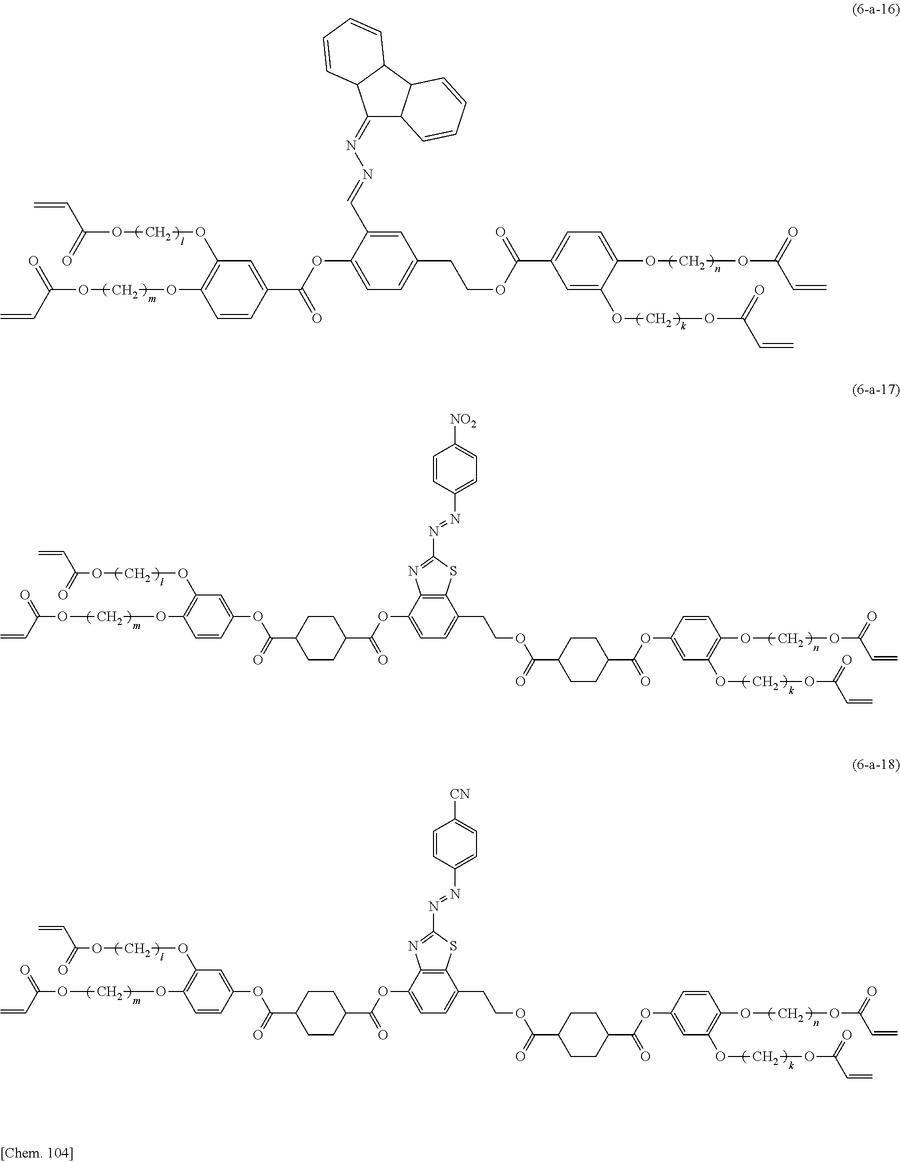

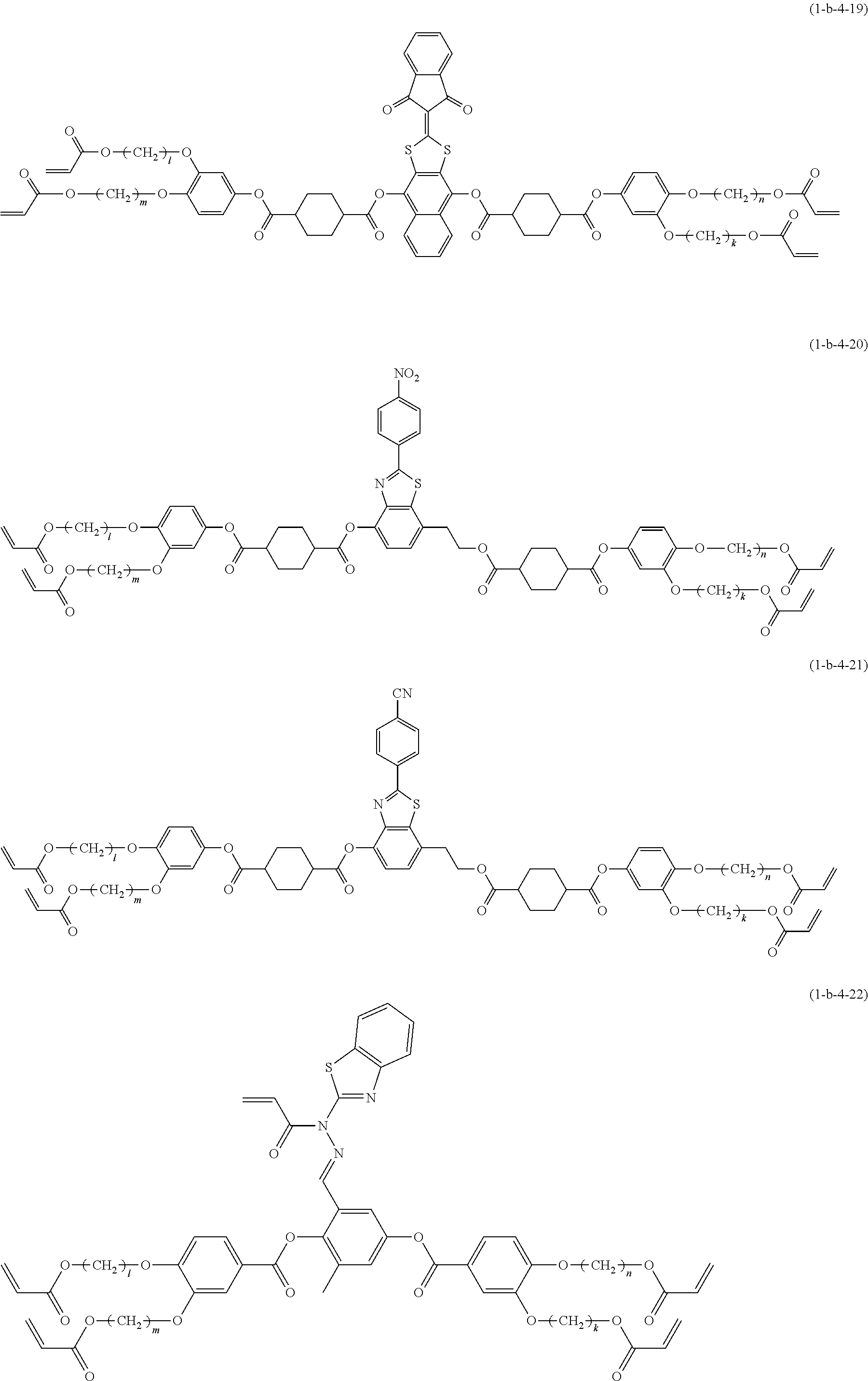

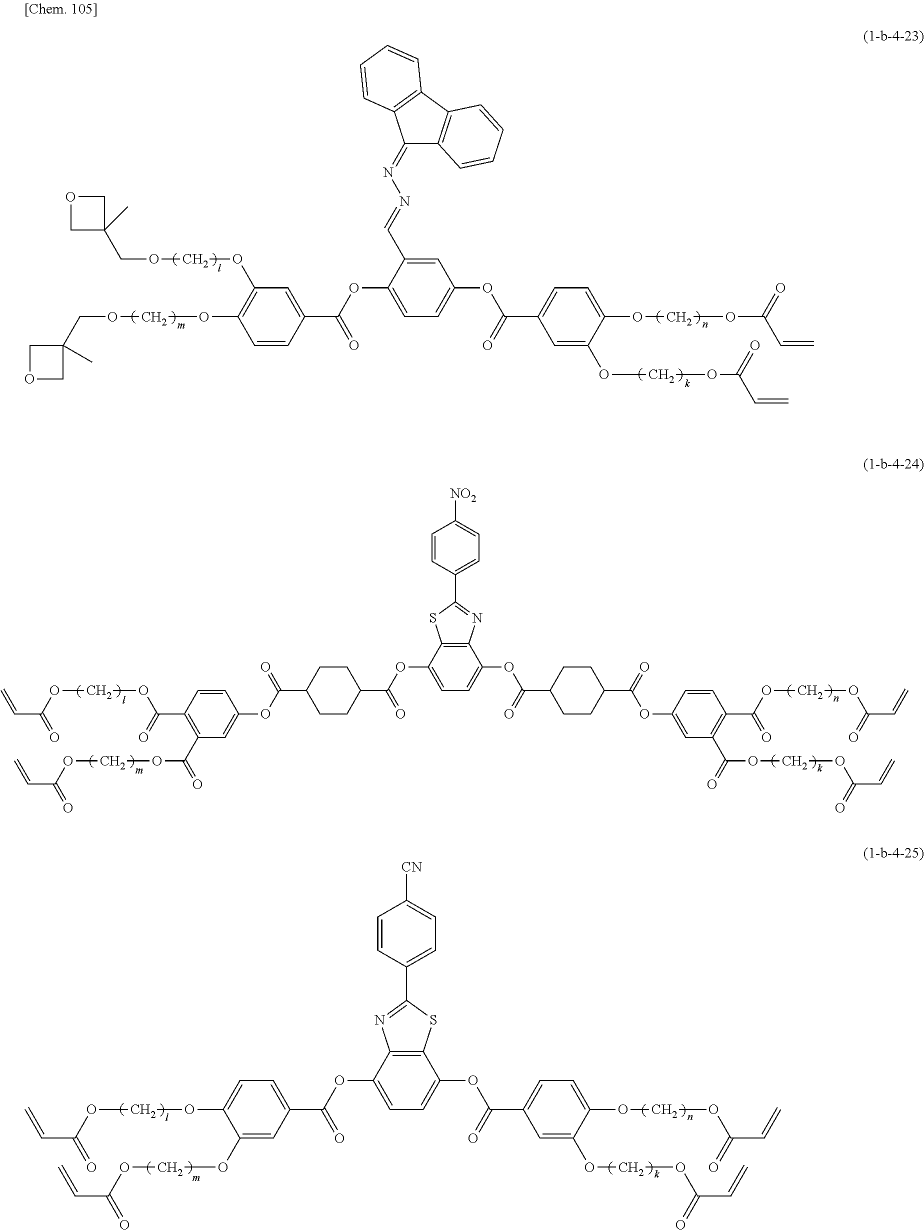

(wherein k, l, m and n each independently represent a carbon number of 1 to 10). These polymerizable compounds may be used alone or may be used as a mixture of two or more of them.

Specifically, the compounds represented by the general formula (1-b-5) are preferably compounds represented by the following formulae (1-b-5-1) to (1-b-5-26):

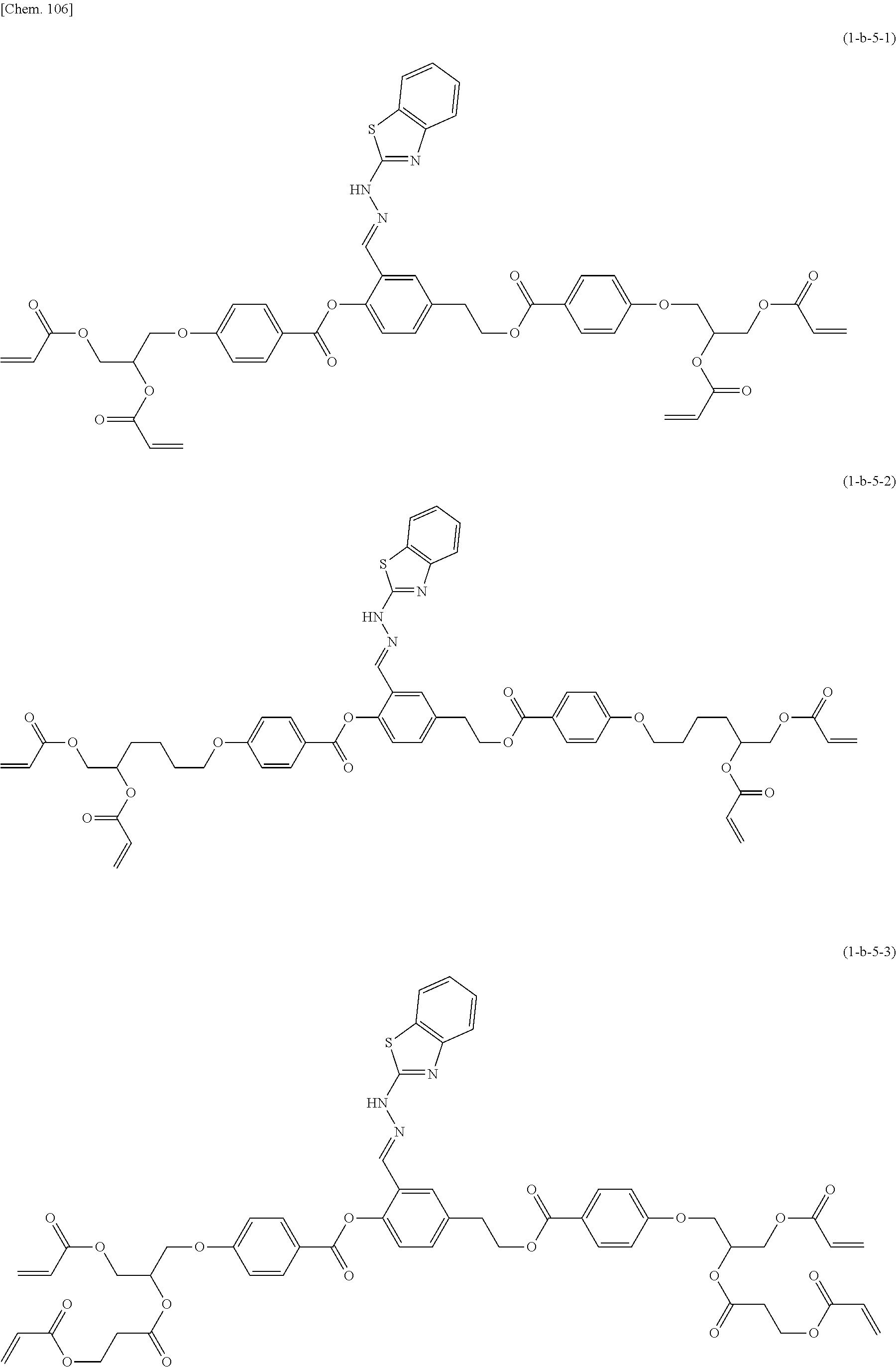

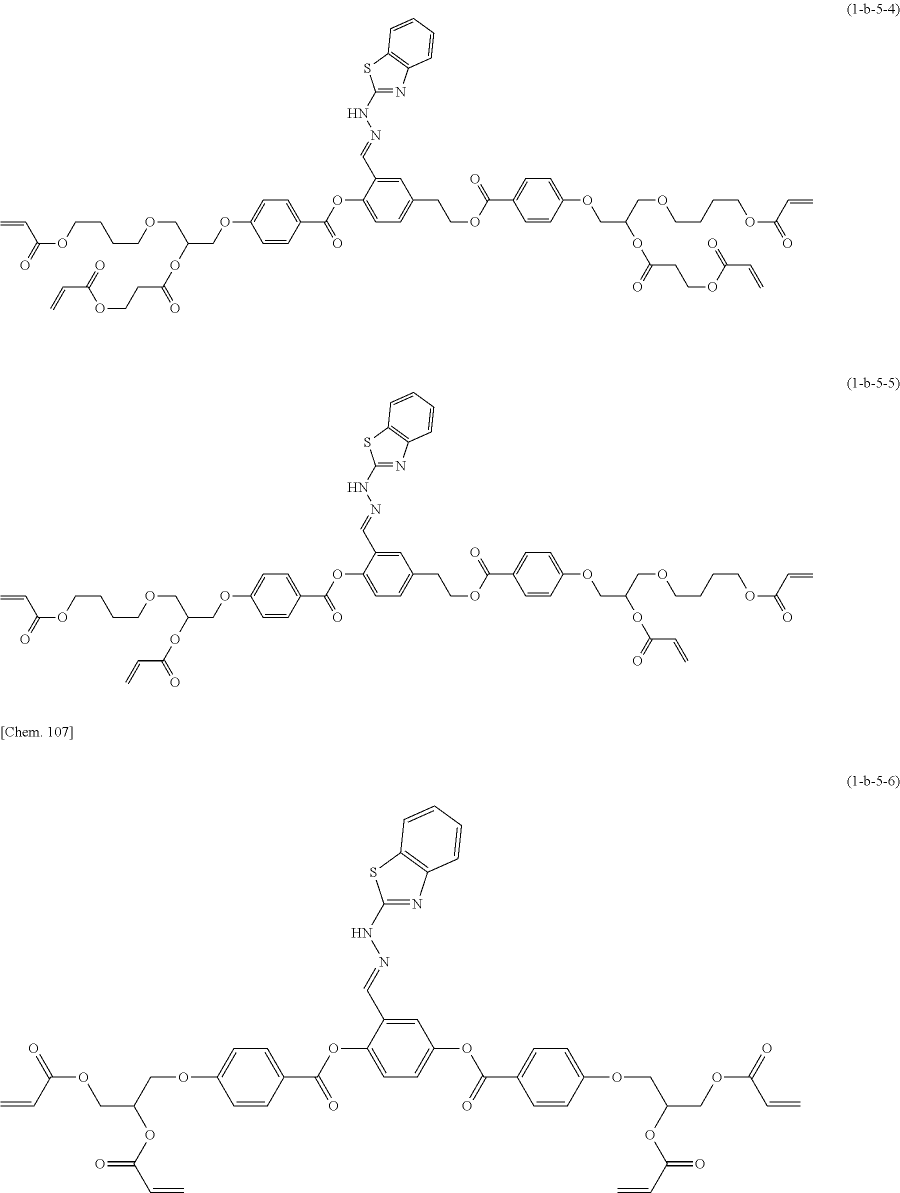

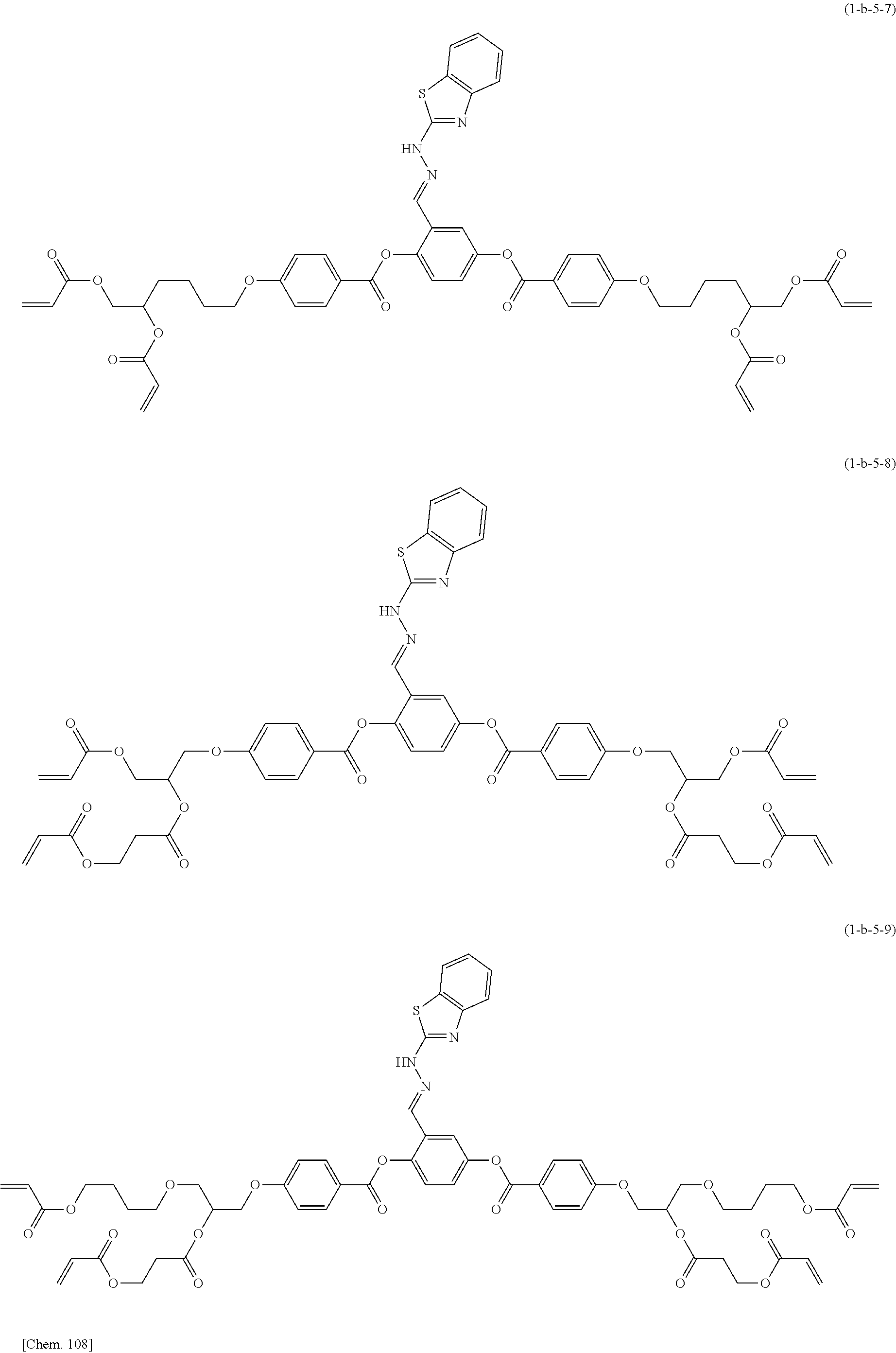

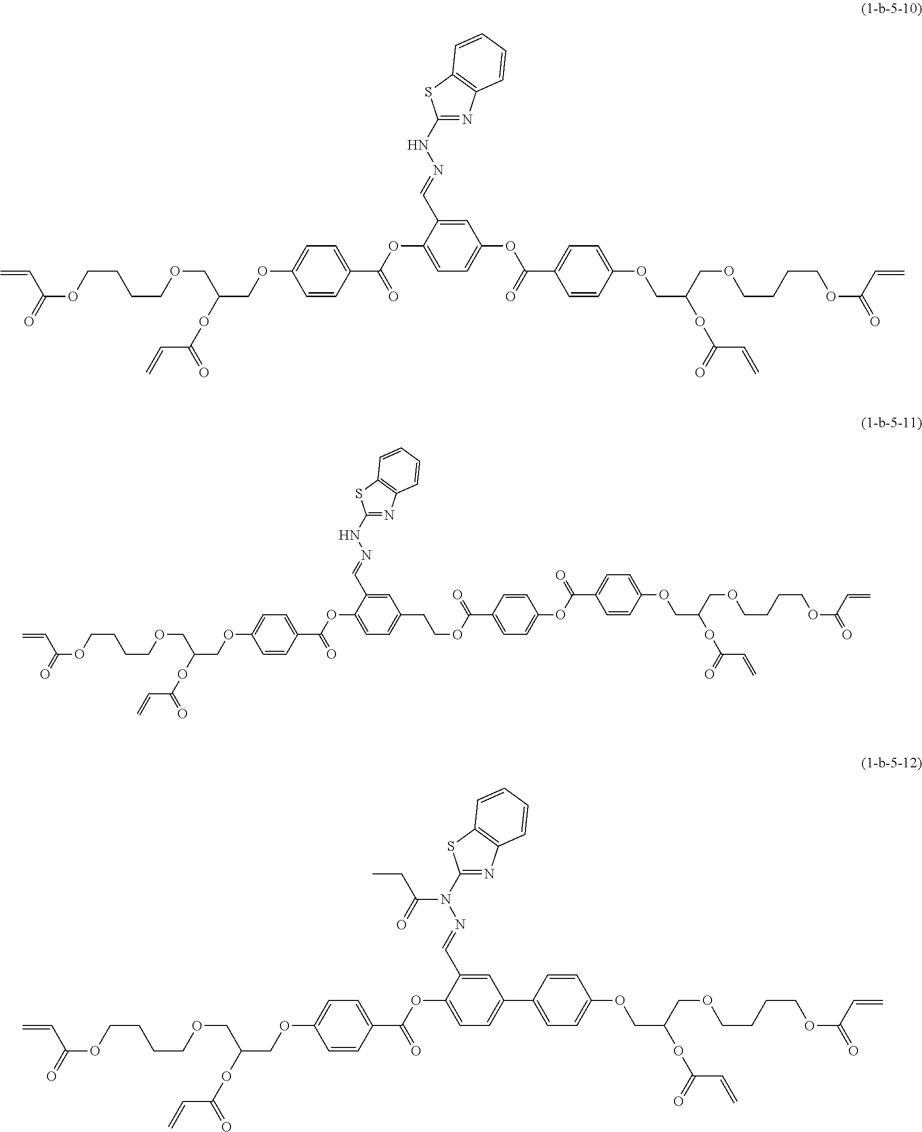

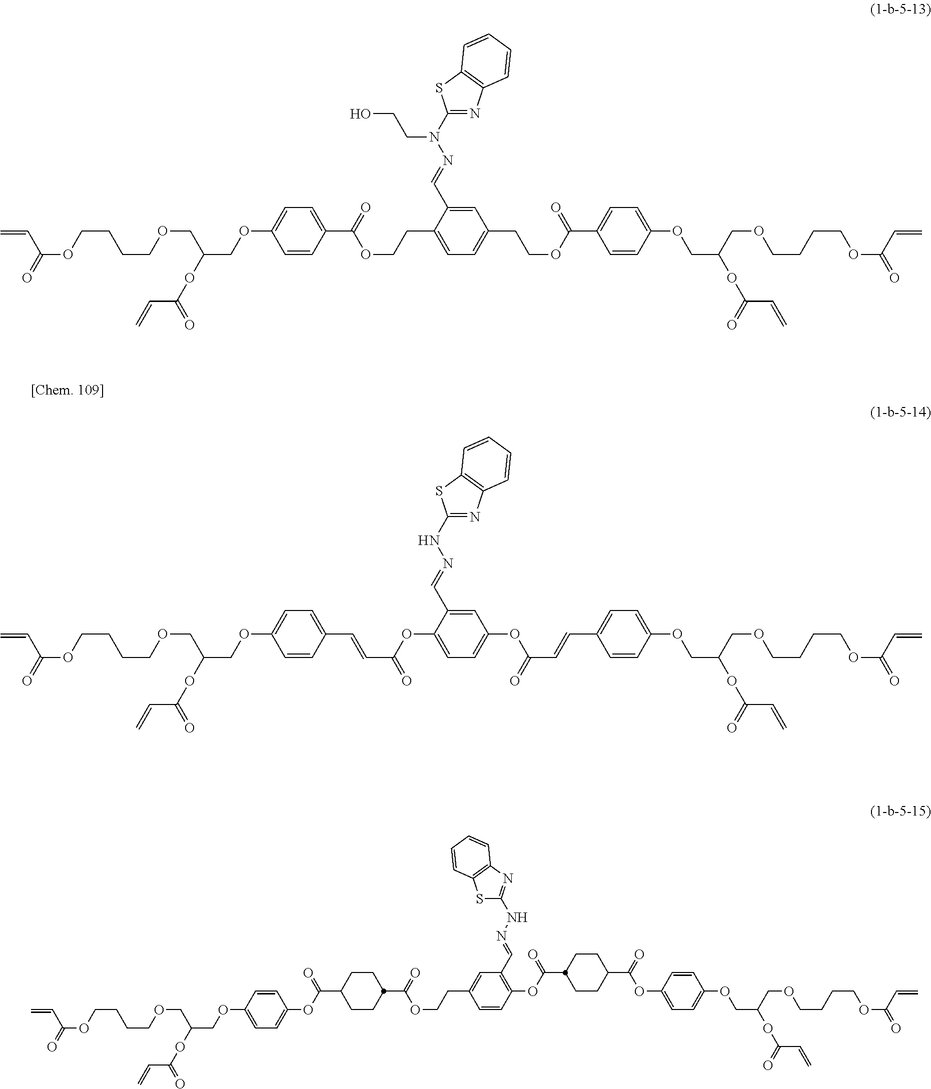

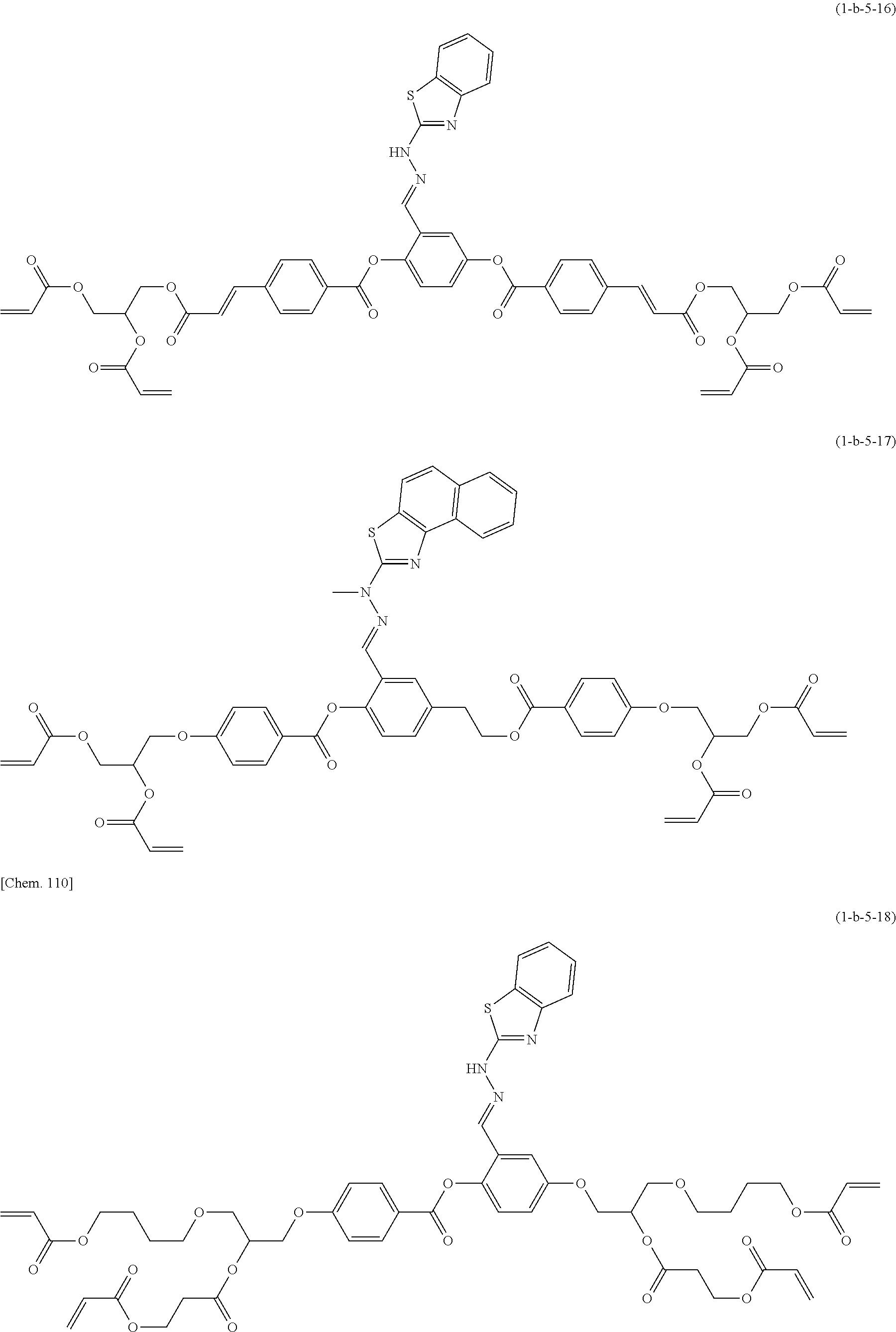

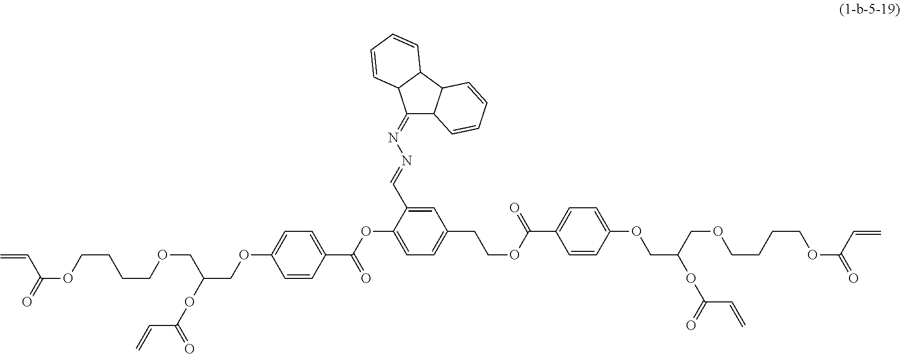

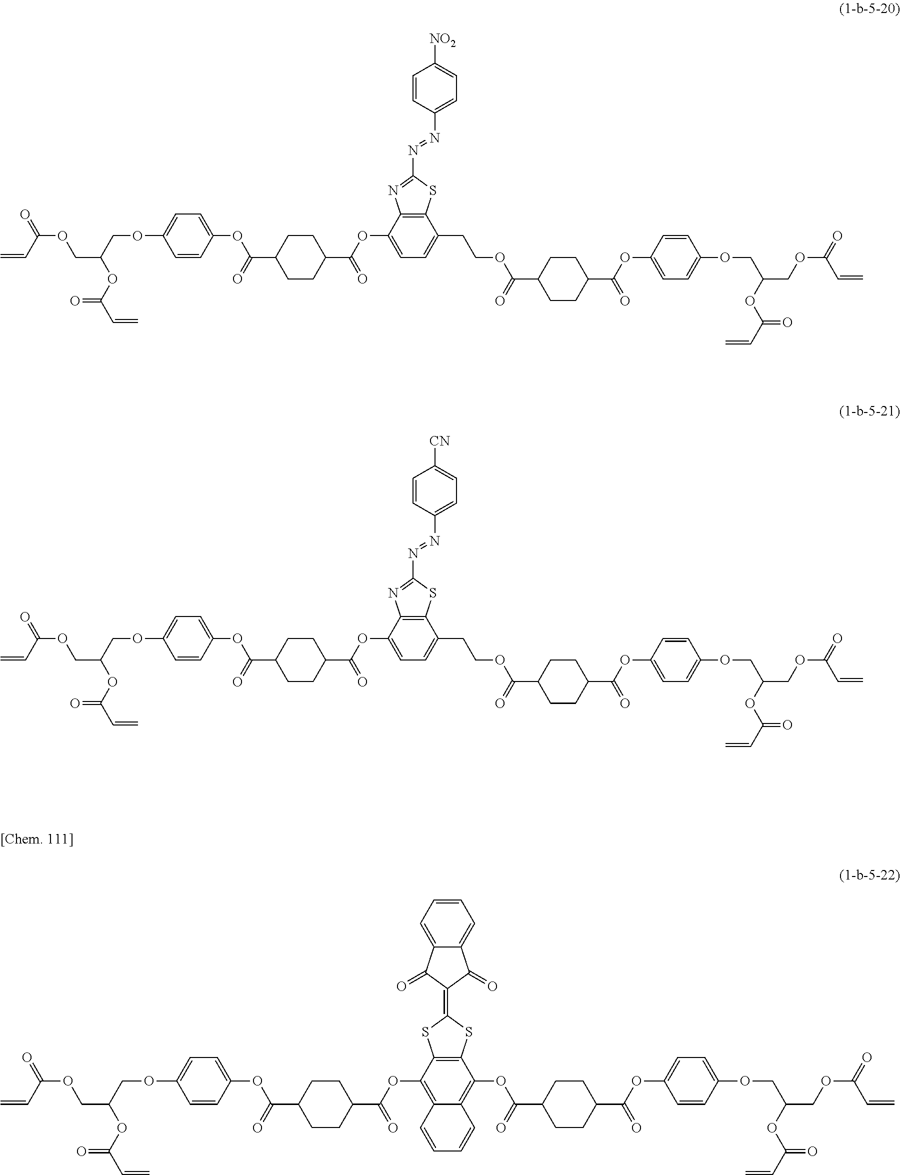

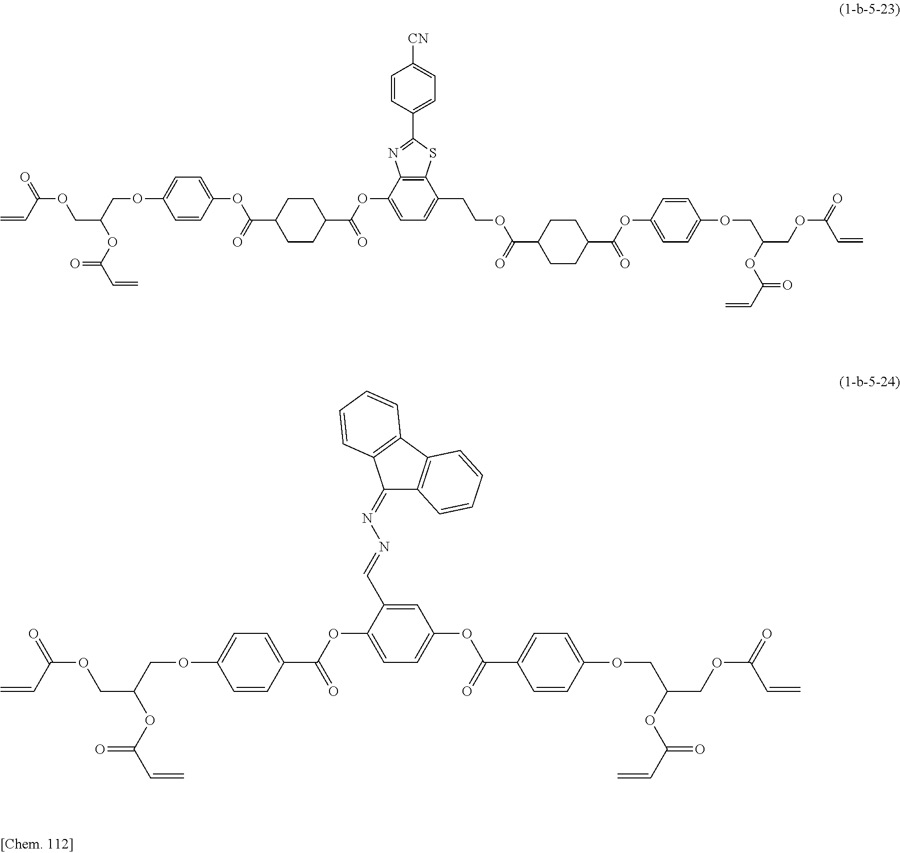

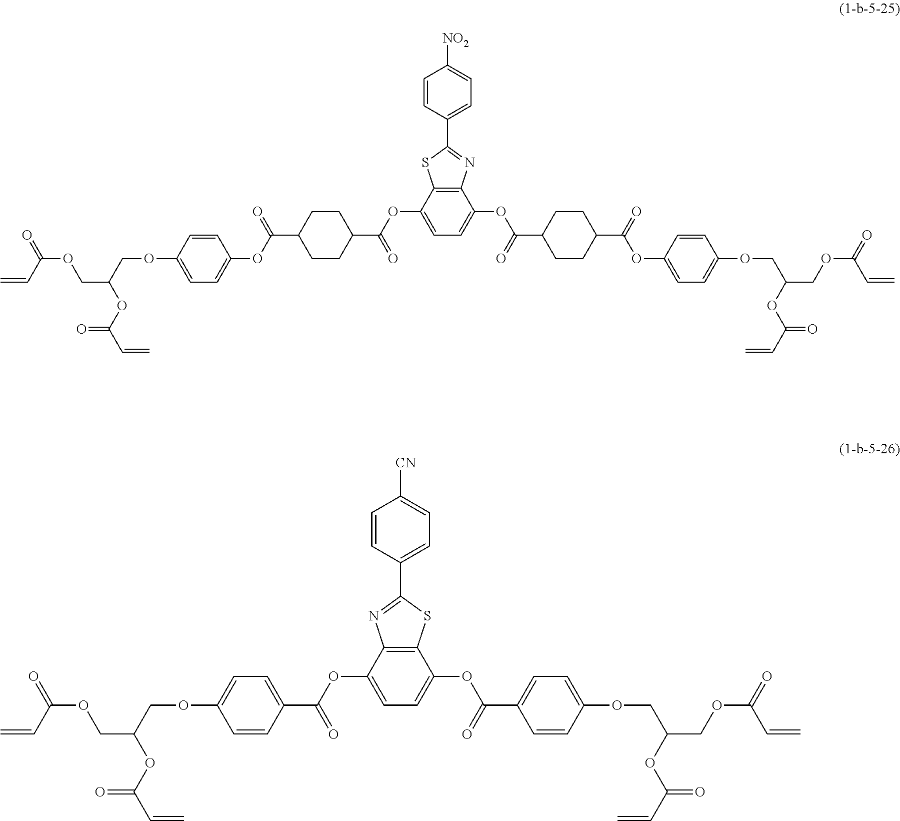

These liquid-crystalline compounds may be used alone or may be used as a mixture of two or more of them.

The permeable membrane of the present invention uses at least one or more kinds of polymerizable compounds, and from the viewpoint of durability, preferably, the polyfunctional polycyclic polymerizable compound represented by the general formula (1) is contained in an amount of 10 to 100% by weight relative to the sum total of the total content of the compounds in the composition to form the permeable membrane, more preferably 15 to 100% by weight, even more preferably 20 to 100% by weight.

In particular, among the polyfunctional polycyclic polymerizable compounds represented by the general formula (1), when those where HD is a group represented by the general formula (1-a) are used as the main component, that is, when the polyfunctional polycyclic polymerizable compounds represented by the general formulae (1-a-1) to (1-a-7) are used as the main component, preferably, the polyfunctional polycyclic polymerizable compound represented by the general formulae (1-a-1) to (1-a-7) is contained in an amount of 10 to 100% by weight relative to the sum total of the total content of the compounds in the composition to be used in producing the permeable membrane, more preferably 15 to 100% by weight, even more preferably 20 to 100% by weight.

Among the polyfunctional polycyclic polymerizable compounds represented by the general formula (1), when those where HD is a group represented by the general formula (1-b) are used as the main component, that is, when the polyfunctional polycyclic polymerizable compounds represented by the general formulae (1-b-1) to (1-b-5) are used as the main component, preferably, the polyfunctional polycyclic polymerizable compound represented by the general formulae (1-b-1) to (1-b-5) is contained in an amount of 30 to 90% by weight relative to the sum total of the total content of the compounds in the composition to be used in producing the permeable membrane, more preferably 35 to 90% by weight, even more preferably 40 to 90% by weight.

The permeable membrane of the present invention may use any other compound than those mentioned above.

The compound having two or more polymerizable groups, a hard segment having two cyclic structures, and optionally a soft segment to be used in the present invention (hereinafter referred to as a polyfunctional bicyclic polymerizable compound in the present invention) has, in the compound, two or more polymerizable functional groups, and a hard segment in which the rings bond to each other via a linking group, and in the compound, the polymerizable functional group directly bonds to the ring, or the ring bonds to the soft segment and the polymerizable functional group bonds to the ring via the soft segment.

### (Polyfunctional Bicyclic Polymerizable Compound)

The composition for use in constituting the polymer to be contained in the gas-selective permeable membrane of the present invention may use, as a polymerizable compound, a polyfunctional bicyclic polymerizable compound. Specifically, the polyfunctional bicyclic polymerizable compound is represented by the following general formula (2):

[Chem. 113]

(P²¹-Sf²¹ₙ₂₁HD²Sf²²-P²²)ₙ₂₂ (2)

(wherein Sf²¹ and Sf²² each independently represent a soft segment, and plural Sf²¹'s and Sf²²'s, if any, each may be the same or different, P²¹ and P²² each independently represent a polymerizable group, and plural P²¹'s and P²²'s, if any, may be the same or different, HD² represents a hard segment having 2 cyclic structures, n1 and n2 each independently represent an integer of 0 to 3, and when these are 0, the compound has a terminal group, but n1+n2≥2).

P²¹ and P²² include radical-polymerizable ones and cationic-polymerizable ones.

P²¹ and P²² may be any polymerizable group capable of undergoing polymerization reaction with a thermal initiator, a photoinitiator, or heat or active energy rays, and preferably, each is independently a polymerizable group selected from the following formulae (P-1) to (P-20):

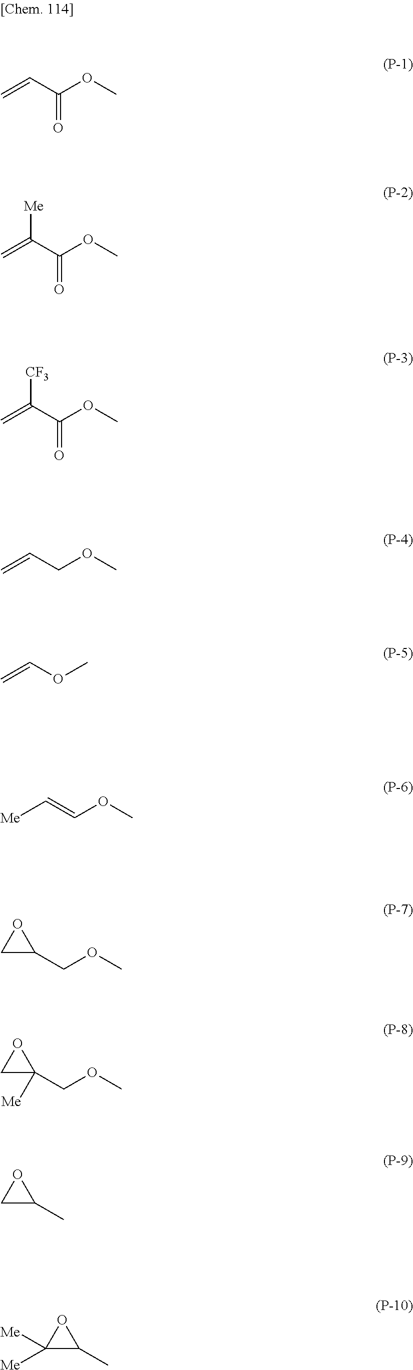

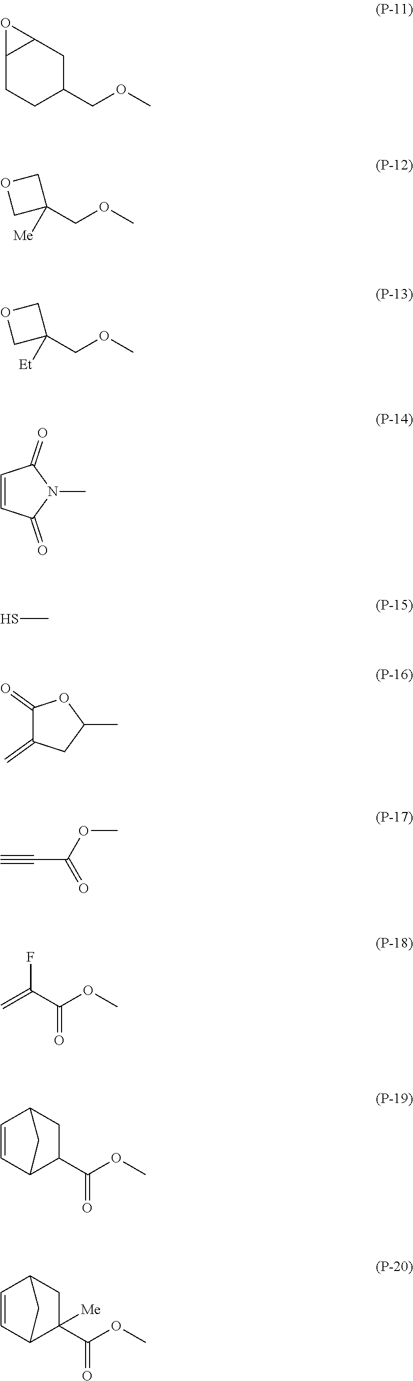

(The above Me represents a methyl group, and Et represents an ethyl group.) In particular, when UV polymerization is employed for the polymerization method, the formula (P-1), (P-2), (P-3), (P-4), (P-5), (P-7), (P-11), (P-13), (P-15) or (P-18) is preferred; the formula (P-1), (P-2), (P-7), (P-11) or (P-13) is more preferred; the formula (P-1), (P-2) or (P-3) is even more preferred; and the formula (P-1) or (P-2) is especially preferred.

Sf²¹ and Sf²² include linear or branched ones.

Preferably, Sf²¹ and Sf²² each are independently a single bond or an alkylene group having 1 to 18 carbon atoms (in which one or two or more hydrogen atoms bonding to the alkylene group may be each independently substituted with a halogen atom, a group CN, an alkyl group having 1 to 8 carbon atoms, or an alkylene group having 1 to 8 carbon atoms and having a polymerizable functional group, and one CH₂ group or two or more CH₂ groups not adjacent to each other existing in this group may be mutually independently substituted with —O—, —S—, —NH—, —N(CH₃)—, —CO—, —COO—, —OCO—, —OCOO—, —SCO—, —COS—, —CF₂O—, —OCF₂—, —CF₂S—, —SCF₂—, —CH═CH—, or —C≡C— in the form where the oxygen atoms do not mutually directly bond to each other).

In the case where n21 and/or n22 are/is 0, HD² has a terminal group, and the terminal group is each independently a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO— or —C≡C—, and any hydrogen atom in the alkyl group may be substituted with a fluorine atom.

HD² includes rod-shaped, disc-shaped or flexed ones.

Specifically, HD² may be such that two cyclic structures therein may bond to each other via a linking group and/or a single bond, as so mentioned hereinabove. The cyclic structure includes 3-membered to 8-membered rings, hetero rings and condensed rings, and one or two or more hydrogen atoms bonding to each ring may be each independently substituted with a substituent.

More specifically, HD² is preferably a hard segment represented by the following general formula (2-a):

[Chem. 115]

-A²¹-Z²¹-A²²^{^{−}} (2-a)

(wherein A²¹ and A²² each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalane-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, one or two or more hydrogen atoms bonding to each ring of A²¹ and A²² may be each independently substituted with a substituent L^{HD2}, and the substituent L^{HD2} represents F, Cl, CF₃, OCF₂, a CN group, a nitro group, an alkyl group having 1 to 8 carbon atoms, an alkoxy group having 1 to 8 carbon atoms, an alkanoyl group, an alkanoyloxy group, a carbamoyl group, a sulfamoyl group, an alkenyl group having 2 to 8 carbon atoms, an alkenyloxy group having 2 to 8 carbon atoms, an alkenoyl group, an alkenoyloxy group, or a group represented by the following general formula (2-b):

[Chem. 116]

A⁶_{q}Sf³ᵣP³ (2-b)

(wherein P³ represents a polymerizable group, and is the same as that defined for the above P¹ and P², A⁶ represents —O—, —COO—, —OCO—, —OCH₂—, —CH₂O—, —CH₂CH₂OCO—, —COOCH₂CH₂—, —OCOCH₂CH₂— or a single bond, Sf³ is the same as that defined for Sf¹ and Sf², q represents 0 or 1, and r represents 0 or 1)).

Z²¹ represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—_{#}—CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —COO—CH₂CH₂—, —CH₂CH₂—COO—, —CH₂CH₂—OCO—, —COO—CH₂—, —COO—CH₂—, —CH₂—COO—, —CH₂—OCO—, —CH═CH—, —N═N—, —CH═N—, —N═CH—, —CH═N—N═CH—, —CF═CF—, —C≡C— or a single bond.

More specifically, the polyfunctional bicyclic polymerizable compounds represented by the general formula (2) are preferably compounds represented by the following general formulae (2-1) to (2-7):

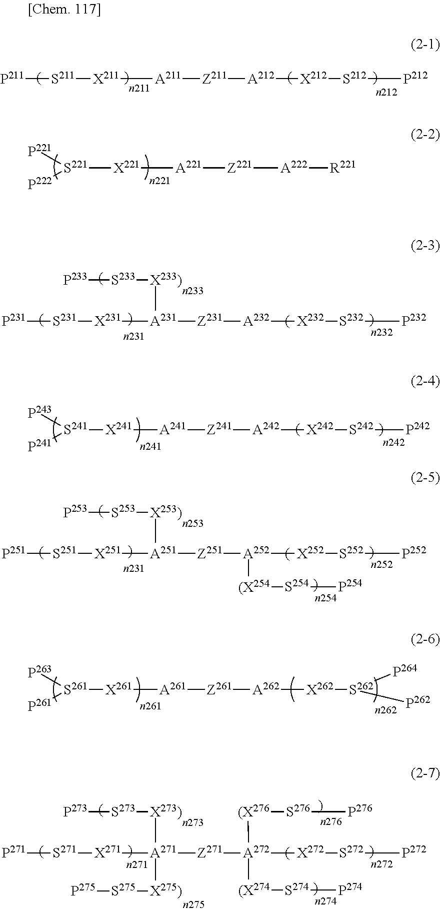

In the above general formulae (2-1) to (2-7), P²¹¹ to P²⁷⁶ each represent a polymerizable group, and preferably, each independently represents a group selected from the following formulae (P-1) to (P-20):

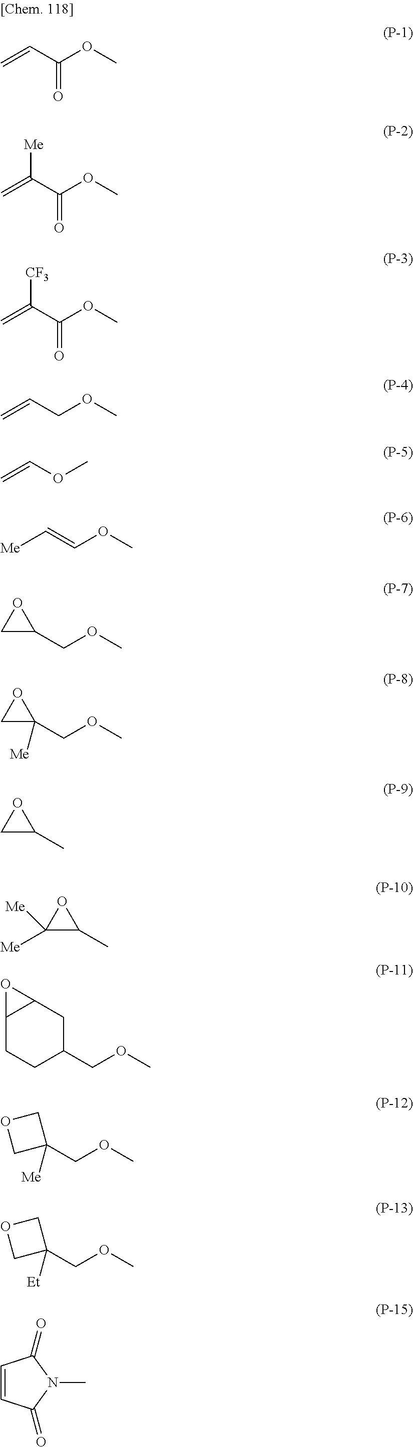

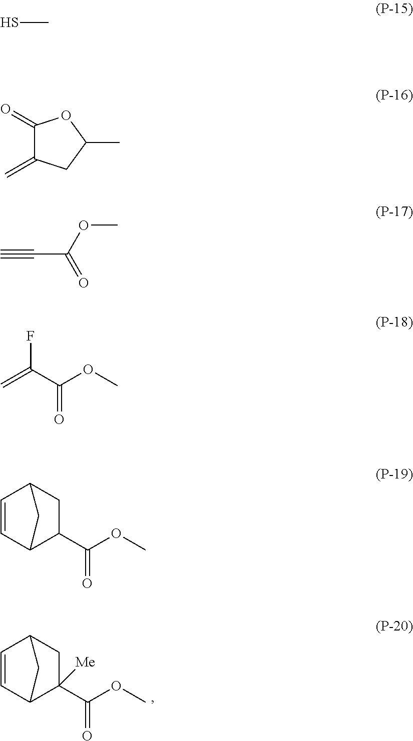

Among these polymerizable groups, from the viewpoint of enhancing polymerizability and storage stability, the formula (P-1), (P-2), (P-7), (P-12), or (P-13) is preferred, the formula (P-1), (P-2), (P-7), or (P-12) is more preferred, and the formula (P-1) or (P-2) is even more preferred.

In the general formulae (2-1) to (2-8), —(S²¹¹—X²¹¹)— to —(S²⁷⁶—X²⁷⁶)— each independently represent a soft segment or a single bond.

S²¹¹ to S²⁷⁶ each independently represent a spacer group or a single bond, and plural S²¹¹'s to S²⁷⁶'s, if any, each may be the same or different. The spacer group represents an alkylene group having 1 to 18 carbon atoms, and one or two or more hydrogen atoms bonding to the alkylene group may be each independently substituted with a halogen atom, a group CN, an alkyl group having 1 to 8 carbon atoms, or an alkylene group having 1 to 8 carbon atoms and having a polymerizable functional group, and one CH₂ group or two or more CH₂ groups not adjacent to each other existing in this group may be mutually independently substituted with —O—, —S—, —NH—, —N(CH₃)—, —CO—, —CH(OH)—, —CH(COOH)—, —COO—, —OCO—, —OCOO—, —SCO—, —COS— or —C≡C— in the form where the oxygen atoms do not mutually directly bond to each other. Among these spacer groups, a linear alkylene group having 2 to 8 carbon atoms, an alkylene group having 2 to 6 carbon atoms and substituted with a fluorine atom, or an alkylene group having 3 to 12 carbon atoms in which one CH₂ group or two or more CH₂ groups not adjacent to each other existing in the alkylene group may be substituted with —O— is preferred, from the viewpoint of alignment performance.

In the general formulae (2-1) to (2-7), X²¹¹ to X²⁷⁶ each independently represent —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C— or a single bond, and plural X²¹¹'s to X²⁷⁶'s, if any, each may be the same or different. From the viewpoint of easy availability of raw materials and easiness in synthesis, those plural groups, if any, may be each independently the same or different, and preferably, each independently represents —O—, —S—, —OCH₂—, —CH₂O—, —COO—, —OCO—, —CO—S—, —S—CO—, —O—CO—O—, —CO—NH—, —NH—CO—, —COO—CH₂CH₂—, —OCO—CH₂CH₂—, —CH₂CH₂COO—, —CH₂CH₂—OCO— or a single bond, and more preferably each independently represents —O—, —OCH₂—, —CH₂O—, —COO—, —OCO—, —COO—CH₂CH₂—, —OCO—CH₂CH₂—, —CH₂CH₂—COO—, —CH₂CH₂—OCO— or a single bond. Plural X²¹¹'s to X²⁷⁶'s, if any, each may be the same or different, and especially preferably, each represents —O—, —COO—, —OCO— or a single bond.

In the above-mentioned general formulae (2-1) to (2-7), each P—(S—X)— does not contain an —O—O— bond.

In the general formulae (2-1) to (2-7), A²¹¹ to A²⁷² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalane-2,6-diyl group or a 1,3-dioxane-2,5-diyl group, and these groups may be unsubstituted or substituted with one or more substituents, and plural A²¹¹'s to A²⁷²'s, if any, each may be the same or different. From the viewpoint of easy availability of raw materials and easiness in synthesis, preferably, A²¹¹ to A²⁷² each are independently a 1,4-phenylene group, a 1,4-cyclohexylene group or a naphthalene-2,6-diyl group that is unsubstituted or may be substituted with one or more substituents of L¹ and L², and each is more preferably a group selected from the following formulae (A-1) to (A-16):

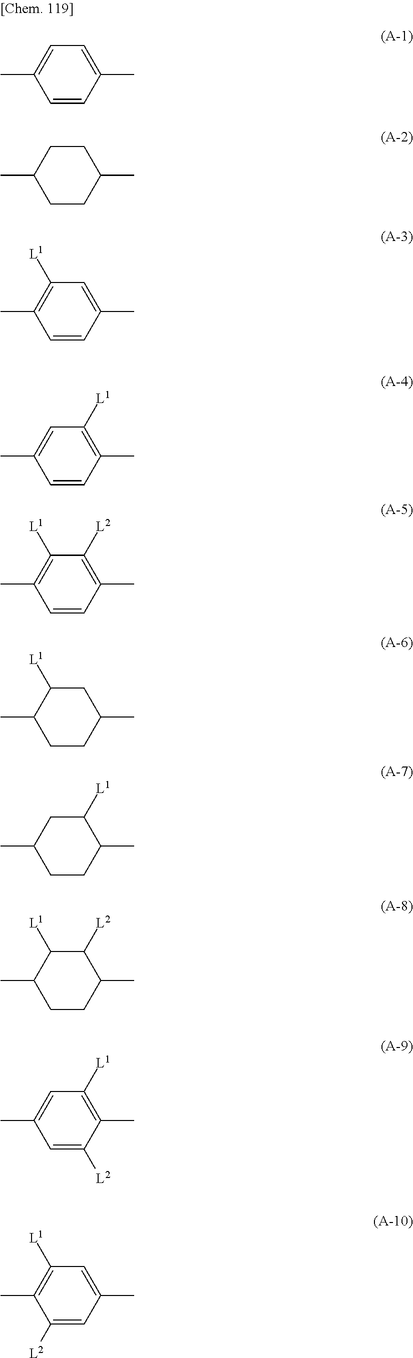

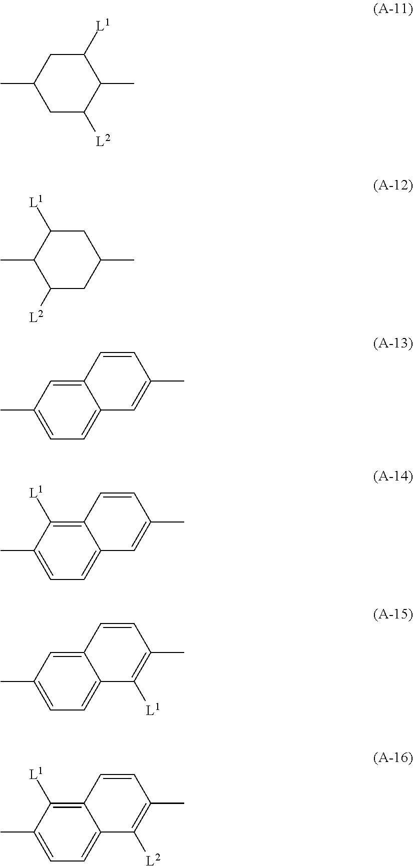

more preferably, each is a group selected from the formulae (A-1) to (A-13), and especially preferably each is a group selected from the formulae (A-1) to (A-4).

In the general formulae (2-1) to (2-7), Z²¹¹ to Z²⁷¹ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C— or a single bond. From the viewpoint of easy availability of raw materials and easiness in synthesis, preferably, Z²¹¹ to Z²⁷¹ each independently represent —OCH₂—, —CH₂O—, —COO—, —OCO—, —O—CO—O—, —CO—NH—, —NH—CO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —CH═CH—, —CF═CF—, —C≡C— or a single bond; more preferably, Z²¹¹ to Z²⁷¹ each independently represent —OCH₂—, —CH₂O—, —CH₂CH₂—, —COO—, —OCO—, —O—CO—O—, —CO—NH—, —NH—CO—, —CF₂O—, —OCF₂—, —COO—CH₂CH₂—, —OCO—CH₂CH₂—, —CH₂CH₂—COO—, —CH₂CH₂—OCO—, —CH═CH—, —C≡C— or a single bond; even more preferably, Z²¹¹ to Z²⁷¹ each independently represent —CH₂CH₂—, —COO—, —OCO—, —O—CO—O—, —CO—NH—, —NH—CO—, —COO—CH₂CH₂—, —OCO—CH₂CH₂—, —CH₂CH₂—COO—, —CH₂CH₂—OCO— or a single bond, and especially preferably, each independently represent —CH₂CH₂—, —COO—, —OCO— or a single bond.

In the general formula (2-2), the terminal group R²²¹ represents a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO— or —C≡C—, and any hydrogen atom in the alkyl group may be substituted with a fluorine atom. From the viewpoint of the properties of the compound and easiness in synthesis, R³¹ is preferably a hydrogen atom, a fluorine atom, a chlorine atom, a cyano group, or a linear or branched alkyl group having 1 to 12 carbon atoms in which one —CH₂— or two or more (—CH₂—)'s not adjacent to each other may be each independently substituted with —O—, —COO—, —OCO— or —O—CO—O—, more preferably a hydrogen atom, a fluorine atom, a chlorine atom, a cyano group, or a linear alkyl group or a linear alkoxy group having 1 to 12 carbon atoms, and is especially preferably a linear alkyl group or a linear alkoxy group having 1 to 12 carbon atoms.

In the above-mentioned general formulae (A-1) to (A-16), the substituents L¹ and L² each independently represent a fluorine atom, a chlorine atom, a bromine atom, an iodine atom, a pentafluorosulfuranyl group, a nitro group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, and any hydrogen atom in the alkyl group may be substituted with a fluorine atom, or the substituents each represent a group represented by the above-mentioned general formula (2-b). From the viewpoint of the properties of the compounds and easiness in synthesis, preferably, L² represents a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which any hydrogen atom may be substituted with a fluorine atom, and one —CH₂— or two or more (—CH₂—)'s not adjacent to each other therein may be each independently substituted with —O—, —S—, —CO—, —COO—, —OCO—, —O—CO—O—, —CH═CH—, —CF═CF— or —C≡C—; more preferably, each is a fluorine atom, a chlorine atom, or a linear or branched alkyl group having 1 to 12 carbon atoms in which any hydrogen atom may be substituted with a fluorine atom, and one —CH₂— or two or more (—CH₂—)'s not adjacent to each other therein may be each independently substituted with —O—, —COO— or —OCO—; even more preferably, each is a fluorine atom, a chlorine atom, or a linear or branched alkyl or alkoxy group having 1 to 12 carbon atoms in which any hydrogen atom may be substituted with a fluorine atom; and especially preferably each is a fluorine atom, a chlorine atom, or a linear alkyl group or a linear alkoxy group having 1 to 8 carbon atoms.

In the general formulae (2-1) to (2-7), n211 to n276 each independently represent an integer of 0 to 6, but from the viewpoint of the properties of the compound, easy availability of raw materials and easiness in synthesis, each preferably represents an integer of 0 to 4, more preferably an integer of 0 to 2, and especially preferably 0 or 1.

Specifically, the compounds represented by the general formula (2-1) are preferably compounds represented by the following general formulae (2-1-1) to (2-1-8):

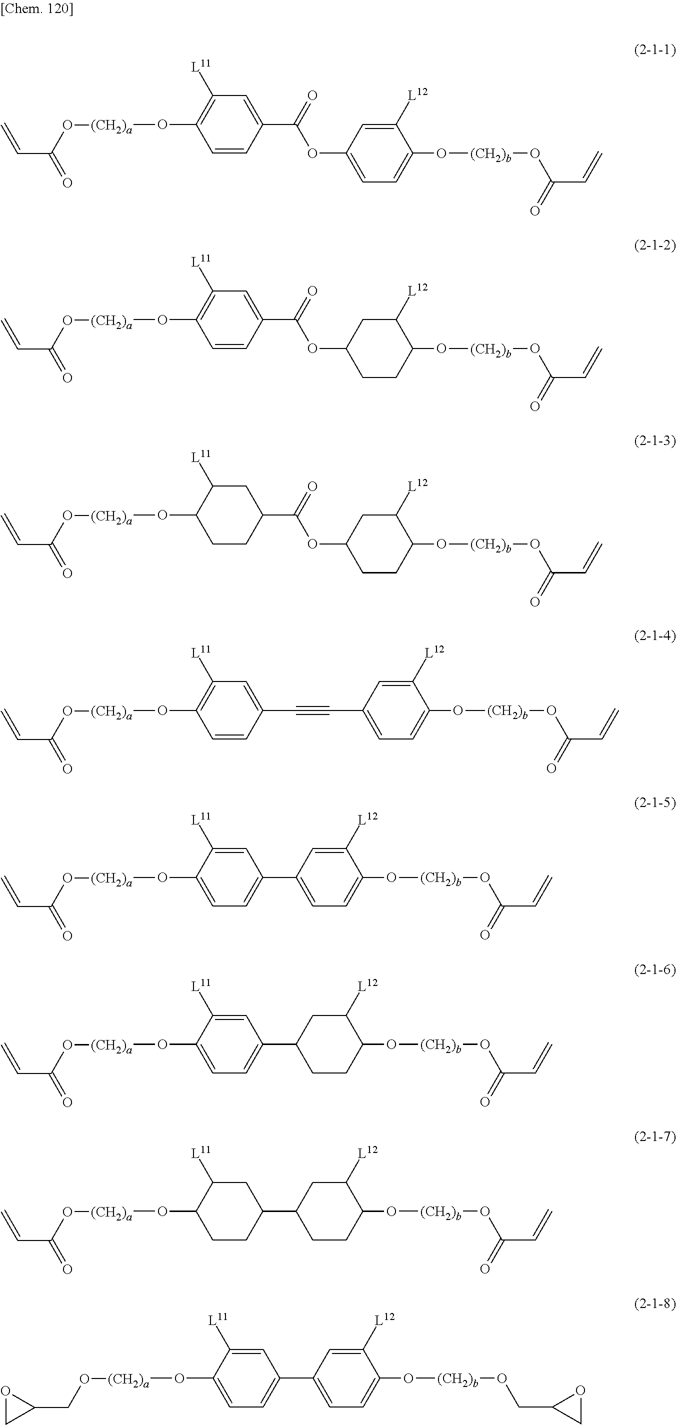

(wherein a and b each independently represent an integer of 1 to 18, L¹¹ and L¹² each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups are an alkyl group having 1 to 6 carbon atoms or an alkoxy group having 1 to 6 carbon atoms, the hydrogen atoms bonding to the alkyl group or the alkoxy group may be unsubstituted, or may be substituted with one or two or more halogen atoms). These compounds may be used alone or may be used as a mixture of two or more of them.

Specifically, the compounds represented by the general formula (2-2) are preferably compounds represented by the following general formulae (2-2-1) to (2-2-6):

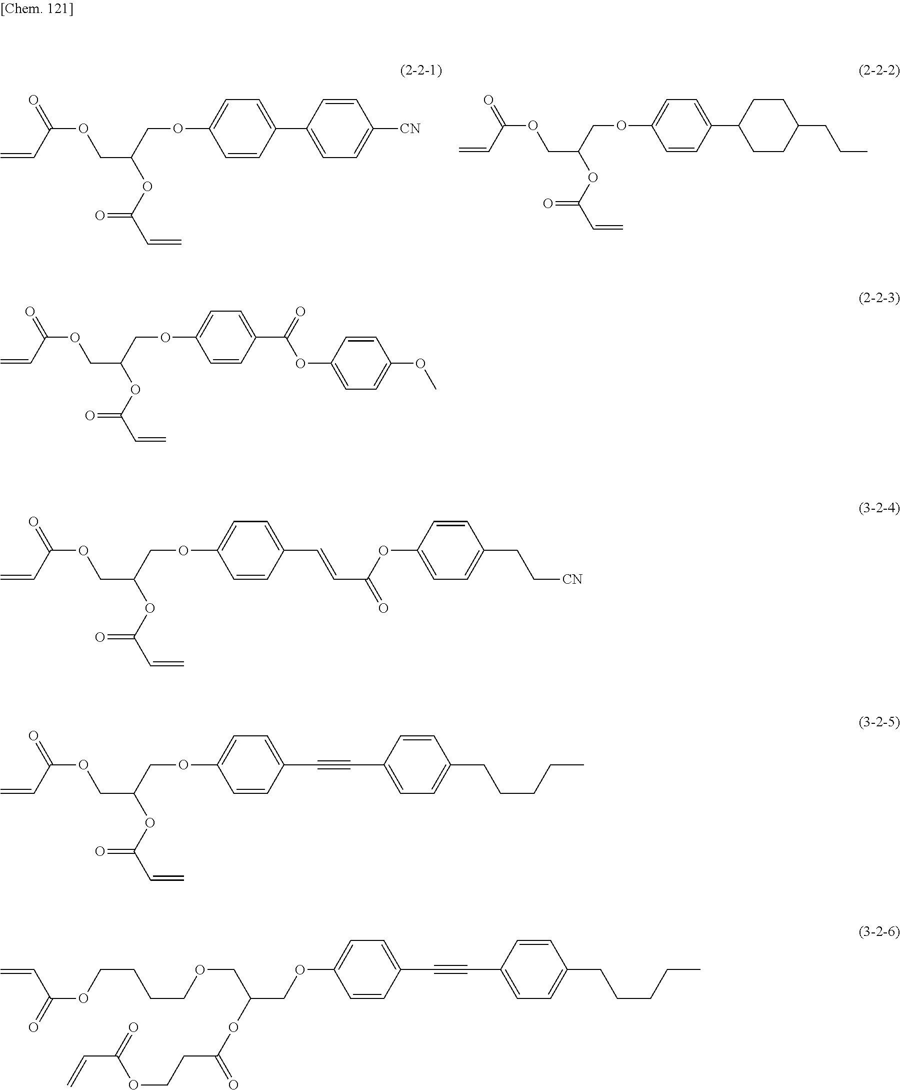

These compounds may be used alone or may be used as a mixture of two or more of them.

Specifically, the compounds represented by the general formula (2-3) are preferably compounds represented by the following general formulae (2-3-1) to (2-3-4):

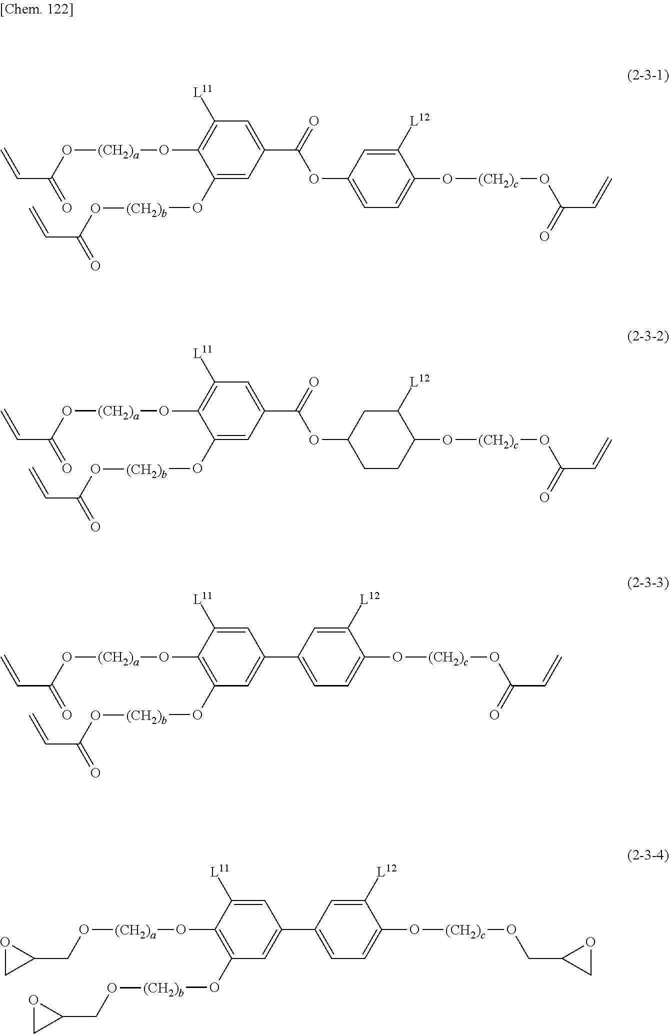

(wherein a, b and c each independently represent an integer of 1 to 18, L¹¹ and L¹² each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups are an alkyl group having 1 to 6 carbon atoms or an alkoxy group having 1 to 6 carbon atoms, the hydrogen atoms bonding to the alkyl group or the alkoxy group may be unsubstituted, or may be substituted with one or two or more halogen atoms). These compounds may be used alone or may be used as a mixture of two or more of them.

Specifically, the compounds represented by the general formula (2-4) are preferably compounds represented by the following general formulae (2-4-1) to (2-4-4):

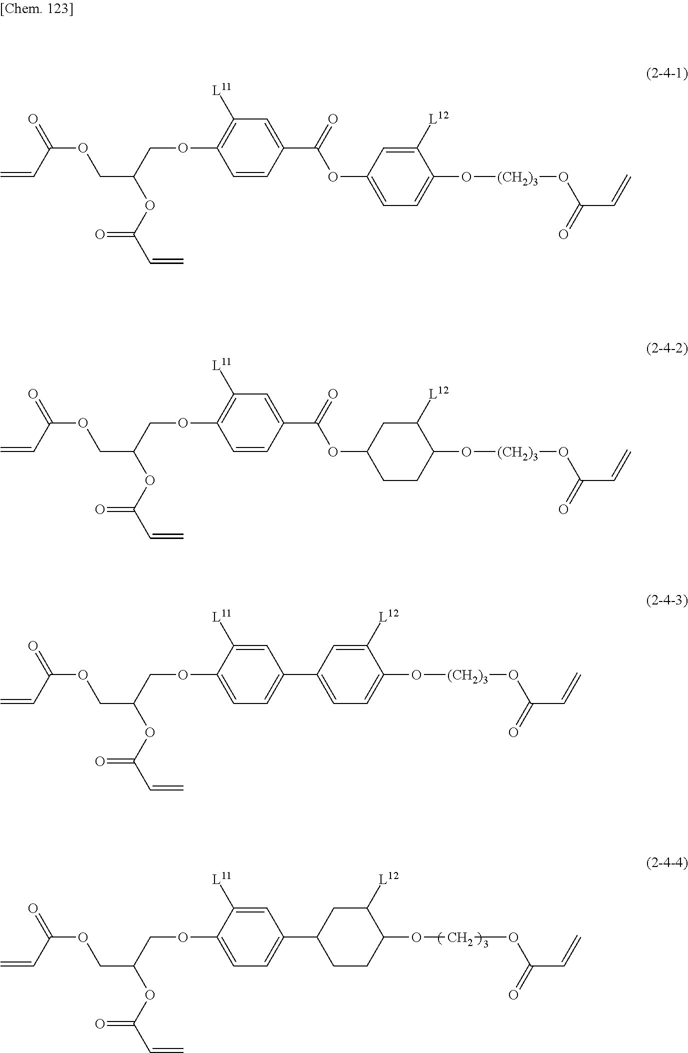

(wherein a each independently represents an integer of 1 to 18, L¹¹ and L¹² each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups are an alkyl group having 1 to 6 carbon atoms or an alkoxy group having 1 to 6 carbon atoms, the hydrogen atoms bonding to the alkyl group or the alkoxy group may be unsubstituted, or may be substituted with one or two or more halogen atoms). These compounds may be used alone or may be used as a mixture of two or more of them.

Specifically, the compounds represented by the general formula (2-5) are preferably compounds represented by the following general formulae (2-5-1) to (2-5-8):

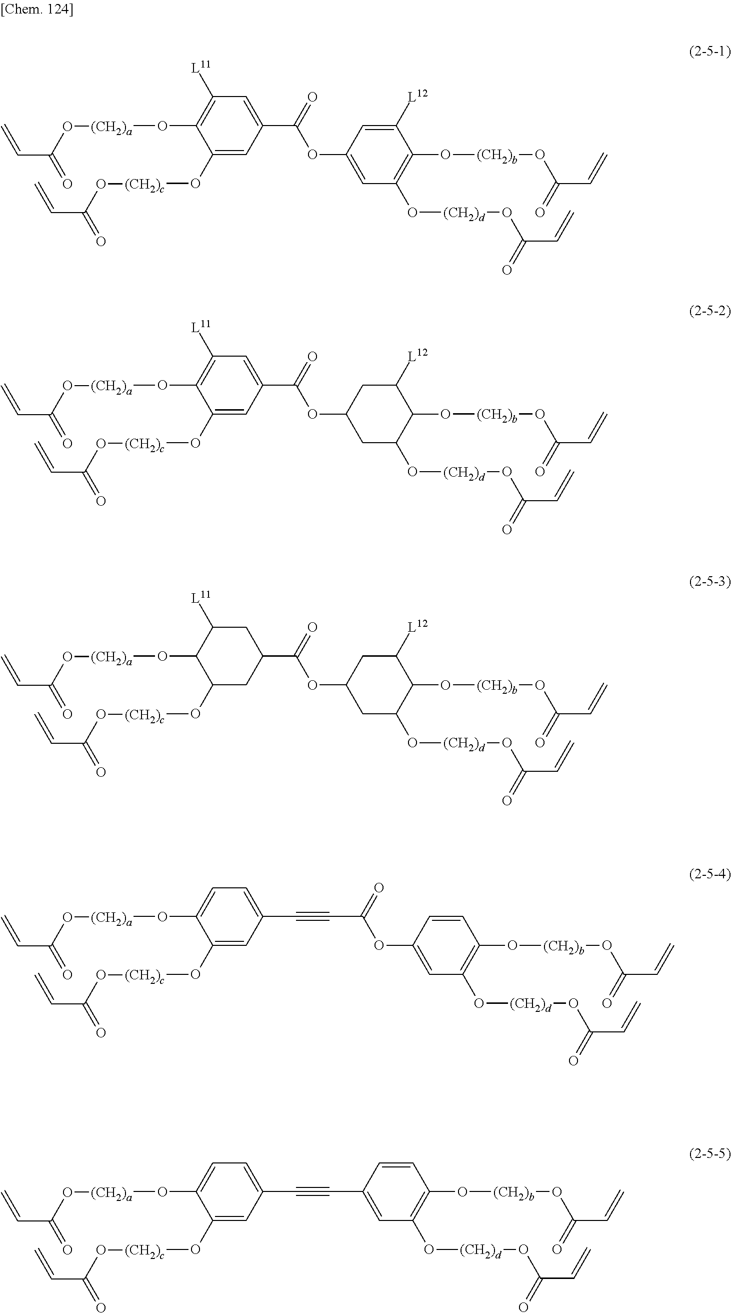

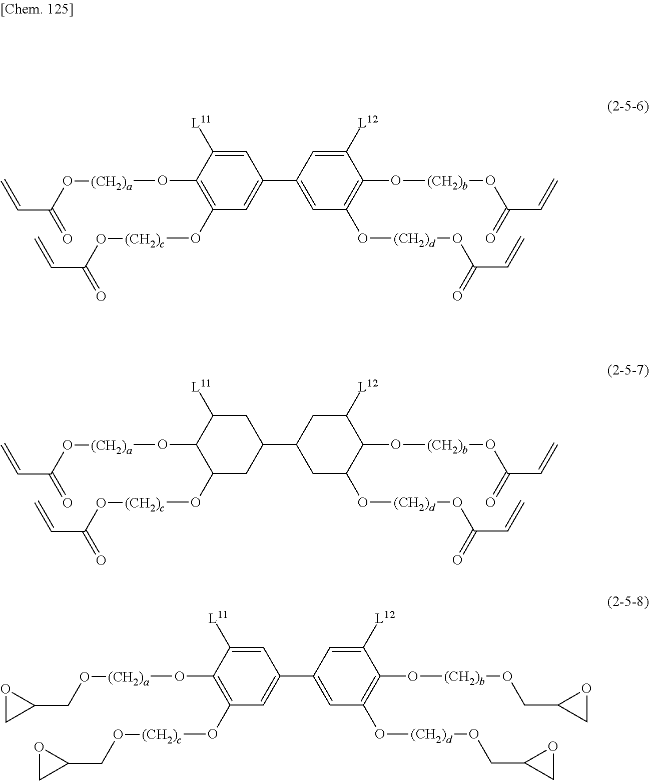

(wherein a, b, c and d each independently represent an integer of 1 to 18, L¹¹ and L¹² each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups are an alkyl group having 1 to 6 carbon atoms or an alkoxy group having 1 to 6 carbon atoms, the hydrogen atoms bonding to the alkyl group or the alkoxy group may be unsubstituted, or may be substituted with one or two or more halogen atoms). These compounds may be used alone or may be used as a mixture of two or more of them.

Specifically, the compounds represented by the general formula (2-6) are preferably compounds represented by the following general formulae (2-6-1) to (2-6-3):

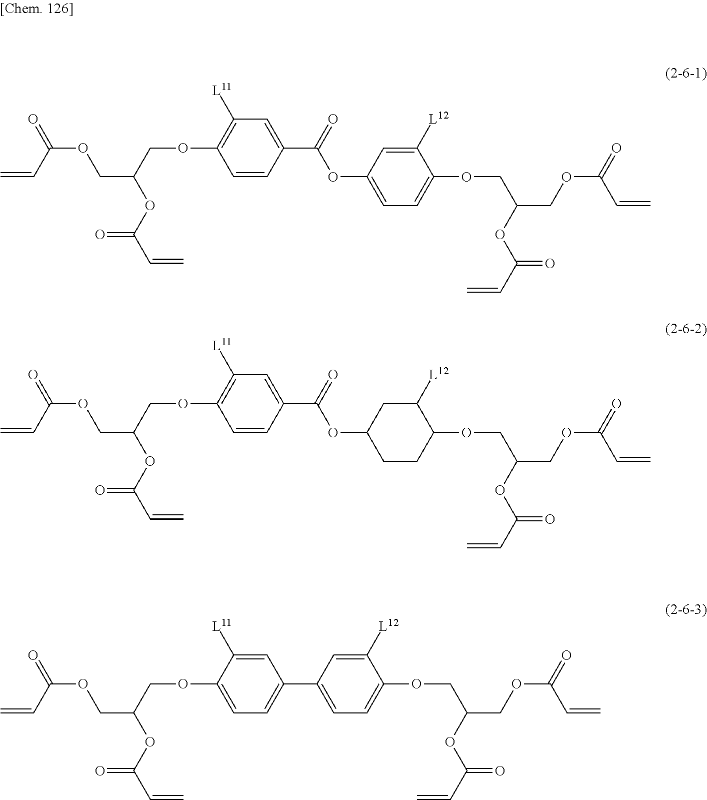

(wherein L¹¹ and L¹² each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. In the case where these groups are an alkyl group having 1 to 6 carbon atoms or an alkoxy group having 1 to 6 carbon atoms, the hydrogen atoms bonding to the alkyl group or the alkoxy group may be unsubstituted, or may be substituted with one or two or more halogen atoms). These compounds may be used alone or may be used as a mixture of two or more of them.

Specifically, the compounds represented by the general formula (2-7) are preferably compounds represented by the following general formulae (2-7-1) to (2-7-8):

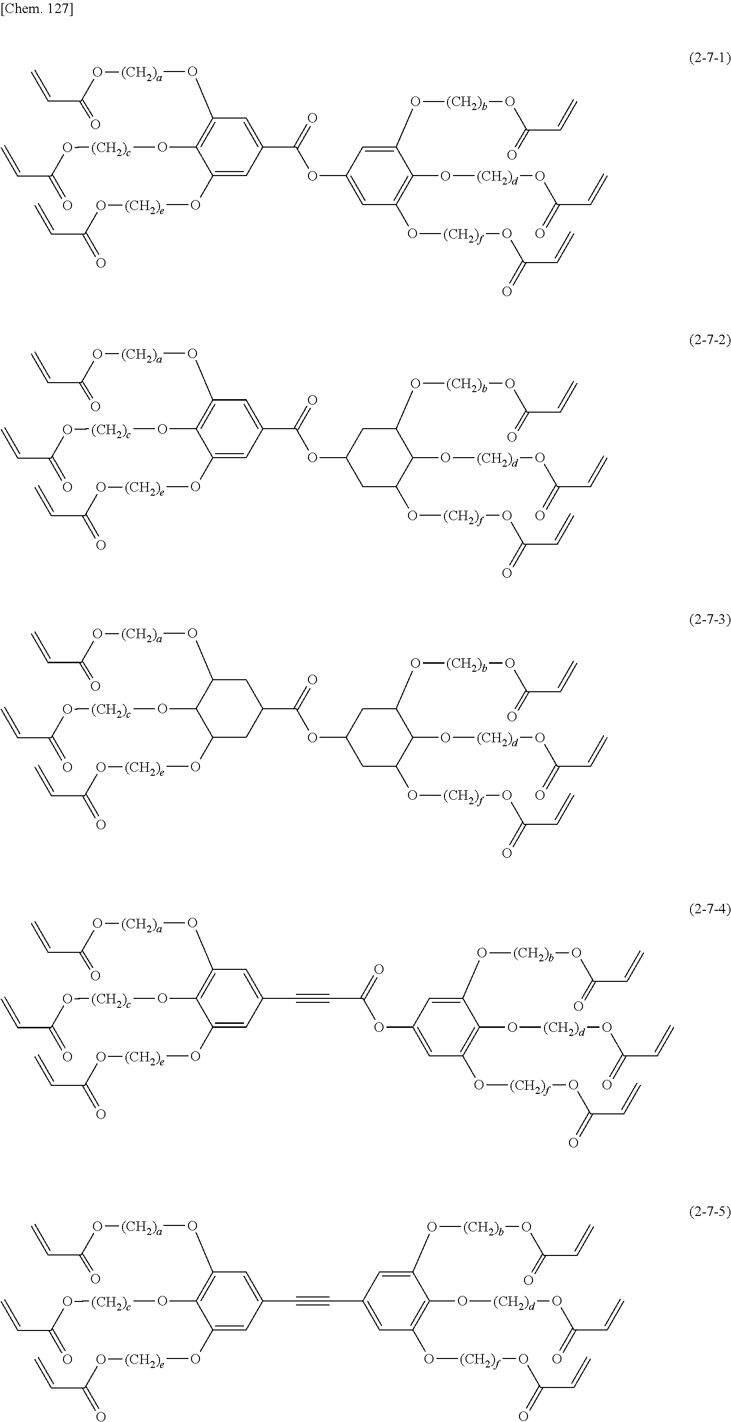

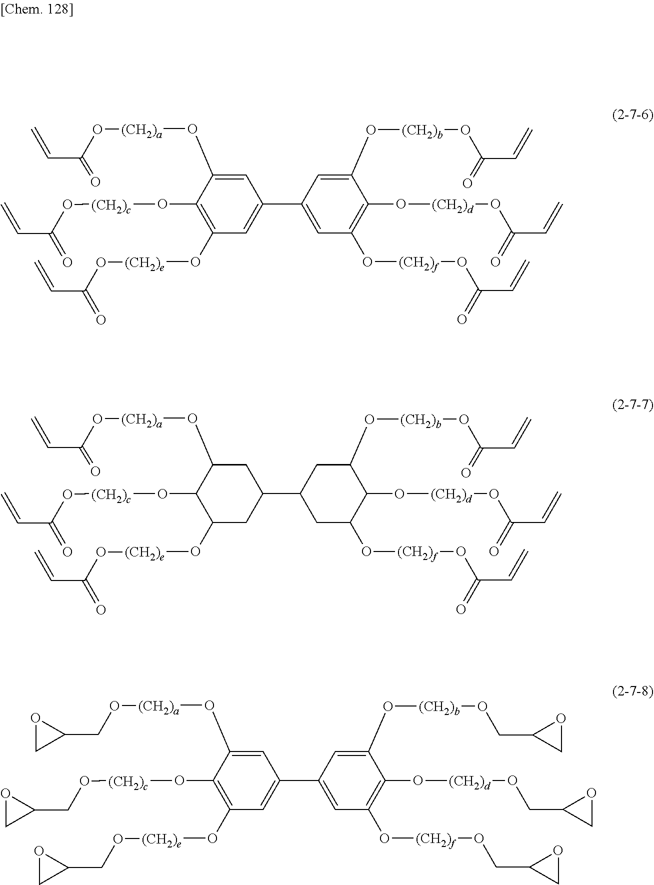

(wherein a, b, c, d, e and f each independently represent an integer of 1 to 18). These compounds may be used alone or may be used as a mixture of two or more of them.

### (Monofunctional Polycyclic Polymerizable Compound)

The compound to be used in constituting the polymer that the gas-selective permeable membrane of the present invention contains may use, as a polymerizable compound, a compound having one polymerizable group, a hard segment having 2 or more cyclic structures, and optionally a soft segment (hereinafter referred to as a monofunctional polycyclic polymerizable compound in the present invention). The monofunctional polycyclic polymerizable compound has, in the compound, one polymerizable functional group, and a hard segment in which the rings bond to each other via a linking group, and in the compound, the polymerizable functional group may directly bond to the ring, or the ring bonds to the soft segment and the polymerizable functional group bonds to the ring via the soft segment.

Specifically, the monofunctional polycyclic polymerizable compound of the present invention is represented by the following general formula (3):

[Chem. 125]

P³¹-Sf³¹-HD³-Sf³² (3)

(wherein Sf³¹ and Sf³² each independently represent a soft segment, P³ⁱ represents a polymerizable group, HD³ represents a hard segment having 2 or more cyclic structures).

P³¹ includes radical-polymerizable ones and cationic-polymerizable ones.

P³¹ may be any polymerizable group capable of undergoing polymerization reaction with a thermal initiator, a photoinitiator, or heat or active energy rays, and preferably, each is independently a polymerizable group selected from the following formulae (P-1) to (P-20):

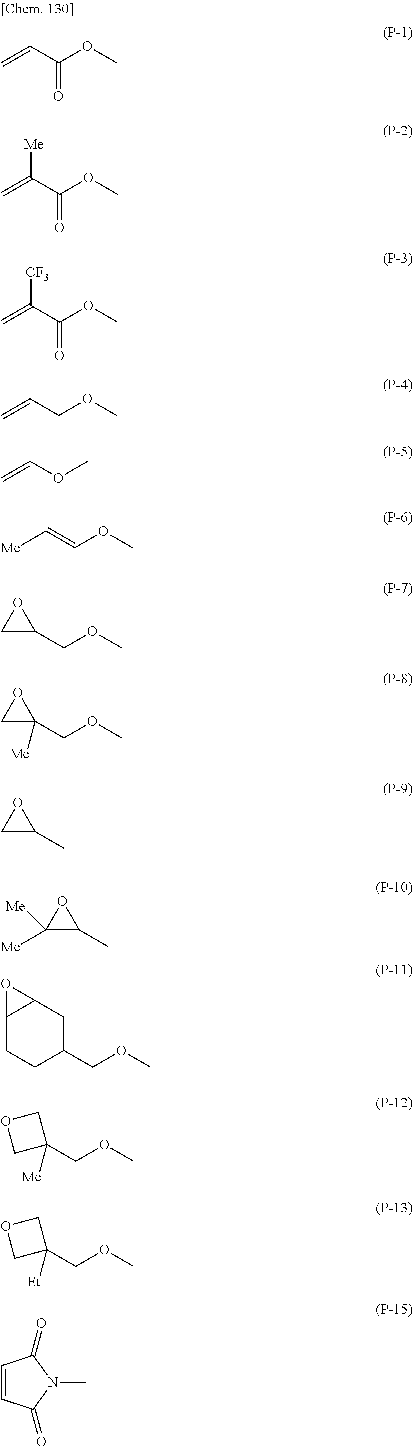

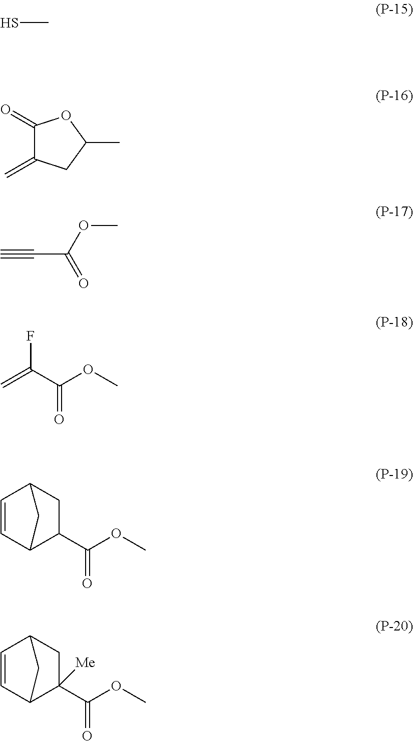

(The above Me represents a methyl group, and Et represents an ethyl group.) In particular, when UV polymerization is employed for the polymerization method, the formula (P-1), (P-2), (P-3), (P-4), (P-5), (P-7), (P-11), (P-13), (P-15) or (P-18) is preferred; the formula (P-1), (P-2), (P-7), (P-11) or (P-13) is more preferred; the formula (P-1), (P-2) or (P-3) is even more preferred; and the formula (P-1) or (P-2) is especially preferred.

Preferably, Sf³¹ represents a single bond or an alkylene group having 1 to 18 carbon atoms (in which one or two or more hydrogen atoms bonding to the alkylene group may be each independently substituted with a halogen atom, a group CN, an alkyl group having 1 to 8 carbon atoms, or an alkylene group having 1 to 8 carbon atoms and having a polymerizable functional group, and one CH₂ group or two or more CH₂ groups not adjacent to each other existing in this group may be mutually independently substituted with —O—, —S—, —NH—, —N(CH₃)—, —CO—, —COO—, —OCO—, —OCOO—, —SCO—, —COS—, —CF₂O—, —OCF₂—, —CF₂S—, —SCF₂—, —CH═CH—, or —C≡C— in the form where the oxygen atoms do not mutually directly bond to each other).

Preferably, Sf³² represents a hydrogen atom, a halogen atom, a cyano group, a nitro group, an isocyanuric group, a thioisocyanuric group, an alkyl group having 1 to 18 carbon atoms, an alkoxy group, an alkanoyl group, an alkanoyloxy group, a carbamoyl group, a sulfamoyl group, an alkenyl group having 2 to 8 carbon atoms, an alkenyloxy group, an alkenoyl group, or an alkenoyloxy group, and the group may be substituted with one or more substituents of a halogen atom or CN, and one CH₂ group or 2 or more CH₂ groups not adjacent to each other existing in the group may be each mutually independently substituted with —O—, —S—, —NH—, —N(CH₃)—, —CO—, —COO—, —OCO—, —OCOO—, —SCO—, —COS— or —C≡C— in the form where the oxygen atoms do not directly bond to each other.

In HD³, two or more cyclic structures may bond to each other via a linking group and/or a single bond as so mentioned above. The cyclic structure includes 3-membered to 8-membered rings, hetero rings and condensed rings, and one or two or more hydrogen atoms bonding to each ring may be each independently substituted with a substituent.

More specifically, HD³ is preferably a hard segment represented by the following general formula (3-a):

[Chem. 131]

-(A³¹-Z³¹)ₗ₃-(A³²-Z³²)ₘ₃-(A³³-Z³³)ₖ₃-A³⁴-Z³⁴-A³⁵^{^{−}} (3-a)

(In this, A³¹, A³², A³³, A³⁴ and A³⁵ each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalane-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, these groups may have one or more substituents of F, Cl, CF₃, OCF₃, a CN group, a nitro group, an alkyl group having 1 to 8 carbon atoms, an alkoxy group, an alkanoyl group, an alkanoyloxy group, a carbamoyl group, a sulfamoyl group, an alkenyl group having 2 to 8 carbon atoms, an alkenyloxy group, an alkenoyl group and an alkanoyloxy group, Z0, Z1, Z2, Z3, Z4 and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms and optionally having a halogen atom, or a single bond, one or two or more hydrogen atoms bonding to the ring of A³¹, A³², A³³, A³⁴ and A³⁵ may be each independently substituted with a substituent L^{HD3}, the substituent L^{HD3} includes F, Cl, CF₃, OCF₃, a CN group, a nitro group, an alkyl group having 1 to 8 carbon atoms, an alkoxy group having 1 to 8 carbon atoms, an alkanoyl group, an alkanoyloxy group, a carbamoyl group, a sulfamoyl group, an alkenyl group having 2 to 8 carbon atoms, an alkenyloxy group having 2 to 8 carbon atoms, an alkenoyl group and an alkenoyloxy group.

Preferably, A³¹, A³², A³³, A³⁴ and A³⁵ each independently represent a group selected from a 1,4-phenylene group, a 1,4-cyclohexylene group and a 2,6-naphthylene group in which one or two or more hydrogen atoms bonding to the ring may be substituted with the above-mentioned substituent L^{HD3}, and more preferably each independently represents a group selected from a 1,4-phenylene group, a 1,4-cyclohexylene group or a 2,6-naphthylene group.

Z³¹, Z³², Z³³ and Z³⁴ each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C— or a single bond.

l3, m3 and k3 each independently represent 0 or 1, and 1≤l3+m3+k3≥8.)

More specifically, the monofunctional polycyclic polymerizable compounds represented by the general formula (3) are preferably compounds represented by the following general formula (3-1):

[Chem. 132]

P³¹¹S³¹¹X³¹¹ₙ₃₁A³¹¹-Z³¹¹ⱼ₃₁₁M³¹¹Z³¹²-A³¹²ⱼ₃₁₂R³¹¹ (3-1)

In the above general formula (3-1), P³¹¹ represents a polymerizable group, and is preferably a group selected from the following formulae (P-1) to (P-20):

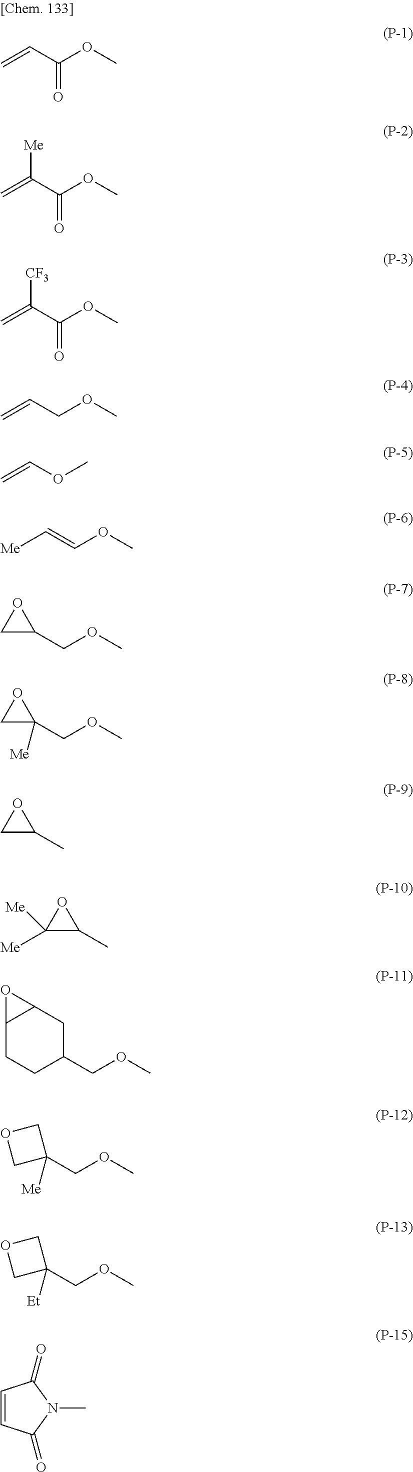

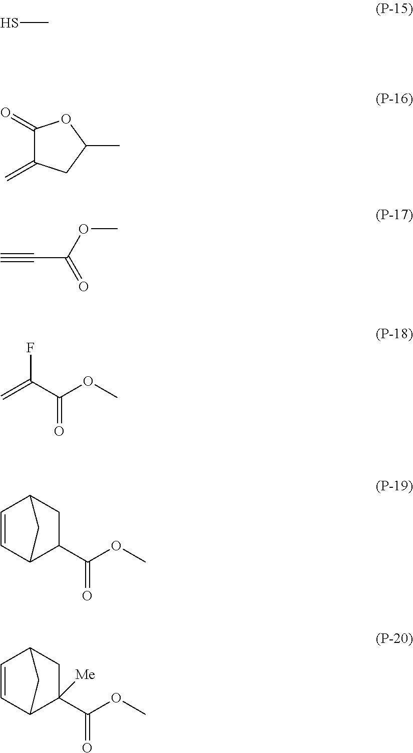

Among these polymerizable groups, from the viewpoint of enhancing polymerizability and storage stability, the formula (P-1), (P-2), (P-7), (P-12), or (P-13) is preferred, the formula (P-1), (P-2), (P-7), or (P-12) is more preferred, and the formula (P-1) or (P-2) is even more preferred.

In the general formula (3-1), —(S³¹¹—X³ⁿ)— each independently represents a soft segment or a single bond.

In the general formula (3-1), S³¹¹ represents a spacer group or a single bond, and plural S³¹¹'s, if any, may be the same or different. The spacer group represents an alkylene group having 1 to 18 carbon atoms, and one or two or more hydrogen atoms bonding to the alkylene group may be each independently substituted with a halogen atom, a group CN, an alkyl group having 1 to 8 carbon atoms, or an alkylene group having 1 to 8 carbon atoms and having a polymerizable functional group, and one CH₂ group or two or more CH₂ groups not adjacent to each other existing in this group may be mutually independently substituted with —O—, —S—, —NH—, —N(CH₃)—, —CO—, —CH(OH)—, —CH(COOH)—, —COO—, —OCO—, —OCOO—, —SCO—, —COS— or —C≡C— in the form where the oxygen atoms do not mutually directly bond to each other. Among these spacer groups, a linear alkylene group having 2 to 8 carbon atoms, an alkylene group having 2 to 6 carbon atoms and substituted with a fluorine atom, or an alkylene group having 3 to 12 carbon atoms in which one CH₂ group or two or more CH₂ groups not adjacent to each other existing in the alkylene group may be substituted with —O— is preferred, from the viewpoint of alignment performance.

In the general formula (3-1), X³¹¹ each independently represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C— or a single bond, and plural X³¹¹'s if any, may be the same or different. From the viewpoint of easy availability of raw materials and easiness in synthesis, those plural groups, if any, may be each independently the same or different, and preferably, each independently represents —O—, —S—, —OCH₂—, —CH₂O—, —COO—, —OCO—, —CO—S—, —S—CO—, —O—CO—O—, —CO—NH—, —NH—CO—, —COO—CH₂CH₂—, —OCO—CH₂CH₂—, —CH₂CH₂—COO—, —CH₂CH₂—OCO— or a single bond, more preferably, each independently represents —O—, —OCH₂—, —CH₂O—, —COO—, —OCO—, —COO—CH₂CH₂—, —OCO—CH₂CH₂—, —CH₂CH₂—COO—, —CH₂CH₂—OCO— or a single bond, and plural X³¹¹'s, if any, may be the same or different, and especially preferably, each independently represents —O—, —COO—, —OCO— or a single bond.

In the above-mentioned general formula (3-1), P³¹¹—(S²¹¹—X³¹¹)— does not contain an —O—O— bond.

In the general formula (3-1), A³¹¹ to A³¹² and M³¹¹ each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalane-2,6-diyl group or a 1,3-dioxane-2,5-diyl group, and these groups may be unsubstituted or substituted with one or more substituents, and plural A³¹¹'s and A³¹²'s, if any, each may be the same or different. From the viewpoint of easy availability of raw materials and easiness in synthesis, preferably, A³¹¹ and A²¹² each are independently a 1,4-phenylene group, a 1,4-cyclohexylene group or a naphthalene-2,6-diyl group that is unsubstituted or may be substituted with one or more substituents of L¹ and L², and each is more preferably a group selected from the following formulae (A-1) to (A-16):

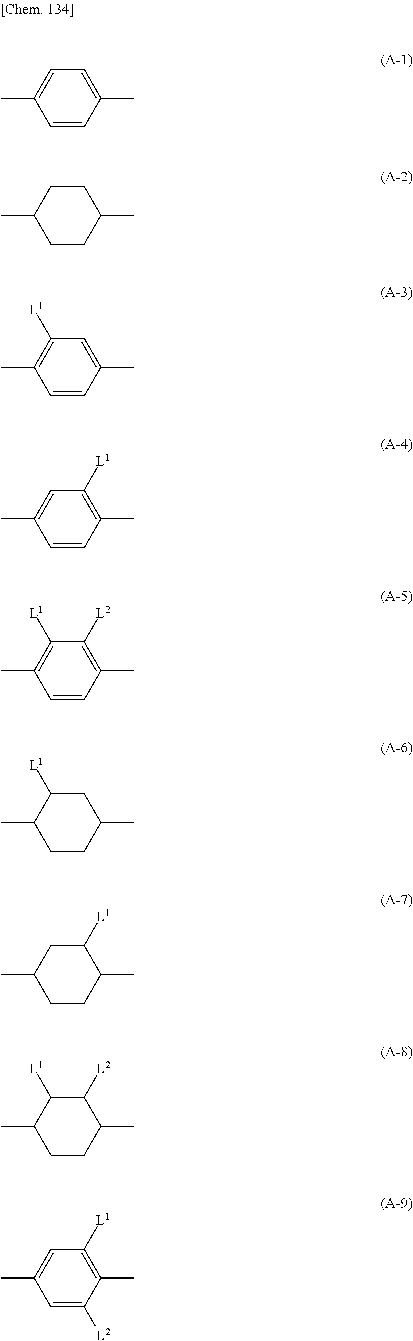

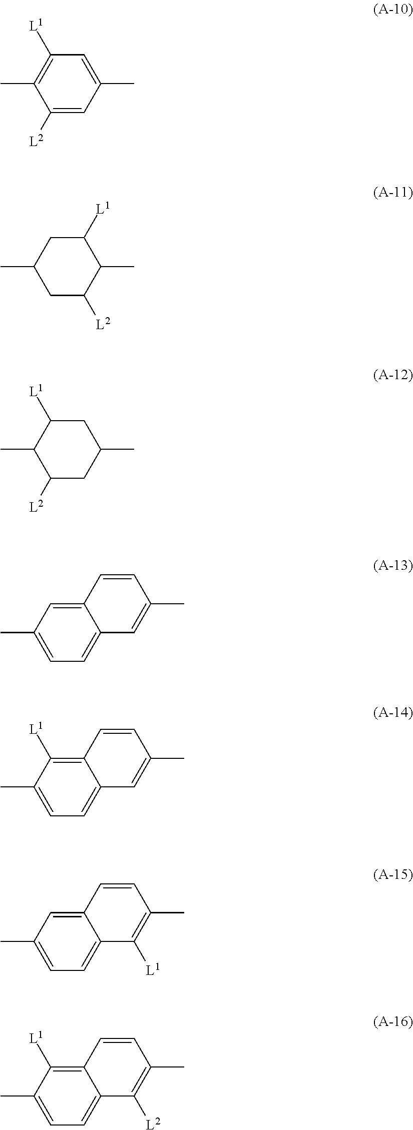

more preferably, each is a group selected from the formulae (A-1) to (A-13), and especially preferably each is a group selected from the formulae (A-1) to (A-4).

In the general formula (3-1), Z³¹¹ to Z³¹² each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C— or a single bond. From the viewpoint of easy availability of raw materials and easiness in synthesis, preferably, Z³¹¹ to Z³¹² each independently represent —OCH₂—, —CH₂O—, —COO—, —OCO—, —O—CO—O—, —CO—NH—, —NH—CO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₅CH₂—, —OCO—CH₂CH₂—, —CH₂CH₂—COO—, —CH₂CH₂—OCO—, —CH═CH—, —CF═CF—, —C≡C— or a single bond; more preferably, Z³¹¹ to Z³¹² each independently represent —OCH₂—, —CH₂O—, —CH₂CH₂—, —COO—, —OCO—, —O—CO—O—, —CO—NH—, —NH—CO—, —CF₂O—, —OCF₂—, —COO—CH₂CH₂—, —OCO—CH₂CH₂—, —CH₂CH₂—COO—, —CH₂CH₂—OCO—, —CH═CH—, —C≡C— or a single bond; even more preferably, Z³¹¹ to Z³¹² each independently represent —CH₂CH₂—, —COO—, —OCO—, —O—CO—O—, —CO—NH—, —NH—CO—, —COO—CH₂CH₂—, —OCO—CH₂CH₂—, —CH₂CH₂—COO—, —CH₂CH₂—OCO— or a single bond, and especially preferably, each independently represents —CH₂CH₂—, —COO—, —OCO— or a single bond.

In the general formula (3-1), the terminal group R³¹¹ represents a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO— or —C≡C—, and any hydrogen atom in the alkyl group may be substituted with a fluorine atom. From the viewpoint of the properties of the compound and easiness in synthesis, R³¹¹ is preferably a hydrogen atom, a fluorine atom, a chlorine atom, a cyano group, or a linear or branched alkyl group having 1 to 12 carbon atoms in which one —CH₂— or two or more (—CH₂—)'s not adjacent to each other may be each independently substituted with —O—, —COO—, —OCO— or —O—CO—O—, more preferably a hydrogen atom, a fluorine atom, a chlorine atom, a cyano group, or a linear alkyl group or a linear alkoxy group having 1 to 12 carbon atoms, and is especially preferably a linear alkyl group or a linear alkoxy group having 1 to 12 carbon atoms.

In the above general formulae (A-1) to (A-16), the substituents L¹ and L² each independently represent a fluorine atom, a chlorine atom, a bromine atom, an iodine atom, a pentafluorosulfuranyl group, a nitro group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more (—CH₂—)'s not adjacent to each other may be each independently substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF— or —C≡C—, and any hydrogen atom in the alkyl group may be substituted with a fluorine atom. From the viewpoint of the properties of the compounds and easiness in synthesis, preferably, the substituents L¹ and L² each independently represent a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which any hydrogen atom may be substituted with a fluorine atom, and one —CH₂— or two or more (—CH₂—)'s not adjacent to each other therein may be each independently substituted with a group selected from —O—, —S—, —CO—, —COO—, —OCO—, —O—CO—O—, —CH═CH—, —CF═CF— or —C≡C—; more preferably, each is a fluorine atom, a chlorine atom, or a linear or branched alkyl group having 1 to 12 carbon atoms in which any hydrogen atom may be substituted with a fluorine atom, and one —CH₂— or two or more (—CH₂—)'s not adjacent to each other therein may be each independently substituted with —O—, —COO— or —OCO—; even more preferably, each is a fluorine atom, a chlorine atom, or a linear or branched alkyl or alkoxy group having 1 to 12 carbon atoms in which any hydrogen atom may be substituted with a fluorine atom; and especially preferably each is a fluorine atom, a chlorine atom, or a linear alkyl group or a linear alkoxy group having 1 to 8 carbon atoms.

In the general formula (3-1), n31 each independently represents an integer of 0 to 6, but from the viewpoint of the properties of the compound, easy availability of raw materials and easiness in synthesis, each preferably represents an integer of 0 to 4, more preferably an integer of 0 to 2, and especially preferably 0 or 1.

In the general formula (3-1), j311 and j312 each independently represent an integer of 0 to 5, and j311+j312 represents an integer of 2 to 7. From the viewpoint of easiness in synthesis and storage stability, preferably, j311 and j312 each are independently an integer of 1 to 4, more preferably an integer of 1 to 3, and especially preferably 1 or 2. j311+j312 is preferably an integer of 2 to 4, more preferably 2 or 3.

Specifically, the compounds represented by the general formula (3-1) are preferably compounds represented by the following general formulae (3-1-1) to (3-1-44):

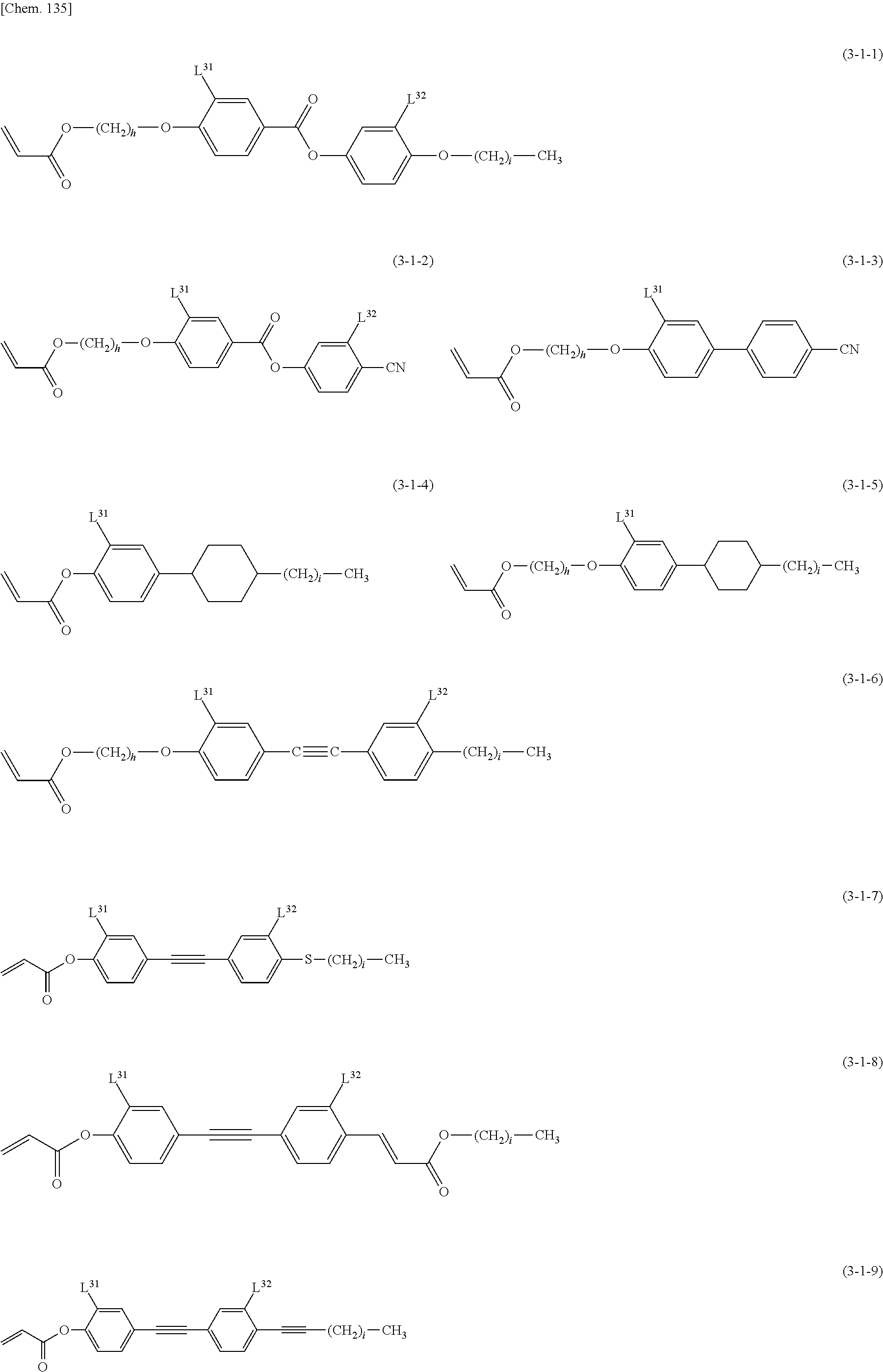

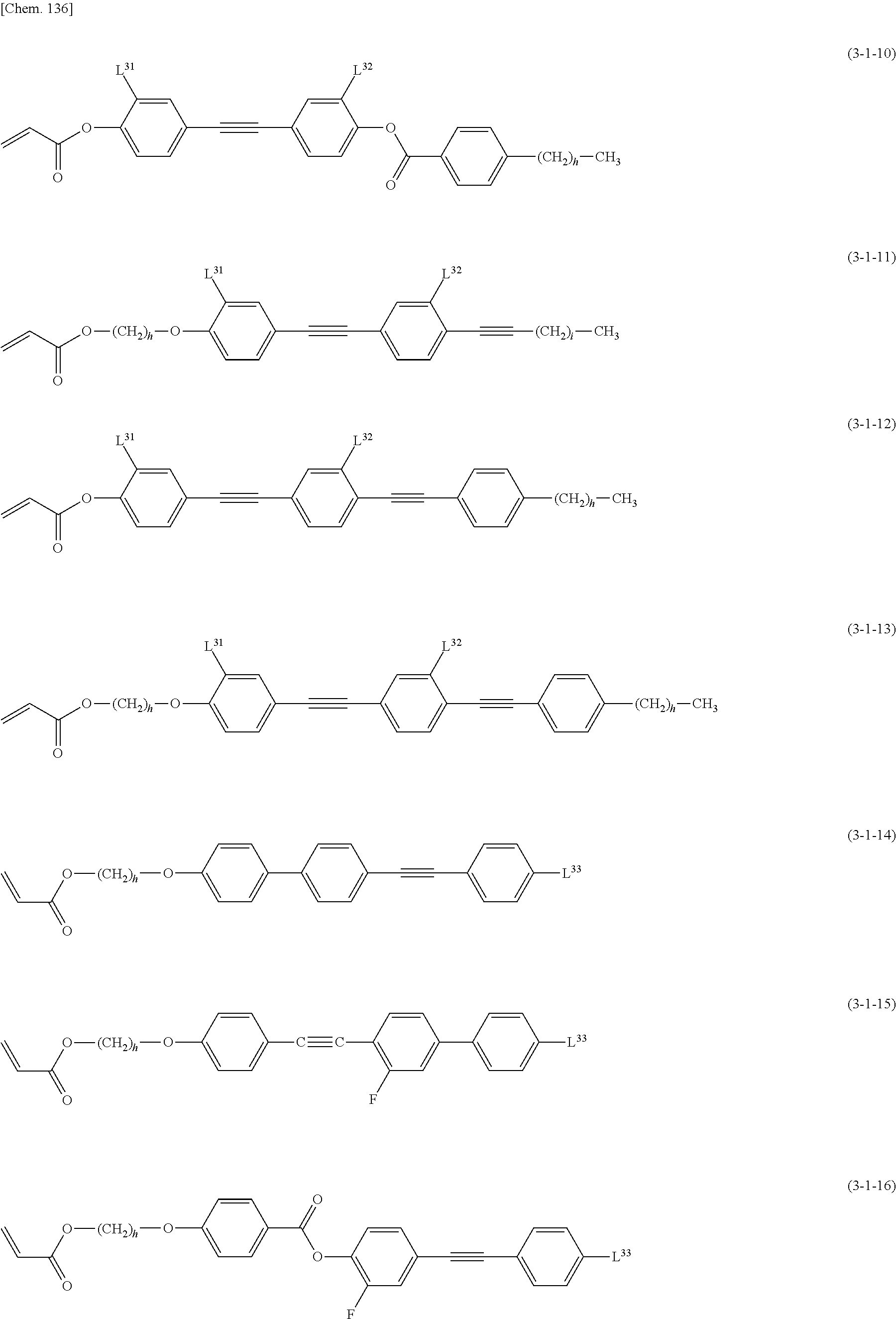

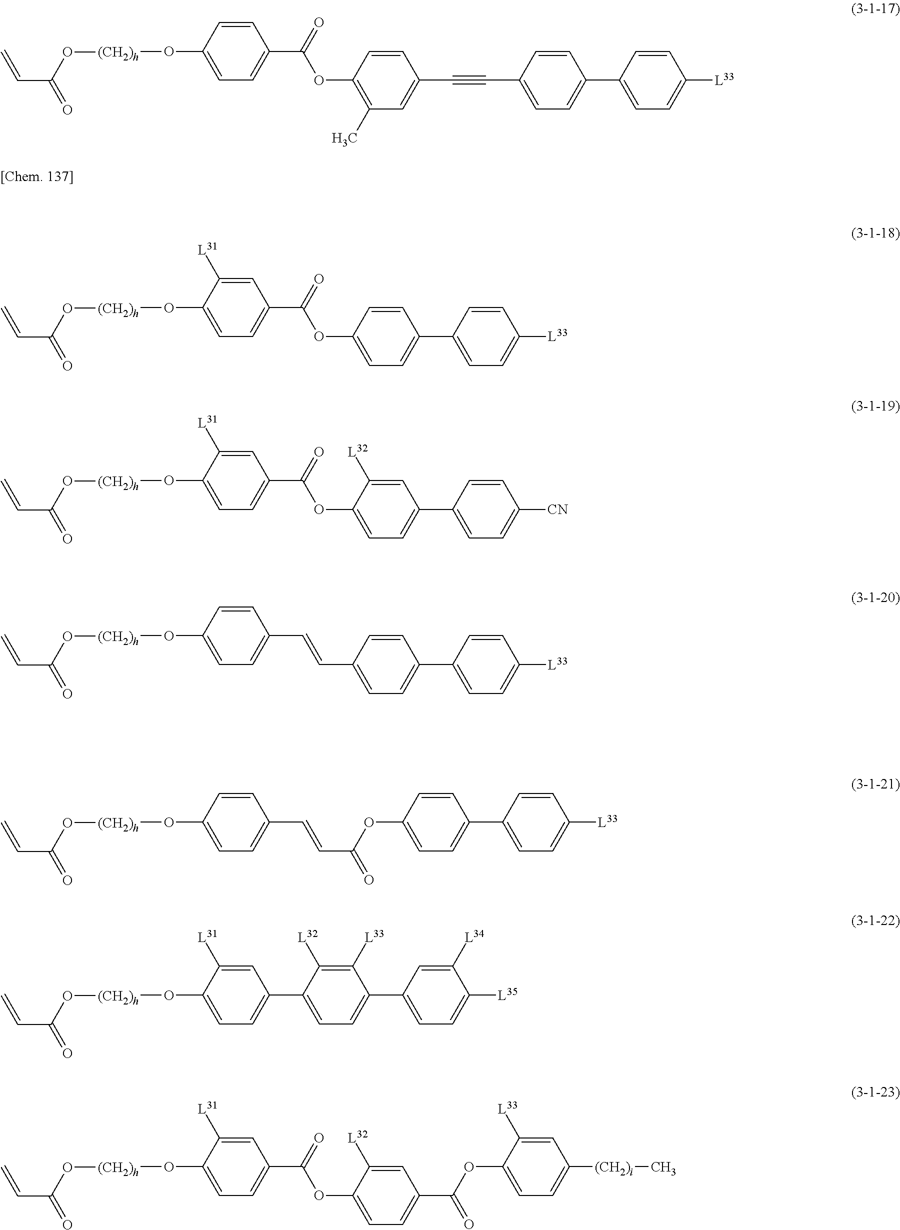

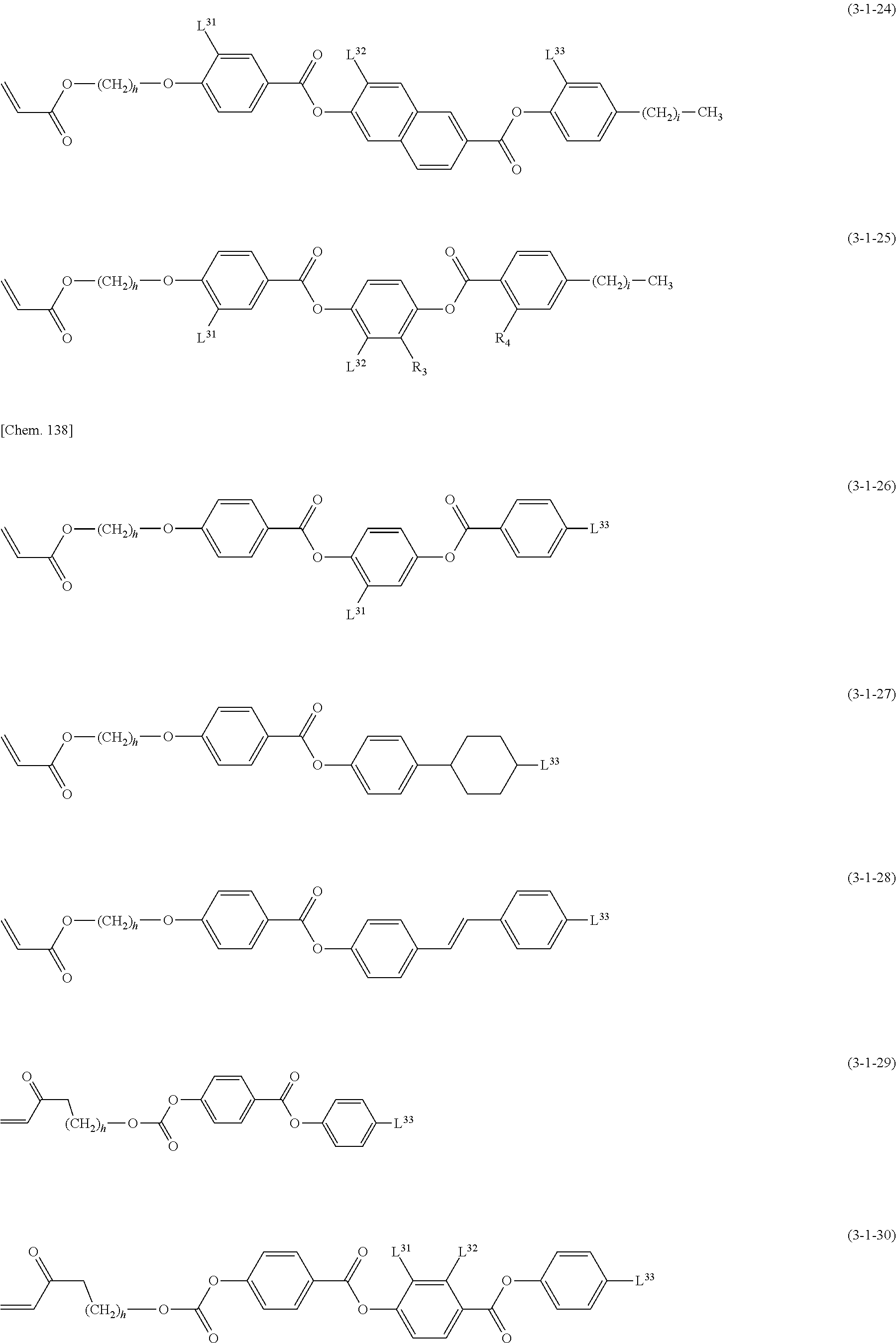

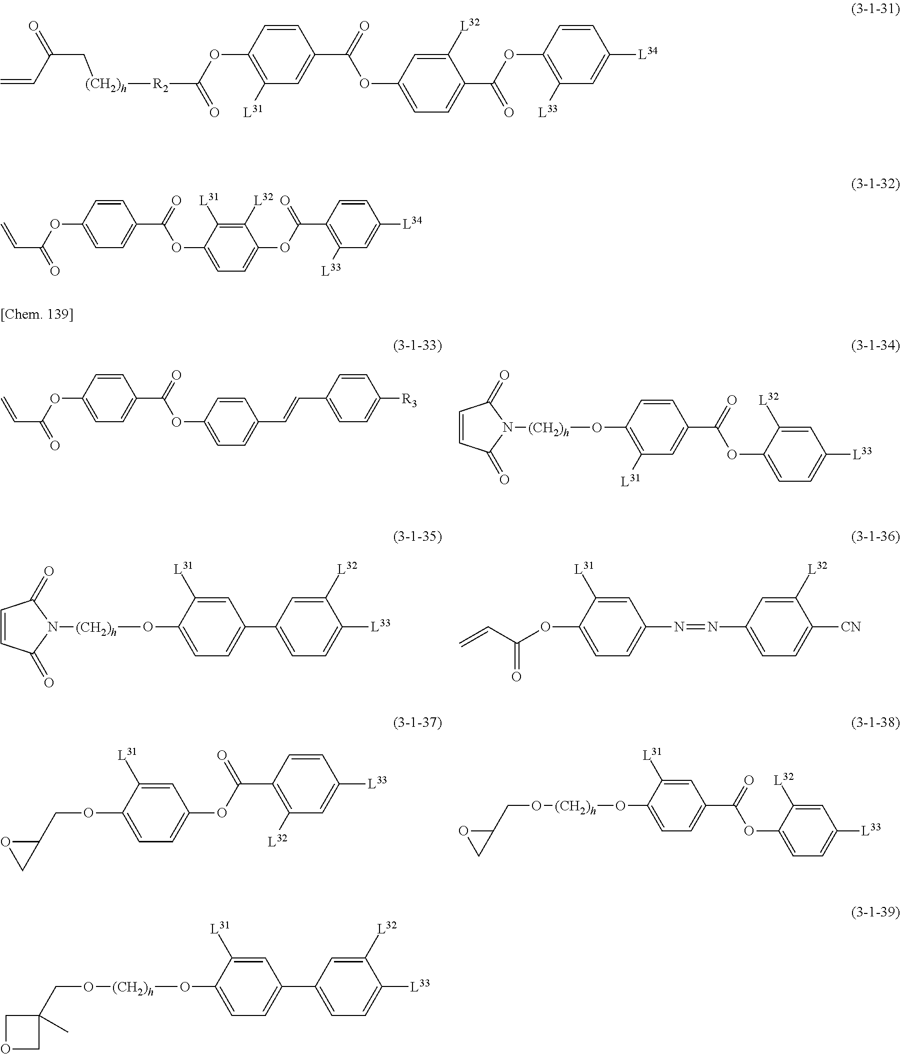

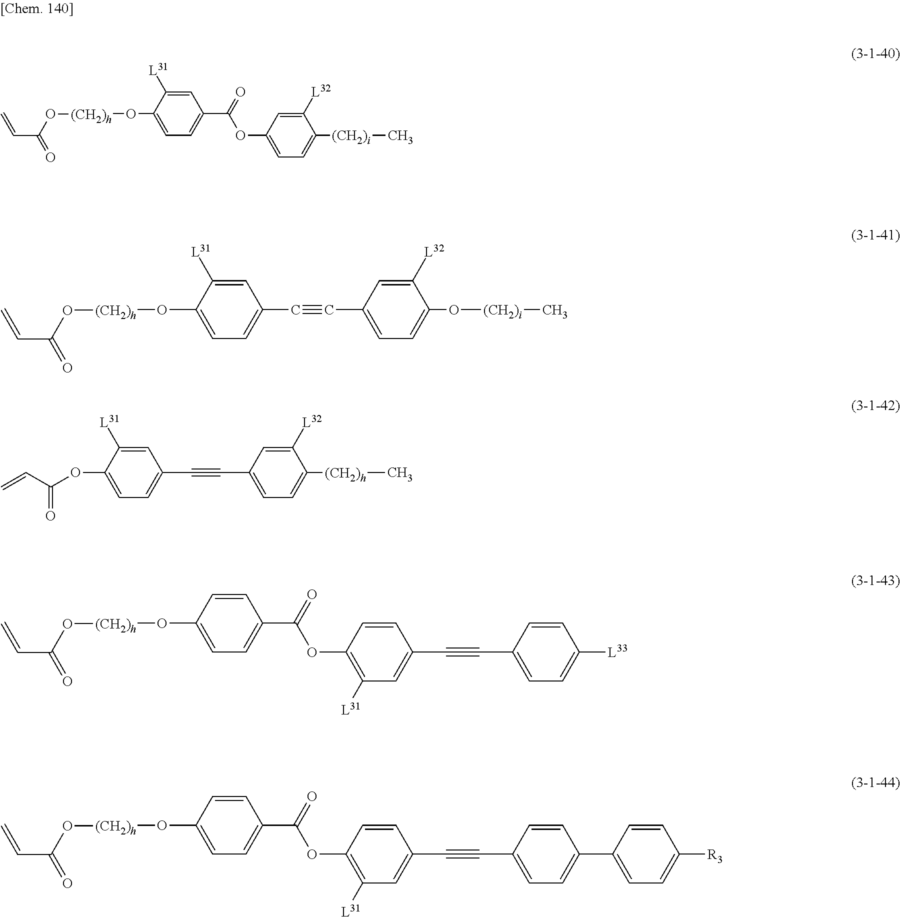

(In the above formulae, h and I each independently represent an integer of 1 to 18, L³¹, L³², L³³ and L³⁴ each independently represent a hydrogen atom, a fluorine atom, a chlorine atom, a bromine atom, an iodine atom, a nitro group, a cyano group, an isocyano group, a carboxyl group, a carbamoyl group, an amino group, a hydroxyl group, a mercapto group, a methylamino group, a dimethylamino group, a trimethylsilyl group, an alkyl group having 1 to 6 carbon atoms, or an alkoxy group having 1 to 6 carbon atoms. When these groups are an alkyl group having 1 to 6 carbon atoms or an alkoxy group having 1 to 6 carbon atoms, the hydrogen atoms bonding to the alkyl group or the alkoxy group may be unsubstituted or substituted with one or two or more halogen atoms.) These compounds may be used alone or may be used as a mixture of two or more of them.

### (Polymerization Initiator)

The composition to be used in constituting the polymer that the gas-selective permeable membrane of the present invention contains may optionally use a polymerization initiator. The polymerization initiator is used for polymerizing the composition. The photopolymerization initiator to be used in the case where the polymerization is carried out by photoirradiation may be, though not specifically limited thereto, any known conventional one not interfering with the molecular alignment of the compound in the polyfunctional polycyclic polymerizable compound-containing composition.

For example, the polymerization initiator includes 1-hydroxycyclohexyl phenyl ketone “Irgacure 184”, 1-(4-isopropylphenyl)-2-hydroxy-2-methylpropan-1-one “Darocure 1116”, 2-methyl-1-[(methylthio)phenyl]-2-morpholinopropane-1 “Irgacure 907”, 2,2-dimethoxy-1,2-diphenylethan-1-one “Irgacure 651”, 2-benzyl-2-dimethylamino-1-(4-morpholinophenyl)butanone “Irgacure 369”, 2-dimethylamino-2-(4-methylbenzyl)-1-(4-morpholino-phenyl) butan-1-one “Irgacure 379”, 2,2-dimethoxy-1,2-diphenylethan-1-one, bis(2,4,6-trimethylbenzoyl)-diphenylphosphine oxide “Lucirin TPO”, 2,4,6-trimethylbenzoyl-phenyl-phosphine oxide “Irgacure 819”, 1,2-octanedione,1-[4-(phenylthio)-,2-(O-benzoyloxime)], ethanone “Irgacure OXE01”, 1-[9-ethyl-6-(2-methylbenzoyl)-9H-carbazol-3-yl]-,1-(O-acetyloxime) “Irgacure OXE02 (all by BASF Corporation), mixture of 2,4-diethylthioxanthone (“Kayacure DETX” by Nippon Kayaku Co., Ltd.) and ethyl p-dimethylaminobenzoate (“Kayacure EPA” by Nippon Kayaku Co., Ltd.), mixture of isopropylthioxanthone (“Quantacure ITX” by Ward Blenkinsop Co., Ltd.) and ethyl p-dimethylaminobenzoate, “Esacure ONE”, “Esacure KIP150”, “Esacure KIP160”, “Esacure 1001M”, “Esacure A198”, “Esacure KIP IT”, “Esacure KT046”, “Esacure TZT” (by Lamberti Corporation), and Lambson Limited's “Speedcure BMS”, “Speedcure PBZ”, “Benzophenone”, etc. Further, as a photocationic initiator, a photoacid generator may be used. The photoacid generator includes diazo disulfone compounds, triphenyl sulfonium compounds, phenyl sulfone compounds, sulfonyl pyridine compounds, triazine compounds, diphenyl iodonium compounds, etc.

The content of the photopolymerization initiator is preferably 0.1 to 10% by mass relative to the total content of the compounds in the composition to be used in producing the polyfunctional polycyclic polymerizable compound-containing permeable membrane, and especially preferably 1 to 6% by mass. These may be used alone or may be used as a mixture of two or more of them.

As the thermal polymerization initiator for use in thermal polymerization, any known conventional one can be used, and examples thereof include organic peroxides such as methyl acetoacetate peroxide, cumene hydroperoxide, benzoyl peroxide, bis(4-t-butylcyclohexyl)peroxy dicarbonate, t-butylperoxy benzoate, methyl ethyl ketone peroxide, 1,1-bis(t-hexylperoxy)-3,3,5-trimethylcyclohexane, p-pentahydroperoxide, t-butylhydroperoxide, dicumyl peroxide, isobutyl peroxide, di(3-methyl-3-methoxybutyl)peroxy dicarbonate, 1,1-bis(t-butylperoxy)cyclohexane, etc.; azonitrile compounds such as 2,2′-azobisisobutyronitrile, 2,2′-azobis(2,4-dimethylvaleronitrile), etc.; azoamidine compounds such as 2,2′-azobis(2-methyl-N-phenylpropione-amidine) dihydrochloride, etc.; azoamide compounds such as 2,2′-azobis{2-methyl-N-[1,1-bis(hydroxymethyl)-2-hydroxyethyl]propionamide}, etc.; and alkylazo compounds such as 2,2′-azobis(2,4,4-trimethylpentane), etc. The content of the thermal polymerization initiator is preferably 0.1 to 10% by mass relative to the total content of the compounds in the composition for use in producing the polyfunctional polycyclic polymerizable compound-containing permeable membrane, and especially preferably 1 to 6% by mass. These may be used alone or may be used as a mixture of two or more of them.

### (Organic Solvent)

The composition to be used for constituting the polymer that the gas-selective permeable membrane of the present invention contains may optionally use an organic solvent. The organic solvent to be used is, though not specifically limited thereto, preferably an organic solvent having good solubility to dissolve the polyfunctional polycyclic polymerizable compound, and is preferably an organic solvent that can be dried at a temperature of 100° C. or lower. Examples of such solvents include aromatic hydrocarbons such as toluene, xylene, cumene, mesitylene, etc.; ester solvents such as methyl acetate, ethyl acetate, propyl acetate, butyl acetate, cyclohexyl acetate, 3-butoxymethyl acetate, ethyl lactate, etc.; ketone solvents such as methyl ethyl ketone, methyl isobutyl ketone, cyclohexanone, cyclopentanone, etc.; ether solvents such as tetrahydrofuran, 1,2-dimethoxyethane, anisole, etc.; amide solvents such as N,N-dimethylformamide, N-methyl-2-pyrrolidone, etc.; ethylene glycol monomethyl ether acetate, propylene glycol monomethyl ether acetate, propylene glycol monomethyl ether, propylene glycol diacetate, propylene glycol monomethyl propyl ether, diethylene glycol monomethyl ether acetate, γ-butyrolactone, chlorobenzene, etc. These may be used alone or may be used as a mixture of two or more of them. From the viewpoint of solution stability, preferably, at least one or more of ketone solvents, ether solvents, ester solvents and aromatic hydrocarbon solvents are used.

Regarding the proportion of the organic solvent to be used, the polymerizable composition for use in constituting the polymer to be contained in the gas-selective permeable membrane of the present invention is generally applied by coating, and therefore, so far as the coating state of the composition is not significantly degraded, the proportion is not specifically limited, but is preferably such that the content ratio of the total content of the compounds in the composition for use in producing the polyfunctional polycyclic polymerizable compound-containing permeable membrane could be 0.1 to 99% by mass, more preferably 5 to 60% by mass, even more preferably 10 to 50% by mass.

In dissolving the polymerizable compound in an organic solvent, preferably, the system is heated and stirred for attaining uniform dissolution. The heating temperature in heating and stirring may be appropriately controlled in consideration of the solubility of the polymerizable compound to be used in the organic solvent, and is, from the viewpoint of productivity, preferably 15° C. to 130° C., more preferably 30° C. to 110° C., even more preferably 50° C. to 100° C.

### (Additives)

The composition to be used for constituting the polymer that the gas-selective permeable membrane of the present invention contains uses general-purpose additives and the like for attaining uniform coating or for various purposes. For example, additives such as a polymerization inhibitor, an antioxidant, a UV absorbent, a leveling agent, an alignment control agent, a chain transfer agent, an IR absorbent, a thixotropic agent, an antistatic agent, a filler, a chiral compound, a monomer, any other compound, an alignment material, etc., may be added to the composition in such a degree as not significantly detracting molecular alignment.

### (Polymerization Inhibitor)

The composition to be used for constituting the polymer that the gas-selective permeable membrane of the present invention contains may optionally contain a polymerization initiator. The polymerization inhibitor may be any known conventional one with no specific limitation.

Examples thereof include phenol compounds such as p-methoxyphenol, cresol, t-butyl catechol, 3,5-di-t-butyl-4-hydroxytoluene, 2,2′-methylenebis(4-methyl-6-t-butylphenol), 2,2′-methylenebis(4-ethyl-6-t-butylphenol), 4,4′-thiobis(3-methyl-6-t-butylphenol), 4-methoxy-1-naphthol, 4,4′-dialkoxy-2,2′-bi-1-naphthol, etc.; quinone compounds such as hydroquinone, methylhydroquinone, tert-butylhydroquinone, p-benzoquinone, methyl-p-benzoquinone, tert-butyl-p-benzoquinone, 2,5-diphenylbenzoquinone, 2-hydroxy-1,4-naphthoquinone, anthraquinone, diphenoquinone, etc.; amine compounds such as p-phenylenediamine, 4-aminodiphenylamine, N,N′-diphenyl-p-phenylenediamine, N-i-propyl-N′-phenyl-p-phenylenediamine, N-(1,3-dimethylbutyl)-N′-phenyl-p-phenylenediamine, diphenylamine, 4,4′-dicumyl-diphenylamine, 4,4′-dioctyl-diphenylamine, etc.; thioether compounds such as phenothiazine, distearylthio dipropionate, etc.; nitroso compounds such as N-nitrosodiphenylamine, N-nitrosophenylnaphthylamine, p-nitrosophenol, nitrosobenzene, α-nitroso-β-naphthol, etc., N, N-dimethyl-p-nitrosoaniline, p-nitrosodiphenylamine, p-nitrosodimethylamine, p-nitroso-N,N-diethylamine, N-nitrosoethanolamine, N-nitroso-di-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salt, nitrosobenzene, 2,4,6-tri-tert-butylnitrosobenzene, N-nitroso-N-methyl-p-toluenesulfonamide, N-nitroso-N-ethylurethane, N-nitroso-N-n-propylurethane, l-nitroso-2-naphthol, 2-nitroso-1-naphthol, sodium 1-nitroso-2-naphthol-3,6-sulfonate, sodium 2-nitroso-1-naphthol-4-sulfonate, 2-nitroso-5-methylaminophenol hydrochloride, 2-nitroso-5-methylaminophenol hydrochloride, etc.

The amount of the polymerization inhibitor to be added is preferably 0.01 to 2.0% by mass relative to the sum total of the total content of the compounds in the composition to prepare in producing the polyfunctional polycyclic polymerizable compound-containing permeable membrane, which is used for constituting the polymer to be contained in the gas-selective permeable membrane of the present invention, more preferably 0.05 to 1.0% by mass.

### (Antioxidant)

The composition to be used for constituting the polymer to be contained in the gas-selective permeable membrane of the present invention may optionally contain an antioxidant, etc. Such compounds include hydroquinone derivatives, nitrosoamine polymerization inhibitors, hindered phenol antioxidants, etc., more specifically tert-butylhydroquinone, “Q-1300” and “Q-1301” by Wako Pure Chemical Corporation; pentaerythritol tetrakis[3-(3,5-di-tert-butyl-4-hydroxyphenyl)propionate]“IRGANOX 1010”, thiodiethylenebis[3-(3,5-di-tert-butyl-4-hydroxyphenyl)propionate] “IRGANOX 1035”, octadecyl-3-(3,5-di-tert-butyl-4-hydroxyphenyl)propionate]“IRGANOX 1076”, “IRGANOX 1135”, “IRGANOX 1330”, 4,6-bis(octylthiomethyl)-o-cresol “IRGANOX 1520L”, “IRGANOX 1726”, “IRGANOX 245”, “IRGANOX 259”, “IRGANOX 3114”, “IRGANOX 3790”, “IRGANOX 5057”, “IRGANOX 565” (all by BASF Corporation); Adekastab AO-20, AO-30, AO-40, AO-50, AO-60, AO-80 by ADEKA Corporation; Sumilizer BHT, Sumilizer BBM-S and Sumilizer GA-80 by Sumitomo Chemical Co., Ltd., etc.

The amount of the antioxidant to be added is preferably 0.01 to 2.0% by mass relative to the sum total of the total content of the compounds in the composition to prepare in producing the polyfunctional polycyclic polymerizable compound-containing permeable membrane, which is used for constituting the polymer to be contained in the gas-selective permeable membrane of the present invention, more preferably 0.05 to 1.0% by mass.

### (UV Absorbent)

The composition to be used for constituting the polymer to be contained in the gas-selective permeable membrane of the present invention may optionally contain a UV absorbent and a light stabilizer. The UV absorbent and the light stabilizer to be used are, though not specifically limited thereto, preferably those capable of improving the lightfastness of optically anisotropic bodies, optical films, etc.

Examples of the UV absorbent include 2-(2-hydroxy-5-t-butylphenyl)-2H-benzotriazole “TINUVIN PS”, “TINUVIN 109”, “TINUVIN 213”, “TINUVIN 234”, “TINUVIN 326”, “TINUVIN 328”, “TINUVIN 329”, “TINUVIN 384-2”, “TINUVIN 571”, 2-(2H-benzotriazol-2-yl)-4,6-bis(1-methyl-1-phenylethyl)phenol “TINUVIN 900”, 2-(2H-benzotriazol-2-yl)-6-(1-methyl-1-phenylethyl)-4-(1,1,3,3-tetramethylbutyl)phenol “TINUVIN 928”, “TINUVIN 1130”, “TINUVIN 400”, “TINUVIN 405”, 2,4-bis[2-hydroxy-4-butoxyphenyl]-6-(2,4-dibutoxyphenyl)-1,3,5-triazine “TINUVIN 460”, “TINUVIN 479”, “TINUVIN 5236 (all by BASF Corporation), “Adekastab LA-32”, “Adekastab LA-34”, “Adekastab LA-36”, “Adekastab LA-31”, “Adekastab 1413”, “Adekastab LA-51” (all by ADEKA Corporation), etc.

Examples of the light stabilizer include “TINUVIN 123”, “TINUVIN 144, “TINUVIN 152”, “TINUVIN 292”, “TINUVIN 622”, “TINUVIN 770”, “TINUVIN 765”, “TINUVIN 780”, “TINUVIN 905”, “TINUVIN 5100”, “TINUVIN 5050”, “TINUVIN 5060”, “TINUVIN 5151”, “CHIMASSORB 119FL”, “CHIMASSORB 944FL”, “CHIMASSORB 944LD” (all by BASF Corporation), “Adekastab LA-52”, “Adekastab LA-57”, “Adekastab LA-62”, “Adekastab LA-67”, “Adekastab LA-63P”, “Adekastab LA-68LD”, “Adekastab LA-77”, “Adekastab LA-82”, “Adekastab LA-87” (all by ADEKA Corporation), etc.

The amount of the UV absorbent to be added is preferably 0.01 to 2.0% by mass, more preferably 0.05 to 1.0% by mass relative to the sum total of the total content of the compounds in the composition to prepare in producing the polyfunctional polycyclic polymerizable compound-containing permeable membrane, which is used for constituting the polymer to be contained in the gas-selective permeable membrane of the present invention.

### (Leveling Agent)

The composition to be used for constituting the polymer to be contained in the gas-selective permeable membrane of the present invention may optionally contain a leveling agent. The leveling agent to be used is, though not specifically limited thereto, preferably one capable of reducing the thickness unevenness in forming the permeable membrane.

The leveling agent includes alkylcarboxylates, alkylphosphates, alkylsulfonates, fluoroalkylcarboxylates, fluoroalkylphosphates, fluoroalkylsulfonates, polyoxyethylene derivatives, fluoroalkylethylene oxide derivatives, polyethylene glycol derivatives, alkylammonium salts, fluoroalkylammonium salts, etc.

Specifically, examples thereof include “Megafac F-251”, “Megafac F-281”, “Megafac F-430”, “Megafac F-444”, “Megafac F-472SF”, “Megafac F-477”, “Megafac F-510”, “Megafac F-511”, “Megafac F-553”, “Megafac F-554”, “Megafac F-555”, “Megafac F-556”, “Megafac F-557”, “Megafac F-558”, “Megafac F-559”, “Megafac F-561”, “Megafac F-562”, “Megafac F-563”, “Megafac F-565”, “Megafac F-567”, “Megafac F-568”, “Megafac F-569”, “Megafac F-570”, “Megafac F-571”, “Megafac R-40”, “Megafac R-41”, “Megafac R-43”, “Megafac R-94”, “Megafac RS-72-K”, “Megafac RS-75”, “Megafac RS-76-E”, “Megafac RS-76-NS”, “Megafac RS-90”, “Megafac EXP.TF-1367”, “Megafac EXP.TF1437”, “Megafac EXP.TF1537”, “Megafac EXP.TF-2066” (all by DIG Corporation),

“PHTHAGENT 100”, “PHTHAGENT 110”, “PHTHAGENT 150”, “PHTHAGENT 150CH”, “PHTHAGENT 300”, “PHTHAGENT 310”, “PHTHAGENT 320”, “PHTHAGENT 400SW”, “PHTHAGENT 251”, “PHTHAGENT 212M”, “PHTHAGENT 215M”, “PHTHAGENT 250”, “PHTHAGENT 222F”, “PHTHAGENT 212D”, “FTX-218”, “PHTHAGENT 209F”, “PHTHAGENT 245F”, “PHTHAGENT 208G”, “PHTHAGENT 240G”, “PHTHAGENT 212P”, “PHTHAGENT 220P”, “PHTHAGENT 228P”, “DFX-18”, “PHTHAGENT 601AD”, “PHTHAGENT 602A”, “PHTHAGENT 650A”, “PHTHAGENT 750FM”, “FTX-730FM”, “PHTHAGENT 730FL”, “PHTHAGENT 710FS”, “PHTHAGENT 710FM”, “PHTHAGENT 710FL”, “FTX-730LS”, “PHTHAGENT 730LM” (all by NEOS Company Limited),

“BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK-UV3500”, “BYK-UV3510”, “BYK-UV3570”, “BYK-Silclean 3700” (all by BYK Corporation),

“TEGO Rad2100”, “TEGO Rad2200N”, “TEGO Rad2250”, “TEGO Rad2300”, “TEGO Rad2500”, “TEGO Flow300”, “TEGO Flow370”, “TEGO Flow425”, “TEGO Flow ATF2”, “TEGO Flow ZFS460”, “TEGO Glide100”, “TEGO Glide130”, “TEGO Glide410”, “TEGO Glide415”, “TEGO Glide432”, “TEGO Glide440”, “TEGO Glide450”, “TEGO Glide482”, “TEGO Glide A115”, “TEGO Glide B1484”, “TEGO Glide ZG400”, “TEGO Twin4000”, “TEGO Twin4100”, “TEGO Twin4200”, “TEGO Wet240”, “TEGO Wet500”, “TEGO Wet510”, “TEGO Wet KL245” (all by Evonik Industries Corporation),

“FC-4430”, “FC-4432” (both by 3M Japan Limited), “Unidyne NS” (by Daikin Industries, Ltd.),

“Surflon S-241”, “Surflon S-242”, “Surflon S-243”, “SurfIon S-420”, “Surflon S-611”, “Surflon S-651”, “Surflon S-386” (all by AGC Seimi Chemical Co., Ltd.)#

“DISPARLON OX-880EF”, “DISPARLON OX-883”, “DISPARLON OX-77EF”, “DISPARLON OX-710”, “DISPARLON 1922”, “DISPARLON 1927”, “DISPARLON 1958”, “DISPARLON P-410EF”, “DISPARLON P-420”, “DISPARLON PD-7”, “DISPARLON 1970”, “DISPARLON 230”, “DISPARLON LF-1980”, “DISPARLON LF-1982”, “DISPARLON LF-1084”, “DISPARLON LF-1985”, “DISPARLON LHP-90”, “DISPARLON LHP-91”, “DISPARLON LHP-96”, “DISPARLON OX-715”, “DISPARLON 1930N”, “DISPARLON 1931”, “DISPARLON 1933”, “DISPARLON 1711EF”, “DISPARLON 1751N”, “DISPARLON 1761”, “DISPARLON LS-009”, “DISPARLON LS-001”, “DISPARLON LS-050” (all by Kusumoto Chemicals, Ltd.)

“PF-151N”, “PF-636”, “PF-6320”, “PF-656”, “PF-6520”, “PF-652-NF”, “PF-3320” (all by OMNOVA SOLUTIONS Corporation), “Polyflow No. 7”, “Polyflow No. 50E”, “Polyflow No. 50EHF”, “Polyflow No. 54N”, “Polyflow No. 75”, “Polyflow No. 85”, “Polyflow No. 90”, “Polyflow No. 90D-50”, “Polyflow No. 95”, “Polyflow No. 99C”, “Polyflow KL-400K”, “Polyflow KL-400HF”, “Polyflow KL-401”, “Polyflow KL-402”, “Polyflow KL-403”, “Polyflow KL-100”, “Polyflow LE-604”, “Polyflow KL-700”, “Flowlen AC-300”, “Flowlen AC-303”, “Flowlen AC-326F”, “Flowlen AC-530”, “Flowlen AC-903”, “Flowlen AC-903HF”, “Flowlen AC-1160”, “Flowlen AC-2000”, “Flowlen AC-2300C”, “Flowlen AO-82”, “Flowlen AO-98”, “Flowlen AO-108” (all by Kyoeisha Chemical Co., Ltd.),

“L-7001”, “L-7002”, “8032 ADDITIVE”, “57 ADDITIVE”, “L-7064”, “FZ-2110”, “FZ-2105”, “67 ADDITIVE”, “8616 ADDITIVE” (all by Toray Dow Silicone Corporation), etc.

The amount of the leveling agent to be added is preferably 0.01 to 2.0% by mass relative to the sum total of the total content of the compounds in the composition to prepare in producing the polyfunctional polycyclic polymerizable compound-containing permeable membrane, which is used for constituting the polymer to be contained in the gas-selective permeable membrane of the present invention, more preferably 0.05 to 0.5% by mass.

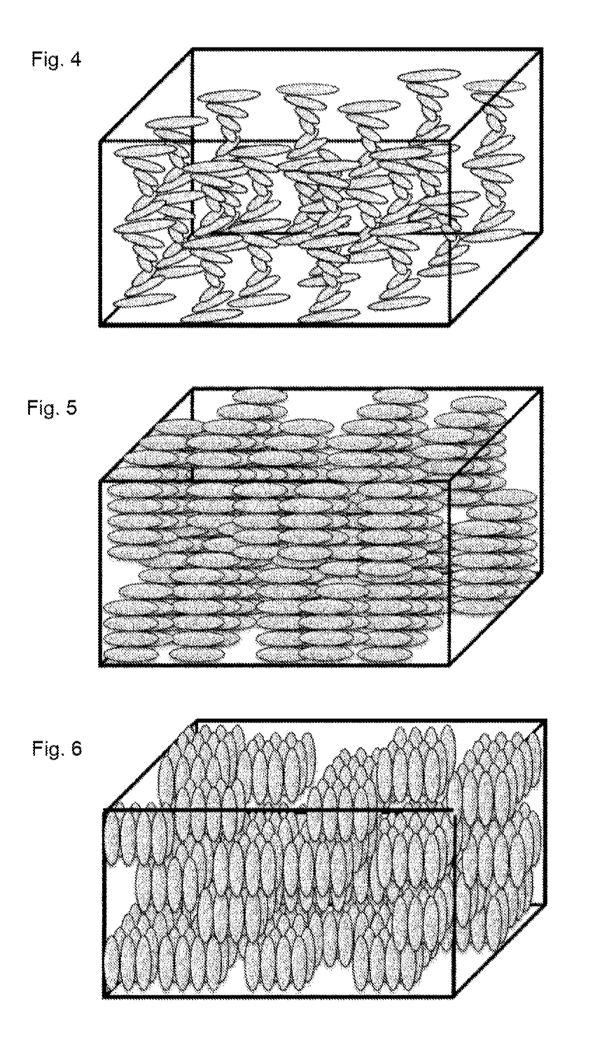

Using the leveling agent, as the case may be, the permeable membrane of the present invention can have a molecular alignment state as shown in FIG. 1, FIG. 4 or FIG. 5.

### (Alignment Control Agent)

The composition to be used for constituting the polymer to be contained in the gas-selective permeable membrane of the present invention may optionally contain an alignment control agent for controlling the molecular alignment state of the polymerizable compound. The alignment control agent to be used is one that makes the polymerizable compound undergo optically uniaxial or more and less than triaxial crystal molecular alignment with respect to a substrate. As described above, at least uniaxial molecular alignment may be induced by a leveling agent, and with no specific limitation, the alignment control agent may be any one capable of inducing each molecular alignment state, and any known conventional ones may be used here.

Examples of such an alignment control agent include compounds having a recurring unit represented by the following general formula (8) and having a weight-average molecular weight of 100 to 1000000, which have an effect of inducing the polymerizable compound in an air interface to undergo molecular alignment with respect to the horizontal direction of the permeable membrane formed of the compound.

[Chem. 141]

CR¹¹R¹²—CR¹³R¹⁴ (8)

(In the formula, R¹¹, R¹², R¹³ and R¹⁴ each independently represent a hydrogen atom, a halogen atom, or a hydrocarbon group having 1 to 20 carbon atoms, and the hydrogen atoms in the hydrocarbon group may be substituted with one or more halogen atoms).

Those having an effect of inducing the polymerizable compound existing in an air interface to undergo molecular alignment with respect to the vertical direction of the permeable membrane formed of the compound include cellulose nitrate, cellulose acetate, cellulose propionate, cellulose butyrate, etc.

### (Chain Transfer Agent)

The composition to be used for constituting the polymer to be contained in the gas-selective permeable membrane of the present invention may optionally contain a chain transfer agent for more improving the adhesiveness between the resultant permeable membrane and a substrate. The chain transfer agent includes aromatic hydrocarbons; halogenohydrocarbons such as chloroform, carbon tetrachloride, carbon tetrabromide, bromotrichloromethane, etc.; mercaptans compounds such as octylmercaptan, n-hexadecylmercaptan, n-tetradecylmercaptan, n-dodecylmercaptan, t-tetradecylmercaptan, t-dodecylmercaptan, etc.; thiol compounds such as hexanedithiol, 1,4-butanediol bisthiopropionate, 1,4-butanediol bisthioglycolate, ethylene glycol bisthioglycolate, ethylene glycol bisthiopropionate, trimethylolpropane tristhioglycolate, trimethylolpropane tristhiopropionate, trimethylolpropane tris(3-mercaptobutyrate), pentaerythritol tetrakisthioglycolate, pentaerythritol tetrakisthiopropionate, tris(2-hydroxyethyl) isocyanurate trimercaptopropionate, 1,4-dimethylmercaptobenzene, 2,4,6-trimercapto-s-triazine, 2-(N,N-dibutylamino)-4,6-dimercapto-s-triazine, etc.; sulfide compounds such as dimethylxanthogen disulfide, diethylxanthogen disulfide, diisopropylxanthogen disulfide, tetramethylthiuram disulfide, tetraethylthiuram disulfide, tetrabutylthiuram disulfide, etc.; N,N-dimethylaniline, N,N-divinylaniline, pentaphenylethane, α-methylstyrene dimer, acrolein, allyl alcohol, terpinolene, α-terpinene, γ-terpinene, dipentene, etc. 2,4-Diphenyl-4-methyl-1-pentene and thiol compounds are more preferred.

Specifically, compounds represented by the following general formulae (9-1) to (9-12) are preferred.

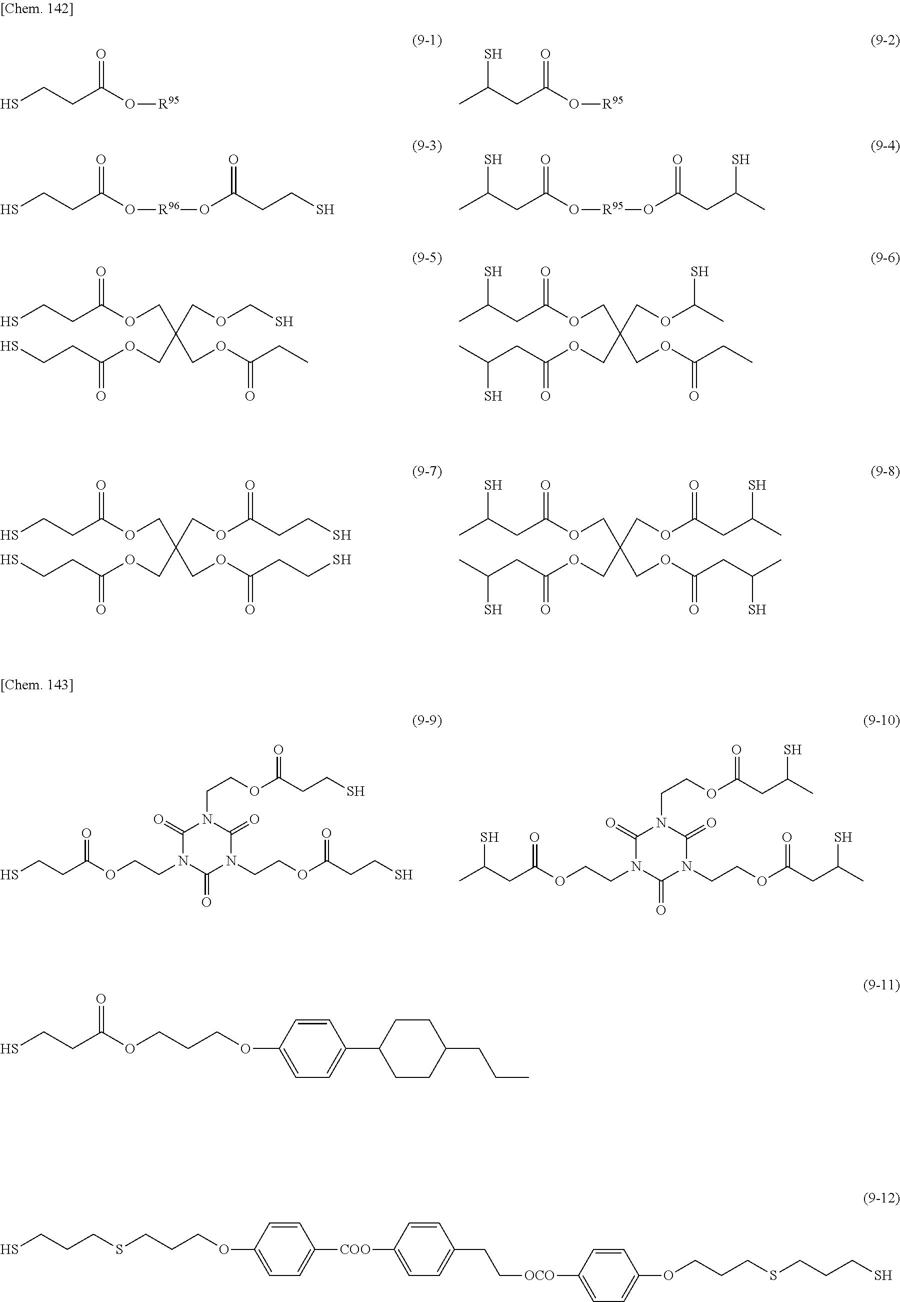

In the formulae, R⁹⁵ represents an alkyl group having 2 to 18 carbon atoms, the alkyl group may be linear or branched, and one or more methylene groups in the alkyl group may be substituted with an oxygen atom, a sulfur atom, —CO—, —OCO—, —COO— or —CH═CH— in such a form that the oxygen atom and the sulfur atom do not directly bond to each other, R⁹⁶ represents an alkylene group having 2 to 18 carbon atoms, and one or more methylene groups in the alkylene group may be substituted with an oxygen atom, a sulfur atom, —CO—, —OCO—, —COO— or —CH═CH— in such a form that the oxygen atom and the sulfur atom do not directly bond to each other.

Preferably, the chain transfer agent is added to the polyfunctional polycyclic polymerizable compound-containing composition in the step of mixing the composition in an organic solvent and heating and stirring it to prepare a polymerizable solution, but may be added in a later step of mixing a polymerization initiator in the polymerizable solution, or may be added in both the two steps.

The amount of the chain transfer agent to be added is preferably 0.5 to 10% by mass relative to the sum total of the total content of the compounds in the composition to prepare in producing the polyfunctional polycyclic polymerizable compound-containing permeable membrane, which is used for constituting the polymer to be contained in the gas-selective permeable membrane of the present invention, more preferably 1.0 to 5.0% by mass.

Further, for physical properties regulation, a non-polymerizable compound having a non-polymerizable hard segment having 2 or more cyclic structures and optionally a soft segment may be added to the composition as needed (the hard segment and the soft segment have the same meanings as defined hereinabove). A polymerizable compound having one or less cyclic structure and having a soft segment is preferably added in the step of mixing the polymerizable compound in an organic solvent and heating and stirring it to prepare a polymerizable solution, but the compound having a non-polymerizable hard segment having 2 or more cyclic structures and optionally a soft segment may be added in a later step of mixing a polymerization initiator to the polymerizable solution, or may be added in both the two steps. As to the added amounts of these compounds, the added amount of the non-polymerizable compound in the composition containing at least the two or more polymerizable groups, a hard segment having three or more cyclic structures, and optionally a soft segment, which is for use in the composition used to form the permeable membrane of the present invention, is preferably 20% by mass or less relative to the sum total of the total content of the compounds in the composition to form in producing the polyfunctional polycyclic polymerizable compound-containing permeable membrane, more preferably 10% by mass or less, even more preferably 5% by mass or less.

### (IR Absorbent)

The composition to be used for constituting the polymer to be contained in the gas-selective permeable membrane of the present invention may optionally contain an IR absorbent. With no specific limitation, the IR absorbent to be used may be any known conventional one within a range not disturbing alignment.

The IR absorbent includes cyanine compounds, phthalocyanine compounds, naphthoquinone compounds, dithiol compounds, diimmonium compounds, azo compounds, aluminum salts, etc.

Specifically, examples thereof include diimmonium-type “NIR-IM1”, aluminum salt-type “NIR-AM1” (by Nagase Chemtex Corporation), “Karenz IR-T”, “Karenz IR-13F” (by Showa Denko K.K.), “YKR-2200”, “YKR-2100” (all by Yamamoto Chemicals Inc.), “IRA908”, “IRA931”, “IRA955”, “IRA1034” (all by INDECO, Inc.), etc.

### (Antistatic Agent)

The composition to be used for constituting the polymer to be contained in the gas-selective permeable membrane of the present invention may optionally contain an antistatic agent. With no specific limitation, the antistatic agent to be used may be any known conventional one within a range not disturbing alignment.

Such an antistatic agent includes polymer compounds having, in the molecule, at least one or more sulfonate bases or phosphonate bases, compounds having a quaternary ammonium salt, surfactants having a polymerizable group, etc.

Above all, surfactants having a polymerizable group are preferred, and for example, among surfactants having a polymerizable group, anionic ones include alkyl ether surfactants such as “Antox SAD”, “Antox MS-2H” (all by Nippon Nyukazai Co., Ltd.), “Aqualon KH-05”, “Aqualon KH-10”, “Aqualon KH-0530”, “Aqualon KH-1025” (all by DKS Co., Ltd.), “Adeka Reasoap SR-10N”, “Adeka Reasoap SR-20N” (all by ADEKA Corporation), “Latemul PD-104” (by Kao Corporation), etc.;

sulfosuccinate surfactants such as “Latemul S-120”, “Latemul S-120A”, “Latemul S-180P”, “Latemul S-180A” (all by Kao Corporation), “Eleminol JS-2” (by Sanyo Chemical Industries), etc.;

alkylphenyl ether or alkylphenyl ester surfactants such as “Aqualon H-2855A”, “Aqualon H-3855B”, “Aqualon-3856”, “Aqualon HS-05”, “Aqualon HS-10”, “Aqualon HS-30”, “Aqualon HS-1025”, “Aqualon BC-05”, “Aqualon BC-10”, “Aqualon BC-1025”, “Aqualon BC-2020” (all by DKS Co., Ltd.), “Adeka Reasoap SDX-222”, “Adeka Reasoap SDX-232”, “Adeka Reasoap SDX-259”, “Adeka Reasoap SE-10N”, “Adeka Reasoap SE-20N” (all by ADEKA Corporation), etc.;

(meth)acrylate sulfate surfactants such as “Antox MS-60”, “Antox MS-2N” (all by Nippon Nyukazai Co., Ltd.), “Eleminol RS-30” (by Sanyo Chemical Industries), etc.; and

phosphate surfactants such as “H-3330P” (by DKS Co., Ltd.), “Adeka Reasoap PP-70” (by ADEKA Corporation), etc.

On the other hand, among surfactants having a polymerizable group, examples of nonionic ones include alkyl ether surfactants such as “Antox LMA-20”, “Antox LMA-27”, “Antox EMH-20”, “Antox LMH-20, “Antox SMH-20” (all by Nippon Nyukazai Co., Ltd.), “Adeka Reasoap ER-10”, “Adeka Reasoap ER-20”, “Adeka Reasoap ER-30”, (all by ADEKA Corporation), “Latemul PD-420”, “Latemul PD-430”, “Latemul PD-450” (all by Kao Corporation), etc.; alkyl phenyl ether or alkyl phenyl ester surfactants such as “Aqualon RN-10”, “Aqualon RN-20”, “Aqualon RN-50”, “Aqualon RN-2025” (all by DKS Co., Ltd.), “Adeka Reasoap NE-10”, “Adeka Reasoap NE-30”, “Adeka Reasoap NE-40” (all by ADEKA Corporation), etc.; (meth)acrylate sulfate surfactants such as “RMA-564”, “RMA-568”, “RMA-1114” (all by Nippon Nyukazai Co., Ltd.), etc.

Examples of other antistatic agents include polyethylene glycol (meth)acrylate, methoxypolyethylene glycol (meth)acrylate, ethoxypolyethylene glycol (meth)acrylate, propoxypolyethylene glycol (meth)acrylate, n-butoxypolyethylene glycol (meth)acrylate, phenoxypolyethylene glycol (meth)acrylate, polypropylene glycol (meth)acrylate, methoxypolypropylene glycol (meth)acrylate, ethoxypolypropylene glycol (meth)acrylate, propoxypolypropylene glycol (meth)acrylate, n-butoxypolypropylene glycol (meth)acrylate, phenoxypolypropylene glycol (meth)acrylate, polytetramethylene glycol (meth)acrylate, methoxypolytetramethylene glycol (meth)acrylate, phenoxytetraethylene glycol (meth)acrylate, hexaethylene glycol (meth)acrylate, methoxyhexaethylene glycol (meth)acrylate, etc.

One alone or two or more of the antistatic agents may be used either singly or as combined.

The amount of the antistatic agent to be added is preferably 0.001 to 10% by weight relative to the sum total of the total content of the compounds in the composition to prepare in producing the polyfunctional polycyclic polymerizable compound-containing permeable membrane, which is used for constituting the polymer to be contained in the gas-selective permeable membrane of the present invention, more preferably 0.01 to 5% by weight.

### (Filler)

The composition to be used for constituting the polymer to be contained in the gas-selective permeable membrane of the present invention may optionally contain a filler for controlling gas permeability. With no specific limitation, the filler to be used may be any known conventional one within a range not lowering the gas selectivity of the resultant permeable membrane.

Examples of the filler include an inorganic filler such as alumina, titanium white, aluminum hydroxide, talc, clay, mica, barium titanate, zinc oxide, glass fibers, etc.; a thermally-conductive filler such as metal powder, e.g., silver powder, copper powder, etc., aluminum nitride, boron nitride, silicon nitride, gallium nitride, silicon carbide, magnesia (magnesium oxide), silica, crystalline silica (silicon oxide), molten silica (silicon oxide), graphite, carbon fibers including carbon nanofibers, etc.; silver nanoparticles, etc.

Specifically, alumina includes DAM-70, DAM-45, DAM-07, DAM-05, DAW-45, DAW-05, DAW-03, ASFP-20 (all by DENKA Company Limited), AL-43-KT, AL-47-H, AL-47-1, AL-160SG-3, AL-43-BE, AS-30, AS-40, AS-50, AS-400, CB-P02, CB-P05 (all by Showa Denko K.K.), A31, A31B, A32, A33F, A41A, A43A, MM-22, MM-26, MM-P, MM-23B, LS-110F, LS-130, LS-210, LS-242C, LS-250, AHP300 (all by Nippon Light Metal Company, Ltd.), AA-03, AA-04, AA-05, AA-07, AA-2, AA-5, AA-10, AA-18 (all by Sumitomo Chemical Co., Ltd.); titanium white includes G-1, G-10, F-2, F-4, F-6 (all by Showa Denko K.K.), TAF-520, TAF-500, TAF-1500, TM-1, TA-100C, TA-100CT (all by Fuji Titanium Industry Co., Ltd.), MT-01, MT-10EX, MT-05, MT-100S, MT-100TV, MT-100Z, MT-150EX, MT-100AQ, MT-100WP, MT-100SA, MT-100HD, MT-300HD, MT-500SA, MT-600SA, MT-700HD (all by Tayca Corporation), TTO-51(A), TTO-51(C), TTO-55(A), TTO-55(B), TTO-55(C), TTO-55(D), TTO-S-1, TTO-S-2, TTO-S-3, TTO-S-4, MPT-136, TTO-V-3 (all by Ishihara Sangyo Kaisha, Ltd.); aluminum hydroxide includes B-309, B-309 (all by Tomoe Engineering Co., Ltd.), BA173, BA103, B703, B1403, BF013, BE033, BX103, BX043 (all by, Nippon Light Metal Company, Ltd.); talc includes Nanoace D-1000, Nanoace D-800, Microace SG-95, Microace P-8, Microace P-6 (all by Nippon Talc Co., Ltd.), FH104, FH105, FL108, FG106, MG115, FH104S, ML112S (all by Fuji Talc Industrial Co., Ltd.); mica includes Y-1800, TM-10, A-11, SJ-005 (all by Yamaguchi Mica Co., Ltd.); barium titanate includes BT-H9DX, HF-9, HF-37N, HF-90D, HF-120D, HT-F (all by KCM Corporation), BT-100, HPBT series (all by Fuji Titanium Industry Co., Ltd.), BT series (by Sakai Chemical Industry Co., Ltd.),

Palserum BT (by Nippon Chemical Industrial Co., Ltd.); zinc oxide includes FINEX-30, FINEX-30W-LP2, FINEX-50, FINEX-50S-LP2, XZ-100F (all by Sakai Chemical Industry Co., Ltd.), FZO-50 (Ishihara Sangyo Kaisha, Ltd.), MZ-300, MZ-306X, MZY-505S, MZ-506X, MZ-510HPSX (all by Tayca Corporation); glass fibers include CS6SK-406, CS13C-897, CS3PC-455, CS3LCP-256 (all by Nitto Boseki Co., Ltd.), ECS03-615, ECS03-650, EFDE50-01, EFDE50-31 (all by Central Glass Co., Ltd.), ACS6H-103, ACS6S-750 (all by Nippon Electric Glass Co., Ltd.); silver powder includes spherical silver powder AG3, AG4, flaky silver powder FAS, FA2 (all by DOWA HIGHTECH Co., Ltd.), SPQ03R, SPN05N, SPN08S, Q03R (all by Mitsui Mining & Smelting Co., Ltd.), AY-6010, AY-6080 (all by Tanaka Kikinzoku Kogyo K.K.), ASP-100 (by Aida Chemical Industries Co., Ltd.), Ag-coated powder AG/SP (by Mitsubishi Materials Electronic Chemicals Co., Ltd.); copper powder includes MA-O015K, MA-O02K, MA-0025K (all by Mitsui Mining & Smelting Co., Ltd.), electrolytic copper powder #52-C, #6 (all by JX Nippon Mining & Metals Corporation), 10% Ag-coated Cu-HWQ (by Fukuda Metal Foil & Powder Co., Ltd.), copper powder Type-A, Type-B (all by DOWA ELECTRONICS Co., Ltd.), UCP-030 (by Sumitomo Metal Mining Co., Ltd.);
aluminum nitride includes H grade, E grade, H-T grade (all by Tokuyama Corporation), TOYAL TecFiller TFS-A05P, TOYAL TecFiller TFZ-A02P (all by Toyo Aluminum K.K.), ALN020BF, ALN050BF, ALN020AF, ALN050AF, ALN020SF (all by TOMOE Engineering Co., Ltd.), FAN-f05, FAN-f30 (all by Furukawa Denshi Co., Ltd.); boron nitride includes Denka Boron Nitride SGP, Denka Boron Nitride MGP, Denka Boron Nitride GP, Denka Boron Nitride HGP, Denka Boron Nitride SP-2, Denka Boron Nitride SGPS (all by Denka Company Limited), UHP-S1, UHP-1K, UHP-2, UHP-EX (all by Showa Denko K.K.); silicon nitride includes SN-9, SN-9S, SN-9FWS, SN-F1, SN-F2 (all by Denka Company Limited), CF0027, CF0093, CF0018, CF0033 (all by Nippon Frit Co., Ltd.); silicon carbide includes GMF-H type, GMF-H2 type, GMF-LC type (all by Pacific Rundum Co., Ltd.), HSC1200, HSC1000, HSC059, HSC059I, HSC007 (all by Tomoe Engineering Co., Ltd.); silica includes Sylysia (by Fuji Silysia Chemical, Ltd.), AEROSIL R972, AEROSIL R104, AEROSIL R202, AEROSIL 805, AEROSIL R812, AEROSIL R7200 (all by Nippon Aerosil Co., Ltd.), Leoroseal series (by Tokuyama Corporation); crystalline silica (silicon oxide) includes CMC-12, VX-S, VX-SR (all by Tatsumori Ltd.), molten silica (silicon oxide) includes FB-3SDC, FB-3SDX, SFP-30M, SFP-20M, SFP-30MHE, SFP-130MC, UFP-30 (all by Denka Company Limited), Excelica series (by Tokuyama Corporation); aluminum oxide includes AEROXIDE Alu C, AEROXIDE Alu 65 (all by Nippon Aerosil Co., Ltd.); carbon fibers and graphite include Torayca milled fiber MLD-30, Torayca milled fiber MLD-300 (all by Toray Co., Ltd.), CFMP-30X, CFMP-150X (all by Nippon Polymer Industry Co., Ltd.), XN-100, HC-600 (all by Nippon Graphite Fiber Co., Ltd.), SWeNT SG65, SWeNT SGi, IsoNanoTubes-M, IsoNanoTubes-S, PureTubes, Pyrograf PR-25-XT-PS, PR-25XT-LHT (all by Sigma Aldrich Corporation), etc.

One alone or two or more of the fillers may be used either singly or as combined.

The amount of the filler to be added is preferably 0.01 to 80% by weight relative to the sum total of the total content of the compounds in the composition to prepare in producing the polyfunctional polycyclic polymerizable compound-containing permeable membrane, which is used for constituting the polymer to be contained in the gas-selective permeable membrane of the present invention, more preferably 0.1 to 50% by weight.

### (Chiral Compound)

The composition to be used for constituting the polymer to be contained in the gas-selective permeable membrane of the present invention may optionally contain a chiral compound for the purpose of attaining helical molecular alignment. The chiral compound may have or may not have a polymerizable group by itself. The helical direction of the chiral compound may be appropriately selected depending on the intended use of the resultant permeable membrane.

With no specific limitation, the chiral compound having a polymerizable group may be any known conventional one, but is preferably a chiral compound having a large helical twisting power (HTP). The polymerizable group is preferably a vinyl group, a vinyloxy group, an allyl group, an allyloxy group, an acryloyloxy group, a methacryloyloxy group, a glycidyl group, or an oxetanyl group, and is especially preferably an acryloyloxy group, a glycidyl group or an oxetanyl group.

The amount of the chiral compound to be added must be appropriately controlled depending on the helix induction force of the compound, but is preferably 0.5 to 70% by mass relative to the sum total of the total content of the polymerizable compounds in the composition to prepare in producing the polyfunctional polycyclic polymerizable compound-containing permeable membrane, which is used for constituting the polymer to be contained in the gas-selective permeable membrane of the present invention, more preferably 1 to 40% by mass, even more preferably 2 to 25% by mass.

Specific examples of the chiral compound include compounds represented by the following general formulae (10-1) to (10-4), but are not limited to the following general formulae.

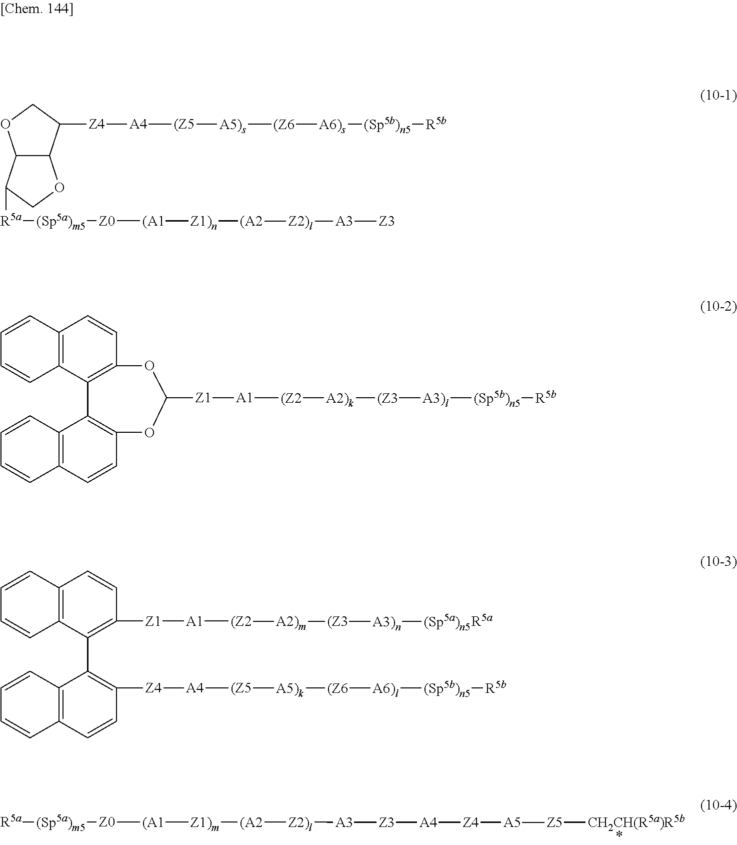

In the above general formulae (10-1) to (10-4), Sp^{5a} and Sp^{5b} each independently represent an alkylene group having 0 to 18 carbon atoms, the alkylene group may be substituted with an alkyl group having 1 to 8 carbon atoms and having one or more halogen atoms, CN groups or polymerizable functional groups, and one CH₂ group or two or more CH₂ groups not adjacent to each other existing in the group may be each independently substituted with —O—, —S—, —NH—, —N(CH₃)—, —CO—, —COO—, —OCO—, —OCOO—, —SCO—, —COS— or —C≡C— in a form where the oxygen atoms do not mutually directly bond to each other,

in the above general formulae (10-1) to (10-4), A1, A2, A3, A4, A5 and A6 each independently represent a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalane-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, n, 1 and k each independently represent 0 or 1, and 0≤n+1+k≤3,

in the above general formulae (10-1) to (10-4), m5 represents 0 or 1,

in the above general formulae (10-1) to (10-4), Z0, Z1, Z2, Z3, Z4, Z5 and Z6 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms and optionally having a halogen atom, or a single bond;

in the above general formulae (10-1) to (10-4), R^{5a} and R^{5b} each represent a hydrogen atom, a halogen atom, a cyano group or an alkyl group having 1 to 18 carbon atoms, the alkyl group may be substituted with one or more halogen atoms or CN's, one CH₂ group or two or more CH₂ groups not adjacent to each other existing in the group may be each independently substituted with —O—, —S—, —NH—, —N(CH₃)—, —CO—, —COO—, —OCO—, —OCOO—, —SCO—, —COS— or —C≡C— in a form where the oxygen atoms do not mutually directly bond to each other, or R^{5a} and R^{5b} each represent the following general formula (10-a):

[Chem. 145]

—P^{5a} (10-a)

(wherein P^{5a} represents a polymerizable functional group), and Sp^{5a} has the same meaning as that of Sp¹.

P^{5a} represents a substituent selected from polymerizable groups represented by the following formulae (P-1) to (P-20):

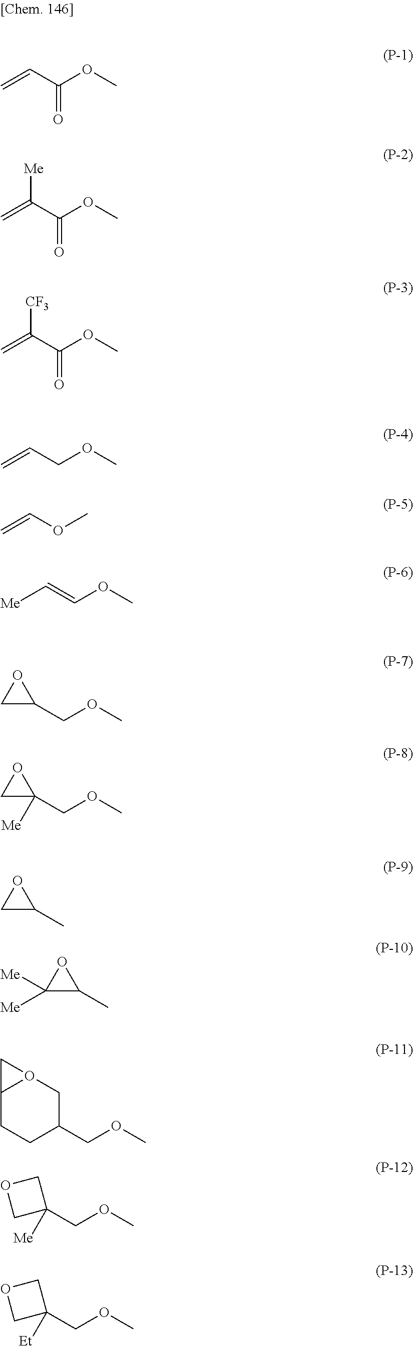

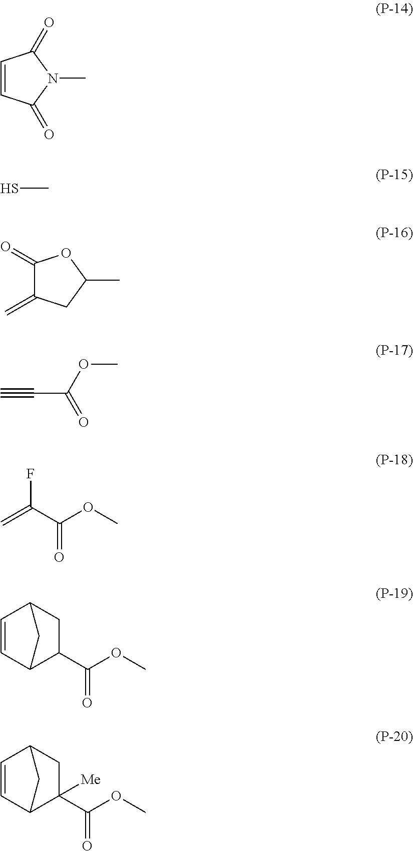

Specific examples of the chiral compounds include compounds represented by the following general formulae (10-5) to (10-38):

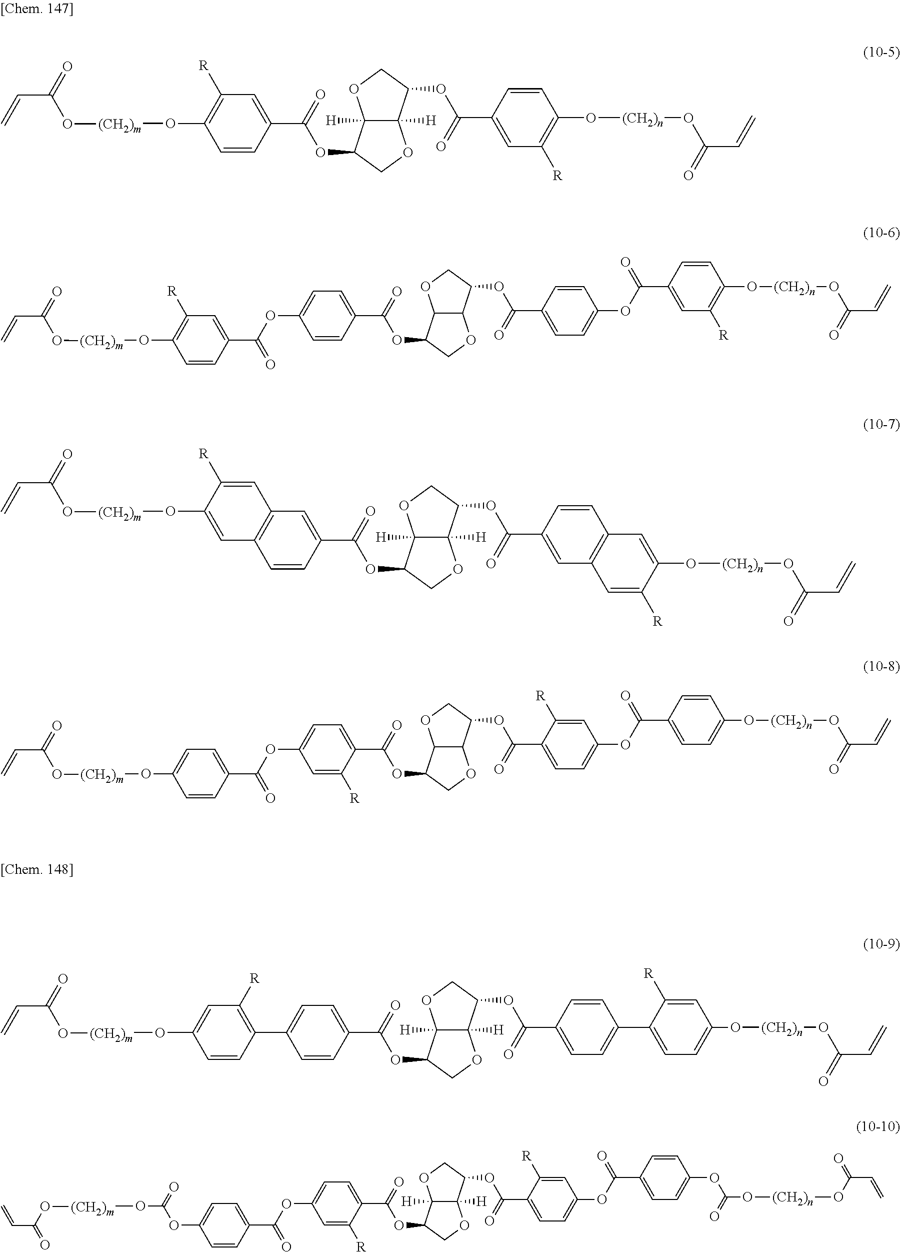

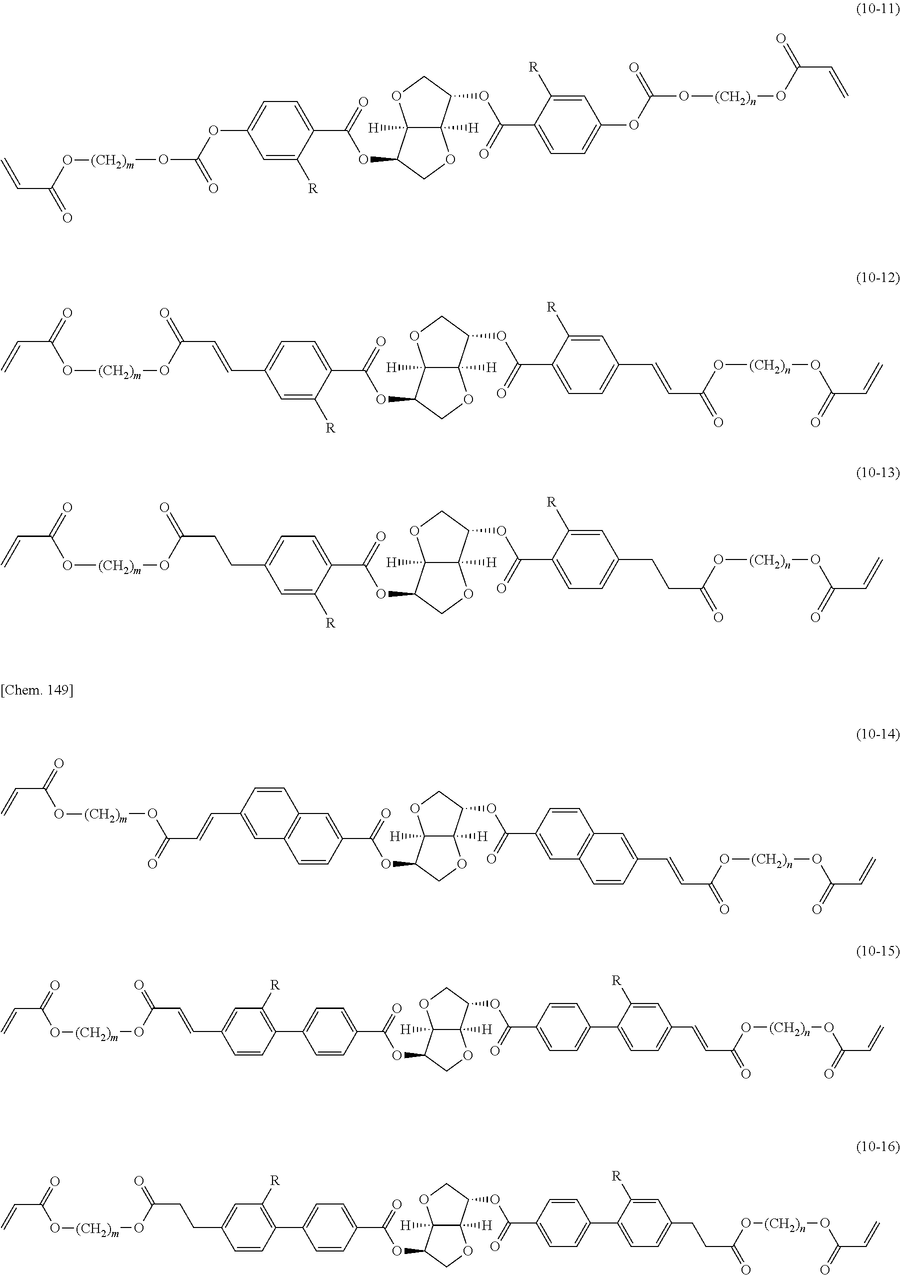

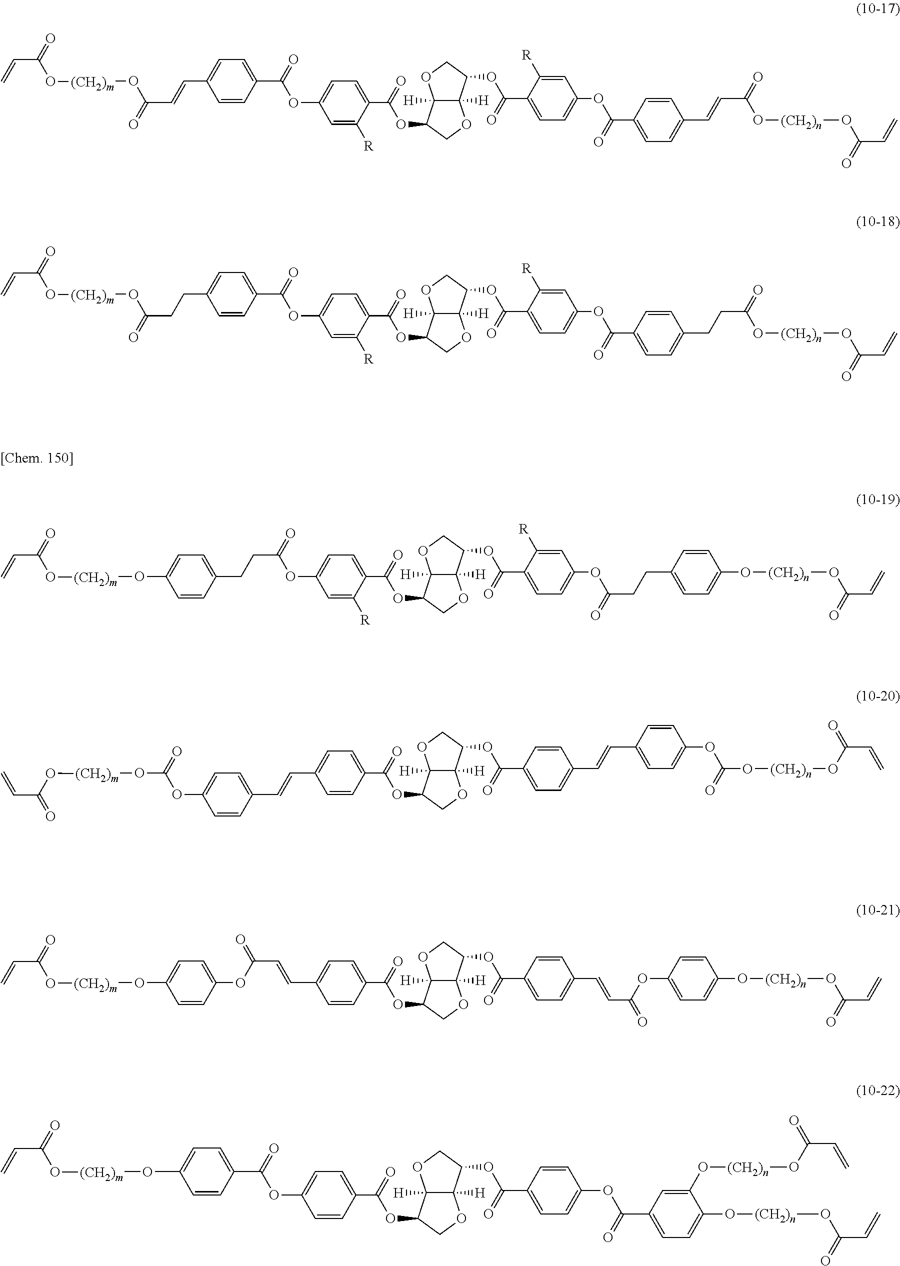

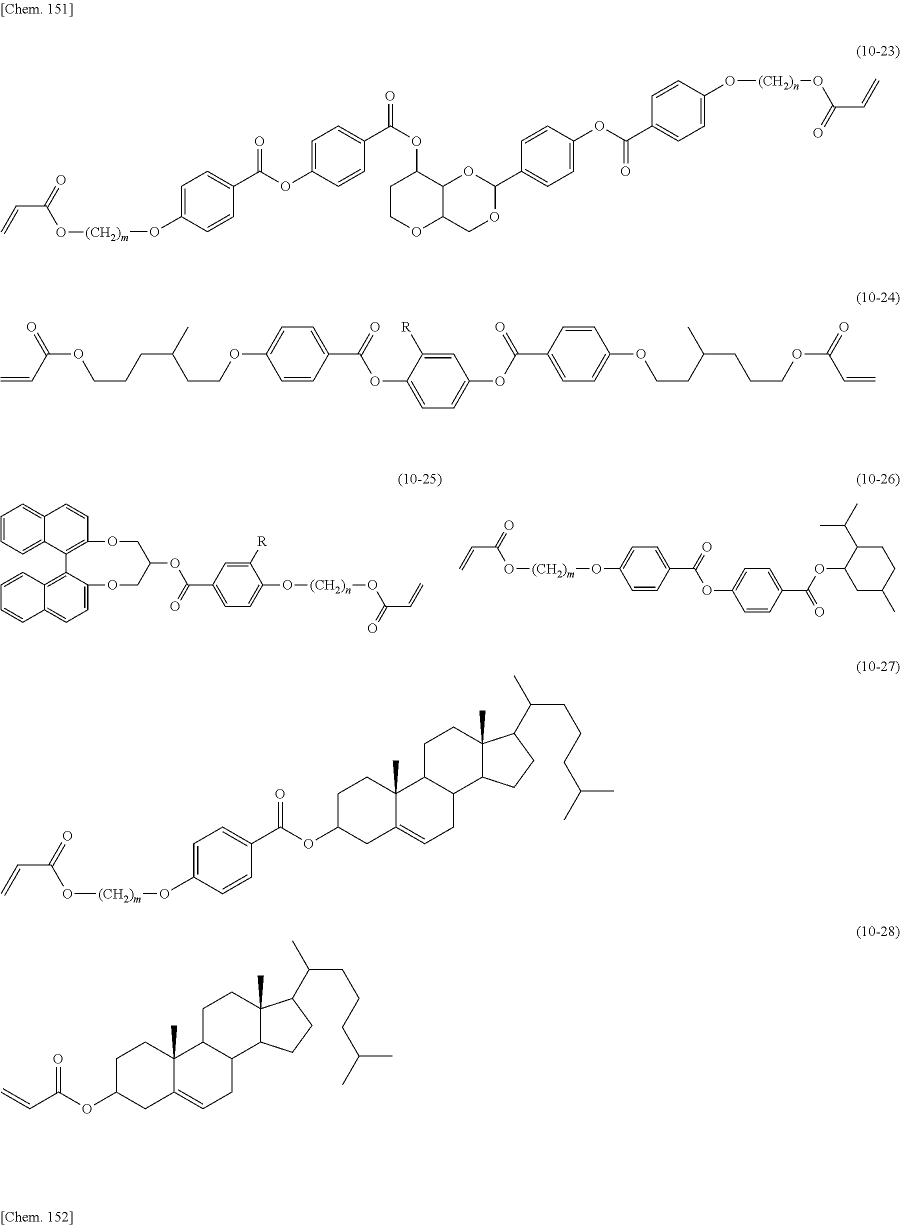

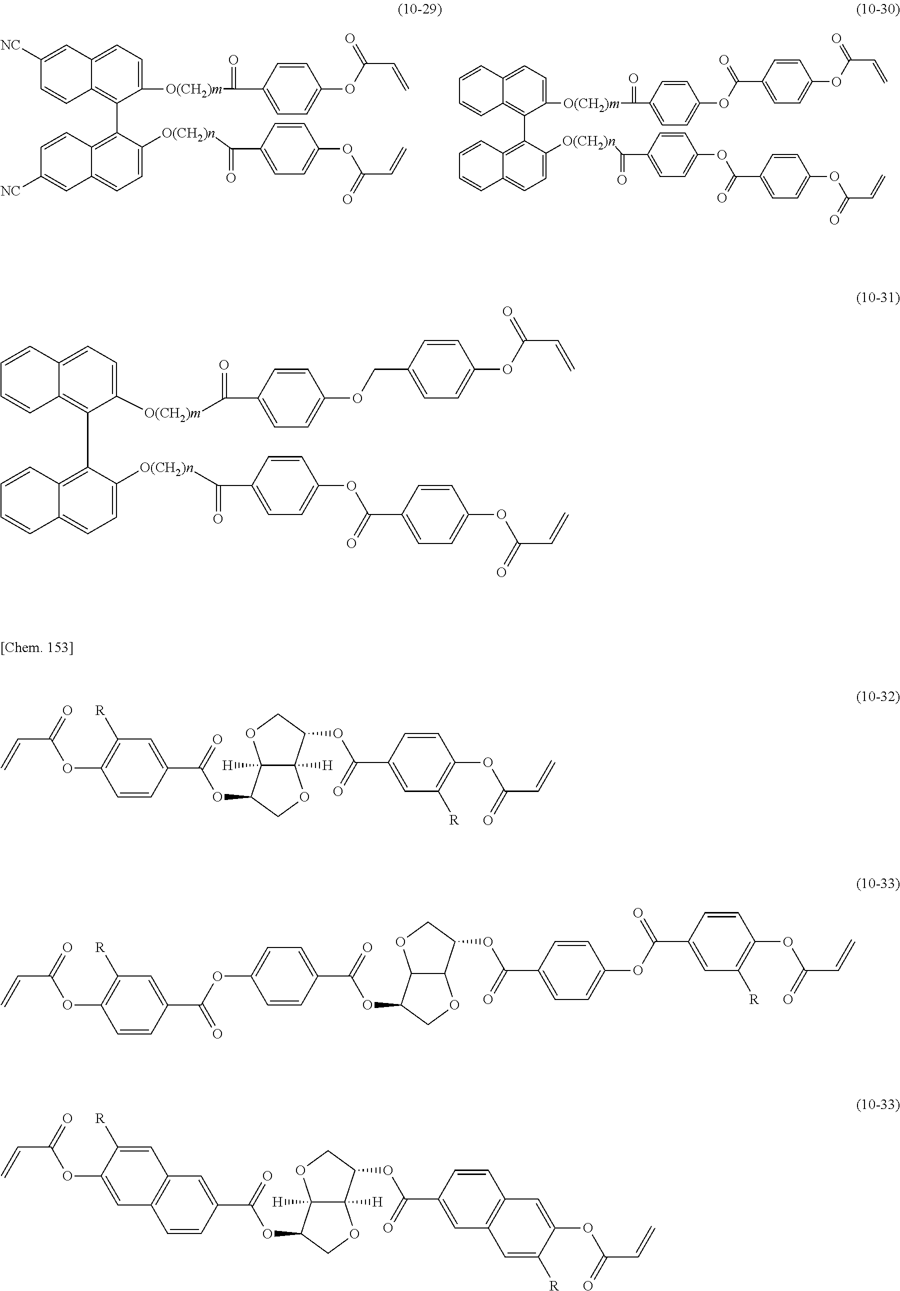

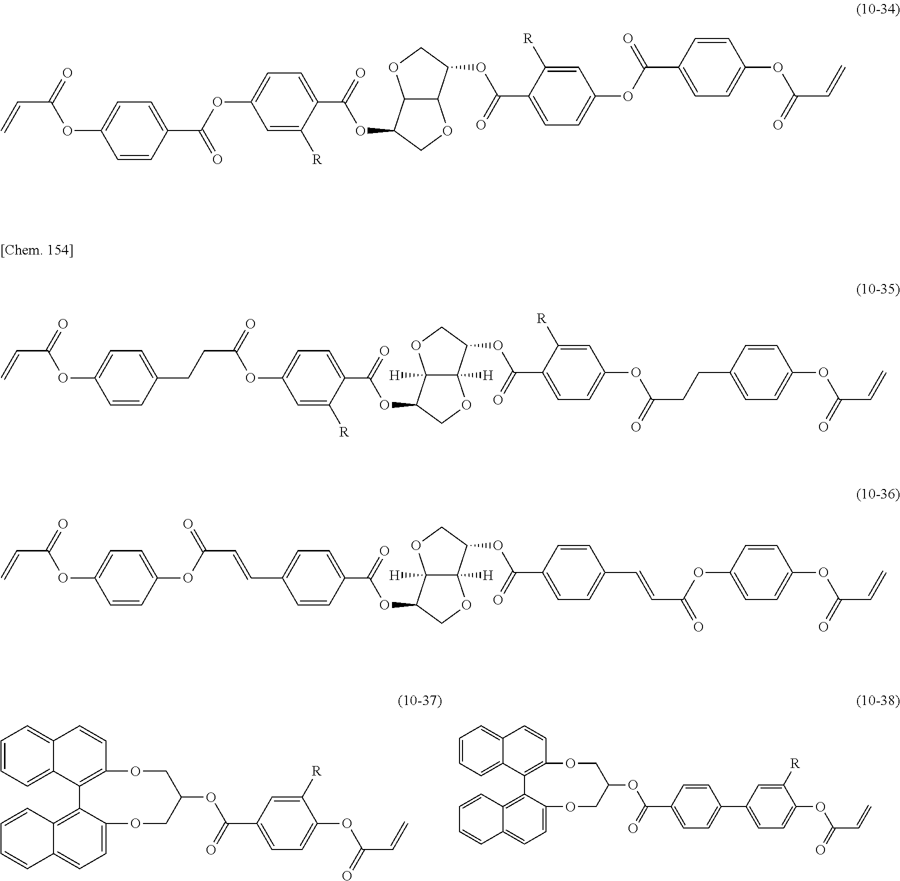

In the above general formulae (10-5) to (10-38), m and n each independently represent an integer of 1 to 10, R represents a hydrogen atom, an alkyl group having 1 to 10 carbon atoms, or a fluorine atom, and plural R's, if any, may be the same or different.

Specifically, examples of the chiral compound not having a polymerizable group include pelargonic acid cholesterol and stearic acid cholesterol having a cholesteryl group as a chiral group; BDH's “CB-15” and “015”, Merck's “S-1082”, Chisso's “CM-19”, “CM-20” and “CM” each having a 2-methylbutyl group as a chiral group; and Merck's “S-811” and Chisso's “CM-21” and “CM-22” each having a 1-methylheptyl group as a chiral group, etc.

In the case where a chiral compound is added, the amount thereof to be added is, though depending on the specific use of the permeable membrane of the present invention, preferably such that the value calculated by dividing the thickness (d) of the resultant permeable membrane by the helical pitch (P) in the permeable membrane (d/P) could fall within a range of 0.1 to 100, more preferably within a range of 0.1 to 20.

### (Monomer)

To the composition to be used for constituting the polymer to be contained in the gas-selective permeable membrane of the present invention, a polymerizable compound having one or less cyclic structure and having a soft segment may be added. As such a compound, in general, any one capable of being recognized as a polymerizable monomer or a polymerizable oligomer can be used with no specific limitation. In the case where the compound is added, the amount thereof is preferably 15% by mass or less relative to the sum total of the total content of the polymerizable compounds in the composition to prepare in producing the polyfunctional polycyclic polymerizable compound-containing permeable membrane, which is used for constituting the polymer to be contained in the gas-selective permeable membrane of the present invention, more preferably 10% by mass or less.

Specifically, the compound includes mono(meth)acrylates such as methyl (meth)acrylate, ethyl (meth)acrylate, 2-hydroxyethyl acrylate, propyl (meth)acrylate, 2-hydroxypropyl (meth)acrylate, butyl (meth)acrylate, isobutyl (meth)acrylate, 4-hydroxybutyl (meth)acrylate, 2-hydroxybutyl (meth)acrylate, octyl (meth)acrylate, 2-ethylhexyl (meth)acrylate, dodecyl (meth)acrylate, stearyl (meth)acrylate, cyclohexyl (meth)acrylate, dicyclopentenyloxyethyl (meth)acrylate, isobornyloxyethyl (meth)acrylate, isobornyl (meth)acrylate, adamantyl (meth)acrylate, dimethyladamantyl (meth)acrylate, dicyclopentanyl (meth)acrylate, dicyclopentenyl (meth)acrylate, methoxyethyl (meth)acrylate, ethylcarbitol (meth)acrylate, tetrahydrofurfuryl (meth)acrylate, benzyl (meth)acrylate, phenoxyethyl (meth)acrylate, 2-phenoxydiethylene glycol (meth)acrylate, 2-hydroxy-3-pheoxyethyl (meth)acrylate, (2-methyl-2-ethyl-1,3-dioxoran-4-yl)methyl (meth)acrylate, (3-ethyloxetan-3-yl)methyl (meth)acrylate, o-phenylphenolethoxy (meth)acrylate, dimethylamino (meth)acrylate, diethylamino (meth)acrylate, 2,2,3,3,3-pentafluoropropyl (meth)acrylate, 2,2,3,4,4,4-hexafluorobutyl (meth)acrylate, 2,2,3,3,4,4,4-heptafluorobutyl (meth)acrylate, 2-(perfluorobutyl)ethyl (meth)acrylate, 2-(perfluorohexyl)ethyl (meth)acrylate, 1H,1H,3H-tetrafluoropropyl (meth)acrylate, 1H,1H,5H-octafluoropentyl (meth)acrylate, 1H,1H,7H-dodeca fluoroheptyl (meth)acrylate, 1H-1-(trifluoromethyl)trifluoromethyl (meth)acrylate, 1H,1H,3H-hexafluorobutyl (meth)acrylate, 1,2,2,2-tetrafluoro-1-(trifluoromethyl)ethyl (meth)acrylate, 1H,1H-pentadecafluorooctyl (meth)acrylate, 1H,1H,2H,2H-tridecafluorooctyl (meth)acrylate, 2-(meth)acryloyloxyethylphthalic acid, 2-(meth)acryloyloxyethylhexahydrophthalic acid, glycidyl (meth)acrylate, 2-(meth)acryloyloxyethylphosphoric acid, acryloylmorpholine, dimethylacrylamide, dimethylaminopropylacrylamide, isopropylacrylamide, diethylacrylamide, hydroxyethylacrylamide, N-acryloyloxyethylhexahydrophthalimide, etc.; diacrylates such as 1,4-butanediol di(meth)acrylate, 1,6-hexanediol di(meth)acrylate, 1,5-nonanediol di(meth)acrylate, neopentyldiol di(meth)acrylate, tripropylene glycol di(meth)acrylate, ethylene glycol di(meth)acrylate, diethylene glycol di(meth)acrylate, triethylene glycol di(meth)acrylate, ethylene oxide-modified bisphenol A di(meth)acrylate, tricyclodecanedimethanol di(meth)acrylate, 9,9-bis[4-(2-acryloyloxyethoxy)phenyl]fluorene, glycerin di (meth)acrylate, 2-hydroxy-3-acryloyloxypropyl methacrylate, 1,6-hexanediol diglycidyl ether acrylic acid adduct, 1,4-butanediol diglycidyl ether acrylic acid adduct, etc.; tri(meth)acrylates such as trimethylolpropane tri (meth)acrylate, ethoxylated isocyanuric acid triacrylate, pentaerythritol tri(meth)acrylate, ε-caprolactone-modified tris-(2-acryloyloxyethyl)isocyanurate, etc.; tetra(meth)acrylates such as pentaerythritol tetra(meth)acrylate, ditrimethylolpropane tetra(meth)acrylate, etc.; dipentaerythritol hexa(meth)acrylate, oligomer-type (meth)acrylates, various urethane acrylates, various macro monomers; epoxy compounds such as ethylene glycol diglycidyl ether, diethylene glycol diglycidyl ether, propylene glycol diglycidyl ether, neopentyl glycol diglycidyl ether, 1,6-hexanediol diglycidyl ether, glycerin diglycidyl ether, bisphenol A diglycidyl ether, etc.; maleimides, etc. One alone or two or more of these may be used either singly or as combined.

### (Alignment Material)

The composition to be used for constituting the polymer to be contained in the gas-selective permeable membrane of the present invention may optionally contain an alignment material for the purpose of bettering the molecular alignment state therein. The alignment material to be used may be any known conventional one capable of being soluble in a solvent that dissolves the polyfunctional polycyclic polymerizable compound for use in the composition for the permeable membrane of the present invention, and is added within such a range that the addition does not significantly degrade alignment. Specifically, the amount of the material to be added is preferably 0.05 to 30% by weight relative to the sum total of the total content of the compounds in the composition to prepare in producing the polyfunctional polycyclic polymerizable compound-containing permeable membrane, which is used for constituting the polymer to be contained in the gas-selective permeable membrane of the present invention, more preferably 0.5 to 15% by weight, even more preferably 1 to 10% by weight.

Specifically, the alignment material includes compounds capable of undergoing photoisomerization or photodimerization, such as polyimide, polyamide, BCB (benzocyclobutane polymer), polyvinyl alcohol, polycarbonate, polystyrene, polyphenylene ether, polyarylate, polyethylene terephthalate, polyether sulfone, epoxy resin, epoxyacrylate resin, acrylic resin, coumarin compound, chalcone compound, cinnamate compound, fulgide compound, anthraquinone compound, azo compound, arylethene compound, etc., and materials (photo-alignment materials) capable of undergoing alignment through UV irradiation or visible light irradiation.

Examples of photoalignment materials include polyimides having a cyclic cycloalkane, wholly aromatic polyarylates, polyvinyl cinnamates as shown in JP-05-232473A, polyvinyl esters of paramethoxycinnamic acid, cinnamate derivatives as shown in JP-06-287453A and JP-06-289374A, maleimide derivatives as shown in JP-2002-265541A, etc. Specifically, compounds represented by the following general formulae (12-1) to (12-9) are preferred.

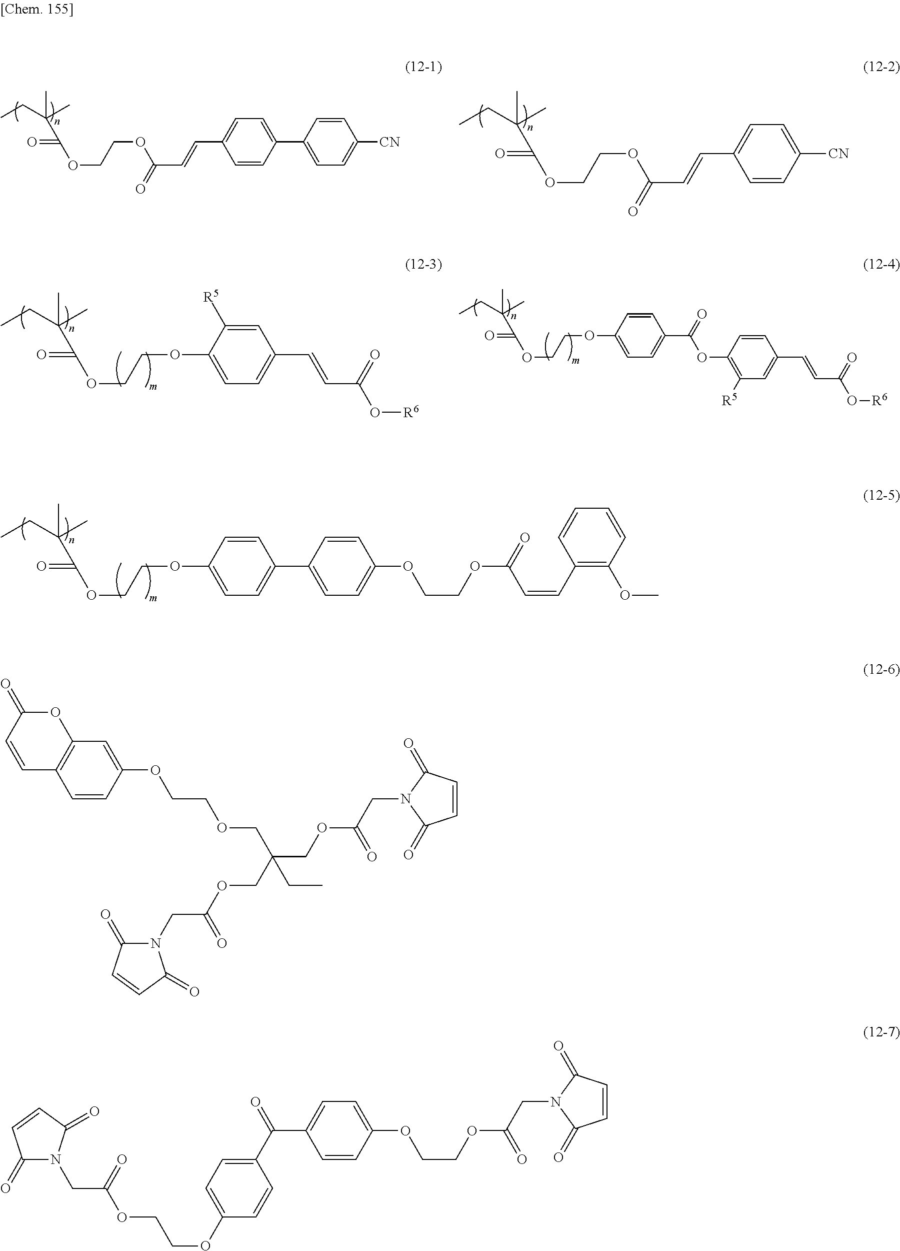

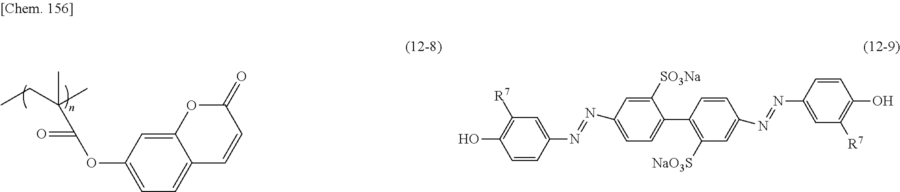

In the above general formulae (12-1) to (12-9), R⁵ represents a hydrogen atom, a halogen atom, an alkyl group having 1 to 3 carbon atoms, an alkoxy group, or a nitro group, R⁶ represents a hydrogen atom or an alkyl group having 1 to 10 carbon atoms, the alkyl group may be linear or branched, any hydrogen atom in the alkyl group may be substituted with a fluorine atom, and one —CH₂— or two or more (—CH₂—)'s not adjacent to each other in the alkyl group may be each independently substituted with —O—, —S—, —CO—, —COO—, —OCO—, —CO—S—, —S—CO—, —O—CO—O—, —CO—NH—, —NH—CO— or —C≡C—, the terminal CH₃ may be substituted with CF₃, CCl₃, a cyano group, a nitro group, an isocyano group, or a thioisocyano group, n represents 4 to 100000, and m represents an integer of 1 to 10.

In the general formulae (12-1) to (12-9), R⁷ represents a polymerizable functional group selected from a group consisting of a hydrogen atom, a halogen atom, a halogenoalkyl group, an allyloxy group, a cyano group, a nitro group, an alkyl group, a hydroxyalkyl group, an alkoxy group, a carboxy group or an alkali metal salt thereof, an alkoxycarbonyl group, a halogenomethoxy group, a hydroxy group, a sulfonyloxy group or an alkali metal salt thereof, an amino group, a carbamoyl group, a sulfamoyl group or a (meth)acryloyl group, a (meth)acryloyloxy group, a (meth)acryloylamino group, a vinyl group, a vinyloxy group and a maleimide group.

### (Production Method for Permeable Membrane/Laminate)

### (Permeable Membrane/Laminate)

The gas-selective permeable membrane of the present invention indicates a polymer of the above-mentioned polyfunctional polycyclic polymerizable compound-containing composition, or a layer part formed of the polymer.

The laminate of the present invention indicates one produced by successively laminating a polymer of the polyfunctional polycyclic polymerizable compound-containing compound on a gas-permeable substrate optionally using an alignment film, or one produced by laminating a polymer of the polyfunctional polycyclic polymerizable compound-containing composition on a substrate, then sticking a gas-permeable substrate onto the polymer via a pressure-sensitive adhesive agent, a pressure-sensitive adhesive tape or a self-adhesive agent, and thereafter peeling the substrate used in forming the polymer, from the polymer. With no specific limitation, the substrate to be used in forming the polymer of the polyfunctional polycyclic polymerizable compound-containing composition may have or may not have gas permeability, but form the viewpoint of the polymer peelability, the substrate is preferably glass, a metal film, an acrylate crosslinked body processed for regular surface roughness formation, a cycloolefin polymer, a polyester such as polyethylene terephthalate, polybutylene terephthalate, polyethylene naphthalate or the like, a polystyrene, a polycarbonate, etc.

### (Gas-Permeable Substrate)

The gas-permeable substrate for use in the permeable membrane or the laminate of the present invention may be any known, conventional, gas-permeable inorganic or organic film, with no specific limitation. Such a substrate includes films, sheets, hollow fiber membranes and porous membranes of organic materials such as plastics and the like, and porous membranes of inorganic materials such as ceramic substrates, etc.

Specifically, the organic material for the substrate includes cellulose derivatives such as diacetyl cellulose, triacetyl cellulose, cellulose acetate, nitrocellulose, etc.; polyolefins such as low-density polyethylene, high-density polyethylene, polypropylene, polymethylpentene (TPX), butyl rubber, etc.; cycloolefin polymers, polyacrylates, PMMA, polyacrylates such as polyacrylonitrile, etc.; polyacetates, polyimides such as aromatic polyimides, aliphatic polyimides, etc.; polyamide, polysulfones, polyether sulfones, polyphenylene sulfides, polyphenylene ethers, polyarylates, nylons, polystyrenes, silicone rubbers, etc.

The inorganic material for the substrate includes zeolite, silica ceramics, silica glass, alumina ceramics, stainless porous materials, titanium porous materials, silver porous materials, etc.

Above all, plastic substrates of polyolefins, polymethylpentens (TPX), cellulose derivatives, polyimides, polyacrylates or the like are preferred.

Regarding the shape thereof, the gas-permeable substrate may be a tabular, cylindrical or curved one. In the case of a tabular substrate such as a film or a sheet, the substrate may have an asymmetric form in which one surface thereof is a compact layer and the other surface is a porous layer, or may have a symmetric form in which both surfaces of the substrate are compact layers, or may have a symmetric form in which both surfaces of the substrate are porous layers. In the case of a cylindrical substrate of a hollow fiber membrane, the substrate may have an asymmetric form in which the outer side is a compact layer and the inner side is a porous layer, or may have a symmetric form in which both the outer side and the inner side are compact layers, or may have a symmetric form in which both the outer side and the inner side are porous layers. The substrate may be optically transparent or non-transparent, or may be formed according to a melting method, or may be formed according to a solution casting method. The substrate may be unstretched, or uniaxially stretched or biaxially stretched.

In the case where the gas-selective permeable membrane of the present invention is used as a laminate, the thickness of the gas-permeable substrate is, from the viewpoint of gas permeability, productivity and module workability, preferably 1 to 100 μm, more preferably 4 to 80 μm, even more preferably 10 to 50 μm.

For the purpose of improving the coatability of the gas-permeable substrate with the composition for constituting the polymer to be contained in the gas-selective permeable membrane of the present invention or for improving the adhesiveness of the composition to the substrate, the gas-permeable substrate may be surface-treated. The surface treatment includes ozone treatment, plasma treatment, corona treatment, silane coupling treatment, etc.

### (Alignment Treatment)

In addition, the gas-permeable substrate is generally processed for alignment treatment for securing alignment of the polymerizable composition in coating and drying the solution of the composition to constitute the polymer to be contained in the gas-selective permeable membrane of the present invention, or an alignment film may be formed on the substrate. The alignment treatment includes stretching treatment, rubbing treatment, polarizing UV or visible light irradiation treatment, ion beam treatment, oblique deposition of SiO₂ on the substrate, etc. In the case where an alignment film is used, the alignment film may be any known conventional one. Such an alignment film includes compounds such as polyimides, polysiloxanes, polyamides, polyvinyl alcohols, polycarbonates, polystyrenes, polyphenylene ethers, polyarylates, polyethylene terephthalates, polyether sulfones, epoxy resins, epoxyacrylate resins, acrylic resins, coumarin compounds, chalcone compounds, cinnamate compounds, fulgide compounds, anthraquinone compounds, azo compounds, arylethene compounds, etc., and polymers or copolymers of those compounds. The compound to be aligned by rubbing is preferably one capable of accelerating crystallization of a material by alignment treatment or by an additional heating step after alignment treatment. Among the compounds to be aligned by any other treatment than rubbing, photoalignment materials are preferred.

### (Coating)

The coating method for producing the gas-selective permeable membrane of the present invention may be a known conventional method, including an applicator method, a bar coating method, a spin coating method, a roll coating method, a direct gravure coating method, a reverse gravure coating method, a flexographic coating method, an ink-jet method, a die coating method, a cap coating method, a dip coating method, a slit coating method, etc.

Preferably, after coated, the molecules of the polymerizable compound in the polymerizable composition for use in producing the gas-selective permeable membrane of the present invention keep uniaxial or multiaxial molecular alignment. Specifically, heat treatment for inducing molecular alignment is preferred as promoting uniaxial or multiaxial molecular alignment. Regarding the heat treatment method, for example, the polymerizable composition for forming the gas-selective permeable membrane of the present invention is applied onto a substrate, then the composition is made to be liquid, and thereafter optionally left cooled to form a uniaxial or multiaxial molecular alignment state. In this step, preferably, the temperature is kept constant to form a uniform molecular alignment state. Alternatively, after applied onto a substrate, the polymerizable composition to form the gas-selective permeable membrane of the present invention may be heat-treated for a predetermined period of time in such that the molecules in the composition could be kept at a temperature falling within a temperature range for forming a uniaxial or multiaxial molecular alignment state. When the heating temperature is too high, the composition may undergo some unfavorable polymerization reaction to degrade. When cooled too much, the molecules in the composition may cause phase separation to disturb the molecular alignment state through crystal precipitation.

Through such heat treatment, a homogeneous, gas-selective permeable membrane having a uniform molecular alignment state with few defects can be obtained, as compared with that produced according to a mere coating method.

### (Polymerization Step)

Regarding the method of polymerizing the polymerizable composition to produce the gas-selective permeable membrane of the present invention, a method of irradiation with active energy rays, a thermal polymerization method or the like is employable. A method of irradiation with active energy rays is preferred since the method does not require heating and the reaction can run on at room temperature. Above all, because the operation is simple, a method of irradiation with UV rays or the like is preferred.

Specifically, irradiation with UV rays at 390 nm or shorter is preferred, and irradiation with light having a wavelength of 250 to 370 nm is most preferred. However, in the case where the polymerizable composition may decompose with UV rays at 390 nm or shorter, polymerization treatment with UV rays at 390 nm or more may be preferred, as the case may be. The light is preferably a diffusion light but not a polarized light. The UV irradiation intensity is preferably within a range of 0.05 kW/m² to 10 kW/m². In particular, a range of 0.2 kW/m² to 2 kW/m² is preferred. When the UV intensity is less than 0.05 kW/m², much time will be taken for completing polymerization. On the other hand, when at an intensity of more than 2 kW/m², the molecules in the polymerizable composition may photodegrade or the temperature during polymerization may increase owing to too much polymerization heat, and if so, there may be a possibility that the order parameter of the molecules may change to disorder the gas permeability or the gas selectivity of the gas-selective permeable membrane after polymerization.

Using a mask, a specific area alone may be polymerized through irradiation with UV rays, and then the molecular alignment state in the unpolymerized area may be changed by applying thereto an electric field or a magnetic field, or by heating it and thereafter the unpolymerized area may be polymerized to give a gas-selective permeable membrane having plural regions each having a different molecular alignment direction.

The temperature in UV irradiation is a temperature at which the polymerizable composition can maintain a uniaxial or multiaxial molecular alignment state in forming the gas-selective permeable membrane of the present invention, and for evading induction of thermal polymerization of the polymerizable composition, the temperature is preferably as near as possible to 60° C. or lower.

The gas-selective permeable membrane of the present invention can be used as a single body of the gas-selective permeable membrane after peeled from a gas-permeable substrate, or may be used as it is a laminate having gas permeability and gas selectivity, not peeled from the gas-permeable substrate. In the case where the gas-selective permeable membrane of the present invention is stuck to a gas-permeable substrate using a pressure-sensitive agent, a pressure-sensitive tape or a self-adhesive agent, the gas-selective permeable membrane of the present invention may be stuck thereto after peeled from the substrate used in producing the permeable membrane; or the gas-selective permeable membrane of the present invention may be stuck to a gas-permeable substrate and then the permeable membrane may be peeled from the substrate used in producing the permeable membrane. In the case where a pressure-sensitive adhesive agent, a pressure-sensitive adhesive tape or a self-adhesive agent is used, the pressure-sensitive adhesive agent, the pressure-sensitive adhesive tape or the self-adhesive agent to be used may be any known conventional one. In the case where a pressure-sensitive adhesive tape is used, the pressure-sensitive adhesive tape is preferably a substrateless pressure-sensitive tape not having a core substrate of PET, cellulose or the like in the center part thereof for securing gas permeability. In the case of using a self-adhesive agent, any of a thermal self-adhesive agent or an optical self-adhesive agent may be used not detracting from the gas permeability and the gas selectivity of the permeable membrane of the present invention.

### (Gas-Selective Module)

The permeable membrane or the laminate of the present invention is favorably used in a module assembly. Using the permeable membrane, the laminate or the gas-selective module of the present invention, a gas separation apparatus having a gas separation and collection function or a gas separation and purification function may be constructed. With no specific limitation, the gas-selective module may be any one having a gas or liquid separation capability, including, for example, a spiral module, a hollow-fiber module, a pleated module, a tubular module, etc. In the present invention, a spiral module and a hollow-fiber module are preferred from the viewpoint of workability and productivity.

### Examples

Some best embodiments of the present invention will be described in detail hereinunder with reference to Examples thereof, but the present invention is not limited to these Examples. Unless otherwise specifically indicated, “part” and “%” are by mass.

### (Preparation of Solution (1) Used for Permeable Membrane of the Invention)

25 parts of the compound represented by the formula (A-1), 25 parts of the compound represented by the formula (A-2), 10 parts of the compound represented by the formula (A-3), 40 parts of the compound represented by the formula (A-4), 3.0 parts of the compound represented by the formula (D-1), 0.1 parts of the compound represented by the formula (E-1), and 0.2 parts of a surfactant, Megafac F-554 (by DIG Corporation) were stirred in 300 parts of propylene glycol monomethyl ether acetate, using a stirring device having a stirring propeller, under the conditions of a stirring speed of 500 rpm and a solution temperature of 70° C. for 1 hour, and then filtered through a 0.2-nm membrane filter to give a solution (1).

### (Preparation of Solutions (2) to (13) for Use for Permeable Membrane of the Invention)

In the same manner as that for the solution (1) for use for the permeable membrane of the present invention, the compounds of the formulae (A-1) to (A-7), (B-1) to (B-7), and (C-1) to (C-2), the compounds of the formulae (D-1) and (E-1) and surfactants of the compounds of the formulae (F-1) to (F-2) shown in Table 1 were stirred in an organic solvent of the formulae (H-1) to (H-2), using a stirring device having a stirring propeller, under the condition of a stirring speed of 500 rpm and a solution temperature of 70° C. for 1 hour, and then filtered through a 0.2-μm membrane filter to give solutions (2) to (13) for use for the permeable membranes of the present invention.

Table 1 shows concrete compositions of the solutions (1) to (13) of the present invention.

TABLE 1

| | Solution | | | | | | | | | | | | |
|---|---|---|---|---|---|---|---|---|---|---|---|---|---|
| | (1) | (2) | (3) | (4) | (5) | (6) | (7) | (8) | (9) | (10) | (11) | (12) | (13) |
| (A-1) | 25 | 43 | 42 | 20 | | | 15 | 15 | | | 43 | 43 | 43 |
| (A-2) | 25 | 43 | 33 | 50 | | | 25 | 45 | | | 43 | 43 | 43 |
| (A-3) | 10 | | | | | | | | | | | | |
| (A-4) | 40 | | | | 40 | | 10 | | 15 | 30 | | | |
| (A-5) | | | | | 40 | 50 | | | | | | | |
| (A-6) | | | | | 20 | 15 | 20 | | 5 | | | | |
| (A-7) | | | | | | | | 40 | | | | | |
| (B-1) | | 14 | | | | | 30 | | | | 14 | 14 | 14 |
| (B-2) | | | 25 | | | | | | | | | | |
| (B-3) | | | | 30 | | | | | | | | | |
| (B-4) | | | | | | 20 | | | | 30 | | | |
| (B-5) | | | | | | 15 | | | | | | | |
| (B-6) | | | | | | | | | 60 | | | | |
| (B-7) | | | | | | | | | 15 | 40 | | | |
| (C-1) | | | 8.5 | | | | | | | | | | |
| (C-2) | | | | | | | | | 5 | | | | |
| (D-1) | 3 | 3 | 3 | 3 | 5 | 5 | 3 | 3 | 5 | 5 | 3 | 3 | 3 |
| (E-1) | 0.1 | 0.1 | 0.1 | 0.1 | 0.1 | 0.1 | 0.1 | 0.1 | 0.1 | 0.1 | 0.1 | 0.1 | 0.1 |
| (F-1) | 0.2 | | 0.2 | | 0.2 | 0.2 | | | 0.2 | 0.1 | | | |
| (F-2) | | 0.1 | | 0.1 | | | 0.1 | 0.1 | | | 0.1 | 0.1 | 0.1 |
| (H-1) | 300 | 300 | | 300 | 300 | 300 | 300 | 300 | | 300 | 1900 | 565 | 150 |
| (H-2) | | | 300 | | | | | | 300 | | | | |

### (Preparation of Comparative Solution (14)

Using a stirring device having a stirring propeller, the compound shown in Table 2 was stirred for 1 hour under the condition of a stirring speed of 100 rpm at a solution temperature of 100° C., and then filtered through a 1-μm membrane filter to give a comparative solution (14).

TABLE 2

| Comparative | |
|---|---|
| Solution | (14) |
| BCH-32 | 10.0 |
| CCP-V-1 | 10.0 |
| CC-3-V1 | 12.0 |
| CPY-2-O2 | 12.0 |
| CPY-3-O2 | 13.0 |
| B-302FF | 19.0 |
| B-502FF | 17.0 |
| PP-1-4 | 7.0 |
| (F-1) | 0.1 |

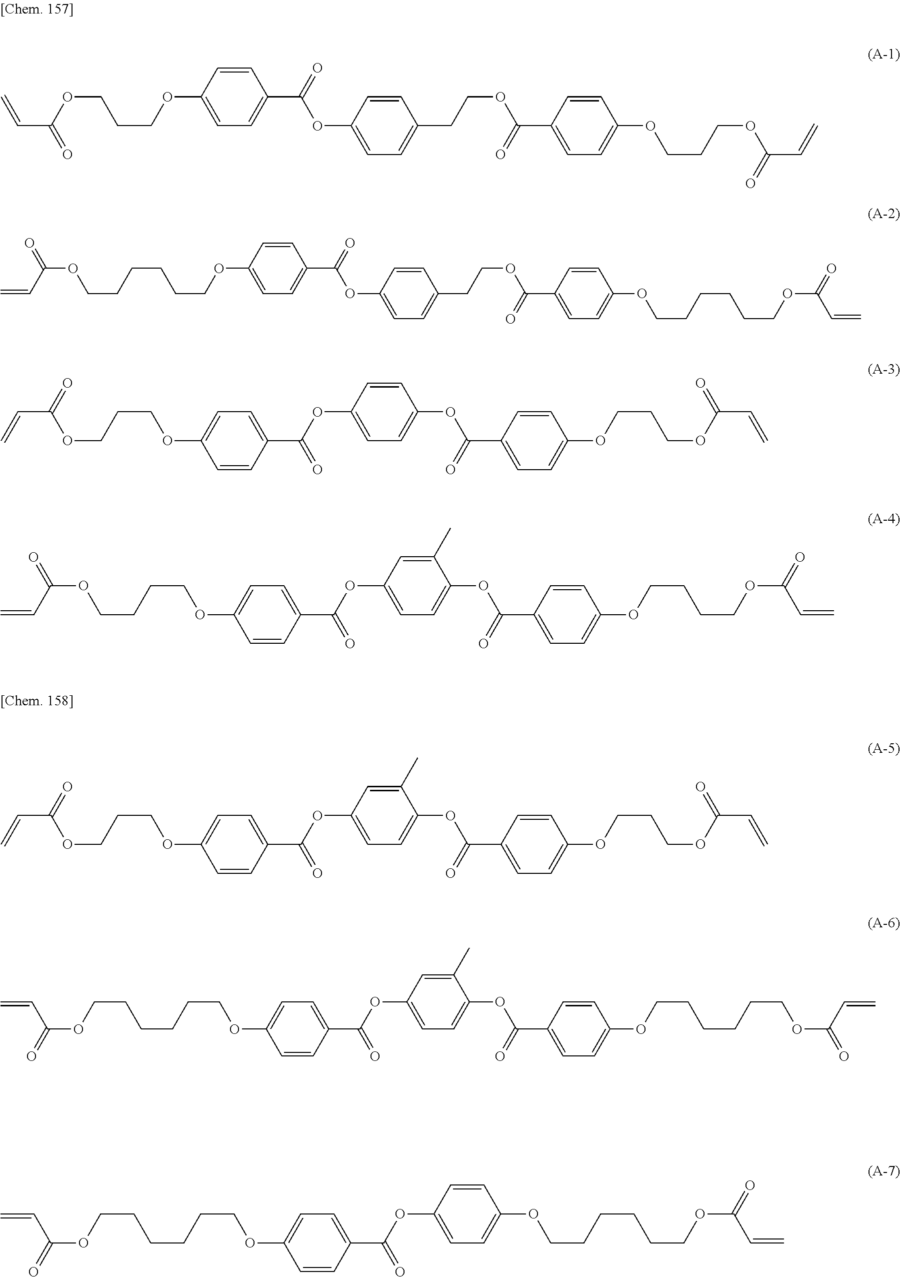

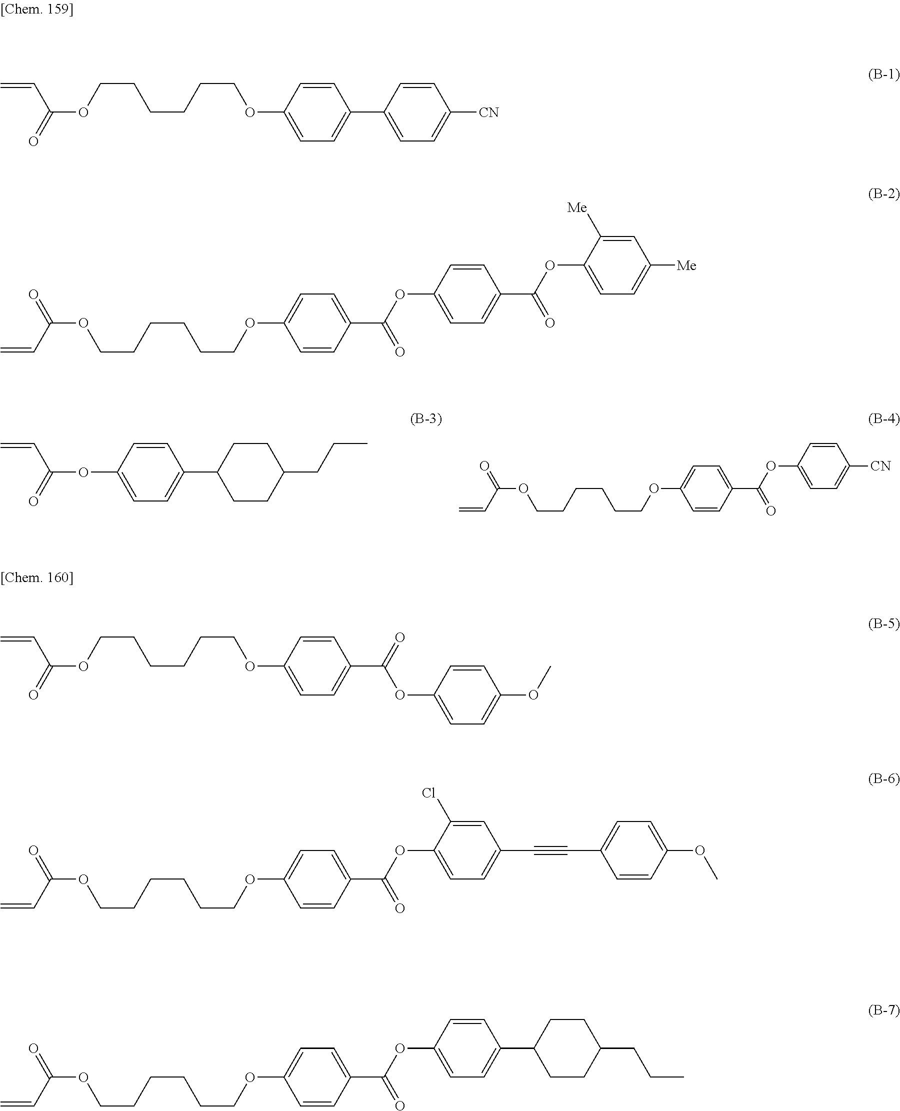

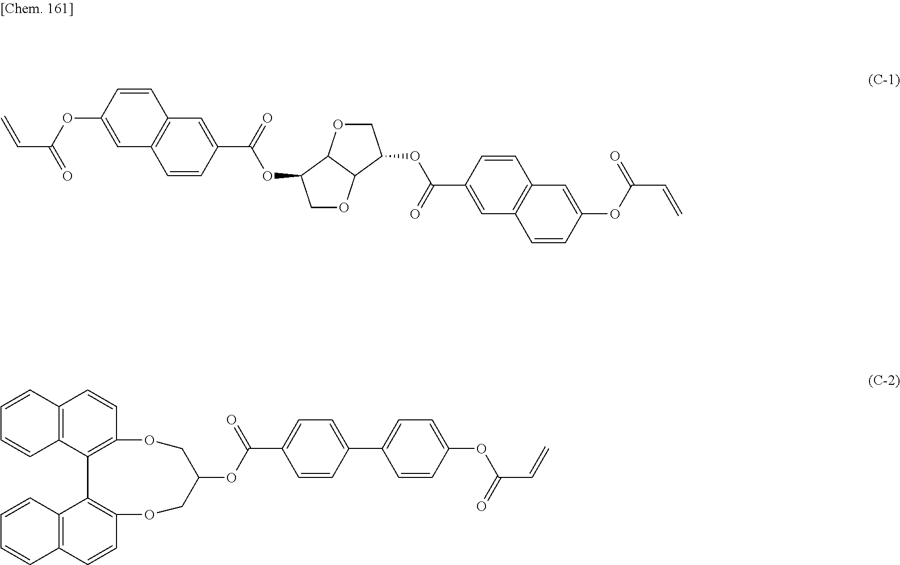 [SMILES: C=CC(=O)Oc1ccc2cc(C(=O)O[C@H]3COC4C3OC[C@H]4OC(=O)c3ccc4cc(OC(=O)C=C)ccc4c3)ccc2c1 ; C=CC(=O)Oc1ccc(-c2ccc(C(=O)OC3COc4ccc5ccccc5c4-c4c(ccc5ccccc45)OC3)cc2)cc1]

### Irgacure 507 (D-1)

### P-methoxyphenol (E-1)

### Megafac F-554 (F-1)

### Megafac F-556 (F-2)

Propylene glycol monoether acetate (abbreviation: PGMEA) (H-1)
Cyclopentanone (abbreviation: CPN) (H-2)

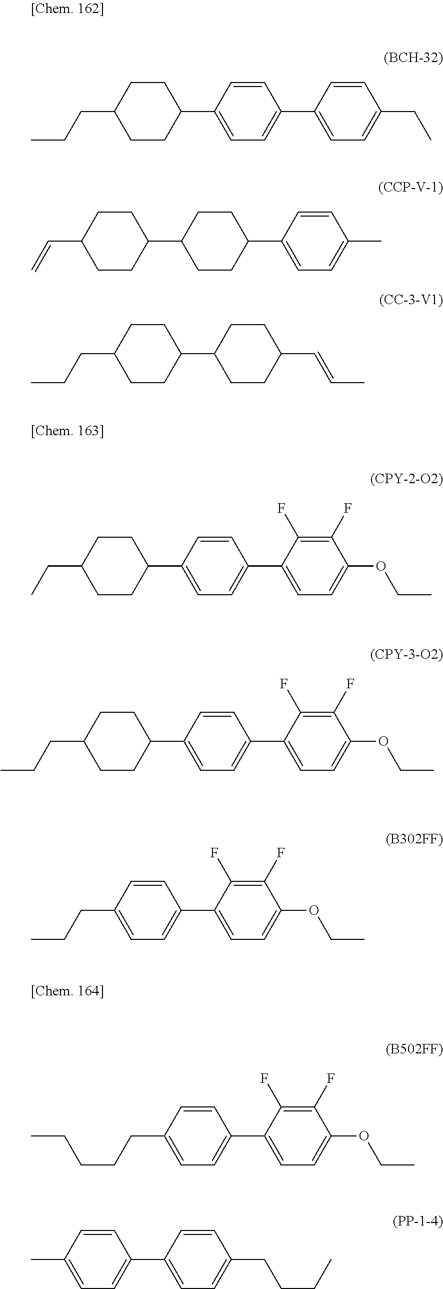

### (Production of Laminate 1)

On a triacetyl cellulose (TAG) film of a substrate having a thickness of 80 μm, which had been rubbed at an angle of 45° with respect to MD (machine direction) of the film, the solution (1) was applied using a die coater for forming a permeable membrane of the present invention, and then dried thereon at 80° C. for 2 minutes. Subsequently, this was left at room temperature for 2 minutes and then irradiated with UV light in a nitrogen atmosphere using an ultra-high pressure mercury lamp in such that the cumulative light quantity could be 500 mJ/cm², thereby giving a laminate 1 containing a polymer that had been polymerized in a state of uniaxial alignment in the horizontal direction with respect to the face of the membrane (FIG. 1). The thickness of the permeable membrane of the laminate 1 was 1.1 μm, as measured using DEKTAK XT (by Bruker Corporation).

### (Production of Laminate 2)

Using a die coater, the solution (2) was applied onto the TAC film of a substrate having a thickness of 80 μm to form a permeable membrane of the present invention, and then dried at 80° C. for 2 minutes. Subsequently, this was left at room temperature for 2 minutes and then irradiated with UV light in a nitrogen atmosphere using an ultra-high pressure mercury lamp in such that the cumulative light quantity could be 500 mJ/cm², thereby giving a laminate 2 containing a polymer that had been polymerized in a state having a long-range order with constant periodicity in the horizontal direction with respect to the face of the membrane and, in the vertical direction with respect to the face of the membrane, not having regularity or having not a long-range order but a short-range order regularity (FIG. 6).

### (Production of Laminate 3)

According to the same production method and under the same condition as those for the laminate 1 except that the solution for use for forming the permeable membrane of the present invention was changed to the solution (3), a laminate 3 was produced, containing a polymer that had been polymerized in an alignment state aligned in the horizontal direction with respect to the face of the membrane and having a constant periodic helical structure in the thickness direction of the membrane (FIG. 4).

### (Production of Laminate 4)

According to the same production method and under the same condition as those for the laminate 1 except that the solution for use for forming the permeable membrane of the present invention was changed to the solution (4), a laminate 4 was produced, containing a polymer that had been polymerized in a state of uniaxial alignment in the horizontal direction with respect to only one face (back face) of the membrane with gradually changing the alignment inclination from the surface of the membrane toward the inside thereof (FIG. 3).

### (Production of Laminate 5 to Laminate 7)

Laminates 5 to 7 having the same alignment state as that of the laminate 1 were produced according to the same production method and under the same condition as those for the laminate 1 except that a poly-4-methyl-pentene-1 (TPX) film having a thickness of 50 μm and having been rubbed at an angle of 45° with respect to MD of the film was used as a substrate and that the solution for forming the permeable membrane of the present invention was changed to any of the solution (1), the solution (5) and the solution (6) (FIG. 1).

### (Production of Laminate 8 and Laminate 10)

Laminates 8 and 10 having the same alignment state as that of the laminate 2 were produced according to the same production method and under the same condition as those for the laminate 2 except that a poly-4-methyl-pentene-1 (TPX) film having a thickness of 50 μm was used as a substrate and that the solution for forming the permeable membrane of the present invention was changed to any of the solution (2) and the solution (8) (FIG. 6).

### (Production of Laminate 9)

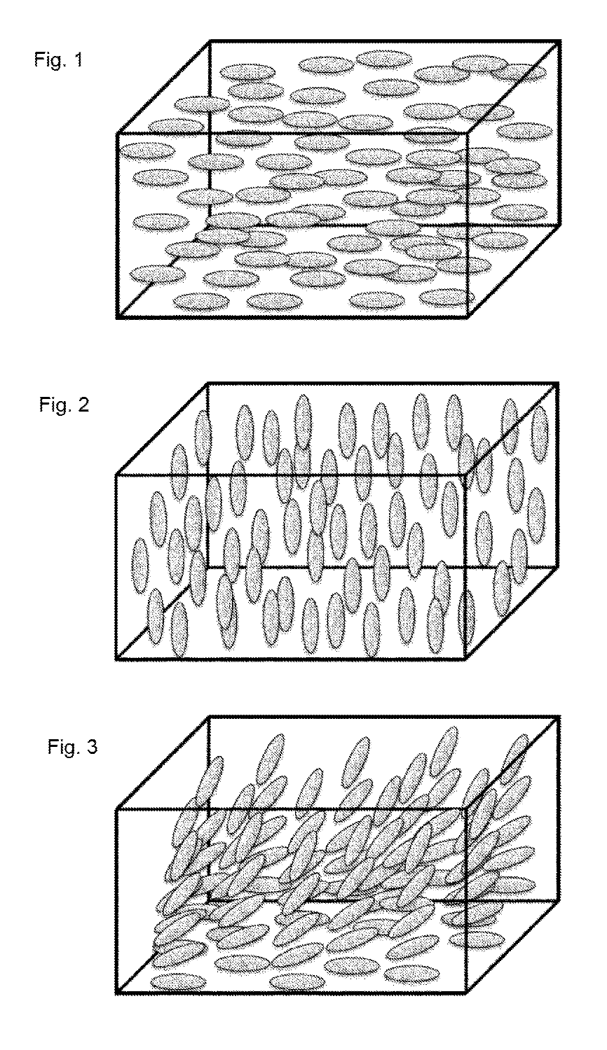

A laminate 9 containing a polymer that had been polymerized in a state where the molecules could uniaxially align in the vertical direction with respect to the face of the membrane was produced according to the same production method and under the same condition as those for the laminate 2 except that a poly-4-methyl-pentene-1 (TPX) film having a thickness of 50 μm was used as a substrate and that the solution for forming the permeable membrane of the present invention was changed to the solution (7) (FIG. 2).

### (Production of Laminate 11 and Laminate 12)

Laminates 11 and 12 having the same alignment state as that of the laminate 3 were produced according to the same production method and under the same condition as those for the laminate 3 except that a poly-4-methyl-pentene-1 (TPX) film having a thickness of 50 μm and having been rubbed at an angle of 45° with respect to MD of the film was used as a substrate and that the solution for forming the permeable membrane of the present invention was changed to the solution (3) or the solution (9) (FIG. 4).

### (Production of Laminate 13 and Laminate 14)

Laminates 13 and 14 having the same alignment state as that of the laminate 4 were produced according to the same production method and under the same condition as those for the laminate 4 except that a poly-4-methyl-pentene-1 (TPX) film having a thickness of 50 μm and having been rubbed at an angle of 45° with respect to MD of the film was used as a substrate and that the solution for forming the permeable membrane of the present invention was changed to the solution (4) or the solution (10) (FIG. 3).

### (Production of Laminate 15)

A laminate 15 having the same alignment state as that of the laminate 2 was produced according to the same production method and under the same condition as those for the laminate 2 except that the substrate was changed to a polypropylene (PP) film having a thickness of 30 μm (FIG. 6).

### (Production of Laminate 16)

A laminate 16 having the same alignment state as that of the laminate 2 was produced according to the same production method and under the same condition as those for the laminate 2 except that the substrate was changed to a polyethylene (PE) film having a thickness of 40 μm (FIG. 6).

### (Production of Laminate 17 to Laminate 19)

Laminates 17 to 19 having the same alignment state as that of the laminate 2 were produced according to the same production method and under the same condition as those for the laminate 2 except that the substrate was changed to a poly-4-methyl-pentene-1 (TPX) film having a thickness of 50 μm and that the solution for forming the permeable membrane of the present invention was changed to any of the solutions (11) to (13) (FIG. 6).

### (Production of Laminate 20)

Using an applicator, the comparative solution (14) was applied onto a substrate, TAG film having a thickness of 80 μm and having been rubbed at an angle of 45° in MD of the film, and left at room temperature for 5 minutes for alignment to produce a laminate 20. However, the permeable membrane layer could not be fixed on the substrate layer, and therefore a measurable laminate could not be produced.

### <Evaluation>

### (Measurement of Gas Permeability and Evaluation of Separation Performance)

Using a gas permeability measuring apparatus (GTR-31A, by GTR Tec Corporation), the laminates produced according to the above-mentioned methods were analyzed for the gas permeability of various gases therethrough under the condition of a pressure of 150 kPa and a temperature of 40° C. to thereby determine the permeation coefficient of various gases therethrough.

The resultant permeation coefficient was divided by the membrane thickness to determine the permeation flux of various gases. Next, according to the following equation (1), the permeation flux through the permeable membranes of Examples was determined. The gas separation performance of the permeable membrane can be determined by calculating the ratio of the permeation flux of each gas.

Q (permeable membrane)={Q (laminate)×Q (substrate)}/{Q (substrate)−Q (laminate)} (1)

(wherein Q represents the gas permeation flux through each layer).

The permeation flux Q (permeable membrane) (unit: GPU) of each gas through the permeable membrane is shown in Table 3 below, and the gas separation performance is in Tables 4 to 6 below.

TABLE 3

| | | Thickness of | Permeation Flux Q | | | | | |
|---|---|---|---|---|---|---|---|---|
| | | Permeable | (permeable membrane) [GPU] | | | | | |
| | | Layer μm | He | H₂ | CO₂ | O₂ | N₂ | CH₄ |
| Example 1 | Laminate 1 | 1.1 | 1.62 | 1.68 | 0.40 | 0.08 | 0.02 | 0.02 |
| Example 2 | Laminate 2 | 1.1 | 3.29 | 3.69 | 0.54 | 0.10 | 0.03 | 0.03 |
| Example 3 | Laminate 3 | 0.9 | 4.22 | 5.70 | 4.59 | 0.32 | 0.10 | 0.11 |
| Example 4 | Laminate 4 | 1.3 | 5.90 | 3.53 | 4.00 | 0.29 | 0.11 | 0.11 |
| Example 5 | Laminate 5 | 1.1 | 1.75 | 1.70 | 0.40 | 0.07 | 0.03 | 0.03 |
| Example 6 | Laminate 6 | 1.1 | 1.60 | 1.60 | 0.40 | 0.07 | 0.02 | 0.02 |
| Example 7 | Laminate 7 | 1.0 | 1.00 | 1.10 | 0.35 | 0.07 | 0.01 | 0.02 |
| Example 8 | Laminate 8 | 1.1 | 2.40 | 2.49 | 0.75 | 0.16 | 0.03 | 0.03 |
| Example 9 | Laminate 9 | 1.1 | 1.50 | 1.50 | 0.38 | 0.08 | 0.01 | 0.02 |
| Example 10 | Laminate 10 | 1.1 | 1.30 | 1.30 | 0.40 | 0.08 | 0.01 | 0.02 |
| Example 11 | Laminate 11 | 0.9 | 4.80 | 5.80 | 4.50 | 0.40 | 0.14 | 0.13 |
| Example 12 | Laminate 12 | 1.0 | 4.10 | 5.00 | 4.00 | 0.30 | 0.10 | 0.10 |
| Example 13 | Laminate 13 | 1.3 | 4.80 | 4.00 | 4.00 | 0.35 | 0.13 | 0.13 |
| Example 14 | Laminate 14 | 1.0 | 2.50 | 2.30 | 0.50 | 0.11 | 0.02 | 0.02 |
| Example 15 | Laminate 15 | 1.1 | 2.40 | 2.30 | 0.70 | 0.12 | 0.03 | 0.03 |
| Example 16 | Laminate 16 | 1.1 | 2.20 | 2.17 | 0.91 | 0.20 | 0.04 | 0.04 |
| Example 17 | Laminate 17 | 0.2 | 5.60 | 5.90 | 2.30 | 0.40 | 0.05 | 0.05 |
| Example 18 | Laminate 18 | 0.5 | 4.50 | 4.60 | 2.00 | 0.32 | 0.04 | 0.04 |
| Example 19 | Laminate 19 | 5.0 | 0.31 | 0.30 | 0.09 | 0.02 | 0.007 | 0.007 |
| Reference | TAC | 81.0 | 0.23 | 0.19 | 0.10 | 0.02 | 0.004 | 0.005 |
| Example 1 | Substrate | | | | | | | |

| | | |
|---|---|---|
| Comparative | Laminate 20 | Unmeasurable since the membrane was not fixed. |
| Example 1 | | |

TABLE 4

| | | Separation Performance | | |
|---|---|---|---|---|
| | | He/O₂ | He/N₂ | He/CH₄ |
| Example 1 | Laminate 1 | 20 | 108 | 90 |
| Example 2 | Laminate 2 | 31 | 114 | 132 |
| Example 3 | Laminate 3 | 13 | 42 | 38 |
| Example 4 | Laminate 4 | 21 | 54 | 54 |
| Example 5 | Laminate 5 | 25 | 58 | 58 |
| Example 6 | Laminate 6 | 23 | 107 | 94 |
| Example 7 | Laminate 7 | 14 | 71 | 63 |
| Example 8 | Laminate 8 | 15 | 80 | 80 |
| Example 9 | Laminate 9 | 20 | 107 | 88 |
| Example 10 | Laminate 10 | 17 | 90 | 76 |
| Example 11 | Laminate 11 | 12 | 34 | 37 |
| Example 12 | Laminate 12 | 14 | 41 | 41 |
| Example 13 | Laminate 13 | 14 | 37 | 37 |
| Example 14 | Laminate 14 | 23 | 125 | 125 |
| Example 15 | Laminate 15 | 20 | 80 | 80 |
| Example 16 | Laminate 16 | 11 | 55 | 55 |
| Example 17 | Laminate 17 | 14 | 112 | 112 |
| Example 18 | Laminate 18 | 14 | 113 | 113 |
| Example 19 | Laminate 19 | 14 | 113 | 113 |

| | | |
|---|---|---|
| Comparative | Laminate 20 | — |
| Example 1 | | |

TABLE 5

| | | Separation Performance | | |
|---|---|---|---|---|
| | | H₂/O₂ | H₂/N₂ | H₂/CH₄ |
| Example 1 | Laminate 1 | 21 | 111 | 93 |
| Example 2 | Laminate 2 | 35 | 127 | 148 |
| Example 3 | Laminate 3 | 18 | 57 | 51 |
| Example 4 | Laminate 4 | 12 | 32 | 32 |
| Example 5 | Laminate 5 | 24 | 57 | 57 |
| Example 6 | Laminate 6 | 23 | 107 | 94 |
| Example 7 | Laminate 7 | 16 | 79 | 69 |
| Example 8 | Laminate 8 | 16 | 83 | 83 |
| Example 9 | Laminate 9 | 20 | 107 | 88 |
| Example 10 | Laminate 10 | 17 | 90 | 76 |
| Example 11 | Laminate 11 | 15 | 41 | 45 |
| Example 12 | Laminate 12 | 17 | 50 | 50 |
| Example 13 | Laminate 13 | 11 | 31 | 31 |
| Example 14 | Laminate 14 | 21 | 115 | 115 |
| Example 15 | Laminate 15 | 19 | 77 | 77 |
| Example 16 | Laminate 16 | 11 | 54 | 54 |
| Example 17 | Laminate 17 | 15 | 118 | 118 |
| Example 18 | Laminate 18 | 14 | 115 | 115 |
| Example 19 | Laminate 19 | 15 | 43 | 43 |

| | | |
|---|---|---|
| Comparative | Laminate 17 | — |
| Example 1 | | |

TABLE 6

| | | Separation Performance | | | | |
|---|---|---|---|---|---|---|
| | | | | CO₂/ | | O₂/ |
| | | CO₂/O₂ | CO₂/N₂ | CH₄ | O₂/N₂ | CH₄ |
| Example 1 | Laminate 1 | 5 | 27 | 22 | 5 | 4 |
| Example 2 | Laminate 2 | 5 | 19 | 22 | 4 | 4 |
| Example 3 | Laminate 3 | 14 | 46 | 41 | 3 | 3 |
| Example 4 | Laminate 4 | 14 | 36 | 36 | 3 | 3 |
| Example 5 | Laminate 5 | 6 | 13 | 13 | 2 | 2 |
| Example 6 | Laminate 6 | 6 | 27 | 24 | 5 | 4 |
| Example 7 | Laminate 7 | 5 | 25 | 22 | 5 | 4 |
| Example 8 | Laminate 8 | 5 | 25 | 25 | 5 | 5 |
| Exampie 9 | Laminate 9 | 5 | 27 | 22 | 5 | 4 |
| Exampie 10 | Laminate 10 | 5 | 28 | 24 | 5 | 4 |
| Example 11 | Laminate 11 | 11 | 32 | 35 | 3 | 3 |
| Example 12 | Laminate 12 | 13 | 40 | 40 | 3 | 3 |
| Example 13 | Laminate 13 | 11 | 31 | 31 | 3 | 3 |
| Example 14 | Laminate 14 | 5 | 25 | 25 | 6 | 6 |
| Exampie 15 | Laminate 15 | 6 | 23 | 23 | 4 | 4 |
| Exampie 16 | Laminate 16 | 5 | 23 | 23 | 5 | 5 |
| Example 17 | Laminate 17 | 6 | 46 | 46 | 8 | 8 |
| Example 18 | Laminate 18 | 6 | 50 | 50 | 8 | 8 |
| Example 19 | Laminate 19 | 5 | 13 | 13 | 3 | 3 |

| | | |
|---|---|---|
| Comparative | Laminate 20 | — |
| Example 1 | | |

### (Preparation of Solutions (20) to (24) for Use for Permeable Membranes of the Invention)

In the same manner as that for preparing the solution (1) for use for the permeable membrane of the present invention and using a stirring device having a stirring propeller, the compound represented by the formula (A-2), (A-7), (B-1), (B-8), (B-9), (D-1) or (E-1), and a surfactant of the compound represented by the formula (F-1) or (F-2) and the compound represented by the formulae (1-1) to (1-3) shown in Table 7 were stirred in the organic solvent represented by the formula (H-2) under the condition of a stirring speed of 500 rpm at a solution temperature of 70° C. or 1 hour, and then filtered through a 0.2-μm membrane filter to give solutions (20) to (24) for use for the permeable membrane of the present invention.

Table 7 shows concrete compositions of the solutions (20) to (24) of the present invention.

TABLE 7

| | Solution | | | | |
|---|---|---|---|---|---|
| | (20) | (21) | (22) | (23) | (24) |
| (A-2) | 45 | 45 | 20 | 30 | 30 |
| (A-7) | 10 | 10 | | | |
| (B-1) | 15 | 15 | | | |
| (B-8) | 30 | | | | |
| (B-9) | | 30 | | 20 | 20 |
| (J-1) | | | 50 | | |
| (J-2) | | | 30 | | |
| (J-3) | | | | 50 | 50 |
| (D-1) | 3 | 3 | 3 | 3 | 3 |
| (E-1) | 0.1 | 0.1 | 0.1 | 0.1 | 0.1 |
| (F-1) | | | | 0.15 | 0.15 |
| (F-2) | 0.1 | 0.1 | 0.1 | | |
| (H-2) | 300 | 300 | 300 | 500 | 300 |

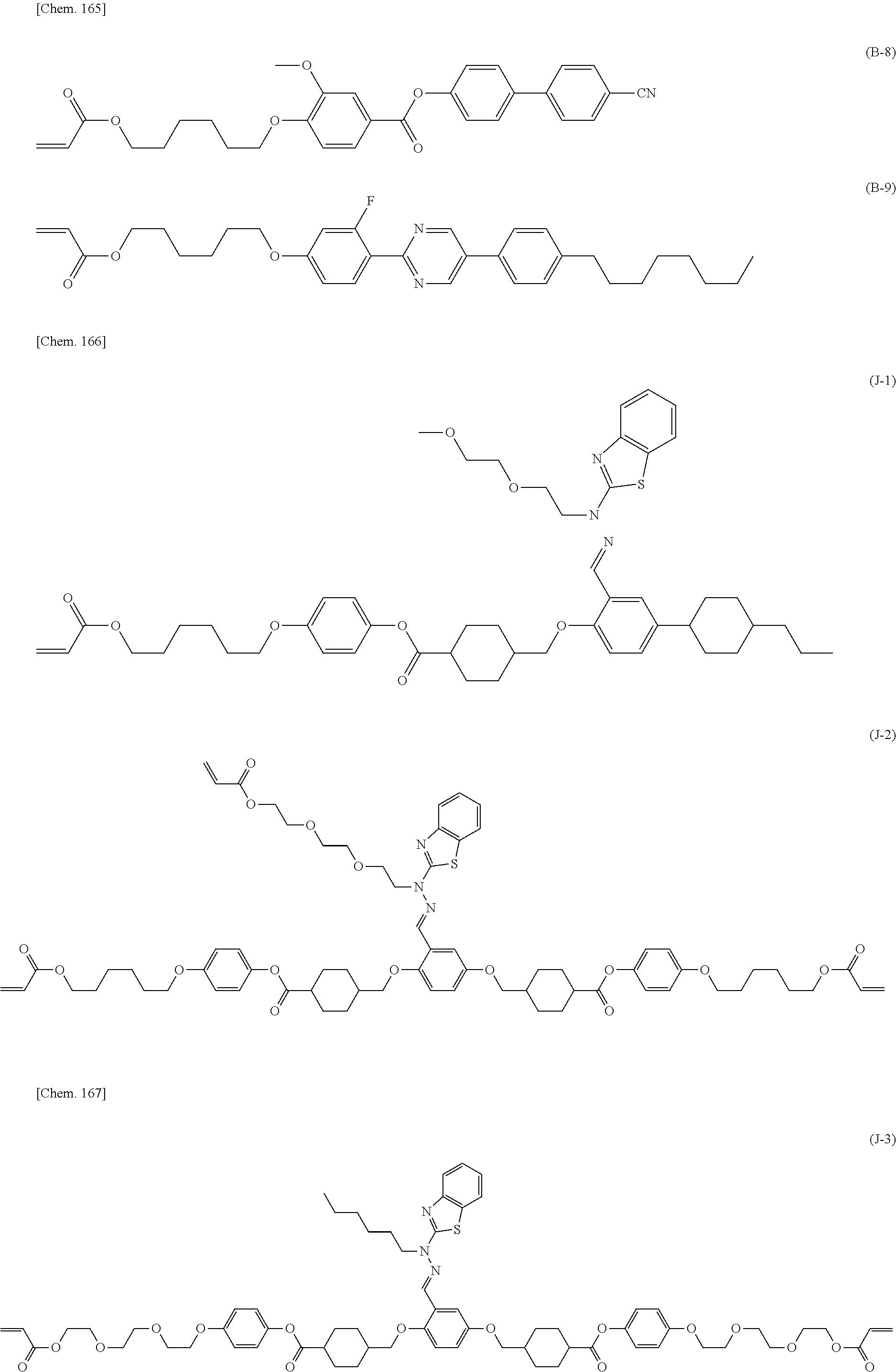

### (Production of Laminate 21 to 24)

According to the same production method and under the same condition as those for the laminate 18 except that a film prepared by laminating a silane coupling-type vertical alignment film on a poly-4-methyl-1-pentene-1 (TPX) film having a thickness of 50 μm was used as the substrate and that the solution for forming the permeable membrane of the present invention was changed to any of the solutions (20) to (23), laminates 21 to 24 were produced, containing a polymer that had been polymerized in a state of uniaxial alignment in the vertical direction with respect to the face of the membrane.

### (Production of Laminate 25)

According to the same production method and under the same condition as those for the laminate 1 except that a poly-4-methyl-1-pentene-1 (TPX) film having a thickness of 50 μm and having been rubbed at an angle of 45° with respect to MD of the film was used as the substrate and that the solution for forming the permeable membrane of the present invention was changed to the solution (24), a laminate 25 having the same alignment state as that of the laminate 1 was produced.

### <Evaluation>

### (Measurement of Gas Permeability and Evaluation of Separation Performance)

The permeation flux Q (permeable membrane) (unit: GPU) of each gas through the permeable membrane is shown in Table 8 below, and the gas separation performance is in Tables 8 to 11 below.

TABLE 8

| | | Thickness of | Permeation Flux Q | | | | | |
|---|---|---|---|---|---|---|---|---|
| | | Permeable | (permeable membrane) [GPU] | | | | | |
| | | Layer μm | He | H₂ | CO₂ | O₂ | N₂ | CH₄ |
| Example 20 | Laminate 21 | 0.5 | 3.65 | 3.60 | 1.84 | 0.08 | 0.08 | 0.14 |
| Example 21 | Laminate 22 | 0.5 | 4.92 | 4.89 | 2.92 | 0.14 | 0.13 | 0.20 |
| Example 22 | Laminate 23 | 0.5 | 12.0 | 12.7 | 8.17 | 0.40 | 0.39 | 0.60 |
| Example 23 | Laminate 24 | 0.2 | 7.80 | 7.94 | 8.94 | 0.39 | 0.36 | 0.61 |
| Example 24 | Laminate 25 | 0.5 | 8.00 | 8.20 | 4.16 | 0.20 | 0.18 | 0.23 |

TABLE 9

| | | Separation Performance | | |
|---|---|---|---|---|
| | | He/O₂ | He/N₂ | He/CH₄ |
| Example 20 | Laminate 21 | 46 | 44 | 26 |
| Example 21 | Laminate 22 | 36 | 37 | 25 |
| Example 22 | Laminate 23 | 30 | 30 | 20 |
| Example 23 | Laminate 24 | 20 | 22 | 13 |
| Example 24 | Laminate 25 | 40 | 46 | 35 |

TABLE 10

| | | Separation Performance | | |
|---|---|---|---|---|
| | | H₂/O₂ | H₂/N₂ | H₂/CH₄ |
| Example 20 | Laminate 21 | 45 | 43 | 26 |
| Example 21 | Laminate 22 | 36 | 37 | 25 |
| Example 22 | Laminate 23 | 32 | 32 | 21 |
| Example 23 | Laminate 24 | 20 | 22 | 13 |
| Example 24 | Laminate 25 | 41 | 47 | 36 |

TABLE 11

| | | Separation Performance | | |
|---|---|---|---|---|
| | | CO₂/O₂ | CO₂/N₂ | CO₂/CH₄ |
| Example 20 | Laminate 21 | 23 | 22 | 13 |
| Example 21 | Laminate 22 | 22 | 22 | 15 |
| Example 22 | Laminate 23 | 20 | 21 | 14 |
| Example 23 | Laminate 24 | 23 | 25 | 15 |
| Example 24 | Laminate 25 | 21 | 24 | 18 |

From the above Tables 3 to 6 and the Tables 8 to 11, it is known that the gas-selective permeable membrane of the present invention has high gas selectivity performance while having high permeability. On the other hand, the laminate 20 of Comparative Example 1 does not use a polymerizable compound but uses a non-polymerizable compound, and therefore it could hardly keep a membrane state, that is, a gas-selective permeable membrane having a desired performance could not be obtained.

In addition, the gas-selective permeable membrane of the present invention has high gas selectivity performance, and therefore can be laminated on a substrate having high gas permeability performance to construct a laminate, or can be formed into a laminate that can add a high gas selectivity performance to the substrate used, and consequently the gas-selective permeable membrane of the present invention can be used for selection of various gases and as gas-selective permeable membrane modules.

1. A gas-selective permeable membrane which is produced using at least one or more polymerizable compounds and comprises a polymer having an optically uniaxial or multiaxial molecular alignment.

2. The permeable membrane according to claim 1, wherein the long axis direction of the molecular alignment of the polymer is in a horizontal direction with respect to a face of the membrane or in a vertical direction with respect to a face of the membrane.

3. The permeable membrane according to claim 1, wherein the long axis direction of the molecular alignment of the polymer is in a horizontal direction with respect to a face of the membrane and is helical with respect to the thickness direction of the membrane.

4. The permeable membrane according to claim 1, wherein the long axis direction of the molecular alignment of the polymer is in a horizontal direction with respect to only one face of the membrane.

5. The permeable membrane according to claim 1, wherein the polymerizable compound is a compound having a hard segment having 3 or more cyclic structures.

6. The permeable membrane according to claim 1, wherein the polymerizable compound is a compound having at least 2 or more polymerizable groups.

7. The permeable membrane according to claim 1, wherein the polymerizable compound has at least 2 or more polymerizable groups and a hard segment having 3 or more cyclic structures, and is represented by the following general formula (1):
(P¹-Sf¹ₙ₁HDSf²-P²)ₙ₂ (1)
wherein Sf¹ and Sf² each independently represent a soft segment, and plural Sf¹'s and Sf²'s, if any, may be the same or different, respectively, P¹ and P² each independently represent a polymerizable group, and plural P¹'s and P²'s, if any, may be the same or different, respectively, HD represents a hard segment having 3 or more cyclic structures, n1 and n2 each independently represent an integer of 0 to 3, and when n1 and/or n2 are/is 0, HD has a terminal group in place of the corresponding -Sf-P, and n1+n2≥2.

8. The permeable membrane according to claim 1, wherein the thickness of the membrane is 0.005 μm or more to 50 μm or less.

9. The permeable membrane according to claim 1, which has gas selectivity for any one or more of hydrogen, helium, methane, carbon monoxide, carbon dioxide, nitrogen, oxygen, ethane, ethylene, propane, propylene, butane and hydrogen sulfide.

10. A laminate comprising: a gas-permeable substrate; and the permeable membrane according to claim 1 laminated on the gas-permeable substrate.

11. The laminate according to claim 10, wherein the gas-permeable substrate is any one of a flat film, a porous film and a hollow fiber film each comprising a material selected from polyethylene glycol, polypropylene glycol, polyvinyl acetate, polydimethylsiloxane, polyimide, polyethylene, polypropylene and polymethylpentene.

12. A gas-selective module comprising the permeable membrane according to claim 1.

13. A gas-selective module comprising the laminate according to claim 11.
